(19) United States
(12) Patent Application Publication
(10) Pub. No.: US 2003/0235795 A1
(43) Pub. Date: Dec. 25, 2003

(54) Photothermographic material

(75) Inventors: Hajime Nakagawa, Kanagawa (JP); Yoshihisa Tsukada, Kanagawa (JP); Seiichi Yamamoto, Kanagawa (JP); Takayoshi Oyamada, Kanagawa (JP); Kouta Fukui, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/225,189

(22) Filed: Aug. 22, 2002

(30) Foreign Application Priority Data
Aug. 22, 2001 (JP) P.2001-251201
Aug. 24, 2001 (JP) P.2001-254278
Aug. 24, 2001 (JP) P.2001-254880
Sep. 12, 2001 (JP) P.2001-276965
Nov. 15, 2001 (JP) P.2001-350124

(51) Int. Cl. G03C 1/04; G03C 1/09; G03C 1/498

(52) U.S. Cl. 430/568; 430/620; 430/627; 430/605; 430/600

(57) ABSTRACT

The object of the present invention is to provide a photothermographic material improved in the aging stability of unprocessed photosensitive material and/or in the image stability after the processing, which is a photothermographic material of the invention comprising a support and on the same surface of the support, a photosensitive silver halide, a non-photosensitive organic silver salt, a reducing agent and a binder, wherein the concentration of chloride contained on the same surface is 1,000 ppm or less based on the organic silver salt.

### FIELD OF THE INVENTION

The present invention relates to a photothermographic material (a heat-developable photosensitive material).

### BACKGROUND OF THE INVENTION

In recent years, reduction of amount of waste processing solutions is strongly desired in the medical field from the standpoint of environmental protection and space savings. Techniques relating to photosensitive heat-developable photographic materials for use in medical diagnosis and photomechanical processes are required, which enable efficient exposure by a laser image setter or laser imager and formation of a clear black image having high resolution and sharpness. The photosensitive heat-developable photographic material can provide users with a simple and non-polluting heat development processing system that eliminates the use of solution-type processing chemicals.

Although the same is required also in the field of general image-forming materials, the image for medical diagnosis in particular must be finely drawn and therefore, high image quality with excellent sharpness and graininess is needed. Moreover, in view of diagnostic convenience, an image of cold black tone is preferred. At present, various hard copy systems using a pigment or a dye are commercially available as a general image-forming system, such as ink jet printer and electrophotography, however, these are not a satisfactory output system for the medical-use image.

On the other hand, thermal image forming systems using an organic silver salt are described, for example, in U.S. Pat. Nos. 3,152,904 and 3,457,075, B. Shely, Thermally Processed Silver Systems, and Sturge, V. Walworth and A. Shepp (compilers), Imaging Processes and Materials, 8th ed., page 2, Neblette (1996). In particular, heat-developable photosensitive materials generally have a photosensitive layer comprising a binder matrix having dispersed therein a catalytic amount of a photocatalyst (for example, silver halide), a reducing agent, a reducible silver salt (for example, organic silver salt) and if desired, a color toner for controlling the silver tone. The heat-developable photosensitive material after image exposure is heated at a high temperature (for example, 80° C. or more) to bring about an oxidation-reduction reaction between the silver halide or reducible silver salt (acting as an oxidizing agent) and the reducing agent and thereby form a black silver image. The oxidation-reduction reaction is accelerated by the catalytic action of a silver halide latent image generated upon exposure. Therefore, the black silver image is formed in the exposed area. This is disclosed in many publications including U.S. Pat. No. 2,910,377 and JP-B-43-4924 (the term “JP-B” as used herein means an “examined Japanese patent publication”). As a medical image forming system using a heat-developable photosensitive material, “FM-DP L” (Fuji Medical Dry Imager) is put on the market.

For the production of a thermal image forming system using an organic silver salt, a method of producing the system by coating a solvent, and a method of producing the system by coating and drying a coating solution containing, as a main binder, an aqueous dispersion of fine polymer particles are known. The latter method needs only a simple production equipment and is suited for mass production, because a step for recovery or the like of solvent is unnecessary.

In order to more downsize the exposure processing apparatus for the thermal image forming system using an organic silver salt, the photosensitive silver halide is demanded to have higher sensitivity. After the heat-development, density sometimes increases in the expressed area due to exposure during storage of the photosensitive material. It is known that a phenomenon called print-out can be improved by reducing the amount of photosensitive silver halide in the photosensitive material.

However, reduction in the amount of photosensitive silver halide incurs reduction in the sensitivity and in the maximum density and therefore, formation of finer photosensitive silver halide grains is demanded to increase the maximum density and elevated the sensitivity. In particular, a method capable of elevating the sensitivity without causing deterioration in the performance, such as increase of fog in aging, is desired.

Conventionally, in many heat-developable photosensitive materials, the photosensitive layer is formed by applying a coating solution using an organic solvent such as toluene, methyl ethyl ketone and methanol as the solvent. Use of an organic solvent is disadvantageous not only in view of the effect on human body and environment in the production step but also in view of the recovery of solvent and furthermore, in view of the cost.

Therefore, a method of forming a photosensitive layer by applying a coating solution using a water medium free of the above-described problems has been disclosed. For example, JP-A-49-52626 (the term “JP-A” as used herein means an “unexamined published Japanese patent application”) and JP-A-53-116114 disclose a technique of using gelatin as a binder, and JP-A-50-151138 discloses a technique of using polyvinyl alcohol as a binder.

However, heat-developable photosensitive materials having a photosensitive layer formed by these techniques cannot be used in practice because of serious fog and very bad color tone of the image formed. On the other hand, JP-A-10-10669 and JP-A-10-62899 disclose a technique of forming a photosensitive layer by using an aqueous medium and employing a polymer as a binder. By this technique, a heat-developable photosensitive material improved in the fog and image tone and preferred in view of environmental conservation, safety, cost and the like can be produced.

This heat-developable photosensitive material is, however, not satisfied in the photographic properties, particularly is deficient in so-called image storability, such as increase in the unexposed area after the image formation or change of silver tone. Thus, an improvement is demanded.

With respect to the technique of specifying the halide ion concentration in the heat-developable material, EP-A-0964299 specifies the halide ion concentration based on a water-soluble protein binder, however, this patent relates to a heat-sensitive recording material and differs from the embodiment of the present invention and the effect of the present invention is not referred to therein.

In the field of image for medical diagnosis by a laser imager system using the above-described heat-developable photosensitive material, the fog density is high as compared with conventional silver halide photosensitive material using processing solutions such as developer and an improvement is demanded.

Furthermore, the dry silver-type heat-developable photosensitive material is not satisfied in the light fastness after heat development and is in need of improvement.

### SUMMARY OF THE INVENTION

The present invention has been made to solve the above-described problems in conventional techniques and achieve the following objects.

The heat-developable photosensitive material is, in view of its principle, poor in the aging stability of unprocessed photosensitive material and in the image stability after processing (e.g., increase of density on white background, change of silver tone of image area) as compared with conventional liquid development system and therefore, the subject matter is to improve these defects.

Accordingly, a first object of the present invention is to provide a heat-developable photosensitive material improved in the aging stability of unprocessed photosensitive material and in the image stability after processing.

Furthermore, the object of the present invention is to provide a heat-developable photosensitive material of giving a preferred silver tone.

A second object of the present invention is to provide a heat-developable photosensitive material free of worsening of fog in aging and having high sensitivity.

A third object of the present invention is to provide a heat-developable photosensitive material reduced in fog and ensuring excellent preservability of image formed.

A fourth object of the present invention is to provide a heat-developable photosensitive material for medical image or photomechanical process, which has sufficiently high sensitivity for practical use, is reduced in fog and is improved in the light fastness after heat-development.

These objects can be attained by the following constructions.

(1) A photothermographic material comprising a support and on the same surface of the support, a photosensitive silver halide, a non-photosensitive organic silver salt, a reducing agent, a binder, cloride ion and a development accelerator,

wherein the concentration of chloride ion on said same surface is 1,000 ppm or less based on said organic silver salt (a first embodiment).

(2) The photothermographic material as described in (1), wherein said binder contains a polymer latex.

(3) The photothermqgraphic material as described in (2), wherein the concentration of chloride ion in said polymer latex is 300 ppm or less based on the latex solution.

(4) The photothermographic material as described in (3), wherein said polymer latex contains a chelate compound in an amount of 20 to 900 ppm based on the latex solution.

(5). The photothermographic material as described in (2), wherein said polymer latex is a polymer latex synthesized by emulsion polymerization in the presence of a basic compound.

(6) The photothermographic material as described in (2), wherein the ratio (dv/dn) of the volume weighted average diameter (dv) to the number average diameter (dn) of dispersed particles in said polymer latex is from 1.00 to 1.10.

(7) The photothermographic material as described in (1), wherein said development accelerator is at least one compound represented by the following formula (1), (5) or (6):

Q¹-NHNH—R¹ (1)

wherein Q¹ represents a 5-, 6- or 7-membered unsaturated ring bonded to NHNH—R¹ through a carbon atom, and R¹ represents a carbamoyl group, an acyl group, an alkoxycarbonyl group, an aryloxycarbonyl group, a sulfonyl group or a sulfamoyl group;

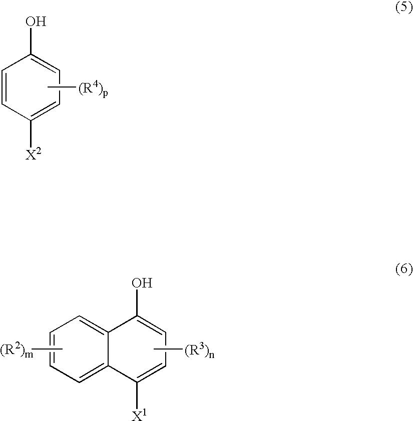

wherein X¹ and X² each independently represents a hydrogen atom or a substituent, R² to R⁴ each independently represents a hydrogen atom or a substituent, m and p each independently represents an integer of 0 to 4, and n represents an integer of 0 to 2.

(8) The photothermographic material as described in (1), wherein the molar ratio of alkali metal ion to NH₄⁺ ion on the surface that said binder resides is from 1:5 to 1:0.5.

(9) The photothermographic material as described in (2), wherein the molar ratio of alkali metal ion to NH₄⁺ ion in said polymer latex is from 1:5 to 1:0.5.

(10) The photothermographic material as described in (9), wherein the alkali metal ion contains at least one of Li⁺, Na⁺ and K⁺.

(11) The photothermographic material as described in (9), wherein the polymer latex is a polymer latex of styrene/butadiene copolymer.

(12) A photothermographic material comprising a support and on the same surface of the support, a photosensitive silver halide, a non-photosensitive organic silver salt, a reducing agent and a binder,

wherein the concentration of chloride ion in all layers in the side of a layer containing said photosensitive silver halide is 1,000 ppm or less based on said organic silver salt, and the photothermographic material comprises a compound represented by the following formula (A):

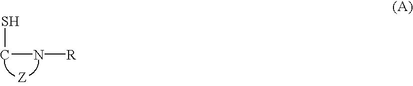

wherein Z represents an atomic group necessary for forming a 5- or 6-membered heteroaromatic ring having at least two or more nitrogen atoms, R represents a hydrogen atom, an alkyl group, an aralkyl group, an alkoxy group, an aryl group, an alkyl group substituted by a substituent (an amino group, an amide group, a sulfonamide group, a ureido group, a urethane group, an aryloxy group, a sulfamoyl group, a carbamoyl group, an aryl group, an alkylthio group, an arylthio group, a hydroxy group, a halogen atom, a sulfonic acid group, a carboxylic acid group, a cyano group, a carboxy group or a salt thereof, or a phosphoric acid amide group) or an aryl group substituted by a substituent (an amino group, an amide group, a sulfonamide group, a ureido group, a urethane group, an aryloxy group, a sulfamoyl group, a carbamoyl group, an aryl group, an alkylthio group, an arylthio group, a hydroxy group, a halogen atom, a sulfonic acid group, a carboxylic acid group, a cyano group, a carboxy group or a salt thereof, or a phosphoric acid amide group). (a second embodiment)

(13) The photothermographic material as described in (12), wherein said photosensitive silver-halide is chemically sensitized.

(14) The photothermographic material as described in (12), wherein said silver halide emulsion is subjected to gold sensitization.

(15) The photothermographic material as described in (12), wherein the average grain size of said silver halide emulsion is from 30 to 50 nm.

(16) The photothermographic material as described in (12), wherein the concentration of chloride ion in all layers in the side of a layer containing said photosensitive silver halide on said support is 200 ppm or less based on said organic silver salt.

(17) A photothermographic material comprising a support and on the same surface of the support, a photosensitive silver halide, a non-photosensitive organic silver salt, a reducing agent and a binder,

wherein said non-photosensitive organic salt has a silver behenate content of 90 to 100 mol %, and said binder contains a polymer latex containing halide ion in an amount of 500 ppm or less based on the latex solution (a third embodiment).

(18) The photothermographic material as described in (17), wherein said polymer latex contains a chelate compound in an amount of 20 to 900 ppm based on the latex solution.

(19) The photothermographic material as described in (17), wherein said polymer latex is a polymer latex synthesized by emulsion polymerization in the presence of a basic compound.

(20) The photothermographic material as described in (17), wherein in said polymer latex, the ratio (dv/dn) of the volume weighted average diameter (dv) to the number average diameter (dn) of dispersed particles is from 1.00 to 1.10.

(21) The photothermographic material as described in (17), wherein said non-photosensitive organic silver salt has a silver behenate content of 94 to 99.5 mol %.

(22) The photothermographic material as described in (17), wherein said non-photosensitive organic silver salt particle has an aspect ratio of 1 to 9.

(23) A process for producing a non-photosensitive organic silver salt particle, comprising adding a solution containing silver ion and a solution or suspension of an organic acid alkali metal salt into closed mixing means to prepare said non-photosensitive organic silver salt particle used in the photothermographic material described in (1).

(24) A process for producing a non-photosensitive organic silver salt particle, comprising ultrafiltering and thereby desalting said non-photosensitive organic silver salt particle used in the photothermographic material described in (1).

(25) A process for producing a non-photosensitive organic silver salt particle, comprising:

adding a solution containing silver ion and a solution or suspension of an organic acid alkali metal salt into closed mixing means to prepare said non-photosensitive organic silver salt grain used in the photothermographic material described in (1); and

ultrafiltering and thereby desalting said non-photosensitive organic silver salt particle.

(26) A photothermographic material comprising a support and on the same surface of the support, a photosensitive silver halide, a non-photosensitive organic silver salt, a reducing agent and a binder,

wherein said non-photosensitive organic silver salt contains two or more reducible silver(I) ions in one molecule, and said binder contains a polymer latex containing a halogen ion in an amount of 500 ppm or less based on the latex solution.

(27) The photothermographic material as described in (26), wherein said polymer latex contains a chelate compound in an amount of 20 to 900 ppm based on the latex solution.

(28) The photothermographic material as described in (26), wherein said polymer latex is a polymer latex synthesized by emulsion polymerization in the presence of a basic compound.

(29) The photothermographic material as described in (26), wherein in said polymer latex, the ratio (dv/dn) of the volume weighted average diameter (dv) to the number average diameter (dn) of dispersed particles is from 1.00 to 1.10.

(30) A photothermographic material comprising a support and on the same surface of the support, a photosensitive silver halide, a non-photosensitive organic silver salt, a reducing agent and a binder,

wherein the concentration of chloride ion on said same surface is 600 ppm or less based on the weight of said organic silver salt, and said reducing agent containes a compound represented by the following formula (R):

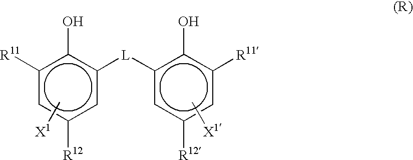

wherein R¹¹ and R¹¹′ each independently represents an alkyl group having from 1 to 20 carbon atoms, R¹² and R¹²′ each independently represents a hydrogen atom or a substituent capable of substituting to the benzene ring, L represents a —S— group or a —CHR¹³— group, R¹³ represents a hydrogen atom or an alkyl group having from 1 to 20 carbon atoms, and X¹ and X¹′ each independently represents a hydrogen atom or a group capable of substituting to the benzene ring. (a fourth embodiment)

(31) The photothermographic material as described in (30), wherein said binder contains a polymer latex in a proportion of 60 to 100 wt %.

(32) The photothermographic material as described in (30), wherein said binder contains polyvinyl butyral in a proportion of 60 to 100 wt %.

(33) The photothermographic material as described in (31), wherein the concentration of chloride ion in said polymer latex is 100 ppm or less based on said polymer latex solution.

(34) The photothermographic material as described in (32), wherein the concentration of chloride ion in said polyvinyl butyral is 50 ppm or less based on said polyvinyl butyral.

(35) The photothermographic material as described in (30), wherein any one of the layers on the same surface of a support contains a compound represented by the following formula (II);

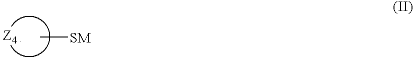

wherein Z₄ represents a heterocyclic ring and M represents a hydrogen atom, an alkali metal atom or a quaternary ammonium or phosphonium group.

(36) The photothermographic material as described in (30), wherein in formula (I), R¹¹ and R¹¹′ each is independently a tertiary alkyl group.

### BRIEF DESCRIPTION OF DRAWING

FIG. 1 is a view showing one practical embodiment of the apparatus for producing organic silver salt grains.

11 Tank

12 Tank

13 Flowmeter

14 Flowmeter

15 Pump

16 Pump

17 Pump

18 Mixing device

19 Heat exchanger

20 Tank

### DETAILED DESCRIPTION OF THE INVENTION

The present invention is described in detail below.

In the heat-developable photosensitive material according to a first embodiment of the present invention, a development accelerator is used and the concentration of chloride ion on the support surface having a photosensitive silver halide, a non-photosensitive organic silver salt, a reducing agent and a binder is specified to 1,000 ppm or less based on the organic silver salt, whereby the object can be attained.

<Description of Chloride Ion in Heat-Developable Photosensitive Material of the Present Invention>

In the first, second and fourth embodiments of the present invention, the chloride ion concentration is specified to 1,000 ppm or less, or 600 ppm or less based on the organic solver salt. In order to attain this concentration range, the chloride ion concentration in chemicals added in the heat-developable photosensitive material must be reduced. Particularly, the chloride ion concentration in a solvent, a binder, an organic silver salt, a reducing agent and the like which are used in a large amount must be strictly controlled.

In the first and second embodiments of the present invention, the chloride ion concentration is preferably 1,000 ppm or less, more preferably 500 ppm or less, still more preferably 200 ppm or less, particularly preferably 100 ppm or less, based on the organic silver salt.

In the heat-developable photosensitive material according to a fourth embodiment of the present invention, the concentration of chloride ion contained in all layers in the side having the photosensitive layer on the support is 600 ppm or less, preferably 400 ppm or less, more preferably 200 ppm or less, still more preferably 50 ppm or less, based on the weight of organic silver salt.

If the chloride ion concentration based on the weight of organic silver salt exceeds 600 ppm, the light fastness after the processing of the heat-developable photosensitive material is seriously deteriorated.

The chloride ion concentration in the heat-developable photosensitive material can be determined by extracting the chloride ion with water/methanol mixed solvent (water:methanol=2:1) from the photosensitive material and measuring the concentration using ion microphotography.

<Description of Alkali Metal Ion and NH₄⁺ Ion in Heat-Developable photosensitive Material of the Present Invention>

The heat-developable photosensitive material of the present invention preferably contains one or more kind of alkali metal ion and ammonium ion. By the content of these alkali metal ion and ammonium ion, the silver tone can be controlled at the heat development.

In order to keep good silver tone, the molar ratio of alkali metal ion to ammonium ion is preferably from 1:5 to 1:0.5, more preferably from 1:4 to 1:1.

Preferred examples of the alkali metal include Li⁺, Na⁺ and K⁺. Only one of these may be used but a plurality of these alkali metal ions may be used simultaneously. Among these, Na⁺ is more preferred.

These alkali metal ion and ammonium ion each is preferably used after adding it to a polymer latex which is described later. In adding an alkali metal to a latex, the alkali metal is preferably added as LiOH, NaOH or KOH. In adding ammonium ion to a latex, the ammonium may be added in the form of an alkali such as aqueous ammonia or in the form of an ammonium salt such as ammonium sulfate and ammonium nitrate, but is preferably added as aqueous ammonia.

<Description of Binder of the Present Invention>

(Binder Which can be used in the Present Invention)

In the present invention, the binder used for the organic silver salt-containing layer may be any polymer and the suitable binder is transparent or translucent and generally colorless. Examples thereof include natural resins, polymers and copolymers; synthetic resins, polymers and copolymers; and film-forming mediums such as gelatins, rubbers, poly(vinyl alcohols), hydroxyethyl celluloses, cellulose acetates, cellulose acetate butyrates, poly(vinyl pyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinyl acetals) (e.g., poly(vinyl formal), poly(vinyl butyral)), poly(esters), poly(urethanes), phenoxy resin, poly(vinylidene chlorides), poly(epoxides), poly(carbonates), poly(vinyl acetates), poly(olefins), cellulose esters and poly(amides). The binder may also be coated and formed from water, an organic solvent or an emulsion.

The binder for use in the present invention preferably has a glass transition temperature (Tg) of −20 to 80° C., more preferably from 0 to 70° C., still more preferably from 10 to 70° C. A blend of two or more polymers may also be used as the binder and in this case, the weighted average Tg by taking account of the composition content is preferably within the above-described range. In the case where the blend undertakes phase separation or has a core-shell structure, Tg of respective phases preferably falls within the above-described range.

In the present specification, the Tg is calculated by the following formula:

1/Tg=Σ(X₁/Tgᵢ)

wherein assuming that the polymer is resultant of the copolymerization of n monomer components from i=1 to i=n, Xᵢ is the weight fraction (ΣXᵢ=1) of the i-th monomer and Tgᵢ is the glass transition temperature (absolute temperature) of a homopolymer of the i-th monomer, provided that Σ is the sum of i=1 to i=n. Incidentally, for the glass transition temperature (Tgᵢ) of a homopolymer of each monomer, the values described in J. Brandrup and E. H. Immergut, Polymer Handbook, 3rd ed., Wiley-Interscience (1989) are employed.

If desired, two or more binders may be used in combination. Also, a binder having a glass transition temperature of 20° C. or more and a binder having a glass transition temperature of less than 20° C. may be used in combination. When two or more polymers different in Tg are blended, the weight average Tg thereof preferably falls within the above-described range.

(Description of Polymer Latex of the Present Invention)

In the present invention, the organic silver salt-containing layer is preferably formed by coating and drying a coating solution where 30 mass % or more of the solvent is water.

In the present invention, the performance is enhanced when the organic silver salt-containing layer is formed by coating and drying a coating solution where 30 mass % or more of the solvent is water, and furthermore when the binder of the organic silver salt-containing layer is soluble or dispersible in an aqueous solvent (water solvent), particularly when the binder is composed of a polymer latex having an equilibrium moisture content of 2 mass % or less at 25° C. and 60% RH. In a most preferred form, the binder is prepared to have an ion conductivity of 2.5 mS/cm or less. Examples of the method for such preparation include a method of synthesizing a polymer and then purifying it using a membrane having a separating function.

The term “an aqueous solvent” in which the above-described polymer is soluble or dispersible means water or a mixture of water and 70 mass % or less of a water-miscible organic solvent. Examples of the water-miscible organic solvent include alcohol-base solvents such as methyl alcohol, ethyl alcohol and propyl alcohol, cellosolve-base solvents such as methyl cellosolve, ethyl cellosolve and butyl cellosolve, ethyl acetate, and dimethylformamide.

The term “aqueous solvent” is used here also for a system where the polymer is not thermodynamically dissolved but is present in a so-called dispersed state.

The term “equilibrium moisture content at 25° C. and 60% RH” can be expressed as follows using the weight W1 of a polymer in the humidity equilibration in an atmosphere of 25° C. and 60% RH and the weight W0 of a polymer in the bone dry state at 25° C.:

Equilibrium moisture content at 25° C. and 60% RH=[(W1−W0)/W0]×100(mass %)

With respect to the definition and the measuring method of moisture content, for example, Kobunshi Kogaku Koza 14, Kobunshi Zairvo Shiken Hou (Lecture 14 of Polymer Engineering, Polymer Material Testing Method), compiled by Kobunshi Gakkai, Chijin Shokan, may be referred to.

In the present invention, a polymer dispersible in an aqueous solvent is particularly preferred. Examples of the dispersed state include a case where fine particles of a water-insoluble hydrophobic polymer are dispersed in the form of latex, and a case where polymer molecules are dispersed in the molecular state or by forming micelles. Either case may be used but the case where particles are dispersed in the latex form is more preferred. The average particle size of the dispersed particles is from 1 to 50,000 nm, preferably from 5 to 1,000 nm, more preferably from 10 to 500 nm, still more preferably from 50 to 200 nm. The particle size distribution of the dispersed particles is not particularly limited and the dispersed particles may have either a wide particle size distribution or a monodisperse particle size distribution. A method of using a mixture of two or more dispersed particles having a monodisperse particle size distribution is also preferred in controlling the physical properties of the coating solution.

Examples of the halide ion contained in the polymer latex for use in the present invention include fluoride ion, chloride ion, bromide ion and iodide ion. In view of photographic performance, chloride ion, bromide ion and iodide ion have a large effect, and chloride ion is larger in the effect.

The chloride ion content in the polymer latex for use in the present invention is preferably 300 ppm or less, more preferably 100 ppm or less, still more preferably 50 ppm or less, based on the latex solution. If the chloride ion content based on the latex exceeds 300 ppm, the aging stability of the heat-developable photosensitive material in the unprocessed state and the image preservability after processing are extremely deteriorated.

Hereinafter, the chloride ion content means a chloride ion content based on the latex solution.

In the heat-developable photosensitive material according to the fourth embodiment of the present invention, the chloride ion concentration in the polymer latex solution or polyvinyl butyral is preferably 100 ppm or less, more preferably 50 ppm or less, still more preferably 20 ppm or less, based on the polymer latex solution or polyvinyl butyral. In the case of polyvinyl butyral, the chloride ion concentration is most preferably 10 ppm or less.

The chloride ion content in the polymer latex for use in the present invention can be determined by pre-treating a sample to be measured by a centrifugal separator (at 3,000 rpm for 1 hour) using an ultrafiltration membrane such as Sartorius Centrisart I (cut-off 5000) and then subjecting the sample to ion chromatography. Representative measurement conditions are shown below.

-Measurement Conditions-

Measuring apparatus:

DIONEX Model DX500 ion chromatography

Separation column: AS4a (F, Cl, Br) AS-12a(I)

Eluent:

sodium carbonate/sodium hydrogencarbonate 4 mM

Flow rate: 1.2 ml/min

For the binder used in the third embodiment of the present invention, a polymer latex is used and the polymer latex may contain halide ion or a chelate compound.

Examples of the halide ion contained in the polymer latex for use in the present invention include fluoride ion, chloride ion, bromide ion and iodide ion. In view of photographic performance, chloride ion, bromide ion and iodide ion are preferred, chloride ion and bromide ion are more preferred, and chloride ion is particularly more preferred.

The halide ion content in the polymer latex for use in the present invention is preferably 500 ppm or less, more preferably 200 ppm or less, still more preferably 100 ppm or less, based on the latex solution. If the halide ion content based on the latex exceeds 500 ppm, the image preservability is deteriorated.

Also, the halide ion content is, based on the latex solid content, preferably 1,200 ppm or less, more preferably 500 ppm or less, still more preferably 250 ppm or less.

Hereinafter, the halide ion content means a halide ion content based on the latex solution.

The halide ion content in the polymer latex for use in the present invention can be determined by pre-treating a sample to be measured by a centrifugal separator (at 3,000 rpm for 1 hour) using an ultrafiltration membrane such as Sartorius Centrisart I (cut-off 5000) and then subjecting the sample to ion chromatography. Representative measurement conditions are shown below.

-Measurement Conditions

Measuring apparatus:

DIONEX Model DX500 ion chromatography Separation column: AS-4a (F, Cl, Br) AS-12a(I)

Eluent:

sodium carbonate/sodium hydrogencarbonate 4 mM

Flow rate: 1.2 ml/min

The chelate compound contained in the polymer latex for use in the present invention is a compound capable of coordinating (chelating) a polyvalent ion such as metal ion (e.g., iron ion) or alkaline earth metal ion (e.g., calcium ion) and examples of the chelate compound which can be used include the compounds described in JP-B-6-8956, U.S. Pat. No. 5,053,322, JP-A-4-73645, JP-A-4-127145, JP-A-4-247073, JP-A-4-305572, JP-A-6-11805, JP-A-5-173312, JP-A-5-66527, JP-A-5-158195, JP-A-6-118580, JP-A-6-110168, JP-A-6-161054, JP-A-6-175299, JP-A-6-214352, JP-A-7-114161, JP-A-7-114154, JP-A-7-120894, JP-A-7-199433, JP-A-7-306504, JP-A-9-43792, JP-A-8-314090, JP-A-10-182571, JP-A-10-182570 and JP-A-11-190892. Preferred examples of the chelate compound for use in the present invention include inorganic chelate compounds (e.g., sodium tripolyphosphate, sodium hexametaphosphate, sodium tetrapolyphosphsate), aminopolycarboxylic acid-based chelate compounds (e.g., nitrilotriacetate, ethylenediaminetetraacetate), organic phosphonic acid-based chelate compounds (e.g., compounds described in Research Disclosure, No. 18170, JP-A-52-102726, JP-A-53-42730, JP-A-56-97347, JP-A-54-121127, JP-A-55-4024, JP-A-55-4025, JP-A-55-29883, JP-A-55-126241, JP-A-55-65955, JP-A-55-65956, JP-A-57-179843, JP-A-54-61125 and West German Patent 1045373), polyphenol-based chelating agents and polyamine-based chelate compounds, with aminopolycarboxylic acid derivatives being more preferred.

Preferred examples of the aminopolycarboxylic acid derivative for use in the present invention include the compounds shown in the Table attached to EDTA (-Complexane no Kagaku (Chemistry of Complexane)-), Nankodo (1977). In these compounds, a part of the carboxyl groups may be substituted by an alkali metal salt such as sodium or potassium or by an ammonium salt. More preferred examples of the aminopolycarboxylic acid derivative include iminodiacetic acid, N-methyliminodiacetic acid, N-(2-aminoethyl)iminodiacetic acid, N-(carbamoylmethyl)imino diacetic acid, nitrilotriacetic acid, ethylenediamine-N,N′-diacetic acid, ethylenediamine-N,N′-di-α-propionic acid, ethylenediamine-N,N′-di-β-propionic acid, N,N′-ethylene-bis(α-o-hydroxyphenyl)glycine, N,N′-di (2-hydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,l-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,l-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraactic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-a-propionic acid, ethylenediamine-N,N′-diacetic acid-N,N′-di-β-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid and 1,2,3-triaminopropane-N,N,N′,N″,N′″,N′″-hexaacetic acid. In these compounds, a part of the carboxyl groups may be substituted by an alkali metal salt such as sodium or potassium or by an ammonium salt.

The content of the chelate compound contained in the polymer latex for use in the present invention is from 20 to 900 ppm, preferably from 40 to 600 ppm, more preferably from 90 to 450 ppm, based on the polymer latex. If the chelate compound concentration is less than 20 ppm, the metal ion mingling in the process of producing the polymer latex is insufficiently captured, as a result, the latex is reduced in the stability against aggregation and worsened in the coating property, whereas if it exceeds 900 ppm, the viscosity of the latex increases and this gives rise to deterioration in the coating property and further in the image preservability. The chelate compound content is from 50 to 2,000 ppm, preferably from 100 to 1,500 ppm, more preferably from 200 to 1,000 ppm, based on the solid content of the polymer latex. Hereinafter, the chelate compound content means a chelate compound content based on the latex solution.

The polymer latex for use in the present invention is preferably synthesized by emulsion polymerization in the presence of a basic compound. The basic compound used may be an inorganic basic compound, an organic basic compound or an inorganic•organic mixed basic compound. Examples of the inorganic basic compound include hydroxides of alkali metal or alkaline earth metal except for beryllium in the periodic table, and ammonia. Among these, preferred are lithium hydroxide, sodium hydroxide, potassium hydroxide, calcium hydroxide, strontium hydroxide, barium hydroxide and ammonia, and more preferred are lithium hydroxide, sodium hydroxide, potassium hydroxide and ammonia.

Examples of the organic basic compound for use in the present invention include aliphatic amines (e.g., methylamine, ethylamine, diethylamine, triethylamine), aromatic amines (e.g., aniline, p-methoxyaniline), nitrogen-containing cyclic compounds (e.g., pyrrole, imidazole, pyridine, pyrazine, pyridazine, derivatives thereof). Among these, preferred are methylamine, ethylamine, triethylamine and pyridine, and more preferred are methylamine and triethylamine.

These basic compounds may be used individually or in combination of two or more thereof.

The basic compound for use in the present invention is preferably used in an amount of 1.0×10⁻⁵ mmol or more, more preferably 1 ×10⁻³ mmol or more, still more preferably from 5.0×10⁻³ to 1.0 mmol, per g of the solid content of polymer latex.

In the polymer latex for use in the present invention, the ratio (dv/dn) of the volume weighted average diameter (dv) to the number average diameter (dn) of dispersed particles is from 1.0 to 1.10, preferably from 1.0 to 1.05, more preferably from 1.0 to 1.02. The dv/dn cannot be theoretically less than 1.0 and if it exceeds 1.10, the viscosity greatly departs from the viscosity range estimated from the average particle size and a homogeneous surface state cannot be obtained.

The number average diameter (dn) and the volume weighted average diameter (dv) each is a value determined as follows. The particle size of dispersed particles of the latex can be analyzed by a direct observation method using a low-temperature transmission-type electron microscope. In the direct observation of dispersed particles of the latex using a transmission-type electron microscope, a latex dispersion solution 20-fold diluted with water is placed on a mesh for the observation with an electron microscope, frozen by dipping the solution in liquid nitrogen and observed through the electron microscope at a liquid nitrogen temperature. The obtained photograph of particles is data-processed by an image processing soft (Win ROOF, produced by Mitsuya Shoji) to determine the calculated number average particle size and volume average particle size, and the ratio thereof is used as an index for the particle size distribution.

The particle size distribution is preferably controlled by adjusting the amount of a surfactant (which is described later) added. More specifically, the amount of the surfactant added to the monomer is preferably from 0.05 to 10 mass %, more preferably from 0.1 to 5 mass %, based on the total amount of monomers.

In the polymer latex for use in the present invention, the dispersed particles preferably have a number average particle size of 30 to 300 nm, more preferably from 40 to 250 nm, still more preferably from 50 to 200 nm. If the number average particle size is less than 30 nm, the viscosity of the coating solution extremely increases and homogeneous coating cannot be obtained, whereas if the number average particle size exceeds 300 nm, the coating solution suffers from bad stability and causes aggregation or precipitation and a homogeneous film cannot be obtained.

The polymer latex for use in the present invention has a sol formation ratio of 5 to 55 mass %, preferably from 15 to 45 mass %, more preferably from 20 to 40 mass %. If the sol formation ratio is less than 5 mass %, the fusing component in the binder is decreased to worsen the work brittleness, whereas if it exceeds 55 mass %, the fusing component in the binder is increased and the binder is elevated in the maneuverability, giving rise to reduction in the image preservability.

The “sol formation ratio” as used herein means a value calculated as follows. In an aluminum foil Petri dish, 25 g of a polymer sample is weighed and dried at 60° C. for 2 hours using a blast drier. The obtained dry film is further dried at 120° C. for 0.5 hours and cut into a size of about 2×2 cm. This film was placed in a wire gauze cage (300 mesh) and left standing in 60 ml of tetrahydrofuran (THF) for 16 hours or more. The cage is taken out from THF and dried at 110° C. for 1 hour, the amount of sample (gel portion) remained in the cage is weighed and therefrom, a sol formation ratio (ratio of components other than gel portion) and a gelling ratio (ratio of gel portion) are calculated.

The sol formation ratio is preferably controlled by adjusting the amount added of a chain transfer agent which is described later. Specifically, the amount of the chain transfer agent added to the monomer is preferably from 0.01 to 5 mass %, more preferably from 0.1 to 3 mass %, based on the total mass of monomers.

In the polymer latex for use in the present invention, the sol moiety has a mass average molecular weight of 10,000 to 200,000, preferably from 30,000 to 150,000, more preferably from 40,000 to 100,000. If the mass average molecular weight of the sol is less than 10,000, the fusibility of the binder decreases and the work brittleness is worsened, whereas if it exceeds 200,000, the fusing component of the binder increases and the maneuverability of the binder is elevated, as a result, the image preservability decreases.

The mass average molecular weight in the sol moiety of the polymer latex for use in the present invention is determined by gel permeation chromatography.

In the polymer latex for use in the present invention, the sol moiety has a glass transition temperature of −30 to 50° C., preferably from 0 to 30° C., more preferably from 10 to 25° C. If the glass transition temperature of the sol is less than −30° C., the maneuverability of the binder is elevated and therefore, the image preservability decreases, whereas it exceeds 50° C., the fusibility of the binder decreases and the work brittleness is worsened.

The binder for use in the present invention preferably has a glass transition temperature (Tg) of −20 to 80° C., more preferably from 0 to 70° C., still more preferably from 10 to 60° C. For the binder, a blend of two or more polymers may also be used and in this case, the weighted average Tg by taking account of the composition content preferably falls within the above-described range. In the case where phase separation takes place or a core-shell structure is formed, each phase preferably has a Tg falling within the above-described range.

The kind of the polymer for the polymer latex used in the present invention is not particularly limited and examples of the polymer which can be used include hydrophobic polymers such as acrylic resin, polyester resin, rubber-base resin (e.g., conjugated diene copolymer), polyurethane resin, vinyl chloride resin, vinyl acetate resin, vinylidene chloride resin and polyolefin resin, and copolymers thereof. Among these, preferred are acrylic resin, polyester resin, rubber-base resin (e.g., conjugated diene copolymer) and polyurethane resin, and more preferred are acrylic resin and rubber-base resin (e.g., conjugated diene copolymer).

In particular, the polymer for use in the present invention is preferably a homopolymer or a copolymer of a monomer selected from the following monomer groups (a) to (j) and these monomers may be used individually or may be freely combined. In view of the photographic properties and film quality, the polymer is more preferably a polymer obtained by the copolymerization of at least a conjugated diene. The monomer unit which can be used is not particularly limited and any monomer unit may be suitably used insofar as it can be polymerized by a normal radical polymerization or ion polymerization method.

Monomer Groups (a) to (j)

(a) Conjugated Diene:

1,3-Butadiene, isoprene, 1,3-pentadiene, 2-ethyl-1,3-butadiene, 2-n-propyl-1,3-butadiene, 2,3-dimethyl-1,3-butadiene, 2-methyl-1,3-butadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chloro-1,3-butadiene, 2-fluoro-1,3-butadiene, 2,3-dichloro-1,3-butadiene, 1,1,2-trichloro-1,3-butadiene, 2-cyano-1,3-butadiene, cyclopentadiene, etc.

(b) Olefin:

Ethylene, propylene, vinyl chloride, vinylidene chloride, 6-hydroxy-1-hexene, 4-pentenoic acid, methyl 8-nonenoate, vinylsulfonic acid, trimethylvinylsilane, trimethoxyvinylsilane, 1,4-divinylcyclohexane, 1,2,5-trivinylcyclohexane, etc.

(c) α,β-Unsaturated Carboxylic Acid and Salts Thereof:

Acrylic acid, methacrylic acid, itaconic acid, maleic acid, sodium acrylate, ammonium methacrylate, potassium itaconate, etc.

(d) α,β-Unsaturated Carboxylic Acid Esters:

Alkyl acrylates (e.g., methyl acrylate, ethyl acrylate, butyl acrylate, cyclohexyl acrylate, 2-ethylhexyl acrylate, dodecyl acrylate), substituted alkyl acrylates (e.g., 2-chloroethyl acrylate, benzyl acrylate, 2-cyanoethyl acrylate), alkyl methacrylates (e.g., methyl methacrylate, butyl methacrylate, 2-ethylhexyl methacrylate, dodecyl methacrylate), substituted alkyl methacrylates (e.g., 2-hydroxyethyl methacrylate, glycidyl methacrylate, glycerol monomethacrylate, 2-acetoxyethyl methacrylate, tetrahydrofurfuryl methacrylate, 2-methoxyethyl methacrylate, polypropylene glycol monomethacrylate (where the addition molar number of polyoxypropylene is from 2 to 100), 3-N,N-dimethylaminopropyl methacrylate, chloro-O-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, 2-isocyanatoethyl methacrylate), unsaturated dicarboxylic acid derivatives (e.g., monobutyl maleate, dimethyl maleate, monomethyl itaconate, dibutyl itaconate), polyfunctional esters (e.g., ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylol ethane triacrylate, dipentaerythritol pentamethacrylate, pentaerythritol hexaacrylate, 1,2,4-cyclohexane tetramethacrylate), etc.

(e) β-Unsaturated Carboxylic Acid Amides:

Acrylamide, methacrylamide, N-methylacrylamide, N,N-dimethylacrylamide, N-methyl-N-hydroxyethylacrylamide, N-tert-butylacrylamide, N-tert-octylmethacrylamide, N-cyclohexylacrylamide, N-phenylacrylamide, N-(2-acetoacetoxyethyl) acrylamide, N-acryloylmorpholine, diacetone acrylamide, itaconic acid diamide, N-methylmaleimide, 2-acrylamido-methylpropanesulfonic acid, methylenebisacrylamide, dimethacryloylpiperazine, etc.

(f) Unsaturated Nitriles:

Acrylonitrile, methacrylonitrile, etc.

(g) Styrene and Derivatives Thereof:

Styrene, vinyl toluene, p-tert-butylstyrene, vinylbenzoic acid, methyl vinylbenzoate, α-methylstyrene, p-chloromethylstyrene, vinyl naphthalene, p-hydroxymethylstyrene, sodium p-styrenesulfonate, potassium p-styrenesulfinate, p-aminomethylstyrene, 1,4-divinylbenzene, etc.

(h) Vinyl Ethers:

Methyl vinyl ether, butyl vinyl ether, methoxyethyl vinyl ether, etc.

(i) Vinyl Esters:

Vinyl acetate, vinyl propionate, vinyl benzoate, vinyl salicylate, vinyl chloroacetate, etc.

(j) Other Polymerizable Monomers:

N-Vinylimidazole, 4-vinylpyridine, N-vinylpyrrolidone, 2-vinyloxazoline, 2-isopropenyloxazoline, divinylsulfone, etc.

Preferred examples of the polymer obtained by the copolymerization of at least a conjugated diene include styrene-butadiene copolymers (e.g., butadiene-styrene block copolymer, styrene-butadiene-styrene block copolymer), styrene-isoprene copolymers (e.g., styrene-isoprene random copolymer, styrene-isoprene block copolymer), ethylenepropylene-diene copolymers (examples of the diene monomer includes 1,4-hexadiene, dicyclopentadiene and ethylidene norbornene), acrylonitrile-butadiene copolymers, isobutylene-isoprene copolymers, butadiene-acrylic acid ester copolymers (examples of the acrylic acid ester include ethyl acrylate and butyl acrylate) and butadiene-acrylic acid ester-acrylonitrile copolymers (examples of the acrylic acid ester which can be used are the same as above). Among these, styrene-butadiene copolymers are most preferred.

Specific examples (Compounds (P-1) to (P-24) and Comparative Compounds (RP-1) to (RP-3)) of the polymer for use in the present invention are set forth below. The molecular weight is a mass average molecular weight and in the case of a polyfunctional monomer, since the concept of the molecular weight cannot be applied, the molecular weight is not shown. In the chemical formulae, x, y, z and z′ attached to the parentheses in the polymer main chain portion represent a mass ratio of the polymer composition and the sum total of x, y, z and z′ is 100%. Also in the chemical formulae, the numerical value attached on the right side of parentheses in the polymer side chain portion represents a polymerization degree. Tg represents a glass transition temperature of the polymer.

Various physical properties of polymer latexes containing the compound set forth below as the dispersed particle are shown in Table 1. The chelate compound is used in the polymerization and the concentration of chelate compound shows the concentration of chelate compound contained in the polymer latex, determined by high performance liquid chromatography. The present invention is not limited to the following specific examples.

TABLE 1

| | |
|---|---|
| (P-1) | 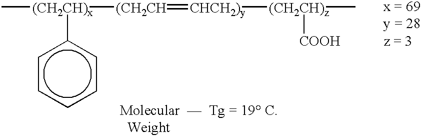 |
| (P-2) | 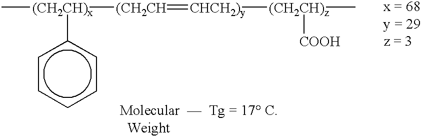 |
| (P-3) | 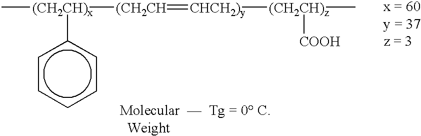 |
| (P-4) | 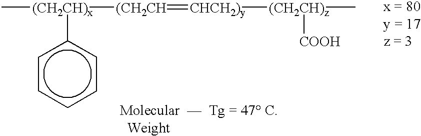 |
| (P-5) | 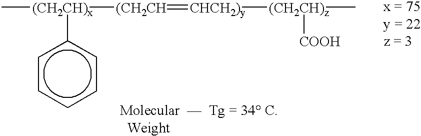 |
| (P-6) | 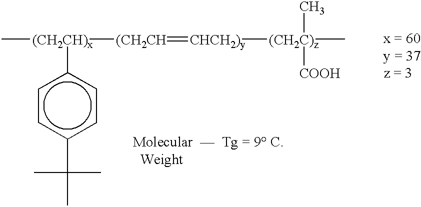 |
| (P-7) | 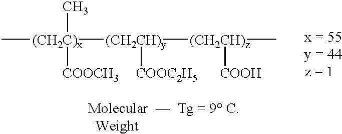 |
| (P-8) | 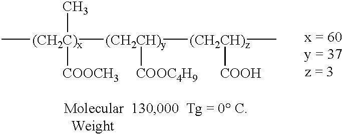 |
| (P-9) | 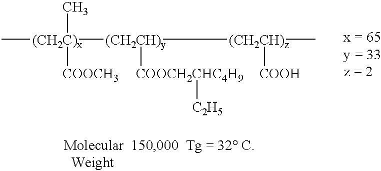 |
| (P-10) | 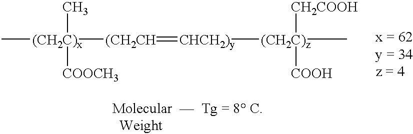 |
| (P-11) | 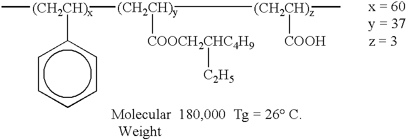 |
| (P-12) | 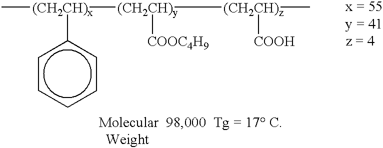 |
| (P-13) | 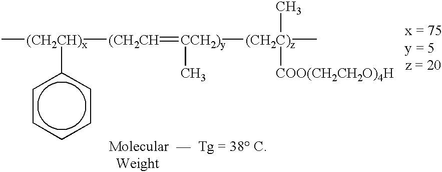 |
| (P-14) | 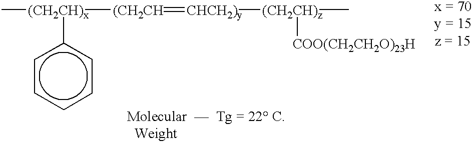 |
| (P-15) | 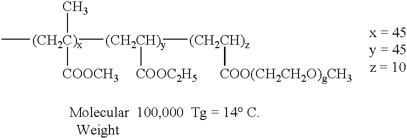 |
| (P-16) | 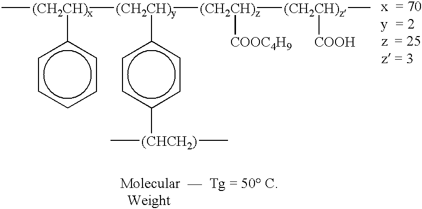 |
| (P-17) | 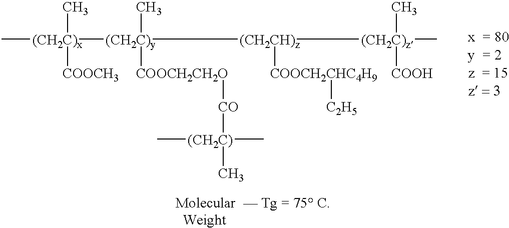 |
| (P-18) | 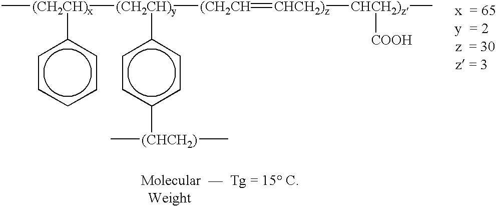 |
| (P-19) | 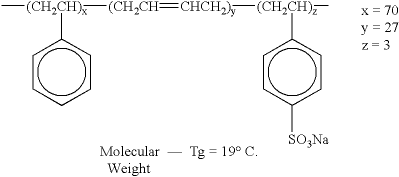 |
| (P-20) | 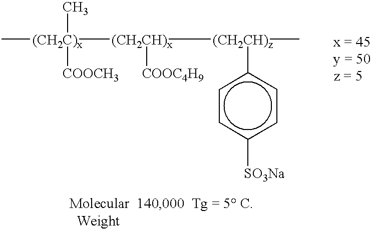 |
| (P-21) | 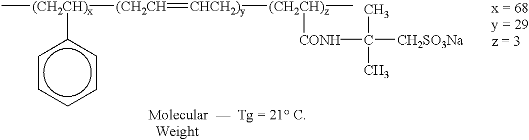 |
| (P-22) | 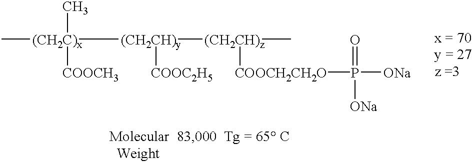 |
| (P-23) | 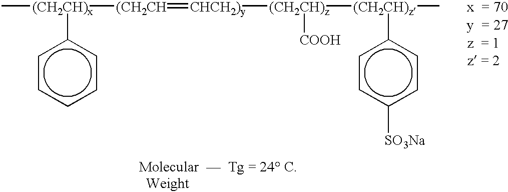 |
| (P-24) | 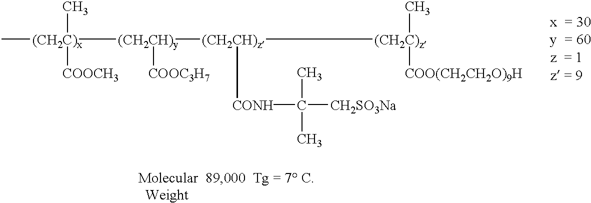 |
| (P-25) | 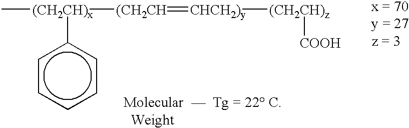 |
| (P-26) | 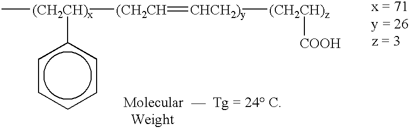 |
| (P-27) | 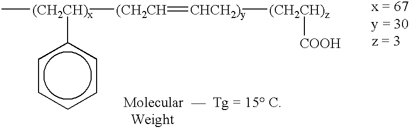 |
| (P-28) | 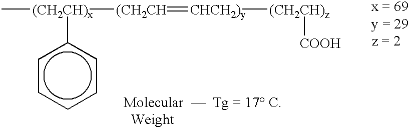 |
| (P-29) | 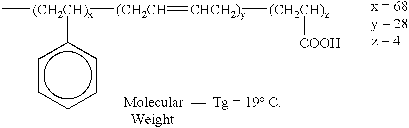 |

| | Halide Ion | | Chelate Compound | | Basic Compound | | | | | | |
|---|---|---|---|---|---|---|---|---|---|---|---|
| | | Concen- | | Concen- | | Concen- | | | Sol | Mole- | |
| Com- | | tration | | tration | | tration | dn | | Formation | cular | Tg |
| pound | Kind | (ppm) | Kind | (ppm) | Kind | (mmol/g) | (nm) | dv/dn | Ratio (%) | Weight | (° C.) |
| P-1 | chloride | 9 | tetrasodium ethylenediaminetetra- | 150 | NaOH | 0.0375 | 95 | 1.007 | 40 | — | 19 |
| | | | acetate | | | | | | | | |
| P-1 | chloride | 9 | tetrasodium ethylenediaminetetra- | 150 | NaOH | 0.0375 | 95 | 2.007 | 40 | — | 19 |
| | | | acetate | | | | | | | | |
| P-2 | chloride | 3 | tetrasodium ethylenediaminetetra- | 145 | NaOH | 0.0375 | 90 | 1.005 | 38 | — | 17 |
| | | | acetate | | | | | | | | |
| P-3 | chloride | 15 | tetrasodium ethylenediaminetetra- | 20 | NaOH | 0.0500 | 91 | 1.020 | 38 | — | 0 |
| | | | acetate | | | | | | | | |
| P-4 | chloride | 25 | tetrasodium ethylenediaminetetra- | 900 | NaOH | 0.0010 | 98 | 1.000 | 32 | — | 47 |
| | | | acetate | | | | | | | | |
| P-5 | chloride | 200 | tetrasodium ethylenediaminetetra- | 500 | NaOH | 0.0040 | 93 | 1.015 | 35 | — | 34 |
| | | | acetate | | | | | | | | |
| P-6 | chloride | 160 | diammonium ethylenediaminetetra- | 35 | NaOH | 0.0750 | 102 | 1.011 | 34 | — | 9 |
| | | | acetate | | | | | | | | |
| P-7 | chloride | 35 | diethylenetriaminepentaacetic | 210 | NaOH | 0.0450 | 95 | 1.005 | 99 | 72000 | 33 |
| | | | acid | | | | | | | | |
| P-8 | chloride | 88 | diaminopropanoltetraacetic acid | 322 | ammonia | 0.0375 | 99 | 1.017 | 100 | 130000 | 0 |
| P-9 | chloride | 32 | hydroxyethylenediaminetriacetac | 48 | ammonia | 0.0450 | 97 | 1.013 | 99 | 150000 | 32 |
| | | | acid | | | | | | | | |
| P-10 | chloride | 7 | dipotassium ethylenediaminetetra- | 581 | NaOH | 0.0250 | 98 | 1.008 | 43 | — | 8 |
| | | | acetate | | | | | | | | |
| P-11 | chloride | 47 | tetrasodium ethylenediaminetetra- | 777 | NaOH | 0.0500 | 107 | 1.009 | 99 | 180000 | 26 |
| | | | acetate | | | | | | | | |
| P-12 | chloride | 86 | 2-hydroxybenzylethylenediamine- | 123 | NaOH | 0.0225 | 100 | 1.007 | 99 | 98000 | 17 |
| | | | diacetic acid | | | | | | | | |
| P-13 | chloride | 56 | nitrilotriacetic acid | 25 | NaOH | 0.0750 | 101 | 1.018 | 50 | — | 38 |
| P-14 | chloride | 146 | dilithium ethylenediaminetetra- | 50 | NaOH | 0.0050 | 94 | 1.020 | 18 | — | 22 |
| | | | acetate | | | | | | | | |
| P-15 | chloride | 220 | tetrasodium ethylenediaminetetra- | 78 | ammonia | 0.0100 | 103 | 1.014 | 98 | 120000 | 14 |
| | | | acetate | | | | | | | | |
| P-16 | chloride | 33 | tetrasodium ethylenediaminetetra- | 99 | NaOH | 0.0750 | 88 | 1.019 | 30 | — | 50 |
| | | | acetate | | | | | | | | |
| P-17 | chloride | 273 | hydroxyethylenediaminetriacetic | 45 | NaOH | 0.0500 | 75 | 1.001 | 33 | — | 75 |
| | | | acid | | | | | | | | |
| P-18 | chloride | 16 | diammonium ethylenediaminetetra- | 334 | NaOH | 0.0250 | 106 | 1.004 | 28 | — | 15 |
| | | | acetate | | | | | | | | |
| P-19 | chloride | 35 | diammonium ethylenediaminetetra- | 786 | NaOH | 0.0100 | 111 | 1.014 | 48 | 140000 | 19 |
| | | | acetate | | | | | | | | |
| P-20 | chloride | 10 | nitrilotriacetic acid | 431 | ammonia | 0.0500 | 108 | 1.009 | 100 | — | 5 |
| P-21 | chloride | 282 | dilithium ethylenediaminetetra- | 234 | LiOH | 0.0375 | 79 | 2.020 | 30 | 83000 | 21 |
| | | | acetate | | | | | | | | |
| P-22 | chloride | 89 | diethylenetriaminepentaacetic | 150 | ammonia | 0.0375 | 110 | 1.011 | 99 | — | 65 |
| | | | acid | | | | | | | | |
| P-23 | chloride | 13 | nitrilotriacetic acid | 701 | NaOH | 0.1125 | 96 | 1.017 | 45 | −0 | 24 |
| P-24 | chloride | 55 | nitrilotriacetic acid | 74 | NaOH | 0.0375 | 112 | 1.009 | 98 | 89000 | 7 |
| P-25 | chloride | 198 | diaminopropanoltetraacetic acid | 206 | NaOH | 0.0500 | 95 | 1.017 | 38 | — | 22 |
| P-26 | chloride | 3 | dipotassium ethylenediaminetetra- | 367 | ammonia | 0.0450 | 114 | 1.013 | 36 | — | 24 |
| | | | acetate | | | | | | | | |
| P-27 | chloride | 1 | tetrasodium ethylenediaminetetra- | 32 | NaOH | 0.0400 | 115 | 1.012 | 35 | — | 15 |
| | | | acetate | | | | | | | | |
| P-28 | chloride | 2 | diammonium ethylenediaminetetra- | 103 | ammonia | 0.0375 | 110 | 1.015 | 44 | — | 17 |
| | | | acetate | | | | | | | | |
| P-29 | chloride | 5 | tetrasodium ethylenediaminetetra- | 134 | NaOH | 0.0375 | 75 | 1.014 | 32 | — | 19 |
| | | | acetate | | | | | | | | |

Comparative Compound

| | | | | | | | | | | | |
|---|---|---|---|---|---|---|---|---|---|---|---|
| RP-1 | chloride | 400 | tetrasodium ethylenediaminetetra- | 150 | NaOH | 0.0375 | 80 | 1.015 | 33 | — | 10 |
| | | | acetate | | | | | | | | |
| RP-2 | chloride | 390 | None | — | NaOH | 0.0375 | 75 | 1.135 | 35 | — | 8 |
| RP-3 | chloride | 4 | tetrasodium ethylenediatainetetra- | 145 | none | — | 90 | 1.205 | 45 | — | 9 |
| | | | acetate | | | | | | | | |

The polymer latex for use in the present invention can be easily obtained, for example, by an emulsion polymerization method. In performing the emulsion polymerization, for example, water or a mixed solvent of water and an organic solvent miscible with water (e.g., methanol, ethanol, acetone) is used as a dispersion medium and a monomer mixture in an amount of from 5 to 40 mass % based on the dispersion medium, a polymerization initiator in an amount of 0.05 to 5 mass % based on the monomer(s) and an emulsifier in an amount of 0.1 to 20 mass % based on the monomer(s) are polymerized under stirring at a temperature of approximately from 30 to 100° C., preferably from 60 to 90° C., for 3 to 8 hours. Various conditions such as dispersion medium, concentration of monomer, amount of polymerization initiator, amount of emulsifier, amount of dispersant, reaction temperature and method for addition of monomer are appropriately selected by taking account of the kind of monomer used. If desired, a dispersant is preferably used.

In the present invention, the chain transfer agent which is used mainly for controlling the sol formation ratio of the polymer latex is preferably selected from the compounds described in Polymer Handbook, 3rd Ed., Wiley-Interscience (1989). A sulfur compound is more preferred because it has high chain transfer function and can serve by the addition in a small amount. A hydrophobic mercaptan-base chain transfer agent such as tert-dodecylmercaptan and n-dodecylmercaptan is still more preferred.

The initiator used in the emulsion polymerization may be sufficient if it is water-soluble and has a radical generating ability, but preferred examples thereof include persulfates and water-soluble azo compounds. Among these, more preferred are ammonium persulfate, sodium persulfate, potassium persulfate and azobiscyanovaleric acid.

The dispersant for use in the emulsion polymerization may be any of an anionic surfactant, a nonionic surfactant, a cationic surfactant and an amphoteric surfactant, however, in view of the dispersibility, an anionic surfactant is preferred.

In addition to the compounds described above, additives described, for example, in Gosei Gomu Handbook (Handbook of Synthetic Rubber) may also be used in the emulsion polymerization, such as electrolyte, stabilizer, thickener, defoaming agent, antioxidant, vulcanizing agent, antifreezing agent, gelling, agent and vulcanization accelerator. In the present invention, the polymer latex is preferably synthesized by the emulsion polymerization in the presence of the above-described basic compound.

In general, the emulsion polymerization can be performed according to the methods described in the following publications: Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Souichi Suzuki and Keiji Kasahara (compilers), Gosei Latex no Oyo (Application of Synthetic Latex), Kobunshi Kankokai (1993), and Soichi Muroi, Gosei Latex no Kagaku (Chemistry of Synthetic Latex), Kobunshi Kankokai (1993).

Synthesis examples of the polymer latex for use in the present invention are set forth below, but the present invention is not limited thereto. Other compounds can also be similarly synthesized.

### SYNTHESIS EXAMPLE 1

### Synthesis of Compound P-1

Into the polymerization furnace of a gas monomer reaction apparatus (Model TAS-2J, manufactured by Taiatsu Techno Corp.), 375.29 g of distilled water, 13.61 g of a surfactant (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 27.6%), 14.06 ml of 1 mol/liter NaOH, 0.15 g of tetrasodium ethylenediaminetetraacetate, 258.75 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 105.0 g of 1,3-butadiene was charged under pressure and the inner temperature was elevated to 60° C. Thereto, a solution prepared by dissolving 1.875 g of ammonium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a 200-mesh filter to obtain 812.2 g of Compound P-1 (solid content: 45%, particle size: 95 nm, Tg: 19° C.). The halide ion was measured by ion chromatography, as a result, the chloride ion concentration was 9 ppm. Also, the concentration of chelating agent was measured by high-performance liquid chromatography and found to be 150 ppm.

### SYNTHESIS EXAMPLE 2

### Synthesis of Compound P-2

Into the polymerization furnace of a gas monomer reaction apparatus (Model TAS-2J, manufactured by Taiatsu Techno Corp.), 287 g of distilled water, 7.73 g of a surfactant (PIONIN A-43-S, produced by Takemoto Yushi, solid content: 48.5%), 14.06 ml of 1 mol/liter NaOH, 0.15 g of tetrasodium ethylenediaminetetraacetate, 255 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 108.75 g of 1,3-butadiene was charged under pressure and the inner temperature was elevated to 60° C. Thereto, a solution prepared by dissolving 1.875 g of ammonium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 774.7 g of Compound P-2 (solid content: 45%, particle size: 90 nm, Tg: 17° C.). The halide ion was measured by ion chromatography, as a result, the chloride ion concentration was 3 ppm. Also, the concentration of chelating agent was measured by high-performance liquid chromatography and found to be 145 ppm.

### SYNTHESIS EXAMPLE 3

### Synthesis of Compound P-20

Into a glass-made three-neck flask equipped with a stirrer and a condenser, 296 g of distilled water, 10.89 g of a surfactant (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 27.6%), 15 ml of 1 mol/liter NaOH, 0.3 g of nitrilotri-hexaacetate, 135 g of methyl methacrylate, 150 g of butyl acrylate, 12 g of sodium styrenesulfonate, 3 g of methylbisacrylamide and 2.4 g of tert-dodecylmercaptan were charged. The mixture was stirred at a stirring rate of 200 rpm in a nitrogen stream and the inner temperature was elevated to 60° C. Thereto, a solution prepared by dissolving 0.6 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 622 g of Compound P-20 (solid content: 45%, particle size: 108 nm, mass average molecular weight: 140,000, Tg: 5° C.). The halide ion was measured by ion chromatography, as a result, the chloride ion concentration was 10 ppm. Also, the concentration of chelating agent was measured by high-performance liquid chromatography and found to be 450 ppm.

In the fourth embodiment of the present invention, when 60 mass % or more of the solvent in the organic silver salt-containing layer is water, a polymer latex of styrene-butadiene copolymer is preferably used for the binder. When 60 mass % or more of the solvent is an organic solvent, polyvinyl butyral is preferably used for the binder.

In the case where 60 wt % or more of the solvent in the coating solution for the photosensitive layer is water, a polymer latex preferably occupies from 60 to 100 wt %, more preferably from 80 to 100 wt %, of the binder. The polymer latex used here is preferably a polymer latex of styrene-butadiene copolymer.

In the case where 60 wt % or more of the solvent in the coating solution for the photosensitive layer is an organic solvent, polyvinyl butyral preferably occupies from 60 to 100 wt %, more preferably from 80 to 100 wt %, of the binder.

In the present invention, the binder in the organic silver salt-containing layer preferably has a glass transition temperature of 10 to 80° C. (hereinafter sometimes referred to as a “high Tg binder”), more preferably from 20 to 70° C., still more preferably from 23 to 65° C.

In the case where the binder is polyvinyl butyral, Tg is particularly preferably from 60 to 80° C.

In the fourth embodiment of the present invention, a preferred embodiment of the polymer dispersible in an aqueous solvent is a hydrophobic polymer such as acrylic polymers, poly(esters), rubbers (e.g., SBR resin), poly(urethanes), poly(vinyl chlorides), poly(vinyl acetates), poly(vinylidene chlorides) and poly(olefins). These polymers may be a linear, branched or crosslinked polymer and also may be a homopolymer obtained by the polymerization of a single monomer or a copolymer obtained by the polymerization of two or more monomers. In the case of a copolymer, the copolymer may be a random copolymer or a block copolymer.

The molecular weight of this polymer is, in terms of the number average molecular weight, from 5,000 to 1,000,000, preferably from 10,000 to 200,000. If the molecular weight is too small, the emulsion layer formed is insufficient in the mechanical strength, whereas if the molecular weight is excessively large, the film forming property is poor.

Specific examples of polymer latexes preferred in the fourth embodiment of the present invention are set forth below. In the following, the polymer latex is expressed using starting material monomers. The numerical value in the parentheses is the unit of mass % and the molecular weight is a number average molecular weight. In the case where a polyfunctional monomer is used, since a crosslinked structure is formed and the concept of molecular weight cannot be applied, the term “crosslinkable” is shown and the molecular weight is omitted. “Tg” indicates a glass transition temperature.

P-1: latex of -MMA(70)-EA(27)-MAA(3)-(molecular weight: 37,000)

P-2: latex of -MMA(70)-2EHA(20)-St(5)-AA(5)-(molecular weight; 40,000)

P-3: latex of -St(50)-Bu(47)-MAA(3)-(crosslinkable)

P-4: latex of -St(68)-Bu(29)-AA(3)-(crosslinkable)

P-5: latex of -St(71)-Bu(26)-AA(3)-(crosslinkable, Tg: 24° C.)

P-6: latex of -St(70)-Bu(27)—IA(3)-(crosslinkable)

P-7: latex of St(75)-Bu(24)-AA(1)-(crosslinkable)

P-8: latex of -St(60)-Bu(35)-DVB(3)-MAA(2)-(crosslinkable)

P-9: latex of St(70)-Bu(25)-DVB(2)-AA(3)-(crosslinkable)

P-10: latex of -VC(50)-MMA(20)-EA(20)-AN(5)-AA(5)-(molecular weight: 80,000)

P-11: latex of -VDC(85)-MMA(5)-EA(5)-MAA(5)-(molecular weight: 67,000)

P-12: latex of -Et(90)-MAA(10)-(molecular weight: 12,000)

P-13: latex of -St(70)-2EHA(27)-AA(3) (molecular weight: 130,000)

P-14: latex of -MMA(63)-EA(35)-AA(2) (molecular weight: 33,000)

P-15: latex of -St(70.5)-Bu(26.5)-AA(3)-(crosslinkable, Tg: 23° C.)

P-16: latex of -St(69.5)-Bu(27.5)-AA(3)-(crosslinkable, Tg: 20.5° C.)

The abbreviations in the above-described structures indicate the following monomers: MMA: methyl methacrylate, EA: ethyl acrylate, MAA: methacrylic acid, 2EHA: 2-ethylhexyl acrylate, St: styrene, Bu: butadiene, AA: acrylic acid, DVB: divinylbenzene, VC: vinyl chloride, AN: acrylonitrile, VDC: vinylidene chloride, Et: ethylene, and IA: itaconic acid.

These polymer latexes are commercially available and the following polymers may be used. Examples of the acrylic polymer include “Sebian A-4635, 4718 and 4601” (produced by Daicel Chemical Industries, Ltd.) and “Nipol Lx811, 814, 821, 820 and 857” (produced by Nippon Zeon K. K.); examples of the poly(esters) include “FINETEX ES650, 611, 675 and 850” (produced by Dai-Nippon Ink & Chemicals, Inc.), and “WD-size” and “WMS” (produced by Eastman Chemical Products, Inc.); examples of the poly(urethanes) include “HYDRAN AP10, 20, 30 and 40” (produced by Dai-Nippon Ink & Chemicals, Inc.); examples of the rubbers include “LACSTAR 7310K, 3307B, 4700H and 7132C” (produced by Dai-Nippon Ink & Chemicals, Inc.), “Nipol Lx416, 410, 438C and 2507” (produced by Nippon ZeQn K. K.); examples of the poly(vinyl chlorides) include “G351 and G576” (produced by Nippon Zeon K. K.); examples of the poly(vinylidene chlorides) include “L502 and L513” (produced by Asahi Chemical Industry Co., Ltd.); and examples of the poly(olefins) include “Chemipearl $120 and SA100” (produced by Mitsui Petrochemical Industries, Ltd.).

These polymer latexes may be used individually or, if desired, as a blend of two or more thereof.

The polymer latex for use in the present invention is particularly preferably a latex of styrene-butadiene copolymer. In the styrene-butadiene copolymer, a weight ratio of the styrene monomer unit to the butadiene monomer unit is preferably from 40:60 to 95:5. Furthermore, the styrene monomer unit and the butadiene monomer unit preferably account for 60 to 99 mass % of the copolymer. The preferred molecular weight range is the same as above.

Examples of the styrene-butadiene copolymer latex which is preferably used in the present invention include the above-described latexes P-3 to P-8, P-14 and P-15 and commercially available products LACSTAR-3307B, 7132C and Nipol Lx416.

The organic silver salt-containing layer of the photosensitive material of the present invention may contain, if desired, a hydrophilic polymer such as gelatin, polyvinyl alcohol, methyl cellulose, hydroxypropyl cellulose and carboxymethyl cellulose.

The amount of the hydrophilic polymer added is preferably 30 mass % or less, more preferably 20 mass % or less, based on the entire binder in the organic silver salt-containing layer.

(Use Method of Binder of the Present Invention)

The amount of the polymer (binder) for use in the present invention, added in the organic silver salt-containing layer is, in terms of a weight ratio of entire binder/organic silver salt, from 1/10 to 10/1, preferably from 1/5 to 4/1.

The organic silver salt-containing layer usually serves also as a photosensitive layer (sometimes called emulsion layer or image-forming layer) containing a photosensitive silver halide which is a photosensitive silver salt. In this case, the weight ratio of entire binder/silver halide is preferably from 400 to 5, more preferably from 200 to 10.

The total binder amount of the image-forming layer is preferably from 0.2 to 30 g/m², more preferably from 1 to 15 g/m². The image-forming layer for use may contain a crosslinking agent for forming a crosslinked structure or a surfactant for improving the work brittleness.

(Description of Development Accelerator)

The development accelerator is described in detail.

In the present invention, the development accelerator means a compound such that in a heat-developable photosensitive material comprising a support and on the same surface of the support, at least a photosensitive silver halide, a non-photosensitive organic silver salt, a reducing agent and a binder, when the compound is substituted in a molar ratio of 10% to the reducing agent (called main reducing agent), the sensitivity at a density of 1.0 increases by 0.05 or more as compared with the sensitivity when the compound is not substituted.

The development accelerator is preferably a compound of giving increase of sensitivity by 0.05 or more when substituted in 5 mol %, more preferably a compound of giving increase of sensitivity by 0.05 or more when substituted in 2 mol %.

The development accelerator may be any compound insofar as when the compound is substituted to the main reducing agent as described above, it brings increase of sensitivity in the heat development. A so-called reducing agent is preferably used. Specific examples of the compound which can be used include aminophenols, p-phenylenediamines, sulfonamidophenols, carbonamidophenols, 1-phenyl-5-pyrazolidones, ascorbic acids, hydrazines, phenols and naphthols. Among these, preferred are sulfonamidophenols (for example, compounds represented by formula (1) of JP-A-10-221806 and compounds represented by formula (A) of JP-A-2000-267222) and hydrazines.

More preferred compounds include the compounds represented by formulae (1), (5) and (6) which are described below.

<Compound Represented by Formula (1)>

The most preferred compound as the development accelerator for use in the present invention is a hydrazine derivative represented by the following formula (1), which is a reducing compound:

Q¹-NHNH—R¹ (1)

wherein Q¹ represents a 5-, 6- or 7-membered unsaturated ring bonded to NHNH—R¹ through a carbon atom, and R¹ represents a carbamoyl group, an acyl group, an alkoxycarbonyl group, an aryloxycarbonyl group, a sulfonyl group or a sulfamoyl group.

The compound represented by formula (1) is described in detail below.

The heat-developable photosensitive material of the present invention preferably has a reducing compound represented by formula (1) on the same surface as the photosensitive silver halide and the reducible non-photosensitive organic silver salt on the support.

The reducing compound represented by formula (1) is a developing agent generically called a hydrazine-base developing agent. In formula (1), Q¹ represents a 5-, 6- or 7-membered unsaturated ring bonded to NHNH—R¹ through a carbon atom, and R¹ represents a carbamoyl group, an acyl group, an alkoxycarbonyl group, an aryloxycarbonyl group, a sulfonyl group or a sulfamoyl group.

Preferred examples of the 5-, 6- or 7-membered unsaturated ring represented by Q¹ include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring and a thiophene ring. A condensed ring obtained by the condensation of these rings with each other is also preferred.

These rings may have a substituent and when two or more substituents are present, these substituents may be the same or different. Examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. When these substituents each can be substituted, these substituents may further have a substituent. Preferred examples of the substituent include a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

The carbamoyl group represented by R¹ is preferably a carbamoyl group having from 1 to 50 carbon atoms, more preferably from 6 to 40 carbon atoms. Examples thereof include unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-[3-2,4-tert-pentylphenoxy)propyl]carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-naphthylcarbamoyl, N-3-pyridylcarbamoyl and N-benzylcarbamoyl.

The acyl group represented by R¹ is preferably an acyl group having from 1 to 50 carbon atoms, more preferably from 6 to 40 carbon atoms. Examples thereof include formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl and 2-hydroxymethylbenzoyl.

The alkoxycarbonyl group represented by R¹ is preferably an alkoxycarbonyl group having from 2 to 50 carbon atoms, more preferably from 6 to 40 carbon atoms. Examples thereof include methoxycarbonyl, ethoxycarbonyl, isobutyloxycarbonyl, cyclohexyloxycarbonyl, dodecyloxycarbonyl and benzyloxycarbonyl.

The aryloxycarbonyl group represented by R¹ is preferably an aryloxycarbonyl group having from 7 to 50 carbon atoms, more preferably from 7 to 40 carbon atoms. Examples thereof include phenoxycarbonyl, 4-octyloxyphenoxycarbonyl, 2-hydroxymethylphenoxycarbonyl and 4-dodecyloxyphenoxycarbonyl.

The sulfonyl group represented by R¹ is preferably a sulfonyl group preferably having from 1 to 50 carbon atoms, more preferably from 6 to 40 carbon atoms. Examples thereof include methylsulfonyl, butylsultonyl, octylsulfonyl, 2-hexadecylsulfonyl, 3-dodecyloxypropylsulfonyl, 2-octyloxy-5-tert-octylphenylsulfonyl and 4-dodecyloxyphenylsulfonyl.

The sulfamoyl group represented by R¹ is preferably a sulfamoyl group having from 0 to 50 carbon atoms, more preferably from 6 to 40 carbon atoms. Examples thereof include unsubstituted sulfamoyl, N-ethylsulfamoyl, N-(2-ethylhexyl)sulfamoyl, N-decylsulfamoyl, N-hexadecyl sulfamoyl, N-{3-(2-ethylhexyloxy)propyl}sulfamoyl, N-(2-chloro-5-dodecyloxycarbonylphenyl)sulfamoyl and N-(2-tetradecyloxyphenyl)sulfamoyl.

The groups represented by R¹ each may have, at the substitutable position, a group described above as examples of the substituent of the 5-, 6- or 7-membered unsaturated ring represented by Q¹ and when two or more substituents are present, these substituents may be the same or different.

Among the compounds represented by formula (1), preferred are those where Q¹ is a 5- or 6-membered unsaturated ring, more preferred are those where Q¹ is a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring or a ring resulting from the condensation of the above-described ring with a benzene ring or an unsaturated heterocyclic ring, still more preferably a quinazoline ring. Q¹ preferably has at least one electron-withdrawing substituent. Preferred examples of the electron-withdrawing substituent include a fluoroalkyl group (e.g., trifluoromethyl, pentafluoroethyl, 1,1-difluoroethyl, difluoromethyl, fluoromethyl, heptafluoropropyl, pentafluorophenyl), a cyano group, a halogen atom (e.g., fluorine, chlorine, bromine, iodine), an acyl group, an alkoxycarbonyl group, a carbamoyl group, an alkylsulfonyl group and an arylsulfonyl group. Among these substituents, a trifluoromethyl group is more preferred.

Compounds where R¹ is a carbamoyl group are preferred, and compounds where R¹ is a substituted carbamoyl group represented by —C═O—NH—R¹¹ and R¹¹ is an alkyl or aryl group having from 1 to 10 carbon atoms are more preferred.

Specific examples of the reducing compound represented by formula (1) are set forth below, however, the compound used in the present intention is not limited to these specific examples.

| | |
|---|---|
| 1-1 | 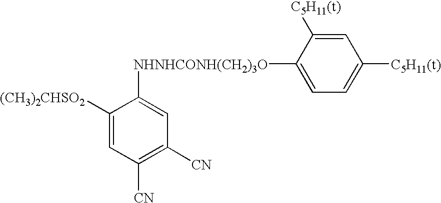 |
| 1-2 | 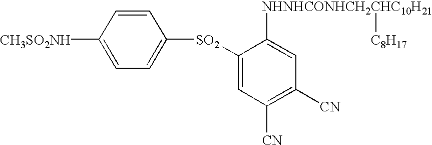 |
| 1-3 | 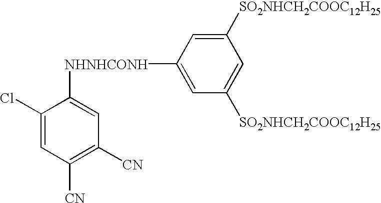 |
| 1-4 | 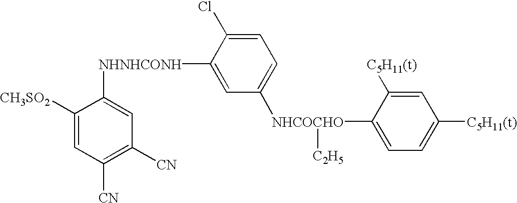 |
| 1-5 | 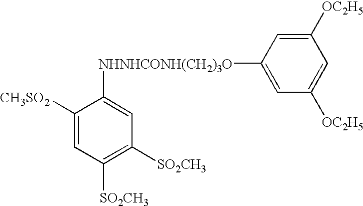 |
| 1-6 | 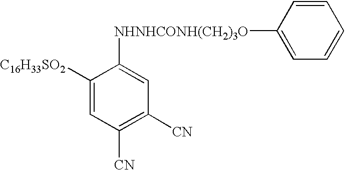 |
| 1-7 | 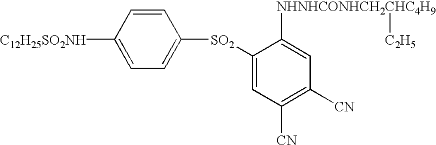 |
| 1-8 | 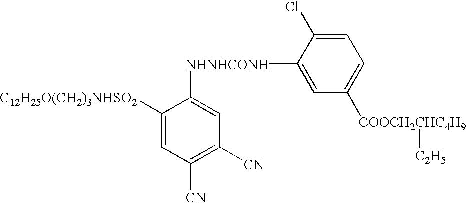 |
| 1-9 | 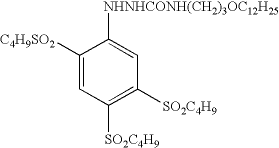 |
| 1-10 | 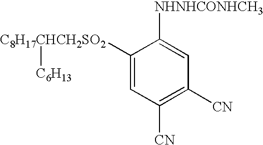 |
| 1-11 | 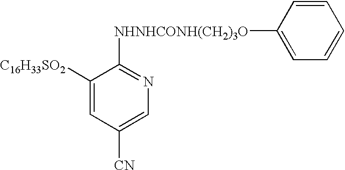 |
| 1-12 | 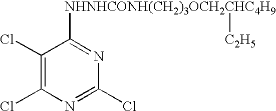 |
| 1-13 | 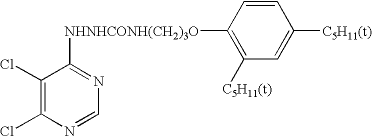 |
| 1-14 | 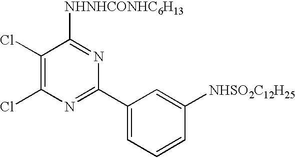 |
| 1-15 | 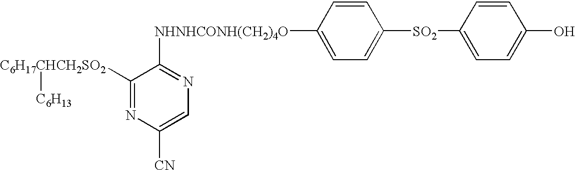 |
| 1-16 | 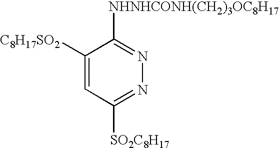 |
| 1-17 | 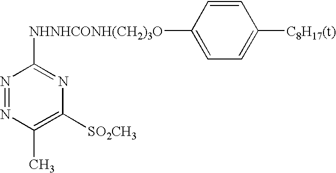 |
| 1-18 | 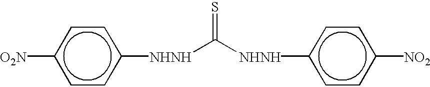 |
| 1-19 | 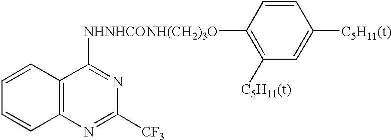 |
| 1-20 | 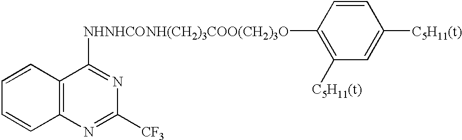 |
| 1-21 | 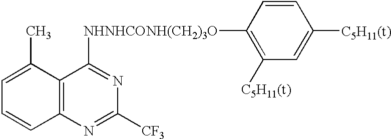 |
| 1-22 | 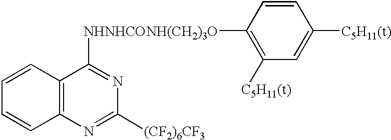 |
| 1-23 | 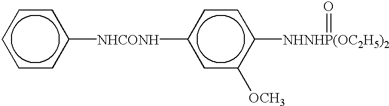 |
| 1-24 | 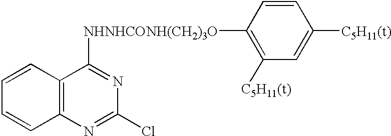 |
| 1-25 | 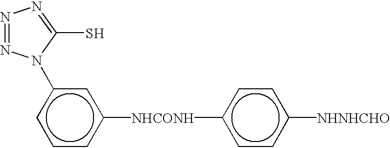 |
| 1-26 | 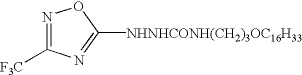 |
| 1-27 | 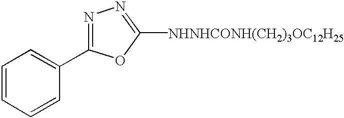 |
| 1-28 | 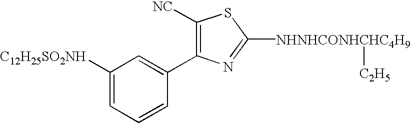 |
| 1-29 | 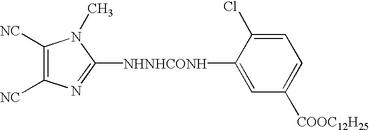 |
| 1-30 | 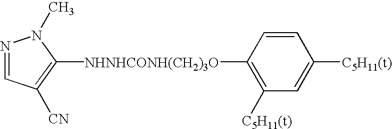 |
| 1-31 | 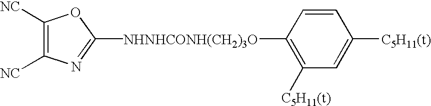 |
| 1-32 | 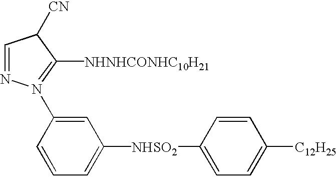 |
| 1-33 | 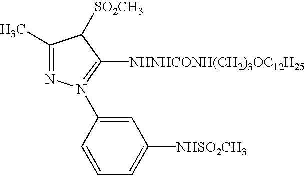 |
| 1-34 | 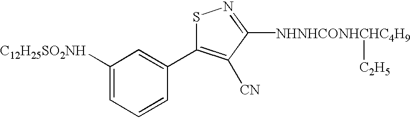 |
| 1-35 | 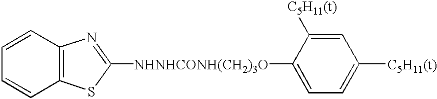 |
| 1-36 | 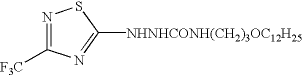 |
| 1-37 | 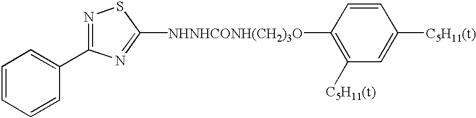 |
| 1-38 | 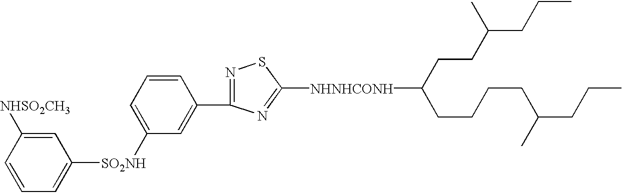 |
| 1-39 | 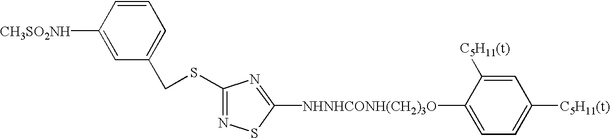 |
| 1-40 | 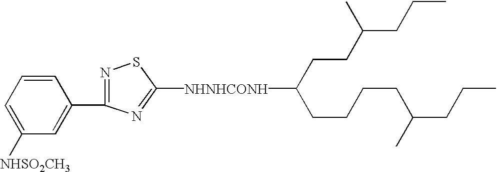 |
| 1-41 | 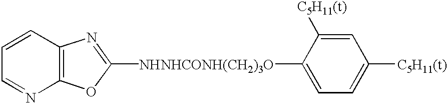 |
| 1-42 | 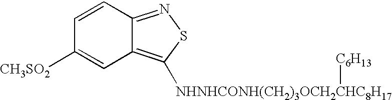 |
| 1-43 | 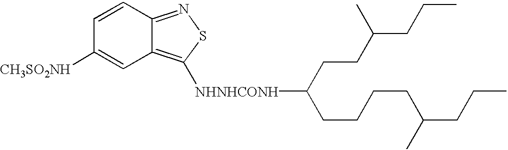 |
| 1-44 | 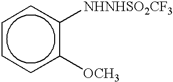 |
| 1-45 | 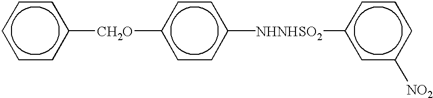 |
| 1-46 | 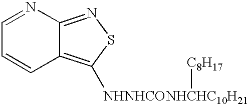 |
| 1-47 | 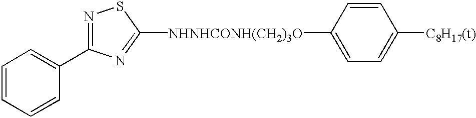 |
| 1-48 | 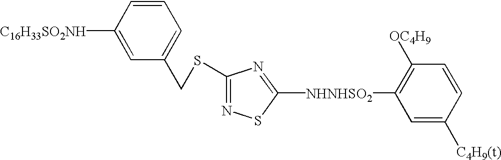 |
| 1-49 | 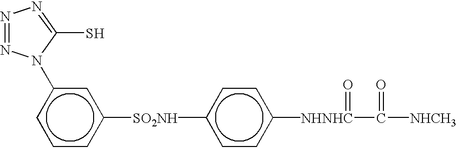 |
| 1-50 | 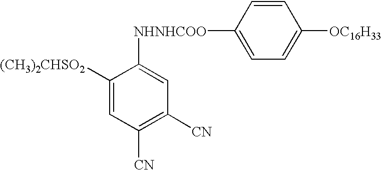 |
| 1-51 | 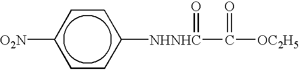 |
| 1-52 | 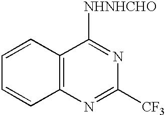 |
| 1-53 | 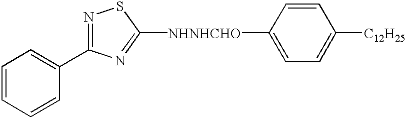 |
| 1-54 | 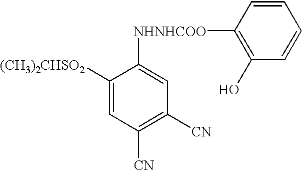 |

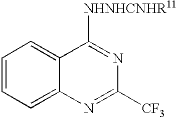

| Compound | R¹¹ |
|---|---|
| 1-55 | CH₃ |
| 1-56 | C₂H₅ |
| 1-57 | (n)C₃H₇ |
| 1-58 | (i)C₃H₇ |
| 1-69 | (n)C₄H₉ |
| 1-60 | (i)C₄H₉ |
| 1-61 | (sec)C₄H₉ |
| 1-62 | (t)C₄H₉ |
| 1-64 | (t)C₅H₁₁ |
| 1-65 | (n)C₆H₁₃ |
| 1-66 | 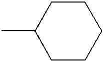 |
| 1-67 | (n)C₈H₁₇ |
| 1-68 | (t)C₈H₁₇ |
| 1-69 | 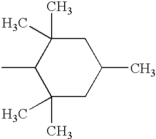 |
| 1-70 | 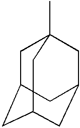 |
| 1-71 | 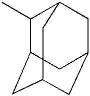 |
| 1-72 | 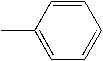 |
| 1-73 | 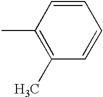 |
| 1-74 | 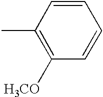 |
| 1-75 | 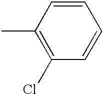 |
| 1-76 | 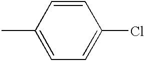 |
| 1-77 | 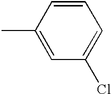 |
| 1-78 | 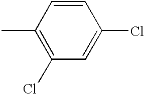 |
| 1-79 | 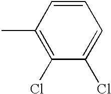 |
| 1-80 | 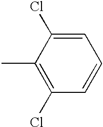 |
| 1-81 | 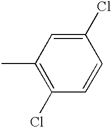 |
| 1-82 | 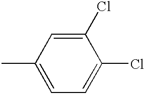 |
| 1-83 | 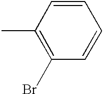 |
| 1-84 | 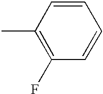 |
| 1-85 | 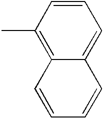 |
| 1-86 | 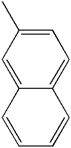 |
| 1-87 | 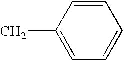 |
| 1-88 | 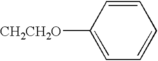 |
| 1-89 | CH₂CH₂OCH₂CH₃ |
| 1-90 | CH₂CH₂OCH₃ |
| 1-91 | 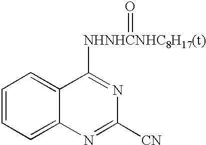 |
| 1-92 | 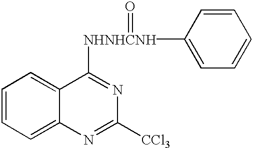 |
| 1-93 | 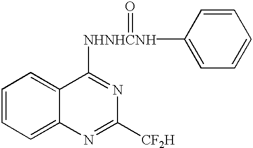 |
| 1-94 | 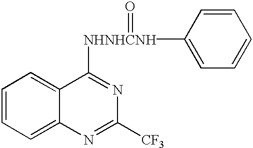 |
| 1-95 | 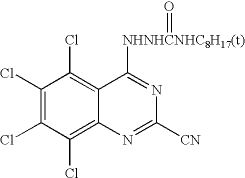 |
| 1-96 | 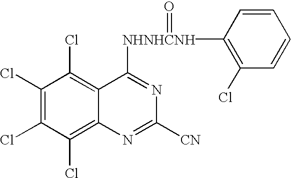 |
| 1-97 | 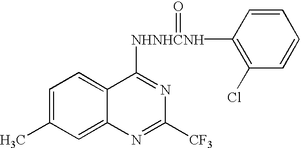 |
| 1-98 | 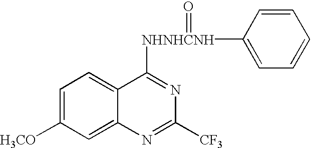 |
| 1-99 | 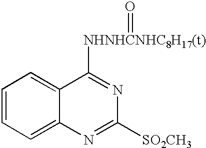 |
| 1-100 | 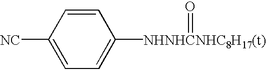 |
| 1-101 | 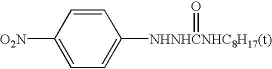 |
| 1-102 | 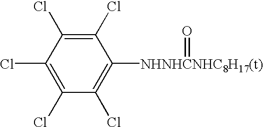 |
| 1-103 | 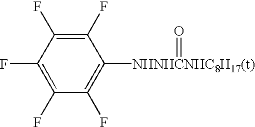 |
| 1-104 | 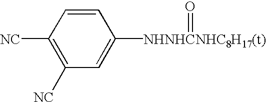 |
| 1-105 | 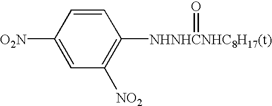 |
| 1-106 | 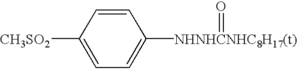 |

The reducing compound represented by formula (1) can be synthesized in accordance with the method described, for example, in JP-A-9-152702, JP-A-8-28640, JP-A-9-152700, JP-A-9-152701, JP-A-9-152703 and JP-A-9-152704.

The reducing compound represented by formula (1) can be added in an amount over a wide range but the amount added is preferably added from 0.01 to 100 molar times, more preferably from 0.1 to 10 molar times, the silver ion.

The reducing compound represented by formula (1) may be added to the coating solution by any method such as solution, powder, solid fine particle dispersion, emulsified product or oil protected dispersion. In the case of using the reducing compound together with the polymer latex of the present invention, the reducing compound is preferably added in the form of a solid fine particle. The dispersion of solid fine particles can be performed by known pulverization means (for example, ball mill, vibration ball mill, sand mill, colloid mill, jet mill, roller mill). In particular, pulverization by a sand mill is preferred. In dispersing the solid fine particles, a dispersion aid may be used.

<Compounds Represented by Formulae (5) and (6)>

Compounds represented by formulae (5) and (6) are described below.

In formulae (5) and (6), X¹ and X² each independently represents a hydrogen atom or a substituent. Examples of the substituent represented by X¹ and X² include a halogen atom (e.g., fluorine atom, chlorine atom, bromine atom, iodine atom), an aryl group (preferably having from 6 to 30, more preferably from 6 to 20, still more preferably from 6 to 12, carbon atoms, e.g., phenyl, p-methylphenyl, naphthyl), an alkoxy group (preferably having from 1 to 20, more preferably from 1 to 12, still more preferably from 1 to 8, carbon atoms, e.g., methoxy, ethoxy, butoxy), an aryloxy group (preferably having from 6 to 20, more preferably from 6 to 16, still more preferably from 6 to 12, carbon atoms, e.g., phenyloxy, 2-naphthyloxy), an alkylthio group (preferably having from 1 to 20, more preferably from 1 to 16, still more preferably from 1 to 12, carbon atoms, e.g., methylthio, ethylthio, butylthio), an arylthio group (preferably having from 6 to 20, more preferably from 6 to 16, still more preferably from 6 to 12, carbon atoms, e.g., phenylthio, naphthylthio), an acyloxy group (preferably having from 1 to 20, more preferably from 2 to 16, still more preferably from 2 to 10, carbon atoms, e.g., acetoxy, benzoyloxy), an acylamino group (preferably having from 2 to 20, more preferably from 2 to 16, still more preferably from 2 to 10, carbon atoms, e.g., N-methylacetylamino, benzoylamino), a sulfonylamino group (preferably having from 1 to 20, more preferably from 1 to 16, still more preferably from 1 to 12, carbon atoms, e.g., methanesulfonylamino, benzenesulfonylamino), a carbamoyl group (preferably having from 1 to 20, more preferably from 1 to 16, still more preferably from 1 to 12, carbon atoms, e.g., carbamoyl, N,N-diethylcarbamoyl, N-phenylcarbamoyl), an acyl group (preferably having from 2 to 20, more preferably from 2 to 16, still more preferably from 2 to 12, carbon atoms, e.g., acetyl, benzoyl, formyl, pivaloyl), an alkoxycarbonyl group (preferably having from 2 to 20, more preferably from 2 to 16, still more preferably from 2 to 12, carbon atoms, e.g., methoxycarbonyl), a sulfo group, a sulfonyl group (preferably having from 1 to 20, more preferably from 1 to 16, still more preferably from 1 to 12, carbon atoms, e.g., mesyl, tosyl), a sulfonyloxy group (preferably having from 1 to 20, more preferably from 1 to 16, still more preferably from 1 to 12, carbon atoms, e.g., methanesulfonyloxy, benzenesulfonyloxy), an azo group, a heterocyclic group, a heterocyclic mercapto group and a cyano group. The heterocyclic group as used herein means a saturated or unsaturated heterocyclic group and examples thereof include a pyridyl group, a quinolyl group, a quinoxalinyl group, a pyrazinyl group, a benzotriazolyl group, a pyrazolyl group, an imidazolyl group, a benzimidazolyl group, a tetrazolyl group, a hydantoin-1-yl group, a succinimide group and a phthalimide group.

The substituent represented by X¹ and X² in formulae (5) and (6) is more preferably an alkoxy group or an aryloxy group. The substituent represented by X¹ and X² may be further substituted by another substituent and the another substituent may be any commonly known substituent insofar as it does not adversely affect the photographic performance.

In formulae (5) and (6), R² to R⁴ each independently represents a hydrogen atom or a substituent, m and p each independently represents an integer of 0 to 4, and n represents an integer of 0 to 2.

The substituent represented by R² to R⁴ may be any substituent insofar as it does not adversely affect the photographic properties. Examples thereof include a halogen atom (e.g., fluorine, chlorine, bromine, iodine), a linear, branched or cyclic alkyl group or an alkyl group having a combination of linear, branched and/or cyclic structures (preferably having from 1 to 20, more preferably from 1 to 16, still more preferably from 1 to 13, carbon atoms, e.g., methyl, ethyl, n-propyl, isopropyl, sec-butyl, tert-butyl, tert-octyl, n-amyl, tert-amyl, n-dodecyl, n-tridecyl, cyclohexyl), an alkenyl group (preferably having from 2 to 20, more preferably from 2 to 16, still more preferably from 2 to 12, carbon atoms, e.g., vinyl, allyl, 2-butenyl, 3-pentenyl), an aryl group (preferably having from 6 to 30, more preferably from 6 to 20, still more preferably from 6 to 12, carbon atoms, e.g., phenyl, p-methylphenyl, naphthyl), an alkoxy group (preferably having from 1 to 20, more preferably from 1 to 16, still more preferably from 1 to 12, carbon atoms, e.g., methoxy, ethoxy, propoxy, butoxy), an aryloxy group (preferably having from 6 to 30, more preferably from 6 to 20, still more preferably from 6 to 12, carbon atoms, e.g., phenyloxy, 2-naphthyloxy), an acyloxy group (preferably having from 2 to 20, more preferably from 2 to 16, still more preferably from 2 to 12, carbon atoms, e.g., acetoxy, benzoyloxy), an amino group (preferably having from 0 to 20, more preferably from 1 to 16, still more preferably from 1 to 12, carbon atoms, e.g., dimethylamino, diethylamino, dibutylamino, anilino), an acylamino group (preferably having from 2 to 20, more preferably from 2 to 16, still more preferably from 2 to 13, carbon atoms, e.g., acetylamino, tridecanoylamino, benzoylamino), a sulfonylamino group (preferably having from 1 to 20, more preferably from 1 to 16, still more preferably from 1 to 12, carbon atoms, e.g., methanesulfonylamino, butanesulfonyl amino, benzenesulfonylamino), a ureido group (preferably having from 1 to 20, more preferably from 1 to 16, still more preferably from 1 to 12, carbon atoms, e.g., ureido, methylureido, phenylureido), a carbamate group (preferably having from 2 to 20, more preferably from 2 to 16, still more preferably from 2 to 12, carbon atoms, e.g., methoxycarbonylamino, phenyloxycarbonylamino), a carboxyl group, a carbamoyl group (preferably having from 1 to 20, more preferably from 1 to 16, still more preferably from 1 to 12, carbon atoms, e.g., carbamoyl, N,N-diethylcarbamoyl, N-dodecylcarbamoyl, N-phenylcarbamoyl), an alkoxycarbonyl group (preferably having from 2 to 20, more preferably from 2 to 16, still more preferably from 2 to 12, carbon atoms, e.g., methoxycarbonyl, ethoxycarbonyl, butoxycarbonyl), an acyl group (preferably having from 2 to 20, more preferably from 2 to 16, still more preferably from 2 to 12, carbon atoms, e.g., acetyl, benzoyl, formyl, pivaloyl), a sulfo group, a sulfonyl group (preferably having from 1 to 20, more preferably from 1 to 16, still more preferably from 1 to 12, carbon atoms, e.g., mesyl, tosyl), a sulfamoyl group (preferably having from 0 to 20, more preferably from 0 to 16, still more preferably from 0 to 12, carbon atoms, e.g., sulfamoyl, methylsulfamoyl, dimethylsulfamoyl, phenylsulfamoyl), a cyano group, a nitro group, a hydroxyl group, a mercapto group, an alkylthio group (preferably having from 1 to 20, more preferably from 1 to 16, still more preferably from 1 to 12, carbon atoms, e.g., methylthio, butylthio) and a heterocyclic group (preferably having from 2 to 20, more preferably from 2 to 16, still more preferably from 2 to 12, carbon atoms, e.g., pyridyl, imidazoyl, pyrrolidyl). These substituents each may be further substituted by another substituent.

Among these, preferred as the substituent represented by R² to R⁴ are a halogen atom, an alkyl group, an aryl group, an alkoxy group, an aryloxy group, an acyloxy group, an anilino group, an acylamino group, a sulfonylamino group, a carboxyl group, a carbamoyl group, an acyl group, a sulfo group, a sulfonyl group, a sulfamoyl group, a cyano group, a hydroxyl group, a mercapto group, an alkylthio group and. a heterocyclic group.

The compound represented by formula (6) preferably has a carbamoyl group (preferably having from 1 to 20, more preferably from 1 to 16, still more preferably from 1 to 12, carbon atoms, e.g., carbamoyl, N,N-diethylcarbamoyl, N-dodecylcarbamoyl, N-phenylcarbamoyl, N-(2-chlorophenyl)carbamoyl, N-(4-chlorophenyl)carbamoyl, N-(2,4-dichlorophenyl)carbamoyl, N-(3,4-dichlorophenyl)carbamoyl) at the 2-position, more preferably has an arylcarbamoyl group (preferably having from 7 to 20, more preferably from 7 to 16, still more preferably from 7 to 12, carbon atoms, e.g., N-phenylcarbamoyl, N-(2-chlorophenyl)carbamoyl, N-(4-chlorophenyl)carbamoyl, N-(2,4-dichlorophenyl)carbamoyl, N-(3,4-dichlorophenyl)carbamoyl) at the 2-position.

Specific examples of the compound represented by formula (6) are set forth below, however, the compound for use in the present invention is not limited to these specific examples.

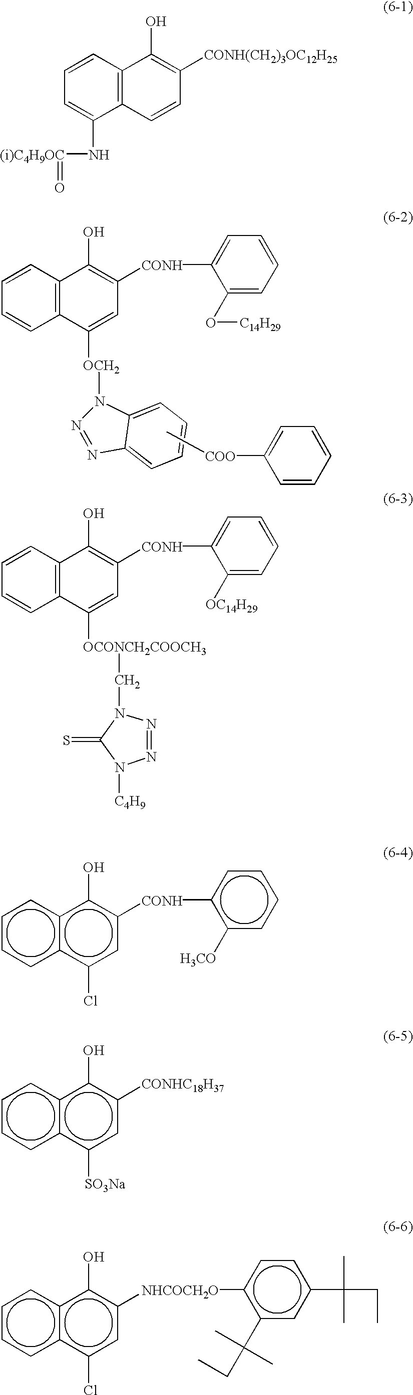

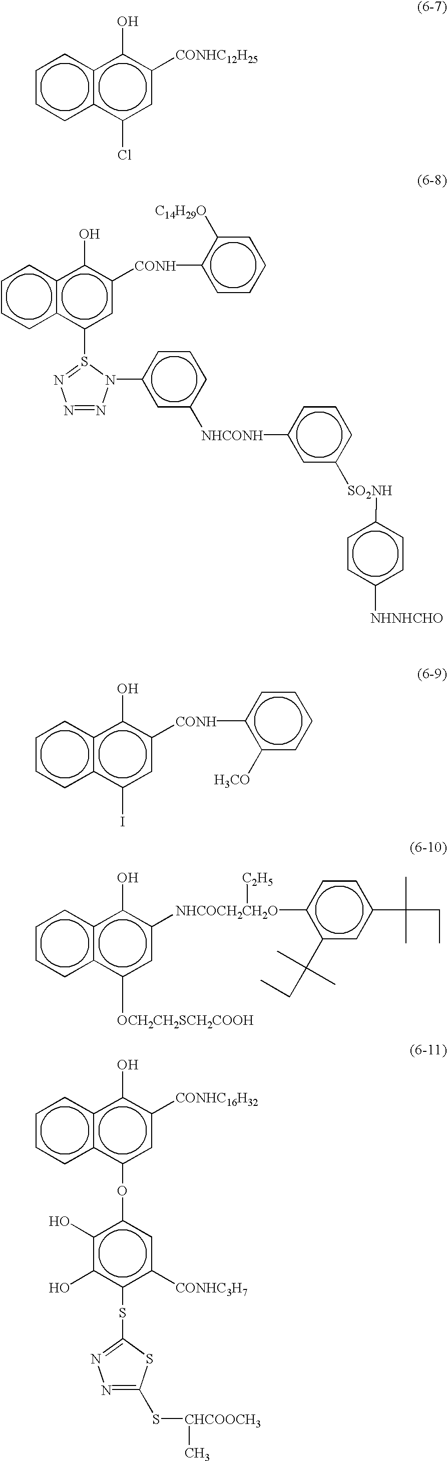

The compounds represented by formulae (5) and (6) for use in the present invention can be easily synthesized by a method known in the photographic industry.

The compound represented by formula (5) or (6) for use in the present invention can be used after dissolving it in water or an appropriate organic solvent such as alcohols (e.g., methanol, ethanol, propanol, fluorinated alcohol), ketones (e.g., acetone, methyl ethyl ketone), dimethylformamide, dimethylsulfoxide and methyl cellosolve.

This compound may also be used as an emulsification dispersion product obtained by a well-known emulsification dispersion method of dissolving the compound using an oil such as dibutyl phthalate, tricresyl phosphate, glyceryl triacetate or diethyl phthalate, and an auxiliary solvent such as ethyl acetate or cyclohexanone, and mechanically emulsification-dispersing the mixture. Also, the compound may be used by dispersing the powder of the compound in water using a ball mill, a colloid mill, a sand grinder mill, Manton Gaulin, a microfluidizer or an ultrasonic wave according to a well-known solid dispersion method.

The compound represented by formula (5) or (6) for use in the present invention may be added to any layer insofar as the layer is on the same surface as the photosensitive silver halide and the reducible organic silver salt on the support but is preferably added to a layer containing the photosensitive silver halide or a layer adjacent thereto.

The amount added of the compound represented by formula (5) to (6) for use in the present invention is preferably from 0.2 to 200 mmol, more preferably from 0.3 to 100 mmol, still more preferably from 0.5 to 30 mmol, per mol of silver. The compounds represented by formulae (5) and (6) for use in the present invention may be used individually or in combination of two or more thereof.

In the present invention, the compound represented by formula (1) and the compound represented by formula (6) are preferably used in combination.

Among the compounds represented by formula (5), more preferred are the compounds represented by the following formulae (2) and (3):

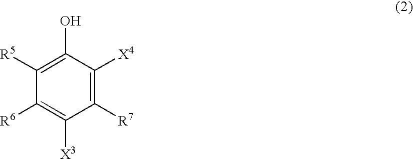

wherein R⁵, R⁶, R⁷, X³ and X⁴ each independently represents a hydrogen atom, a halogen atom or a substituent bonded to the benzene ring through a carbon atom, an oxygen atom, a nitrogen atom, a sulfur atom or a phosphorus atom, provided that at least one of X³ and X⁴ is a group represented by —NR⁸R⁹, R⁸ and R⁹ each independently represents a hydrogen atom, an alkyl group, an alkenyl group, an alkynyl group, an aryl group, a heterocyclic group or a group represented by —C(═O)—R, —C(═O)—C(═O)—R, —SO₂—R, —SO—R, —P(═O)(R)₂ or —C(═NR′)—R, R and R′ each independently represents a hydrogen atom or a group selected from the group consisting of an alkyl group, an aryl group, a heterocyclic group, an amino group, an alkoxy group and an aryloxy group, and the substituents adjacent to each other may combine to form a ring;

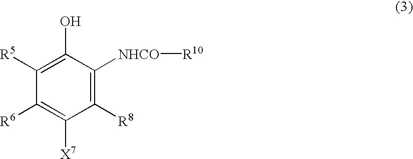

wherein X⁵ represents a substituent, X⁶ to X⁸ each independently represents a hydrogen atom or a substituent, provided that X⁵ to X⁸ each is not a hydroxy group and that X⁷ is not a sulfonamido group, the substituents represented by X⁵ to X⁸ may combine with each other to form a ring, R¹⁰ represents a hydrogen atom, an alkyl group, an aryl group, a heterocyclic group, an amino group or an alkoxy group.

The development accelerator represented by formula (2) is described below.

R⁵, R⁶ and R⁷ each independently represents a hydrogen atom, a halogen atom or a substituent bonded to the benzene ring through a carbon atom, an oxygen atom, a nitrogen atom, a sulfur atom or a phosphorus atom. Specific examples of the substituent bonded to the benzene ring through a carbon atoms include, but are not limited to, a linear, branched or cyclic alkyl group (e.g., methyl, ethyl, iso-propyl, tert-butyl, n-octyl, tert-amyl, 1,3-tetramethylbutyl, cyclohexyl), an alkenyl group (e.g., vinyl, allyl, 2-butenyl, 3-pentenyl), an alkynyl group (e.g., propargyl, 3-pentynyl), an aryl group (e.g., phenyl, p-methylphenyl, naphthyl), an acyl group (e.g., acetyl, benzoyl, formyl, pivaloyl), an alkoxycarbonyl group (e.g., methoxycarbonyl, ethoxycarbonyl), an aryloxycarbonyl group (e.g., phenoxycarbonyl), a carbamoyl group (e.g., carbamoyl, diethylcarbamoyl, phenylcarbamoyl), a cyano group, a carboxyl group and a heterocyclic group (e.g., 3-pyrazolyl).

Specific examples of the substituent bonded to the benzene ring through an oxygen atom include, but are not limited to, a hydroxyl group, an alkoxy group (e.g., methoxy, ethoxy, butoxy), an aryloxy group (e.g., phenyloxy, 2-naphthyloxy), a heterocyclic oxy group (e.g., 4-pyridyloxy) and an acyloxy group (e.g., acetoxy, benzoyloxy). Specific examples of the substituent bonded to the benzene ring through a nitrogen atom include, but are not limited to, an amino group (e.g., amino, -methylamino, dimethylamino, diethylamino, dibenzylamino), a nitro group, a hydrazino group, a heterocyclic group (e.g., 1-imidazolyl, morpholyl), an acylamino group (e.g., acetylamino, benzoylamino), an alkoxycarbonylamino group (e.g., methoxycarbonylamino), an aryloxycarbonylamino group (e.g., phenyloxycarbonylamino), a sulfonylamino group (e.g., methanesulfonylamino, benzenesulfonylamino), a sulfamoyl group (e.g., sulfamoyl, methylsulfamoyl, dimethylsulfamoyl, phenylsulfamoyl), a ureido group (e.g., ureido, methylureido, phenylureido), a phosphorylamino group (e.g., diethylphosphorylamino) and an imide group (e.g., succinimide, phthalimide, trifluoromethanesulfonimide). Specific examples of the substituent bonded to the benzene ring through a sulfur atom include, but are not limited to, a mercapto group, a disulfide group, a sulfo group, a sulfino group, a sulfonylthio group, a thiosulfonyl group, an alkylthio group (e.g., methylthio, ethylthio), an arylthio group (e.g., phenylthio), a sulfonyl group (e.g., mesyl, tosyl, phenylsulfonyl), a sulfinyl group (e.g., methanesulfinyl, benzenesulfinyl) and a heterocyclic thio group (e.g., 2-imidazolylthio). Specific examples of the substituent bonded to the benzene ring through a phosphorus atom include, but are not limited to, a phosphoric acid ester group (e.g., diethyl phosphate, diphenyl phosphate).

R⁵, R⁶ and R⁷ each is preferably a hydrogen atom, a halogen atom, a linear, branched or cyclic alkyl group, an aryl group, an acyl group, an alkoxycarbonyl group, an aryloxycarbonyl group, a cyano group, a carboxyl group, a heterocyclic group, a hydroxyl group, an alkoxy group, an aryloxy group, a heterocyclic oxy group, an acyloxy group, an amino group, a nitro group, an acylamino group, an alkoxycarbonylamino group, an aryloxycarbonylamino group, a sulfonylamino group, an imide group, a sulfamoyl group, a carbamoyl group, a ureido group, a mercapto group, a disulfide group, a sulfo group, a sulfino group, an alkylthio group, an arylthio group, a sulfonyl group, a sulfinyl group or a heterocyclic thio group. R⁵, R⁶ and R⁷ each is more preferably a hydrogen atom, a halogen atom, a linear, branched or cyclic alkyl group, an aryl group, an acyl group, an alkoxycarbonyl group, an aryloxycarbonyl group, a cyano group, a carboxyl group, a heterocyclic group, a hydroxyl group, an alkoxy group, an aryloxy group, an acyloxy group, an amino group, a nitro group, an acylamino group, an alkoxycarbonylamino group, an aryloxycarbonylamino group, a sulfonylamino group, an imide group, a carbamoyl group, a mercapto group, a sulfo group, an alkylthio group, an arylthio group or a sulfonyl group.

R⁵, R⁶ and R⁷ each is still more preferably a hydrogen atom, a halogen atom, a linear, branched or cyclic alkyl group, an aryl group, an acyl group, an alkoxycarbonyl group, an aryloxycarbonyl group, a cyano group, a carboxyl group, an acyloxy group, an acylamino group, an alkoxycarbonylamino group, an aryloxycarbonylamino group, a sulfonylamino group, a carbamoyl group, a sulfo group, an alkylsulfonyl group or an arylsulfonyl group.

X³ and X⁴ each represents a hydrogen atom, a halogen atom or a substituent bonded to the benzene ring through a carbon atom, an oxygen atom, a nitrogen atom, a sulfur atom or a phosphorus atom. Specific examples of the substituent bonded to the benzene ring through a carbon atoms include, but are not limited to, a linear, branched or cyclic alkyl group (e.g., methyl, ethyl, iso-propyl, tert-butyl, n-octyl, tert-amyl, 1,3-tetramethylbutyl, cyclohexyl), an alkenyl group (e.g., vinyl, allyl, 2-butenyl, 3-pentenyl), an alkynyl group (e.g., propargyl, 3-pentynyl), an aryl group (e.g., phenyl, p-methylphenyl, naphthyl), an acyl group (e.g., acetyl, benzoyl, formyl, pivaloyl), an alkoxycarbonyl group (e.g., methoxycarbonyl, ethoxycarbonyl), an aryloxycarbonyl group (e.g., phenoxycarbonyl), a cyano group, a carboxyl group, a heterocyclic group (e.g., 3-pyrazolyl) and a carbamoyl group (e.g., carbamoyl, diethylcarbamoyl, phenylcarbamoyl). Specific examples of the substituent bonded to the benzene ring through an oxygen atom include, but are not limited to, a hydroxyl group, an alkoxy group (e.g., methoxy, ethoxy, butoxy), an aryloxy group (e.g., phenyloxy, 2-naphthyloxy), a heterocyclic oxy group (e.g., 4-pyridyloxy) and an acyloxy group (e.g., acetoxy, benzoyloxy).

Specific examples of the substituent bonded to the benzene ring through a nitrogen atom include, but are not limited to, an amino group (e.g., amino, methylamino, dimethylamino, diethylamino, dibenzylamino), a nitro group, a hydroxam group, a hydrazino group, a heterocyclic group (e.g., 1-imidazolyl, morpholyl), an acylamino group (e.g., acetylamino, benzoylamino), an alkoxycarbonylamino group (e.g., methoxycarbonylamino), an aryloxycarbonylamino group (e.g., phenyloxycarbonylamino), a sulfonylamino group (e.g., methanesulfonylamino, benzenesulfonylamino), a sulfamoyl group (e.g., sulfamoyl, methylsulfamoyl, dimethylsulfamoyl, phenylsulfamoyl) and a phosphorylamino group (e.g., diethylphosphorylamino). Specific examples of the substituent bonded to the benzene ring through a sulfur atom include, but are not limited to, a mercapto group, a disulfide group, a sulfo group, a sulfino group, a sulfonylthio group, a thiosulfonyl group, an alkylthio group (e.g., methylthio, ethylthio), an arylthio group (e.g., phenylthio), a sulfonyl group (e.g., mesyl, tosyl, phenylsulfonyl), a sulfinyl group (e.g., methanesulfinyl, benzenesulfinyl) and a heterocyclic thio group (e.g., 2-imidazolylthio). Specific examples of the substituent bonded to the benzene ring through a phosphorus atom include, but are not limited to, a phosphoric acid ester group (e.g., diethyl phosphate, diphenyl phosphate).

X³ and X⁴ each is preferably a hydrogen atom, a halogen atom, a linear, branched or cyclic alkyl group, an aryl group, an acyl group, an alkoxycarbonyl group, an aryloxycarbonyl group, a cyano group, a carboxyl group, a heterocyclic group, a hydroxyl group, an alkoxy group, an aryloxy group, a heterocyclic oxy group, an acyloxy group, an amino group, a nitro group, an acylamino group, an alkoxycarbonylamino group, an aryloxycarbonylamino group, a sulfonylamino group, an imide group, a sulfamoyl group, a carbamoyl group, a ureido group, a mercapto group, a disulfide group, a sulfo group, an alkylthio group, an arylthio group, a sulfonyl group or a heterocyclic thio group. X³ and X⁴ each is more preferably a hydrogen atom, a halogen atom, a linear, branched or cyclic alkyl group, an aryl group, an acyl group, an alkoxycarbonyl group, an aryloxycarbonyl group, a cyano group, a carboxyl group, a hydroxyl group, an alkoxy group, an aryloxy group, an acyloxy group, an amino group, an acylamino group, an alkoxycarbonylamino group, an aryloxycarbonylamino group, a sulfonylamino group, an imide group, a carbamoyl group, a sulfo group or an arylsulfonyl group.

X³ and X⁴ each is still more preferably a hydrogen atom, a halogen atom, a linear, branched or cyclic alkyl group, an aryl group, an acyl group, an alkoxycarbonyl group, an aryloxycarbonyl group, a cyano group, a carboxyl group, an alkoxy group, an aryloxy group, an acyloxy group, an acylamino group, an alkoxycarbonylamino group, an aryloxycarbonylamino group, a sulfonylamino group, a carbamoyl group, a mercapto group or an alkylthio group.

At least one of X³ and X⁴ is a group represented by —NR⁸R⁹, R⁸ and R⁹ each independently represents a hydrogen atom, an alkyl group, an alkenyl group, an alkynyl group, an aryl group, a heterocyclic group or a group represented by —C(O)—R, —C(═O)—C(═O)—R, —SO₂—R, —SO—R, —P(═O)(R)₂ or —C(═NR′)—R, and R and R′ each independently represents a hydrogen atom or a group selected from the group consisting of an alkyl group, an aryl group, a heterocyclic group, an amino group, an alkoxy group and an aryloxy group. When R⁸ and R⁹ each represents a hydrogen atom, an alkyl group, an alkenyl group, an alkynyl group, an aryl group or a heterocyclic group, these groups are, for example, a linear, branched or cyclic alkyl group (e.g., methyl, ethyl, iso-propyl, tert-butyl, n-octyl, tert-amyl, 1,3-tetramethylbutyl, cyclohexyl), an alkenyl group (e.g., vinyl, allyl, 2-butenyl, 3-pentenyl), an alkyl group (e.g., propargyl, 3-pentenyl), an aryl group (e.g., phenyl, p-methylphenyl, naphthyl) and a heterocyclic group (e.g., 2-imidazolyl, 1-pyrazolyl).

When R⁸ and R⁹ each represents a group represented by —C(═O)—R, —C(═O)—C(═O)—R, —SO₂—R, —SO—R, —P (═O)(R)₂ or —C(═NR′)—R, R and R′ each independently represents a hydrogen atom, an alkyl group (e.g., methyl, ethyl, iso-propyl, tert-butyl, n-octyl, tert-amyl, 1,3-tetramethylbutyl, cyclohexyl), an aryl group (e.g., phenyl, p-methylphenyl, naphthyl), a heterocyclic group (e.g., 4-pyridyl, 2-thienyl, 1-methyl-2-pyrrolyl), an amino group (e.g., amino, dimethylamino, diphenylamino, phenylamino, 2-pyridylamino), an alkoxy group (e.g., methoxy, ethoxy, cyclohexyloxy) or an aryloxy group (e.g., phenoxy, 2-naphthoxy).

R⁸ and R⁹ each is preferably a hydrogen atom, a linear, branched or cyclic alkyl group, an aryl group, an acyl group, an alkoxycarbonyl group, an aryloxycarbonyl group, a sulfamoyl group, a carbamoyl group, a sulfonyl group or a sulfinyl group. R⁸ and R⁹ each is more preferably a hydrogen atom, a linear, branched or cyclic alkyl group, an aryl group, an acyl group or a sulfonyl group. In particular, preferred is the combination where one of R⁸ and R⁹ is a hydrogen atom and the other is an alkylsulfonyl group or an arylsulfonyl group. These substituents each may be further substituted by the substituent described above. In the case where the substituent has a hydrogen atom having high acidity, the proton salt may be dissociated sand a salt may be formed. For the counter cation, metal ion, ammonium ion or phosphonium ion may be used. Such a state that active hydrogen is dissociated is effective means when the volatility of the compound becomes a problem at the development. The groups represented by R⁵, R⁶, R⁷, X³ and X⁴ are, when adjacent to each other, may combine to form a ring.

Specific examples of the compound represented by formula (2) for use in the present invention are set forth below, however, the compound which can be used in the present invention is not limited thereto.

(Specific Examples of Compound Formula (2)):

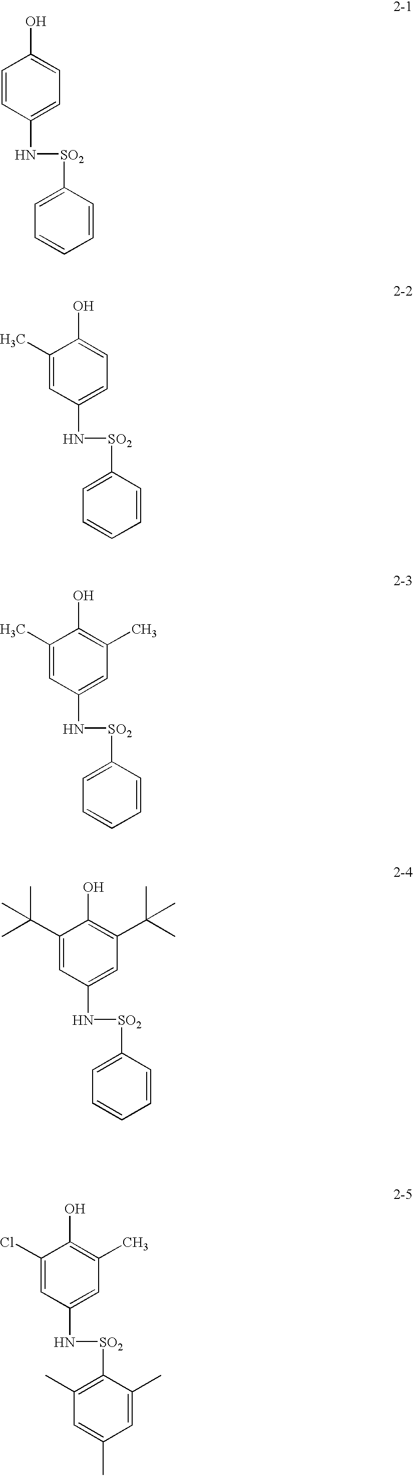

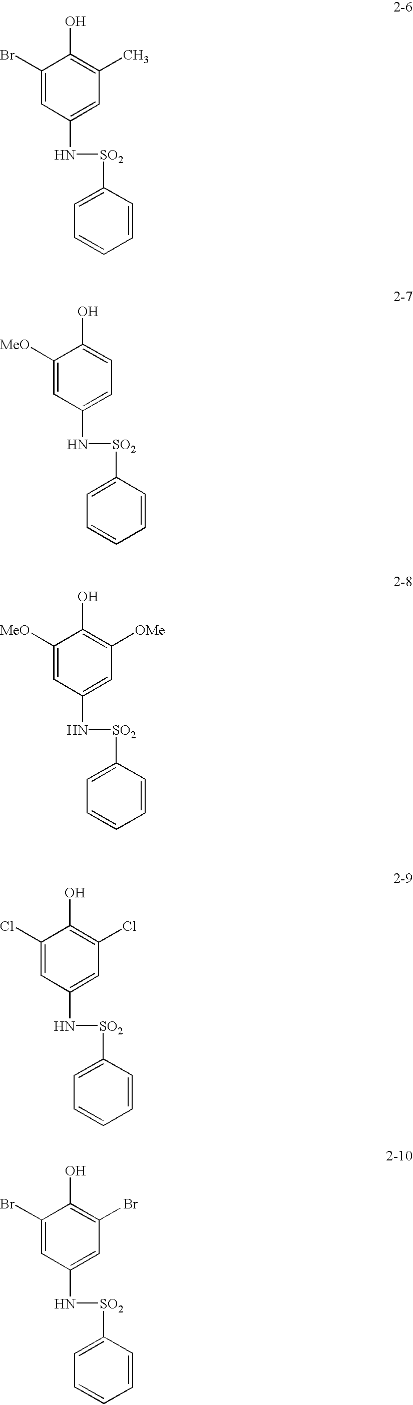

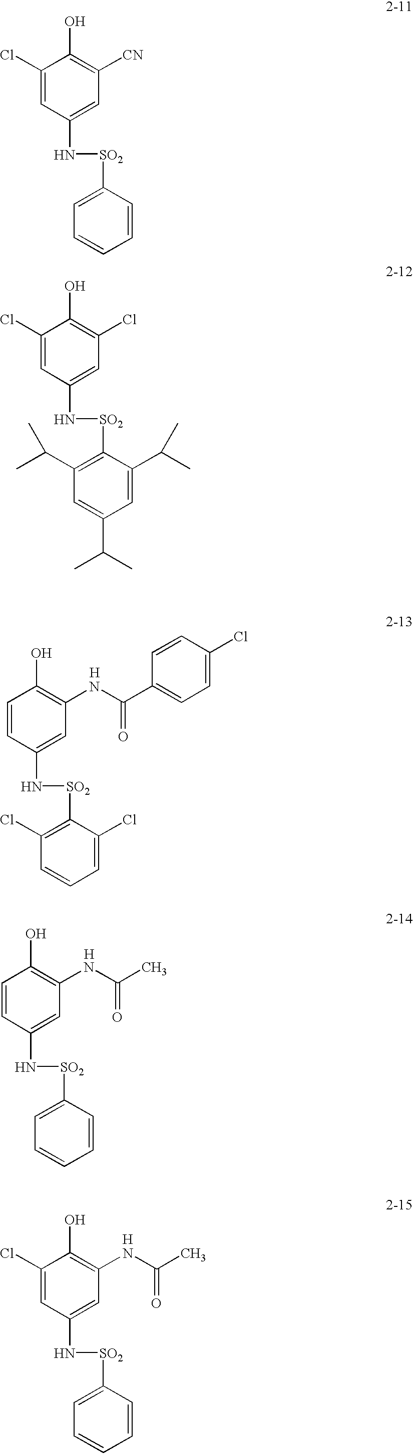

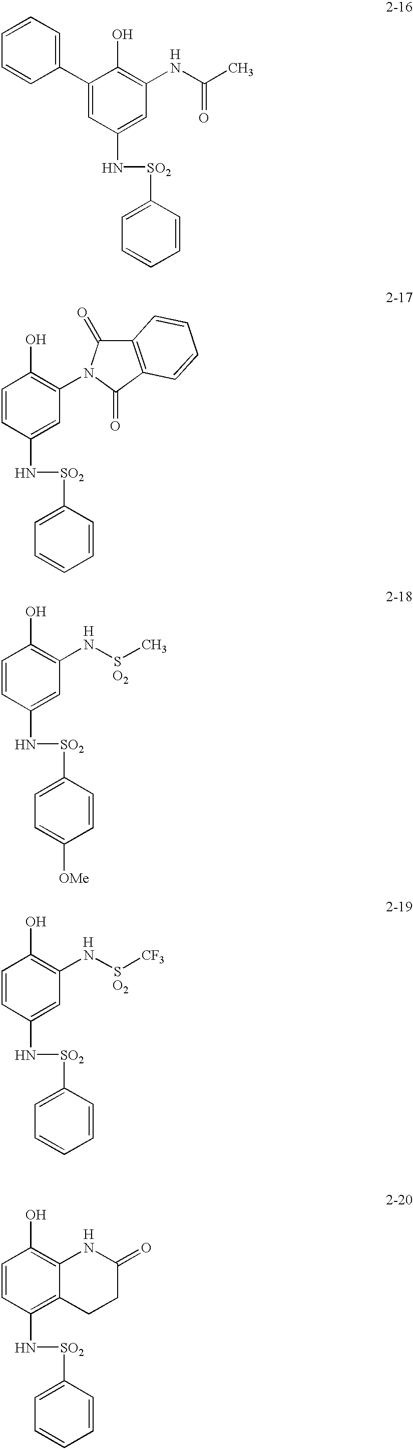

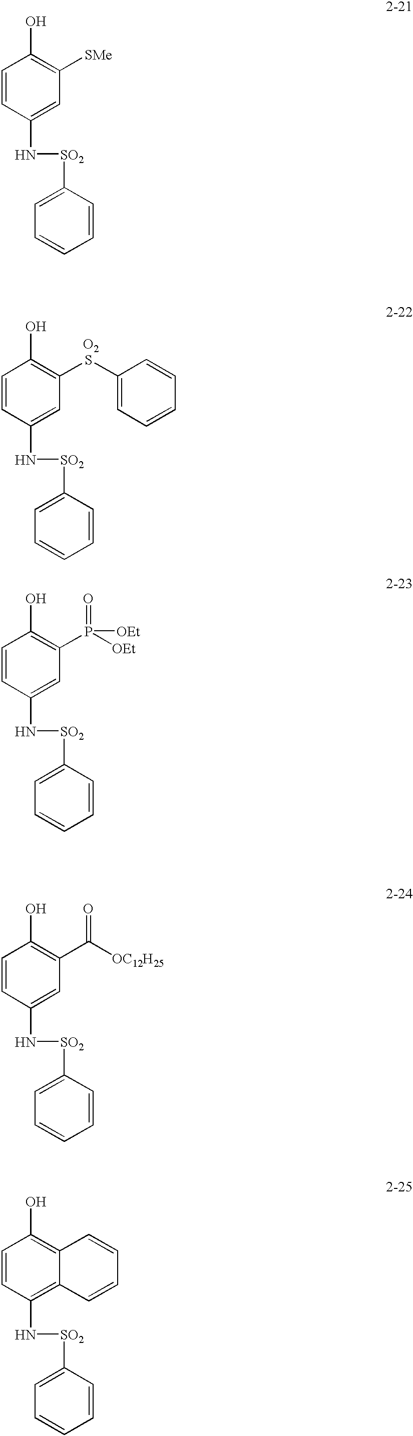

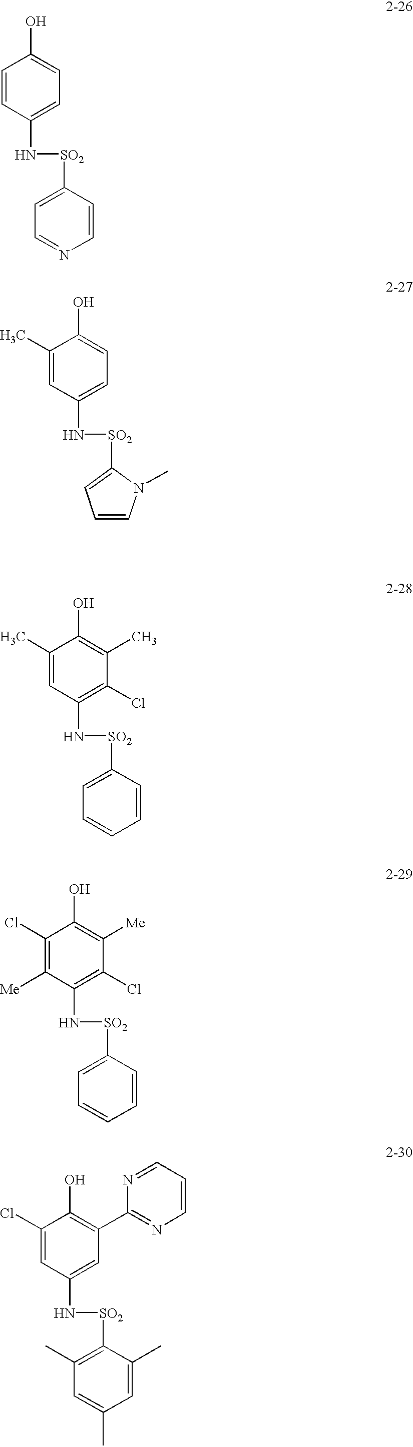

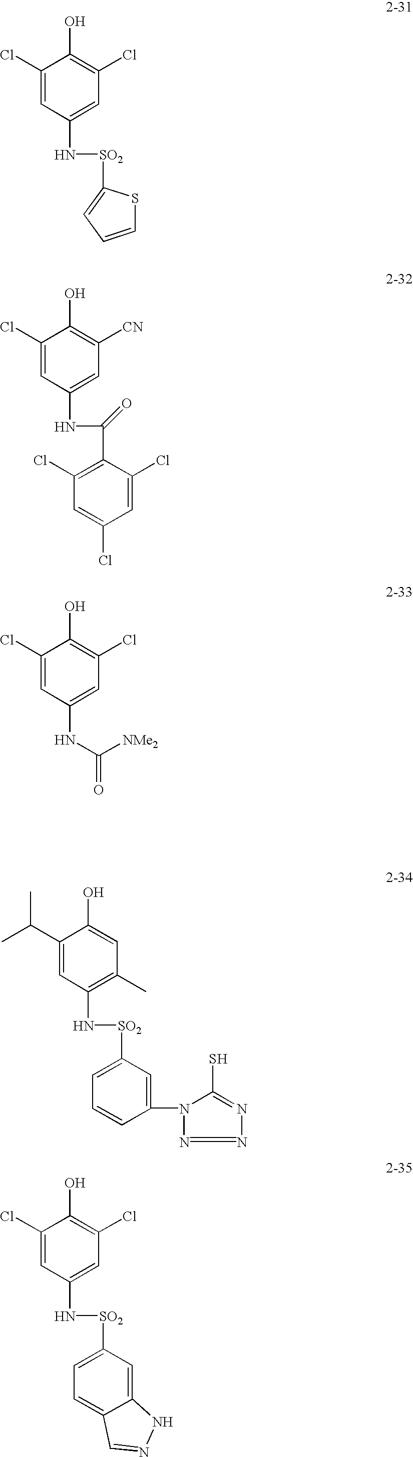

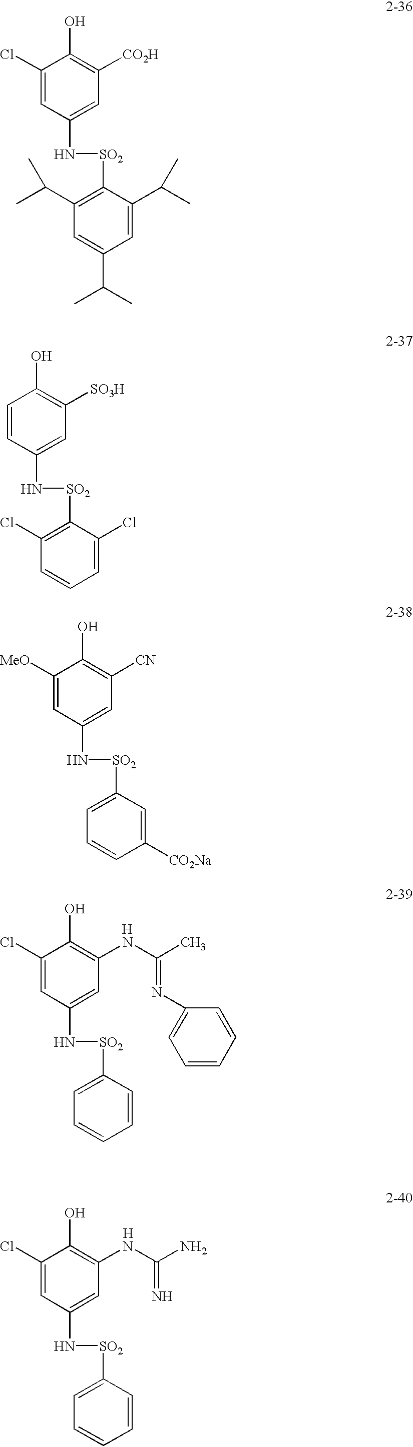

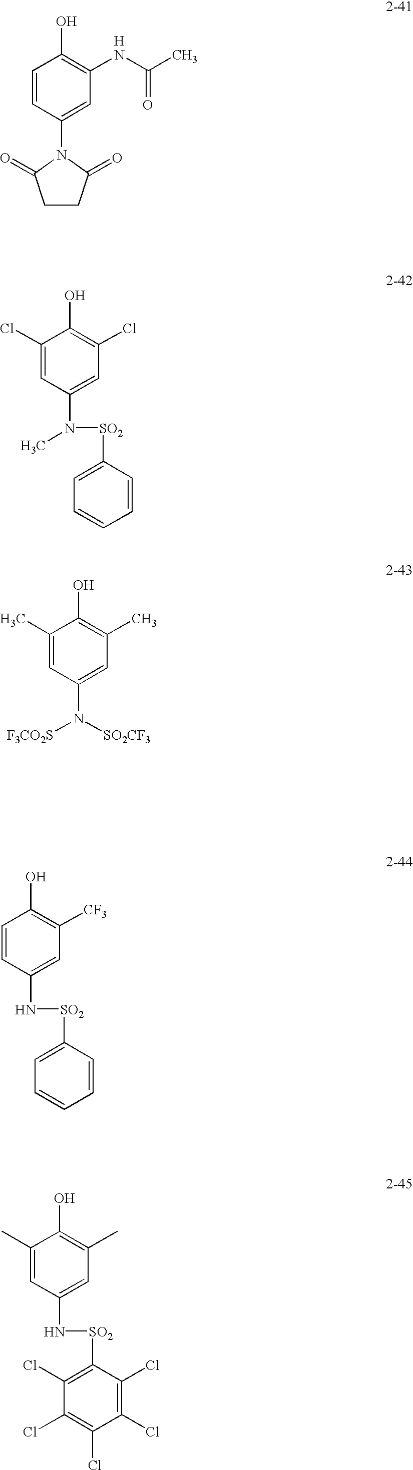

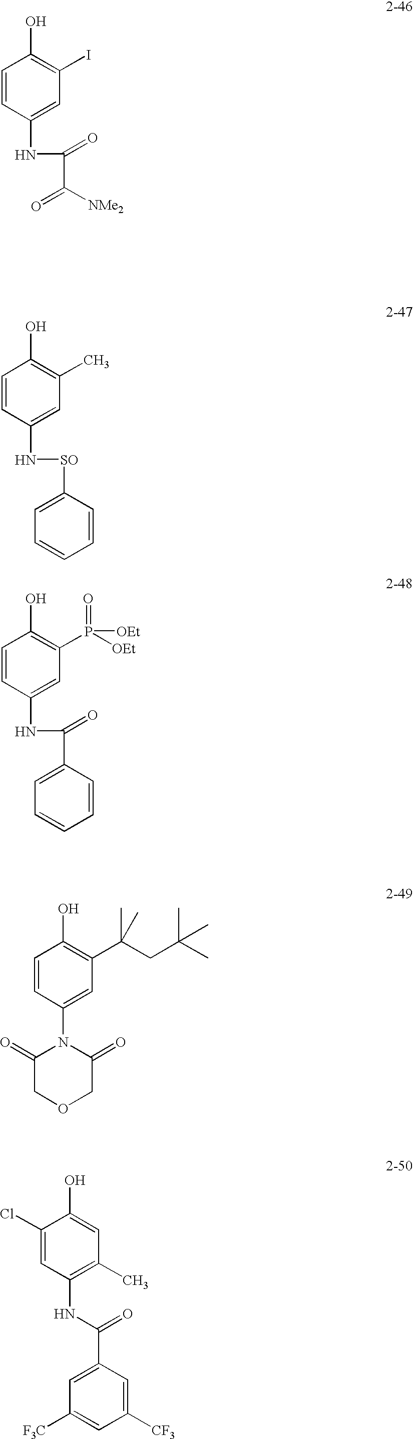

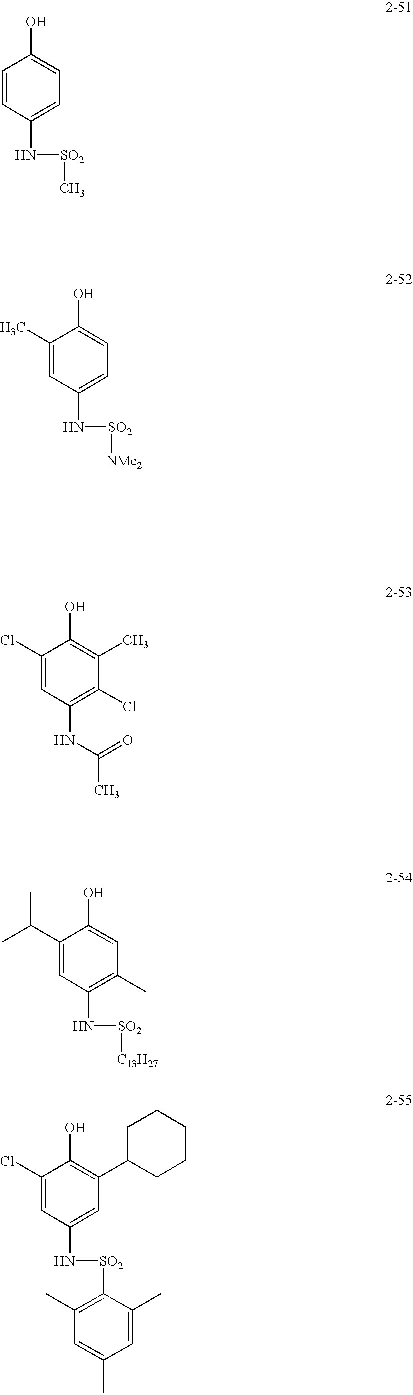

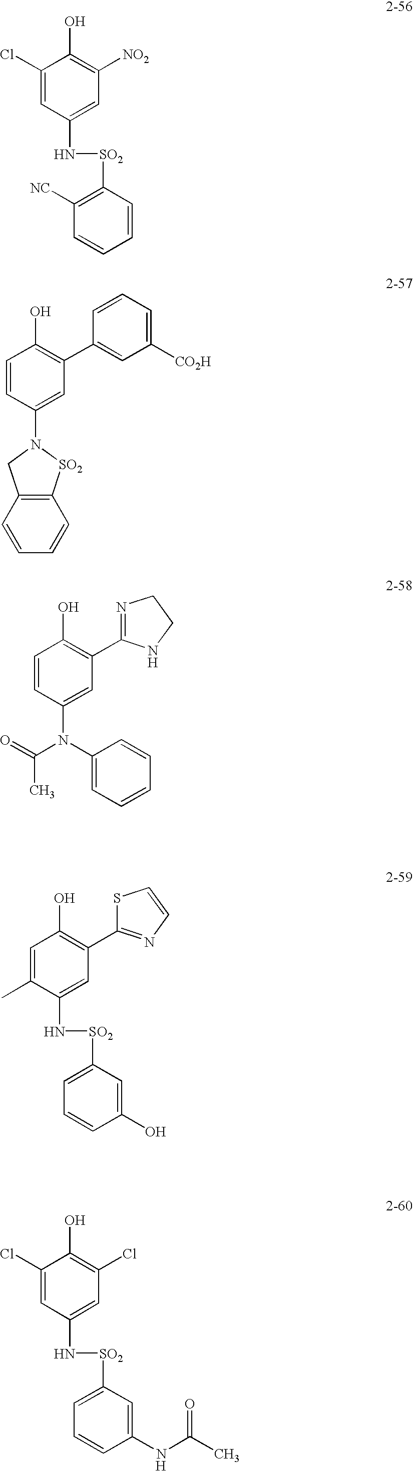

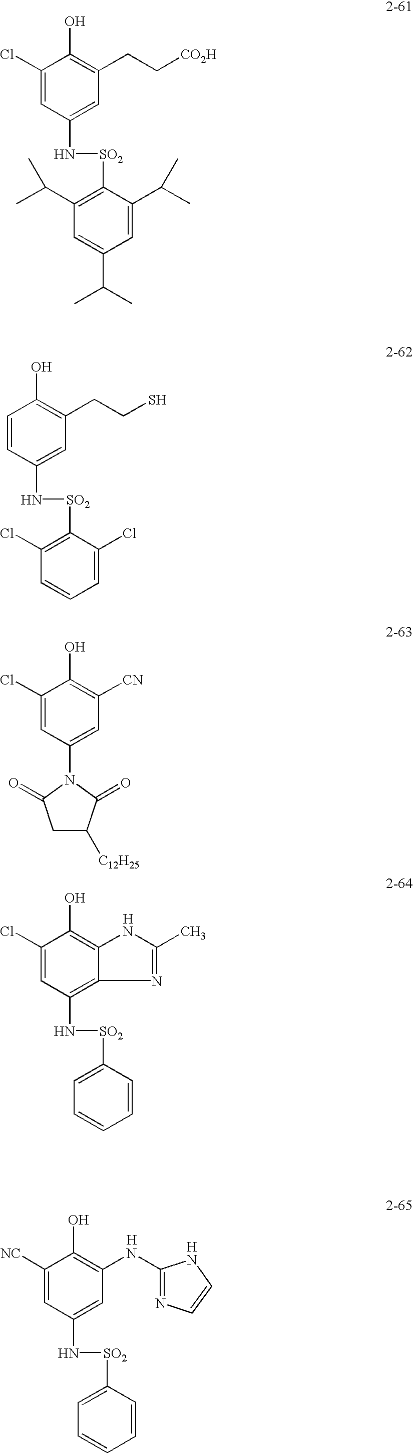

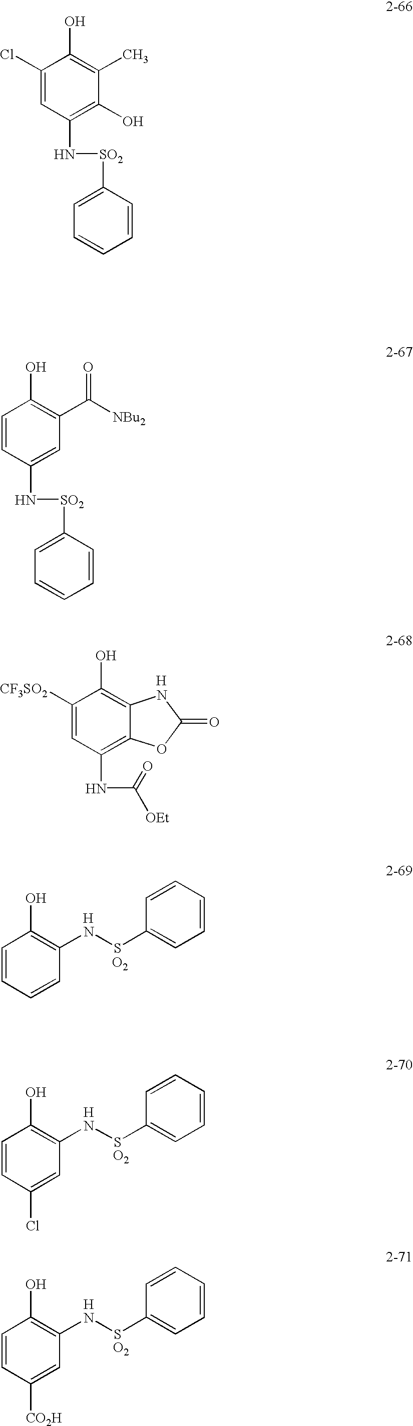

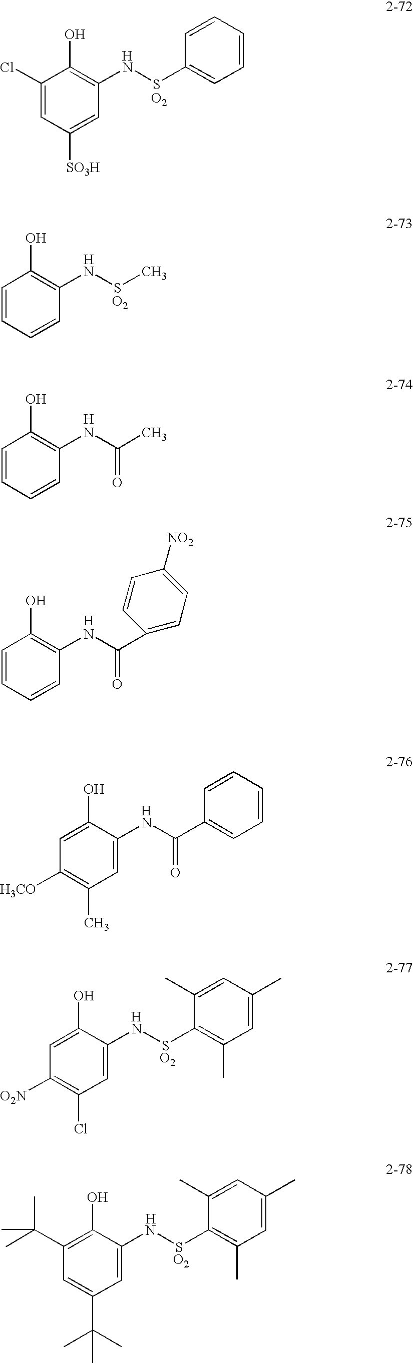

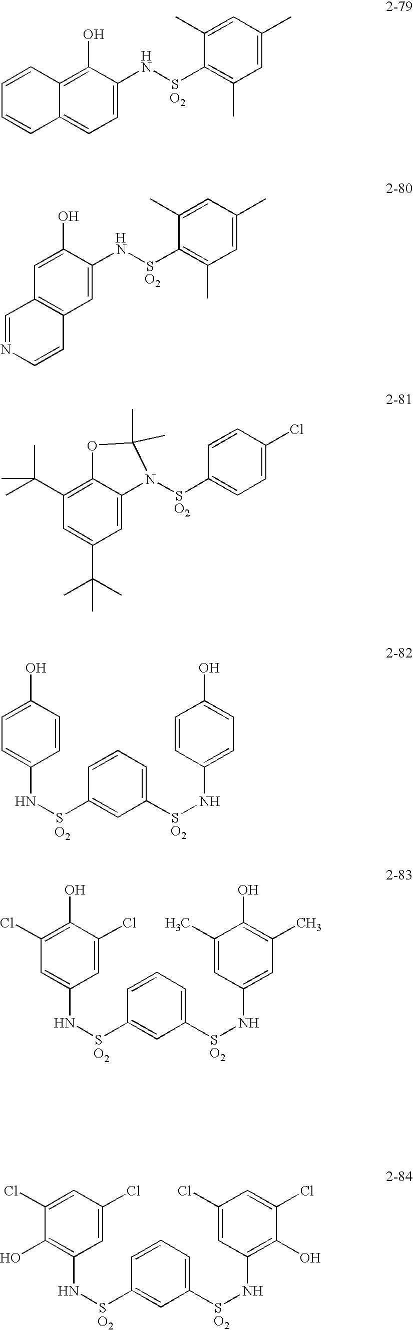

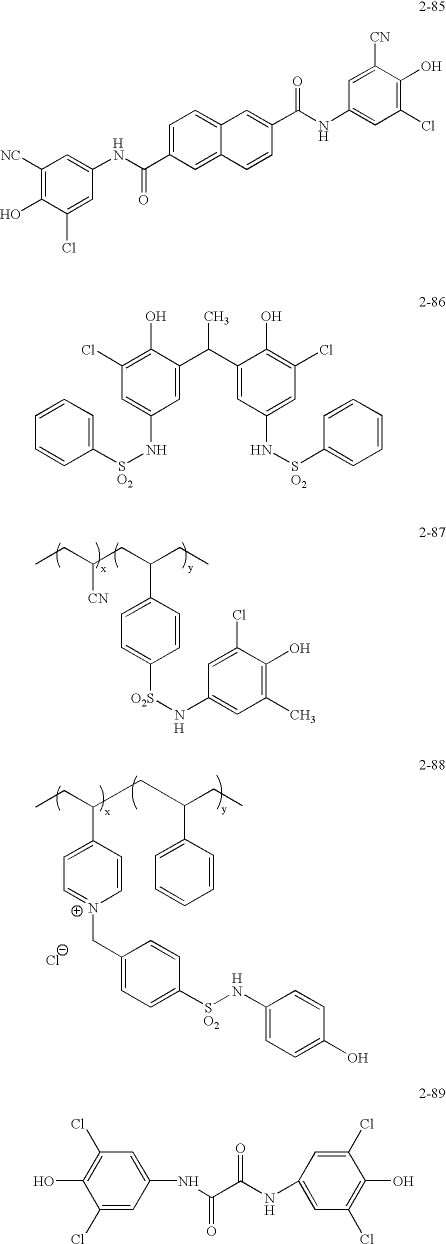

In Compounds 2-87 and 2-88, “x” and “y” each may be an arbitrary value, however, in 2-87, y is not 0 and in 2-88, x is not 0.

The development accelerator of formula (3) is described below.

In formula (3), X⁵ represents a substituent which can be substituted on the benzene ring (but the substituent is not a hydrogen atom), however, X⁵ is not a hydroxyl group. Specific examples of the substituent include a halogen atom, an alkyl group (including a cycloalkyl group and a bicycloalkyl group), an alkenyl group (including a cycloalkenyl group and a bicycloalkenyl group), an alkynyl group, an aryl group, a heterocyclic group, a cyano group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an arylazo group, a heterocyclic azo group, an imido group, a phosphino group, a phosphinyl group, a phosphinyloxy group, a phosphinylamino group and a silyl group.

More specifically, examples of the substituent include a halogen atom (e.g., fluorine, chlorine, bromine, iodine), an alkyl group [a linear, branched or cyclic, substituted or unsubstituted alkyl group; the alkyl group includes an alkyl group (preferably an alkyl group having from 1 to 30 carbon atoms, e.g., methyl, ethyl, n-propyl, isopropyl, tert-butyl, n-octyl, eicosyl, 2-chloroethyl, 2-cyanoethyl, 2-ethylhexyl), a cycloalkyl group (preferably a substituted or unsubstituted cycloalkyl group having from 3 to 30 carbon atoms, e.g., cyclohexyl, cyclopentyl, 4-n-dodecylcyclohexyl), a bicycloalkyl group (preferably a substituted or unsubstituted bicycloalkyl group having from 5 to 30 carbon atoms, namely, a monovalent group resulting from removing one hydrogen atom of bicycloalkane having from 5 to 30 carbon atoms, e.g., bicyclo[1,2,2]heptan-2-yl, bicyclo[2,2,2]octan-3-yl), and a tricycloalkyl group having many ring structures; the alkyl group in the substituents described below (for example, the alkyl group in an alkylthio group) means an alkyl group having such a concept], an alkenyl group [a linear, branched or cyclic, substituted or unsubstituted alkenyl group, such as an alkenyl group (preferably a substituted or unsubstituted alkenyl group having from 2 to 30 carbon atoms, e.g., vinyl, allyl, prenyl, geranyl, oleyl), a cycloalkenyl group (preferably a substituted or unsubstituted cycloalkenyl group having from 3 to 30 carbon atoms, namely, a monovalent group resulting from removing one hydrogen atom of cycloalkane having from 3 to 30 carbon atoms, e.g., 2-cyclopenten-1-yl, 2-cyclohexen-1-yl) and a bicycloalkenyl group (a substituted or unsubstituted bicycloalkenyl group, preferably a substituted or unsubstituted bicycloalkenyl group having from 5 to 30 carbon atoms, namely, a monovalent group resulting from removing one hydrogen atom of bicycloalkane having one double bond, e.g., bicyclo[2,2,1]hept-2-en-1-yl, bicyclo[2,2,2]oct-2-en-4-yl)], an alkynyl group (preferably a substituted or unsubstituted alkynyl group having from 2 to 30 carbon atoms, e.g., ethynyl, propargyl, trimethylsilylethynyl), an aryl group (preferably a substituted or unsubstituted aryl group having from 6 to 30 carbon atoms, e.g., phenyl, p-tolyl, naphthyl, m-chlorophenyl, o-hexadecanoylaminophenyl), a heterocyclic group (preferably a monovalent group resulting from removing one hydrogen atom of a substituted or unsubstituted, aromatic or non-aromatic 5- or 6-membered heterocyclic compound, more preferably an aromatic 5- or 6-membered heterocyclic group having from 3 to 30 carbon atoms, e.g., 2-furyl, 2-thienyl, 2-pyrimidinyl, 2-benzothiazolyl), a cyano group, a nitro group, a carboxyl group, an alkoxy group (preferably a substituted or unsubstituted alkoxy group having from 1 to 30 carbon atoms, e.g., methoxy, ethoxy, isopropoxy, tert-butoxy, n-octyloxy, 2-methoxyethoxy), an aryloxy group (preferably a substituted or unsubstituted aryloxy group having from 6 to 30 carbon atoms, e.g., phenoxy, 2-methylphenoxy, 4-tert-butylphenoxy, 3-nitrophenoxy, 2-tetradecanoylaminophenoxy), a silyloxy group (preferably a silyloxy group having from 3 to 20 carbon atoms, e.g., trimethylsilyloxy, tert-butyldimethylsilyloxy), a heterocyclic oxy group (preferably a substituted or unsubstituted heterocyclic oxy group having from 2 to 30 carbon atoms, e.g., 1-phenyltetrazol-5-oxy, 2-tetrahydropyranyloxy), an acyloxy group (preferably a formyloxy group, a substituted or unsubstituted alkylcarbonyloxy group having from 2 to 30 carbon atoms and a substituted or unsubstituted arylcarbonyloxy group having from 6 to 30 carbon atoms, e.g., formyloxy, acetyloxy, pivaloyloxy, stearoyloxy, benzoyloxy, p-methoxyphenylcarbonyloxy), a carbamoyloxy group (preferably a substituted or unsubstituted carbamoyloxy group having from 1 to 30 carbon atoms, e.g., N,N-dimethylcarbamoyloxy, N,N-diethylcarbamoyloxy, morpholinocarbonyloxy, N,N-di-n-octylaminocarbonyloxy, N-n-octylcarbamoyloxy), an alkoxycarbonyloxy group (preferably a substituted or unsubstituted alkoxycarbonyloxy group having from 2 to 30 carbon atoms, e.g., methoxycarbonyloxy, ethoxycarbonyloxy, tert-butoxycarbonyloxy, n-octylcarbonyloxy), an aryloxycarbonyloxy group (preferably a substituted or unsubstituted aryloxycarbonyloxy group having from 7 to 30 carbon atoms, e.g., phenoxycarbonyloxy, p-methoxyphenoxycarbonyloxy, p-n-hexadecyloxyphenoxycarbonyloxy), an acylamino group (preferably a formylamino group, a substituted or unsubstituted alkylcarbonylamino group having from 1 to 30 carbon atoms and a substituted or unsubstituted arylcarbonylamino group having from 6 to 30 carbon atoms, e.g., formylamino, acetylamino, pivaloylamino, lauroylamino, benzoylamino, 3,4,5-tri-n-octyloxyphenylcarbonylamino), an aminocarbonylamino group (preferably a substituted or unsubstituted aminocarbonylamino group having from 1 to 30 carbon atoms, e.g., carbamoylamino, N,N-dimethylaminocarbonylamino, N,N-diethylaminocarbonylamino, morpholinocarbonylamino), an alkoxycarbonylamino group (preferably a substituted or unsubstituted alkoxycarbonylamino group having from 2 to 30 carbon atoms, e.g., methoxycarbonylamino, ethoxycarbonylamino, tert-butoxycarbonylamino, n-octadecyloxycarbonylamino, N-methylmethoxycarbonylamino), an aryloxycarbonylamino group (preferably a substituted or unsubstituted aryloxycarbonylamino group having from 7 to 30 carbon atoms, e.g., phenoxycarbonylamino, p-chlorophenoxycarbonylamino, m-n-octyloxyphenoxycarbonylamino), a sulfamoylamino group (preferably a substituted or unsubstituted sulfamoylamino group having from 0 to 30 carbon atoms, e.g., sulfamoylamino, N,N-dimethylaminosulfonylamino, N-n-octylaminosulfonylamino), an alkyl- or aryl-sulfonylamino group (preferably a substituted or unsubstituted alkylsulfonyl amino group) having from 1 to 30 carbon atoms and a substituted or unsubstituted arylsulfonylamino group having from 6 to 30 carbon atoms, e.g., methylsulfonylamino, butylsulfonylamino, phenylsulfonylamino, 2,3,5-trichlorophenylsulfonylamino, p-methylphenylsulfonylamino), a mercapto group, an alkylthio group (preferably a substituted or unsubstituted alkylthio group having from 1 to 30 carbon atoms, e.g., methylthio, ethylthio, n-hexadecylthio), an arylthio group (preferably a substituted or unsubstituted arylthio group having from 6 to 30 carbon atoms, e.g., phenylthio, p-chlorophenylthio, m-methoxyphenylthio), a heterocyclic thio group (preferably a substituted or unsubstituted heterocyclic thio group having from 2 to 30 carbon atoms, e.g., 2-benzothiazolylthio, 1-phenyltetrazol-5-ylthio), a sulfamoyl group (preferably a substituted or unsubstituted sulfamoyl group having from 0 to 30 carbon atoms, e.g., N-ethylsulfamoyl, N-(3-dodecyloxypropyl)sulfamoyl, N,N-dimethylsulfamoyl, N-acetylsulfamoyl, N-benzoylsulfamoyl, N-(N′-phenylcarbamoyl)sulfamoyl), a sulfo group, an alkyl- or aryl-sulfinyl group (preferably a substituted or unsubstituted alkylsulfinyl group having from 1 to 30 carbon atoms and a substituted or unsubstituted arylsulfinyl group having from 6 to 30 carbon atoms, e.g., methylsulfinyl, ethylsulfinyl, phenylsulfinyl, p-methylphenylsulfinyl), an alkyl- or aryl-sulfonyl group (preferably a substituted or unsubstituted alkylsulfonyl group having from 1 to 30 carbon atoms and a substituted or unsubstituted arylsulfonyl group having from 6 to 30 carbon atoms, e.g., methylsulfonyl, ethylsulfonyl, phenylsulfonyl, p-methylphenylsulfonyl), an acyl group (preferably a formyl group, a substituted or unsubstituted alkylcarbonyl group having from 2 to 30 carbon atoms, a substituted or unsubstituted arylcarbonyl group having from 7 to 30 carbon atoms and a substituted or unsubstituted heterocyclic carbonyl group having from 4 to 30 carbon atoms, bonded to the carbonyl group through a carbon atom, e.g., acetyl, pivaloyl, 2-chloroacetyl, stearoyl, benzoyl, p-n-octyloxyphenylcarbonyl, 2-pyridylcarbonyl, 2-furylcarbonyl), an aryloxycarbonyl group (preferably a substituted or unsubstituted aryloxycarbonyl group having from 7 to 30 carbon atoms, e.g., phenoxycarbonyl, o-chlorophenoxycarbonyl, m-nitrophenoxycarbonyl, p-tert-butylphenoxycarbonyl), an alkoxycarbonyl group (preferably a substituted or unsubstituted alkoxycarbonyl group having from 2 to 30 carbon atoms, e.g., methoxycarbonyl, ethoxycarbonyl, tert-butoxycarbonyl, n-octadecyloxycarbonyl), a carbamoyl group (preferably a substituted or unsubstituted carbamoyl group having from 1 to 30 carbon atoms, e.g., carbamoyl, N-methylcarbamoyl, N,N-dimethylcarbamoyl, N,N-di-n-octylcarbamoyl, N-(methylsulfonyl)carbamoyl), an aryl- or heterocyclic-azo group (preferably a substituted or unsubstituted arylazo group having from 6 to 30 carbon atoms and a substituted or unsubstituted heterocyclic azo group having from 3 to 30 carbon atoms, e.g., phenylazo, p-chlorophenylazo, 5-etbylthio-1,3,4-thiadiazol-2-ylazo), an imido group (preferably N-succinimido and N-phthalimido), a phosphino group (preferably a substituted or unsubstituted phosphino group having from 2 to 30 carbon atoms, e.g., dimethylphosphino, diphenylphosphino, methylphenoxyphosphino), a phosphinyl group (preferably a substituted or unsubstituted phosphinyl group having from 2 to 30 carbon atoms, e.g., phosphinyl, dioctyloxyphosphinyl, diethoxyphosphinyl), a phosphinyloxy group (preferably a substituted or unsubstituted phosphinyloxy group having from 2 to 30 carbon atoms, e.g., diphenoxyphosphinyloxy, dioctyloxyphosphinyloxy), a phosphinylamino group (preferably a substituted or unsubstituted phosphinylamino group having from 2 to 30 carbon atoms, e.g., dimethoxyphosphinylamino, dimethylaminophosphinylamino), and a silyl group (preferably a substituted or unsubstituted silyl group having from 3 to 30 carbon atoms, e.g., trimethylsilyl, tert-butyldimethylsilyl, phenyldimethylsilyl).

The substituent represented by X⁵ is preferably a halogen atom (e.g., fluorine, chlorine, bromine or iodine, preferably chlorine or bromine), an acylamino group (preferably having from 1 to 20, more preferably from 1 to 14, still more preferably from 1 to 8, carbon atoms, e.g., formylamino, acetylamino, benzoylamino), an alkyl group (preferably having from 1 to 20, more preferably from 1 to 14, still more preferably from 1 to 8, carbon atoms, e.g., methyl, ethyl, isopropyl, cyclohexyl), an aryl group (preferably having from 6 to 20, more preferably from 6 to 14, still more preferably from 6 to 8, carbon atoms, e.g., phenyl, naphthyl, p-methylphenyl), an alkoxy group (preferably having from 1 to 20, more preferably from 1 to 14, still more preferably from 1 to 8, carbon atoms, e.g., methoxy, ethoxy), an aryloxy group (preferably having from 6 to 20, more preferably from 6 to 14, still more preferably from 6 to 8, carbon atoms, e.g., phenoxy, 2-naphthyloxy), an acyloxy group (preferably having from 1 to 20, more preferably from 1 to 14, still more preferably from 1 to 8, carbon atoms, e.g., acetoxy, benzoyloxy), a sulfonylamino group (preferably having from 1 to 20, more preferably from 1 to 14, still more preferably from 1 to 8, carbon atoms, e.g., methanesulfonylamino, benzenesulfonylamino), a carbamoyl group (preferably having from 1 to 20, more preferably from 1 to 14, still more preferably from 1 to 8, carbon atoms, e.g., carbamoyl, N,N-dimethylcarbamoyl, N-phenylcarbamoyl), an acyl group (preferably having from 1 to 20, more preferably from 1 to 14, still more preferably from 1 to 8, carbon atoms, e.g., formyl, acetyl, benzoyl), an alkoxycarbonyl group (preferably having from 2 to 20, more preferably from 2 to 16, still more preferably from 2 to 12, carbon atoms, e.g., methoxycarbonyl, ethoxycarbonyl, butoxycarbonyl), an aryloxycarbonyl group (preferably having from 6 to 20, more preferably from 6 to 16, still more preferably from 6 to 12, carbon atoms, e.g., phenoxycarbonyl, 2-naphthyloxycarbonyl), a cyano group or a nitro group, more preferably a halogen atom, an acylamino group or an alkyl group, still more preferably a chlorine atom or a bromine atom.

In formula (3), X⁷ represents a hydrogen atom or a substituent. However, X⁷ is not a hydroxyl group or a sulfonamido group. Specific examples of the substituent include those described above as examples of the substituent represented by X⁵ of formula (3) (excluding a sulfonamido group). X⁷ is preferably a hydrogen atom, a halogen atom (e.g., fluorine, chlorine, bromine or iodine, preferably chlorine or bromine), an acylamino group (preferably having from 1 to 20, more preferably from 1 to 14, still more preferably from 1 to 8, carbon atoms, e.g., formylamino, acetylamino, benzoylamino), an alkyl group (preferably having from 1 to 20, more preferably from 1 to 14, still more preferably from 1 to 8, carbon atoms, e.g., methyl, ethyl, isopropyl, cyclohexyl), an aryl group (preferably having from 6 to 20, more preferably from 6 to 14, still more preferably from 6 to 8, carbon atoms, e.g., phenyl, naphthyl, p-methylphenyl), an alkoxy group (preferably having from 1 to 20, more preferably from 1 to 14, still more preferably from 1 to 8, carbon atoms, e.g., methoxy, ethoxy), an aryloxy group (preferably having from 6 to 20, more preferably from 6 to 14, still more preferably from 6 to 8, carbon atoms, e.g., phenoxy, 2-naphthyloxy), an acyloxy group (preferably having from 1 to 20, more preferably from 1 to 14, still more preferably from 1 to 8, carbon atoms, e.g., acetoxy, benzoyloxy), a carbamoyl group (preferably having from 1 to 20, more preferably from 1 to 14, still more preferably from 1 to 8, carbon atoms, e.g., carbamoyl, N,N-dimethylcarbamoyl, N-phenylcarbamoyl), an acyl group (preferably having from 1 to 20, more preferably from 1 to 14, still more preferably from 1 to 8, carbon atoms, e.g., formyl, acetyl, benzoyl), an alkoxycarbonyl group (preferably having from 2 to 20, more preferably from 2 to 16,. still more preferably from 2 to 12, carbon atoms, e.g., methoxycarbonyl, ethoxycarbonyl, butoxycarbonyl), an aryloxycarbonyl group (preferably having from 6 to 20, more preferably from 6 to 16, still more preferably from 6 to 12, carbon atoms, e.g., phenoxycarbonyl, 2-naphthyloxycarbonyl), a cyano group or a nitro group, more preferably a halogen atom, an acylamino group or an alkyl group, still more preferably a chlorine atom or a bromine atom.

At least either one of the substituents represented by X⁵ and X⁷ is preferably an electron-withdrawing group. The electron-withdrawing group is a substituent having a positive value as the Hammett's substituent constant σₚ. Specific examples thereof include a halogen atom, a cyano group, a nitro group, an alkoxycarbonyl group, an aryloxycarbonyl group, an imino group, an imino group substituted by N atom, a thiocarbonyl group, a perfluoroalkyl group, a sulfonamide group, a formyl group, a phosphoryl group, a carboxyl group, a carbamoyl group, an acyl group, a sulfo group (or a salt thereof), an alkylsulfonyl group, an arylsulfonyl group, a sulfamoyl group, an acyloxy group, an acylthio group, a sulfonyloxy group, a heterocyclic group, and an aryl group substituted by the above-described electron-withdrawing group. More preferably, X⁵ and X⁷ both are an electron-withdrawing group, still more preferably, X⁵ and X⁷ both are a halogen atom, and particularly preferably, X⁵ and X⁷ both are a chlorine atom or a bromine atom.

In formula (3), X⁶ and X⁸ each represents a hydrogen atom or a substituent. However, X⁶ and X⁸ are not a hydroxyl group. Specific examples of the substituent include those described above as examples of the substituent represented by X⁵ of formula (3). X⁶ and X⁸ each is preferably a hydrogen atom, a halogen atom (e.g., fluorine, chlorine, bromine or iodine, preferably chlorine or bromine), an acylamino group (preferably having from 1 to 20, more preferably from 1 to 14, still more preferably from 1 to 8, carbon atoms, e.g., formylamino, acetylamino, benzoylamino), an alkyl group (preferably having from 1 to 20, more preferably from 1 to 14, still more preferably from 1 to 8, carbon atoms, e.g., methyl, ethyl, isopropyl, cyclohexyl), an aryl group (preferably having from 6 to 20, more preferably from 6 to 14, still more preferably from 6 to 8, carbon atoms, e.g., phenyl, naphthyl, p-methylphenyl), an alkoxy group (preferably having from 1 to 20, more preferably from 1 to 14, still more preferably from 1 to 8, carbon atoms, e.g., methoxy, ethoxy), an aryloxy group (preferably having from 6 to 20, more preferably from 6 to 14, still more preferably from 6 to 8, carbon atoms, e.g., phenoxy, 2-naphthyloxy), an acyloxy group (preferably having from 1 to 20, more preferably from 1 to 14, still more preferably from 1 to 8, carbon atoms, e.g., acetoxy, benzoyloxy), a sulfonylamino group (preferably having from 1 to 20, more preferably from 1 to 14, still more preferably from 1 to 8, carbon atoms, e.g., methanesulfonylamino, benzenesulfonylamino), a carbamoyl group (preferably having from 1 to 20, more preferably from 1 to 14, still more preferably from 1 to 8, carbon atoms, e.g., carbamoyl, N,N-dimethylcarbamoyl, N-phenylcarbamoyl), an acyl group (preferably having from 1 to 20, more preferably from 1 to 14, still more preferably from 1 to 8, carbon atoms, e.g., formyl, acetyl, benzoyl), an alkoxycarbonyl group (preferably having from 2 to 20, more preferably from 2 to 16, still more preferably from 2 to 12, carbon atoms, e.g., methoxycarbonyl, ethoxycarbonyl, butoxycarbonyl), an aryloxycarbonyl group (preferably having from 6 to 20, more preferably from 6 to 16, still more preferably from 6 to 12, carbon atoms, e.g., phenoxycarbonyl, 2-naphthyloxycarbonyl), a cyano group or a nitro group, more preferably a hydrogen atom, an alkyl group, an aryl group, a halogen atom or an acylamino group, still more preferably a hydrogen atom, a methyl group or an ethyl group.

X⁵ to X⁸ each may be further substituted and specific examples of the substituent include those described above as examples of the substituent represented by X⁵ of formula (3). Also, X⁵ to X⁸ may combine with each other to form a ring.

In formula (3), R¹⁰ represents a hydrogen atom, an alkyl group (preferably having from 1 to 20, more preferably from 1 to 14, still more preferably from 1 to 7, carbon atoms, e.g., methyl, ethyl, isopropyl, cyclohexyl), an aryl group (preferably having from 6 to 20, more preferably from 6 to 14, still more preferably from 6 to 8, carbon atoms, e.g., phenyl, naphthyl, p-methylphenyl), a heterocyclic group (e.g., pyridyl, imidazolyl, pyrrolidyl), an amino group (preferably having from 0 to 20, more preferably from 0 to 14, still more preferably from 0 to-8, carbon atoms, e.g., amino, methylamino, N,N-dimethylamino, N-phenylamino) or an alkoxy group (preferably having from 1 to 20, more preferably from 1 to 14, still more preferably from 1 to 8, carbon atoms, e.g., methoxy, ethoxy), more preferably a hydrogen atom, an aryl group, a heterocyclic group, an amino group, an alkoxy group or an alkyl group having from 1 to 7 carbon atoms, still more preferably an aryl group or an alkyl group having from 1 to 7 carbon atoms, and particularly preferably an aryl group. R¹⁰ may be further substituted and specific examples of the substituent include those described above as examples of the substituent represented by X⁵ of formula (3).

The combination of X⁵ to X⁸ and R¹⁰ is preferably a combination such that at least one of X⁵ and X⁷ is a halogen atom, X⁶ and X⁸ each is a hydrogen atom or an alkyl group and R¹⁰ is an aryl group or an alkyl group having from 1 to 7 carbon atoms, more preferably a combination such that X⁵ and X⁷ both are a chlorine atom or a bromine atom, X⁶ is a hydrogen atom or an alkyl group, X⁸ is a hydrogen atom and R¹⁰ is an aryl group.

The total molecular weight of the compound represented by formula (3) is preferably from 170 to 800, more preferably from 220 to 650, still more preferably from 220 to 500.

Specific examples of the compound represented by formula (3) are set forth below, however, the compound represented by formula (3) which can be used in the present invention is not limited to these specific examples).

(Specific Examples of Compound of Formula (3))

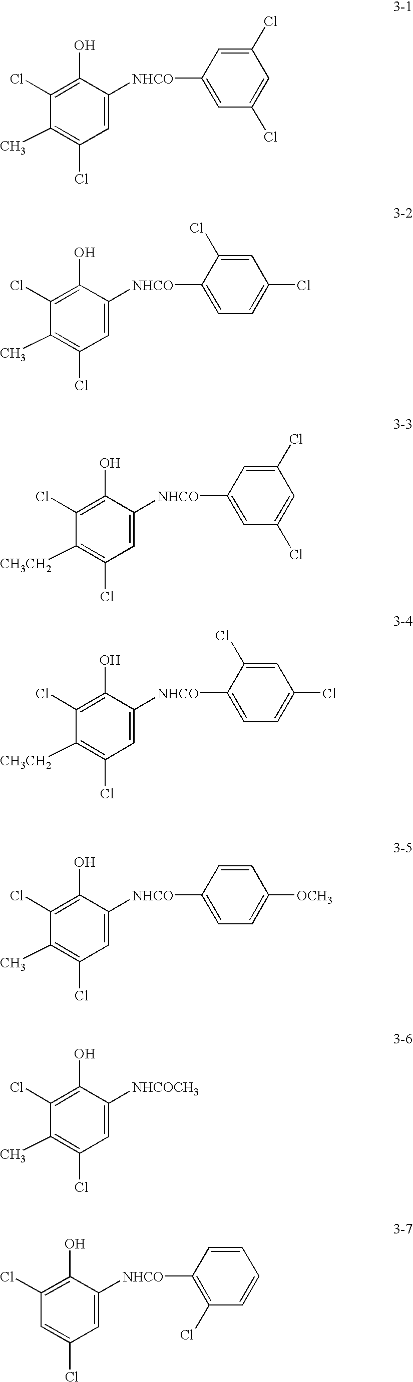

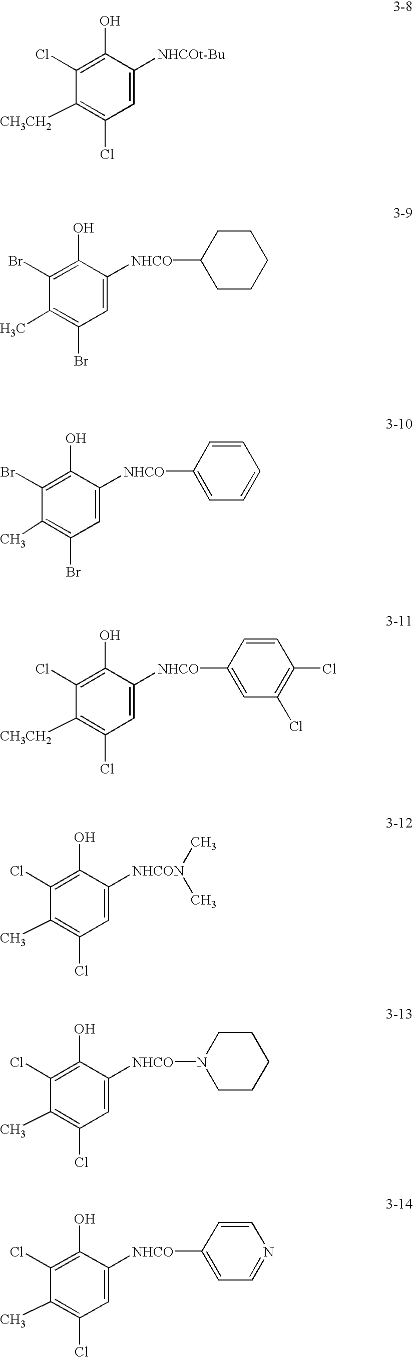

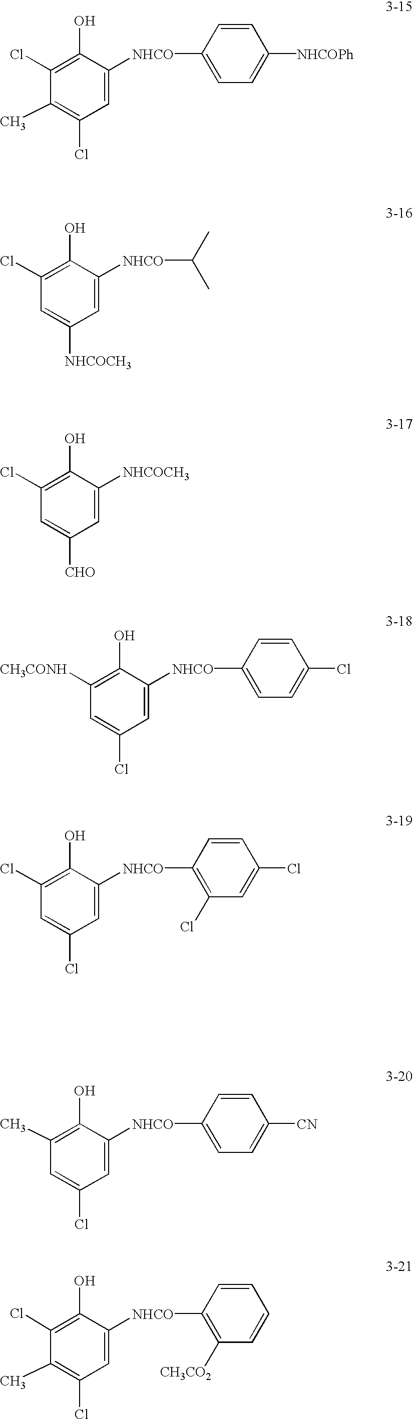

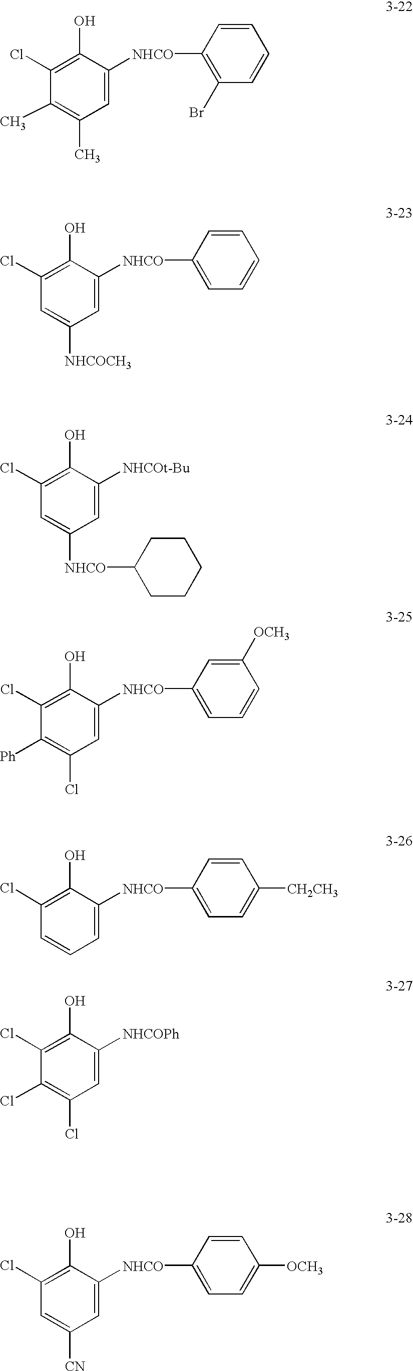

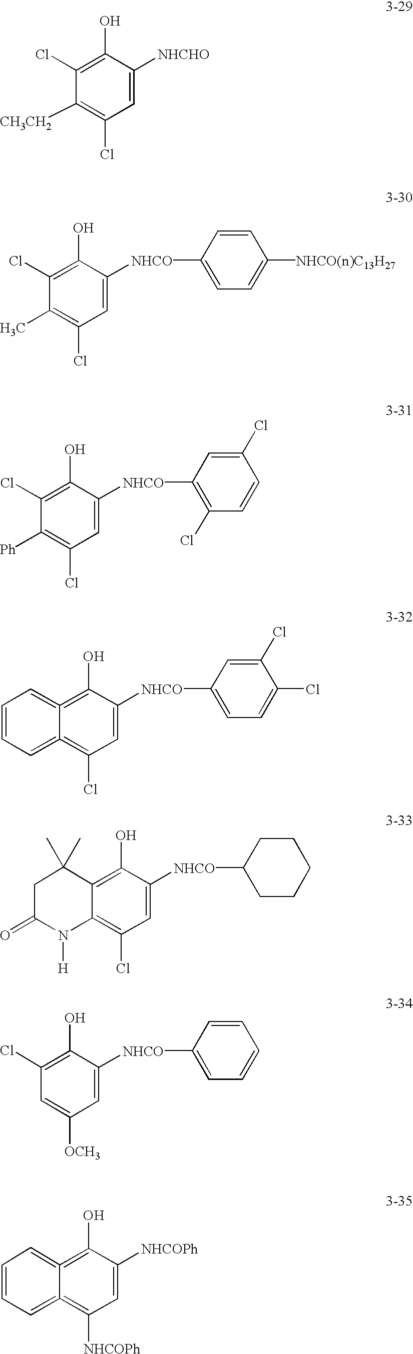

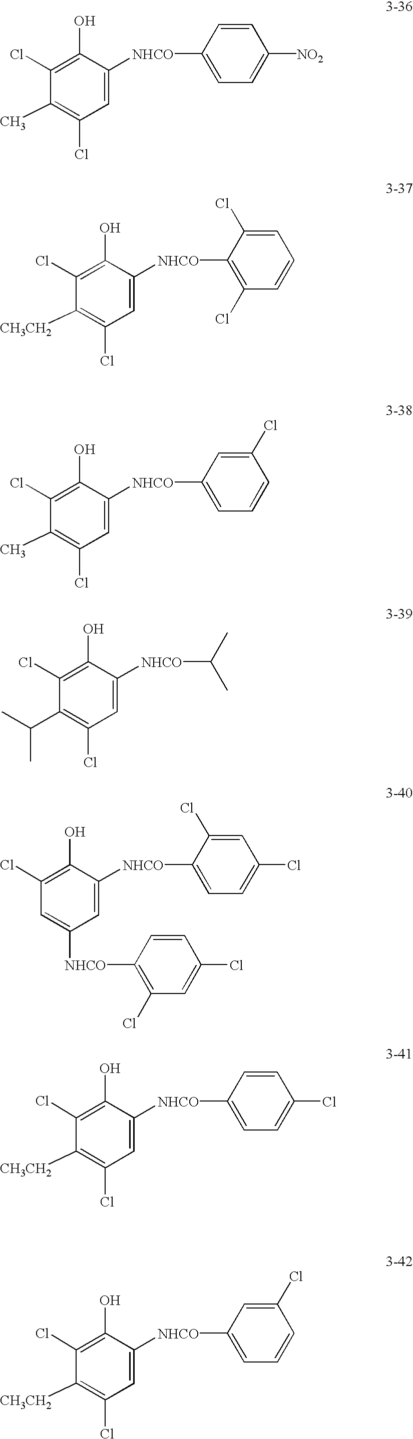

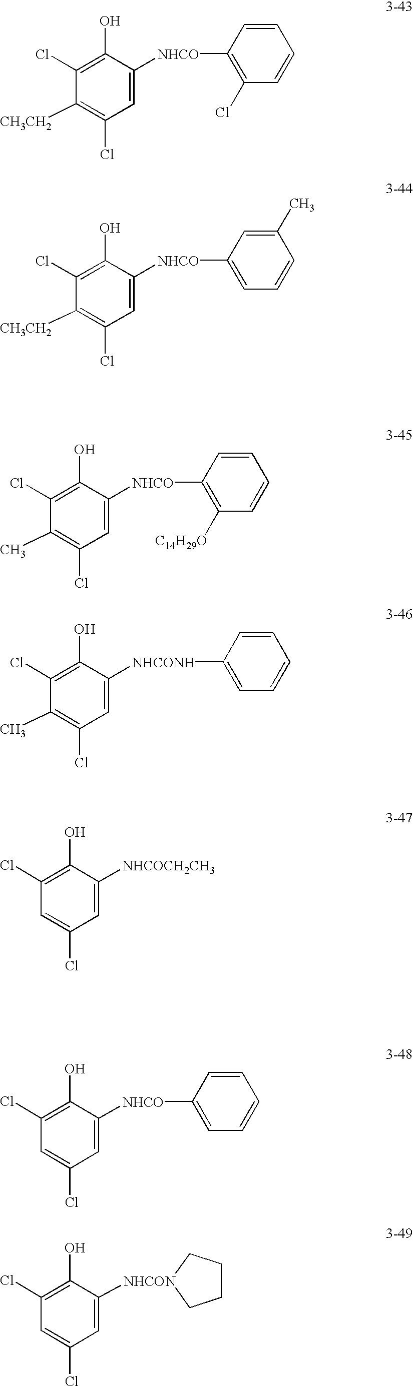

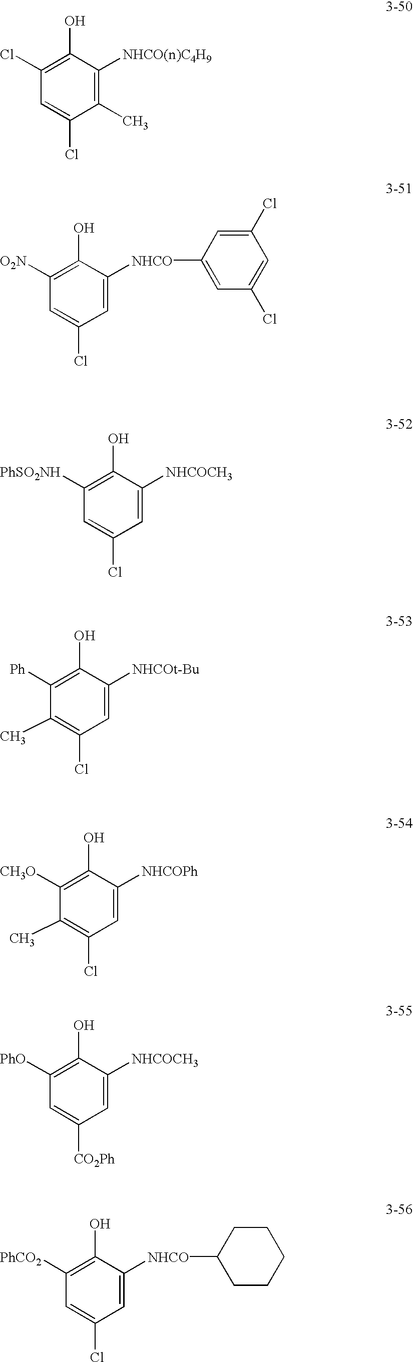

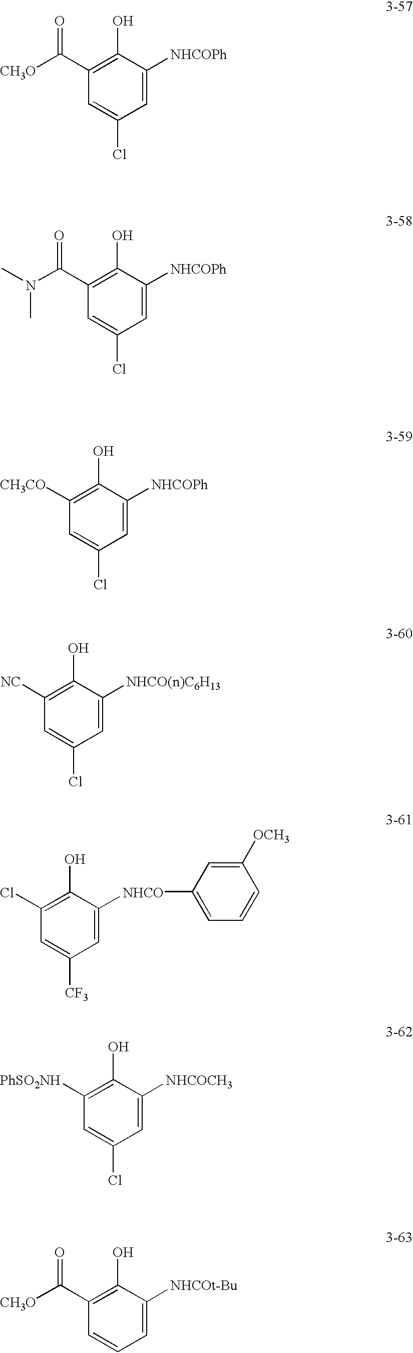

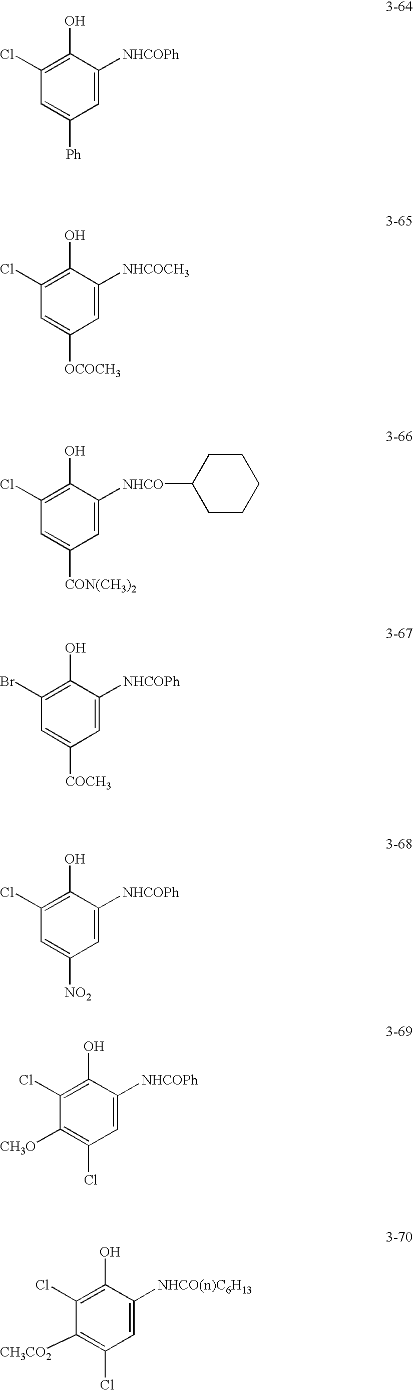

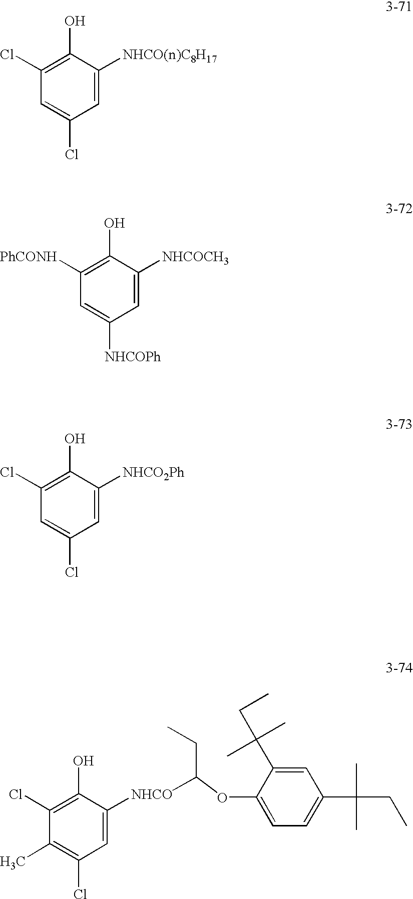

The compound represented by formula (6) is more preferably represented by formula (4):

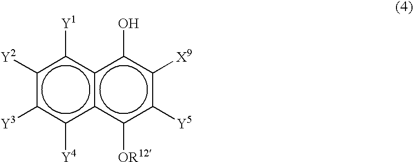

wherein R¹² represents an alkyl group, an aryl group, an alkenyl group or an alkynyl group, X⁹ represents an acyl group, an alkoxycarbonyl group, a carbamoyl group, a sulfonyl group or a sulfamoyl group, and Y¹ to Y⁵ each independently represents a hydrogen atom or a substituent.

The development accelerator of formula (4) is described below.

In formula (4), R¹² represents an alkyl group, an aryl group, an alkenyl group or an alkynyl group.

The alkyl group represented by R¹² is a linear, branched or cyclic alkyl group or an alkyl group having a combination of linear, branched and/or cyclic structures, preferably having from 1 to 30, more preferably from 1 to 16, still more preferably from 1 to 13, carbon atoms, such as methyl, ethyl, n-propyl, isopropyl, n-butyl, sec-butyl, tert-butyl, n-hexyl, cyclohexyl, n-octyl, tert-octyl, n-amyl, tert-amyl, n-decyl, n-dodecyl, n-tridecyl, benzyl and phenethyl.

The aryl group represented by R¹² is an aryl group preferably having from 6 to 30, more preferably from 6 to 20, still more preferably from 6 to 12, carbon atoms, such as phenyl, 4-methylphenyl, 2-chlorophenyl, 4-chlorophenyl, 2,4-dichlorophenyl, 3,4-dichlorophenyl, 2-methoxyphenyl, 4-methoxyphenyl, 4-hexyloxyphenyl, 2-dodecyloxyphenyl and naphthyl

The alkenyl group represented by R¹² is an alkenyl group preferably having from 2 to 30, more preferably from 2 to 20, still more preferably from 2 to 12, carbon atoms, such as vinyl, allyl, isopropenyl, butenyl and cyclohexenyl.

The alkynyl group represented by R¹² is an alkynyl group preferably having from 2 to 30, more preferably from 2 to 20, still more preferably from 2 to 12, carbon atoms, e.g., ethynyl and propynyl.

R¹² may further have a substituent and preferred examples of the substituent include the groups represented by Y¹ to Y⁵ of formula (4), which are described later.

R¹² is more preferably an alkyl group or an aryl group, still more preferably an alkyl group.

In the compound of formula (4), X⁹ represents an acyl group, an alkoxycarbonyl group, a carbamoyl group, a sulfonyl group or a sulfamoyl group.

The acyl group represented by X⁹ is an acyl group preferably having from 2 to 20, more preferably from 2 to 16, still more preferably from 2 to 12, carbon atoms, such as acetyl, propionyl, butyryl, valeryl, hexanoyl, myristyl, palmitoyl, stearyl, oleyl, acryloyl, cyclohexanecarbonyl, benzoyl, formyl and pivaloyl.

The alkoxycarbonyl group represented by X⁹ is an. alkoxycarbonyl group preferably having from 2 to 20, more preferably from 2 to 16, still more preferably from 2 to 12, carbon atoms, such as methoxycarbonyl, ethoxycarbonyl, butoxycarbonyl and phenoxycarbonyl.

The carbamoyl group represented by X⁹ is a carbamoyl group preferably having from 1 to 20, more preferably from 1 to 16, still more preferably from 1 to 12, carbon atoms, such as carbamoyl, N,N-diethylcarbamoyl, N-dodecylcarbamoyl, N-decylcarbamoyl, N-hexadecylcarbamoyl, N-phenylcarbamoyl, N-(2-chlorophenyl)carbamoyl, N-(4-chlorophenyl)carbamoyl, N-(2,4-dichlorophenyl)carbamoyl, N-(3,4-dichlorophenyl)carbamoyl, N-pentachlorophenylcarbamoyl, N-(2-methoxyphenyl)carbamoyl, N-(4-methoxyphenyl)carbamoyl, N-(2, 4-dimethoxyphenyl)carbamoyl, N-(2-dodecyloxyphenyl)carbamoyl and N-(4-dodecyloxyphenyl)carbamoyl.

The sulfonyl group represented by X⁹ is a sulfonyl group preferably having from 1 to 20, more preferably from 1 to 16, still more preferably from 1 to 12, carbon atoms, such as mesyl, ethanesulfonyl, cyclohexanesulfonyl, benzenesulfonyl, tosyl and 4-chlorobenzenesulfonyl.

The sulfamoyl group represented by X⁹ is a sulfamoyl group preferably having from 0 to 20, more preferably from 0 to 16, still more preferably from 0 to 12, carbon atoms, such as sulfamoyl, methylsulfamoyl, dimethylsulfamoyl and phenylsulfamoyl.

X⁹ may further have a substituent and preferred examples of the substituent include the groups represented by Y¹ to Y⁵, which are described later.

X⁹ is preferably a carbamoyl group, more preferably an alkylcarbamoyl group or an arylcarbamoyl group, still more preferably an arylcarbamoyl group.

Y¹ to Y⁵ each independently represents a hydrogen atom or a substituent.

The substituent represented by Y¹ to Y⁵ may be any substituent insofar as it does not adversely affect the photographic properties. Examples thereof include a halogen atom (e.g., fluorine, chlorine, bromine, iodine), a linear, branched or cyclic alkyl group or an alkyl group having a combination of linear, branched and/or cyclic structures (preferably having from 1 to 20, more preferably from 1 to 16, still more preferably from 1 to 13, carbon atoms, e.g., methyl, ethyl, n-propyl, isopropyl, sec-butyl, tert-butyl, tert-octyl, n-amyl, tert-amyl, n-dodecyl, n-tridecyl, cyclohexyl), an alkenyl group (preferably having from 2 to 20, more preferably from 2 to 16, still more preferably from 2 to 12, carbon atoms, e.g., vinyl, allyl, 2-butenyl, 3-pentenyl), an aryl group (preferably having from 6 to 30, more preferably from 6 to 20, still more preferably from 6 to 12, carbon atoms, e.g., phenyl, p-methylphenyl, naphthyl), an alkoxy group (preferably having from 1 to 20, more preferably from 1 to 16, still more preferably from 1 to 12, carbon atoms, e.g., methoxy, ethoxy, propoxy, butoxy), an aryloxy group (preferably having from 6 to 30, more preferably from 6 to 20, still more preferably from 6 to 12, carbon atoms, e.g., phenyloxy, 2-naphthyloxy), an acyloxy group (preferably having from 2 to 20, more preferably from 2 to 16, still more preferably from 2 to 12, carbon atoms, e.g., acetoxy, benzoyloxy), an amino group (preferably having from 0 to 20, more preferably from 1 to 16, still more preferably from 1 to 12, carbon atoms, e.g., dimethylamino, diethylamino, dibutylamino, anilino), an acylamino group (preferably having from 2 to 20, more preferably from 2 to 16, still more preferably from 2 to 13, carbon atoms, e.g., acetylamino, tridecanoylamino, benzoylamino), a sulfonylamino group (preferably having from 1 to 20, more preferably from 1 to 16, still more preferably from 1 to 12, carbon atoms, e.g., methanesulfonylamino, butanesulfonylamino, benzenesulfonylamino), a ureido group (preferably having from 1 to 20, more preferably from 1 to 16, still more preferably from 1 to 12, carbon atoms, e.g., ureido, methylureido, phenylureido), a carbamate group (preferably having from 2 to 20, more preferably from 2 to 16, still more preferably from 2 to 12, carbon atoms, e.g., methoxycarbonylamino, phenyloxycarbonylamino), a carboxyl group, a carbamoyl group (preferably having from 1 to 20, more preferably from 1 to 16, still more preferably from 1 to 12, carbon atoms, e.g., carbamoyl, N,N-diethylcarbamoyl, N-dodecylcarbamoyl, N-phenylcarbamoyl), an alkoxycarbonyl group (preferably having from 2 to 20, more preferably from 2 to 16, still more preferably from 2 to 12, carbon atoms, e.g., methoxycarbonyl, ethoxycarbonyl, butoxycarbonyl), an acyl group (preferably having from 2 to 20, more preferably from 2 to 16, still more preferably from 2 to 12, carbon atoms, e.g., acetyl, benzoyl, formyl, pivaloyl), a sulfo group, a sulfonyl group (preferably having from 1 to 20, more preferably from 1 to 16, still more preferably from 1 to 12, carbon atoms, e.g., mesyl, tosyl), a sulfamoyl group (preferably having from 0 to 20, more preferably from 0 to 16, still more preferably from 0 to 12, carbon atoms, e.g., sulfamoyl, methylsulfamoyl, dimethylsulfamoyl, phenylsulfamoyl), a cyano group, a nitro group, a hydroxyl group, a mercapto group, an alkylthio group (preferably having from 1 to 20, more preferably from 1 to 16, still more preferably from 1 to 12, carbon atoms, e.g., methylthio, butylthio) and a heterocyclic group (preferably having from 2 to 20, more preferably from 2 to 16, still more preferably from 2 to 12, carbon atoms, e.g., pyridyl, imidazoyl, pyrrolidyl). These substituents each may be further substituted by another substituent.

Among these, preferred as the substituent represented by Y¹ to Y⁵ are a halogen atom, an alkyl group, an aryl group, an alkoxy group, an aryloxy group, an acyloxy group, an anilino group, an acylamino group, a sulfonylamino group, a carboxyl group, a carbamoyl group, an acyl group, a sulfo group, a sulfonyl group, a sulfamoyl group, a cyano group, a hydroxyl group, a mercapto group, an alkylthio group and a heterocyclic group.

In the compound represented by formula (4), a combination such that R¹² is an alkyl group, X⁹ is a carbamoyl group and Y¹ to Y⁵ each is a hydrogen atom is preferred.

Specific examples of the compound represented by formula (4) are set forth below, however, the compound for use in the present invention is not limited to these specific examples.

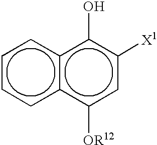

| Compound | X¹ | R₁₂ |
|---|---|---|
| 4-1 | CONHC₆H₅ | CH₃ |
| 4-2 | CONHC₆H₅ | C₂H₅ |
| 4-3 | CONHC₆H₅ | C₃H₇ |
| 4-4 | CONHC₆H₅ | (i)C₃H₇ |
| 4-5 | CONHC₆H₅ | C₄H₉ |
| 4-6 | CONHC₆H₅ | C₅H₁₁ |
| 4-7 | CONHC₆H₅ | C₆H₁₃ |
| 4-8 | CONHC₆H₅ | C—C₆H₁₁ |
| 4-9 | CONHC₆H₅ | C₁₀H₂₁ |
| 4-10 | CONHC₆H₅ | C₁₂H₂₅ |
| 4-11 | CONHC₆H₅ | C₁₆H₃₃ |
| 4-12 | CONHC₆H₅ | CH₂C₆H₅ |
| 4-13 | CONHC₆H₅ | (CH₂)₂C₆H₅ |
| 4-14 | CONHC₆H₅ | (CH₂)₂NHSO₂CH₃ |
| 4-15 | CONHC₆H₅ | (CH₂)₂OCH₂CH₃ |
| 4-16 | CONHC₆H₅ | (CH₂)₂O(CH₂)₂OH |
| 4-17 | CONHC₆H₅ | (CH₂)₂OCH₂CO₂H |
| 4-18 | CONHC₆H₅ | C₈H₁₇ |
| 4-19 | CONHC₆H₅ | (CH₂)₂SO₂CH₃ |
| 4-20 | CONHC₆H₅ | (CH₂)₂SO₂CH₂CH₃ |
| 4-21 | CONHC₆H₅ | (CH₂)₂O(CH₂)₂OCH₂CH₃ |
| 4-22 | CONHC₆H₅ | 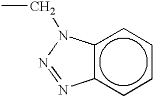 |
| 4-23 | CONHC₆H₅ | 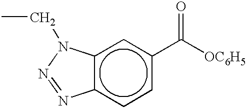 |
| 4-24 | CONHC₆H₅ | C₆H₅ |
| 4-25 | CONHC₆H₅ | p-CH₃—C₆H₄ |
| 4-26 | CONHC₆H₅ | p-Cl—C₆H₄ |
| 4-27 | CONHC₆H₅ | 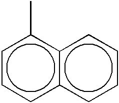 |
| 4-28 | CONHC₆H₅ | 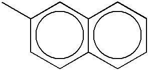 |
| 4-29 | CONH—2-Cl—C₆H₄ | CH₃ |
| 4-30 | CONH—2-Cl—C₆H₄ | C₄H₉ |
| 4-31 | CONH—2-Cl—C₆H₄ | C₆H₁₃ |
| 4-32 | CONH—2-Cl—C₆H₄ | CH₂CH₂C₆H₅ |
| 4-33 | CONH—2-Cl—C₆H₄ | C₁₂H₂₅ |
| 4-34 | CONH—4-Cl—C₆H₄ | C₄H₉ |
| 4-35 | CONH—4-Cl—C₆H₄ | C₆H₁₃ |
| 4-36 | CONH—4-Cl—C₆H₄ | C₈H₁₇ |
| 4-37 | CONH—4-Cl—C₆H₄ | CH₂CH₂C₆H₅ |
| 4-38 | CONH—4-Cl—C₆H₄ | C₁₀H₂₅ |
| 4-39 | 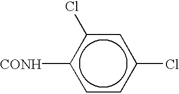 | CH₃ |
| 4-40 | 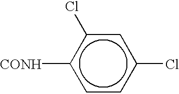 | C₄H₉ |
| 4-41 | 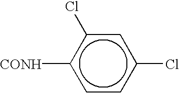 | C₆H₁₃ |
| 4-42 | 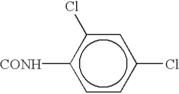 | C₈H₁₇ |
| 4-43 | 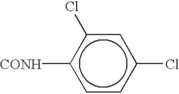 | CH₂CH₂C₆H₅ |
| 4-44 | 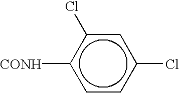 | C₁₀H₂₁ |
| 4-45 | 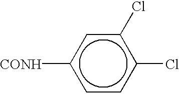 | CH═CHCH₃ |
| 4-46 | 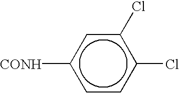 | C₄H₉ |
| 4-47 | 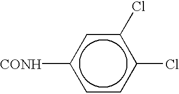 | C₆H₁₃ |
| 4-48 | 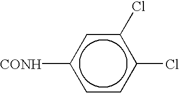 | C≡CH |
| 4-49 | 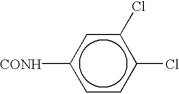 | C₈H₁₇ |
| 4-50 | 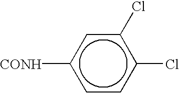 | CH₂CH₂C₆H₅ |
| 4-51 | 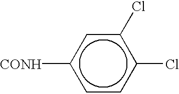 | CH₂C₆H₅ |
| 4-52 | 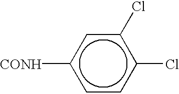 | C₆H₅ |
| 4-53 | 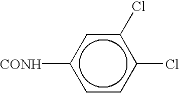 | CH₂CH₂SO₂CH₃ |
| 4-54 | 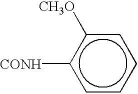 | C₆H₁₃ |
| 4-55 | 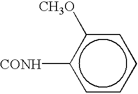 | CH₂CH₂C₆H₅ |
| 4-56 | 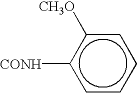 | C₄H₉ |
| 4-57 | CONHCH₃ | C₆H₁₃ |
| 4-58 | CONHC₄H₉ | C₆H₁₃ |
| 4-59 | CONHC₁₀H₂₁ | C₆H₁₃ |
| 4-60 | CONHC₁₂H₂₅ | C₆H₁₃ |
| 4-62 | CONHC₁₆H₃₃ | C₆H₁₃ |
| 4-63 | 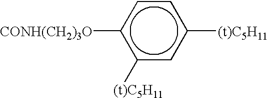 | C₆H₁₃ |
| 4-64 | CONH(CH₂)₃OC₁₂H₂₅ | C₆H₁₃ |
| 4-65 | 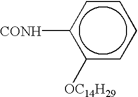 | C₆H₁₃ |
| 4-66 | CONHCH₂C₆H₅ | C₆H₁₃ |
| 4-67 | 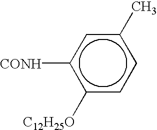 | C₆H₁₃ |
| 4-68 | 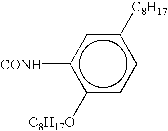 | C₆H₁₃ |
| 4-69 | CONH-(t)C₄H₉ | C₆H₁₃ |
| 4-70 | CONH-(t)C₈H₁₇ | C₆H₁₃ |
| 4-71 | CON(C₂H₅)₂ | C₆H₁₃ |
| 4-72 | 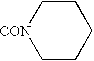 | C₆H₁₃ |
| 4-73 | 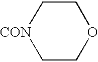 | C₆H₁₃ |
| 4-74 | 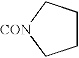 | C₆H₁₃ |
| 4-75 | CONHC₄H₉ | (CH₂)₂C₆H₅ |
| 4-76 | CONHC₁₀H₂₁ | (CH₂)₂C₆H₅ |
| 4-77 | CONHC₁₂H₂₅ | (CH₂)₂C₆H₅ |
| 4-78 | CONH-(t)C₄H₉ | (CH₂)₂C₆H₅ |
| 4-79 | CONH-(t)C₈H₁₇ | (CH₂)₂C₆H₅ |
| 4-80 | CONHCH₃ | (CH₂)₂C₆H₅ |
| 4-81 | 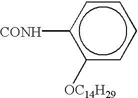 | (CH₂)₂C₆H₅ |
| 4-82 | CON(C₂H₅)₂ | (CH₂)₂C₆H₅ |
| 4-83 | 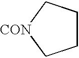 | (CH₂)₂C₆H₅ |
| 4-84 | CONHCH₂C₆H₅ | (CH₂)₂C₆H₅ |
| (4-85) | 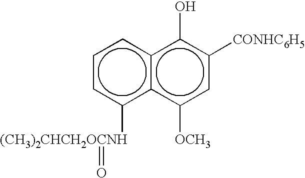 | |
| (4-86) | 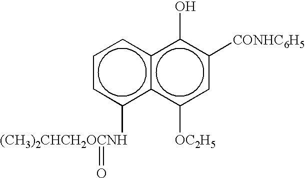 | |
| (4-87) | 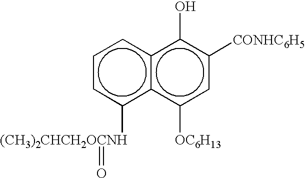 | |
| (4-88) | 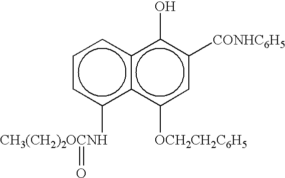 | |
| 4-89 | COCH₃ | C₆H₁₃ |
| 4-90 | COC₂H₅ | C₆H₁₃ |
| 4-91 | COC₇H₁₅ | C₆H₁₃ |
| 4-92 | COC₁₁H₂₃ | C₆H₁₃ |
| 4-93 | COCH₃ | (CH₂)₂C₆H₅ |
| 4-94 | COC₂H₅ | (CH₂)₂C₆H₅ |
| 4-95 | COC₇H₁₅ | (CH₂)₂C₆H₅ |
| 4-96 | COC₁₂H₂₃ | (CH₂)₂C₆H₅ |
| 4-97 | COCH₃ | CH₃ |
| 4-98 | COCH₃ | C₄H₉ |
| 4-100 | COCH₃ | C₆H₅ |
| 4-101 | COCH₃ | C₁₀H₂₁ |
| 4-102 | COCH₃ | C₁₂H₂₅ |
| 4-103 | COCH₃ | C₁₆H₃₃ |
| 4-104 | CO₂C₆H₅ | C₆H₅ |
| 4-105 | CO₂C₆H₅ | CH₃ |
| 4-106 | CO₂C₆H₅ | C₂H₅ |
| 4-107 | CO₂C₆H₅ | C₄H₉ |
| 4-108 | CO₂C₆H₅ | C₆H₁₃ |
| 4-109 | CO₂C₆H₅ | C₁₀H₂₁ |
| 4-110 | CO₂C₆H₅ | CH₂C₆H₅ |
| 4-111 | CO₂C₆H₅ | (CH₂)₂C₆H₅ |
| 4-112 | CO₂C₆H₅ | C₁₂H₂₅ |
| 4-113 | CO₂C₆H₅ | C₁₆H₃₃ |
| 4-114 | CO₂C₆H₅ | (CH₂)₂SO₂CH₃ |
| 4-115 | CO₂C₆H₅ | (CH₂)₂SO₂NHCH₃ |
| 4-116 | CO₂C₆H₅ | (CH₂)₂NHSO₂C₂H₅ |
| 4-117 | CO₂CH₃ | CH₃ |
| 4-118 | CO₂CH₃ | C₄H₉ |
| 4-119 | CO₂C₂H₅ | C₆H₁₃ |
| 4-120 | CO₂C₂H₅ | (CH₂)₂C₆H₅ |
| 4-121 | CO₂C₂H₅ | C₁₂H₂₅ |
| 4-122 | CO₂C₁₂H₂₅ | CH₃ |
| 4-123 | CO₂C₁₂H₂₅ | C₄H₉ |
| 4-124 | CO₂C₁₂H₂₅ | C₆H₁₃ |
| 4-125 | CO₂C₁₂H₂₅ | (CH₂)₂C₆H₅ |
| 4-126 | CO₂C₁₂H₂₅ | (CH₂)₂SO₂CH₃ |
| 4-127 | CO₂C₁₂H₂₅ | CH═CHCH₃ |
| 4-128 | CO₂C₁₂H₂₅ | CH₂CH═CH₂ |
| 4-129 | CO₂C₁₂H₂₅ | C≡CCH₃ |
| 4-130 | CO₂C₁₂H₂₅ | C—C₆H₁₁ |
| 4-131 | CO₂C₁₂H₂₅ | C₆H₅ |
| 4-132 | SO₂CH₃ | C₄H₉ |
| 4-133 | SO₂CH₃ | C₆H₁₃ |
| 4-134 | SO₂CH₃ | C₆H₅ |
| 4-135 | SO₂CH₃ | CH₃ |
| 4-136 | SO₂CH₃ | (CH₂)₂C₆H₅ |
| 4-137 | SO₂CH₃ | CH₂C₆H₅ |
| 4-138 | SO₂C₆H₅ | C₄H₉ |
| 4-139 | SO₂C₆H₅ | C₆H₁₃ |
| 4-140 | SO₂C₆H₅ | CH₃ |
| 4-141 | SO₂C₆H₅ | (CH₂)₂C₆H₅ |
| 4-142 | SO₂C₆H₅ | C₁₂H₂₅ |
| 4-143 | SO₂NHC₆H₅ | C₆H₅ |
| 4-144 | SO₂NHCH₃ | C₆H₅ |
| 4-145 | SO₂NHC₂H₅ | C₆H₅ |
| 4-146 | SO₂NHC₆H₁₃ | C₆H₅ |
| 4-147 | SO₂NHC₄H₉ | C₆H₅ |
| 4-148 | SO₂NH—(t)C₄H₉ | C₆H₅ |
| 4-149 | SO₂NH—(t)C₈H₁₇ | C₆H₅ |
| 4-150 | SO₂NHC₆H₅ | C₆H₁₃ |
| 4-151 | SO₂NHCH₃ | C₆H₁₃ |
| 4-152 | SO₂NHC₂H₅ | C₆H₁₃ |
| 4-153 | SO₂NHC₄H₉ | C₆H₁₃ |
| 4-154 | SO₂NH—(t)C₄H₉ | C₆H₁₃ |
| 4-155 | SO₂NH—(t)C₈H₁₇ | C₆H₁₃ |
| 4-156 | SO₂NHC₆H₁₃ | (CH₂)₂C₆H₅ |
| 4-157 | SO₂NHC₆H₅ | (CH₂)₂C₆H₅ |
| 4-158 | SO₂NHCH₃ | (CH₂)₂C₆H₅ |
| 4-159 | SO₂NH—(t)C₈H₁₇ | (CH₂)₂C₆H₅ |

The development accelerator as a reducing compound represented by formulae (2) to (6) may be added to the coating solution by any method such as solution, powder, solid fine particle dispersion, emulsified product or oil protected dispersion. In the case of using the development accelerator together with the polymer latex of the present invention, the development accelerator is preferably added in the form of a solid fine particle. The dispersion of solid fine particles can be performed by known pulverization means (for example, ball mill, vibration ball mill, sand mill, colloid mill, jet mill, roller mill). In particular, pulverization by a sand mill is preferred. In dispersing the solid fine particles, a dispersion aid may be used.

The compound represented by formula (A) is described below.

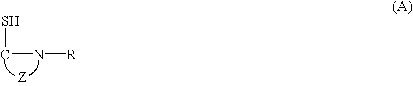

In formula (A), Z represents an atomic group necessary for forming a 5- or 6-membered heteroaromatic ring having at least two or more nitrogen atoms. Z is preferably an atomic group necessary for forming a 5- or 6-membered heteroaromatic group containing at least two or more nitrogen atoms and further comprising an atom selected from the group consisting of carbon, oxygen, sulfur, selenium and tellurium. Z may have a substituent. Also, these substituents may combine with each other to have a cyclic structure and form a condensed ring with the cyclic structure formed by Z. Specific examples of the heteroaromatic ring include imidazole, pyrazole, triazole, tetrazole, thiadiazole, thiadiazine, pyridazine, pyrimidine, pyrazine and triazine.

In formula (A), R represents a hydrogen atom, an alkyl group (e.g., methyl, ethyl, propyl, cyclohexyl), an aralkyl group (e.g., benzyl), an alkoxy group (e.g., methoxy, ethoxy), an aryl group. (e.g., phenyl, naphthyl), an alkyl group substituted by a substituent (for example, an amino group, an amide group, a sulfonamide group (e.g., methylsulfonamide), a ureido group, a urethane group (e.g., methylurethane, ethylurethane), an aryloxy group (e.g., phenoxy, naphthoxy), a sulfamoyl group, a carbamoyl group (e.g., ethylcarbamoyl, phenylcarbamoyl), an aryl group (e.g., phenyl, naphthyl), an alkylthio group (e.g., methylthio, hexylthio), an arylthio group (e.g., phenylthio), a hydroxy group, a halogen atom (e.g., fluorine, chlorine, bromine, iodine), a sulfonic acid group, a carboxylic acid group, a cyano group, a carboxy group or a salt thereof, or a phosphoric acid amide group) or an aryl group substituted by a substituent (for example, an amino group, an amide group, a sulfonamide group, a ureido group, a urethane group, an aryloxy group, a sulfamoyl group, a carbamoyl group, an aryl group, an alkylthio group, an arylthio group, a hydroxy group, a halogen atom, a sulfonic acid group, a carboxylic acid group, a cyano group, a carboxy group or a salt thereof, or a phosphoric acid amide group). These groups may further have a substituent and examples of the substituent include the groups described above for R. The total carbon atom number of R is preferably from 0 to 20.

Specific examples of the compound represented by formula (A) are set forth below, however, the present invention is not limited thereto.

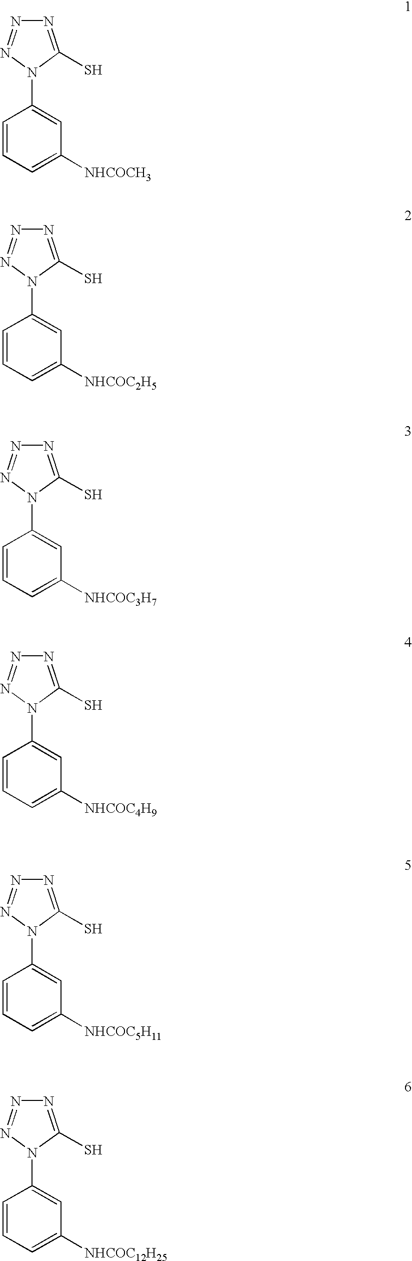

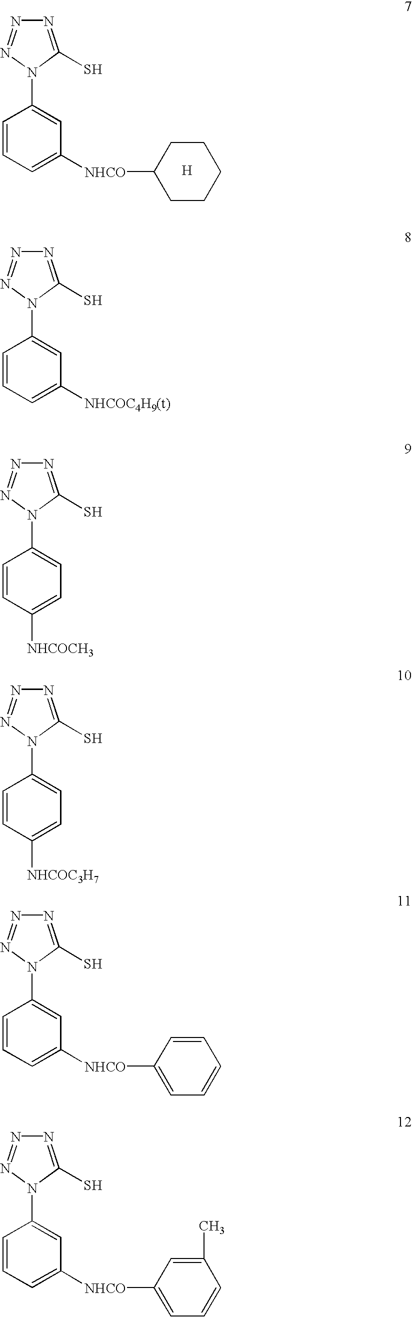

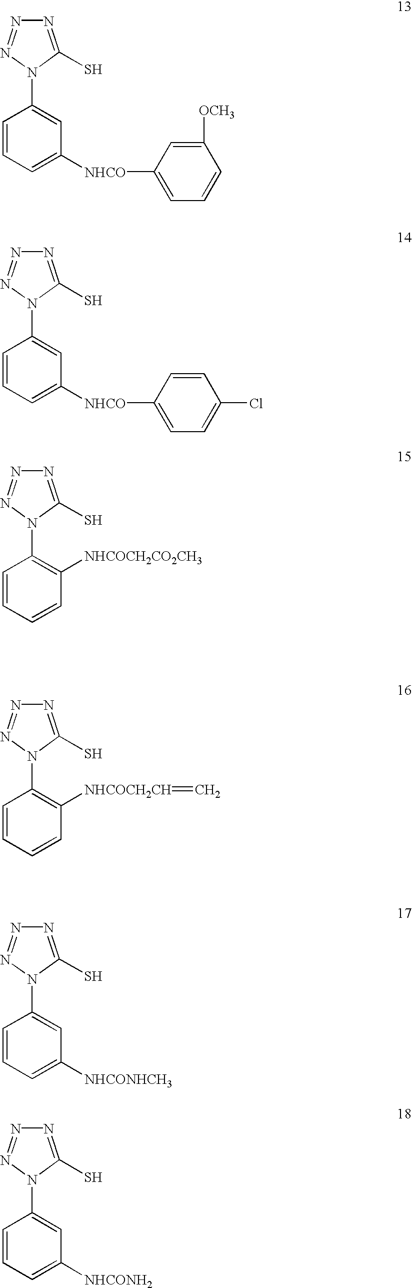

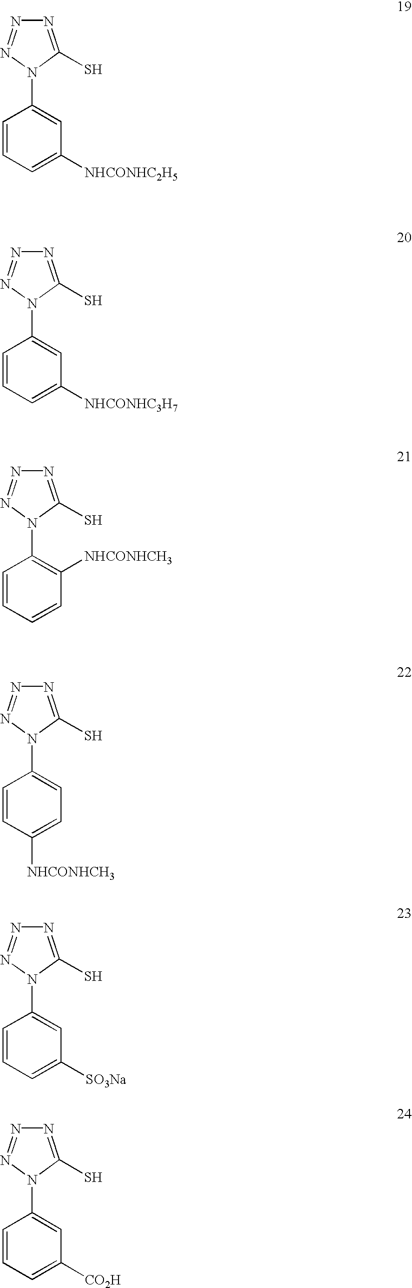

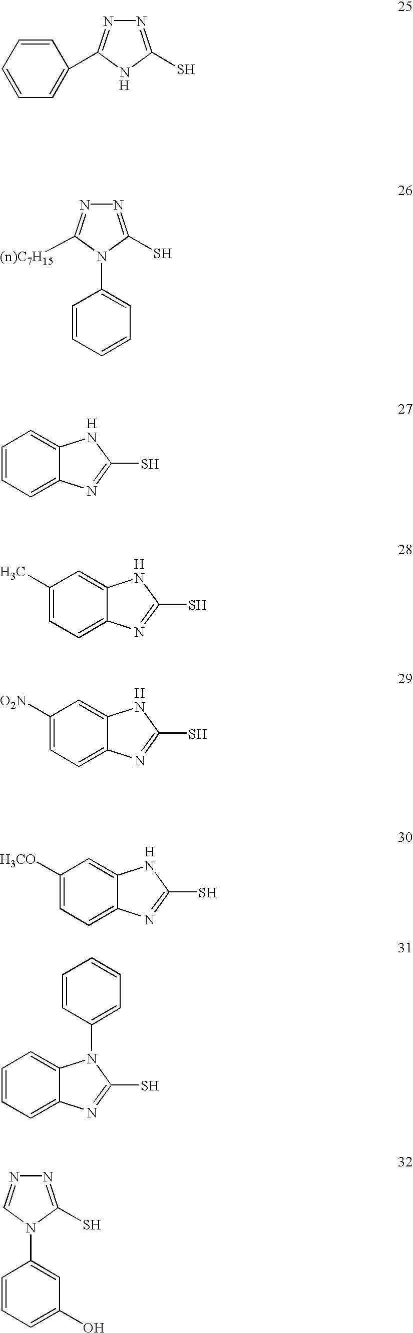

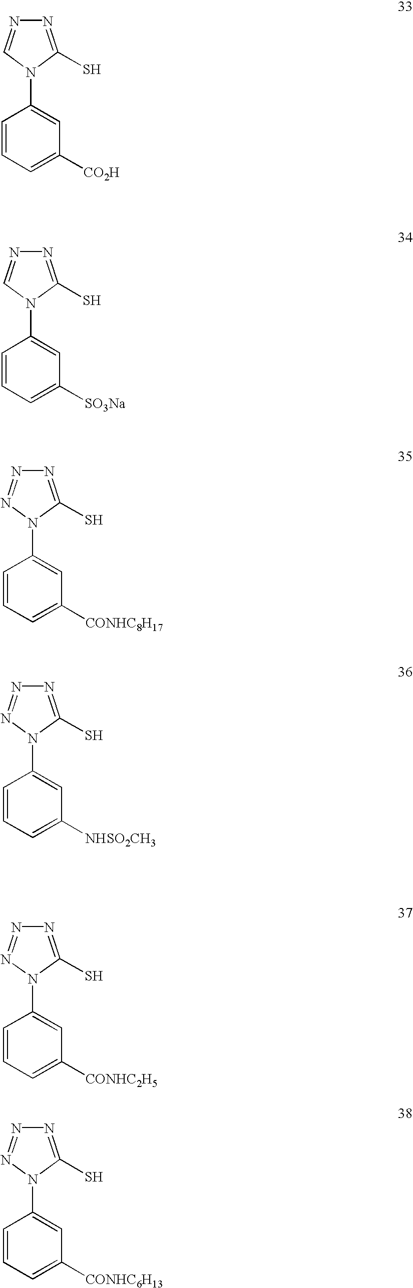

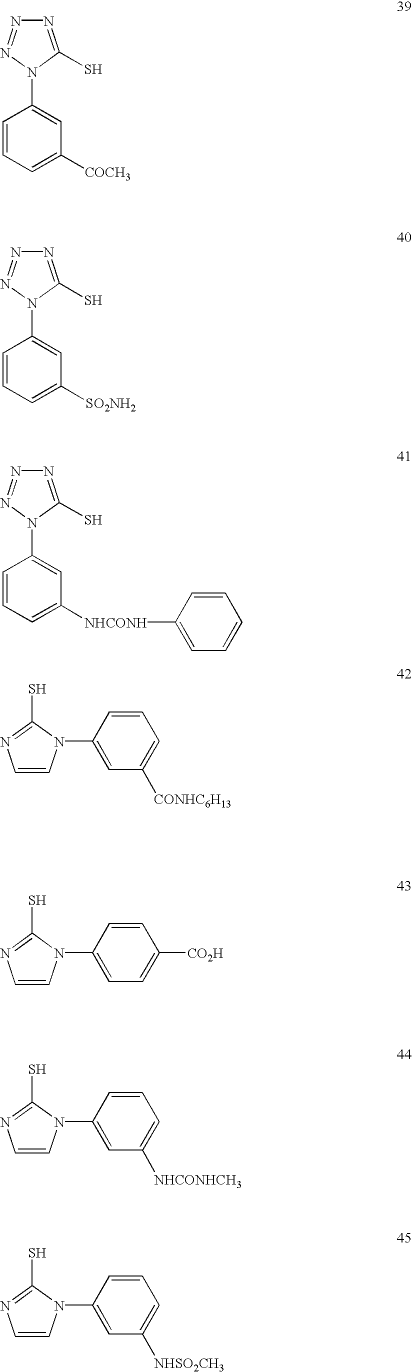

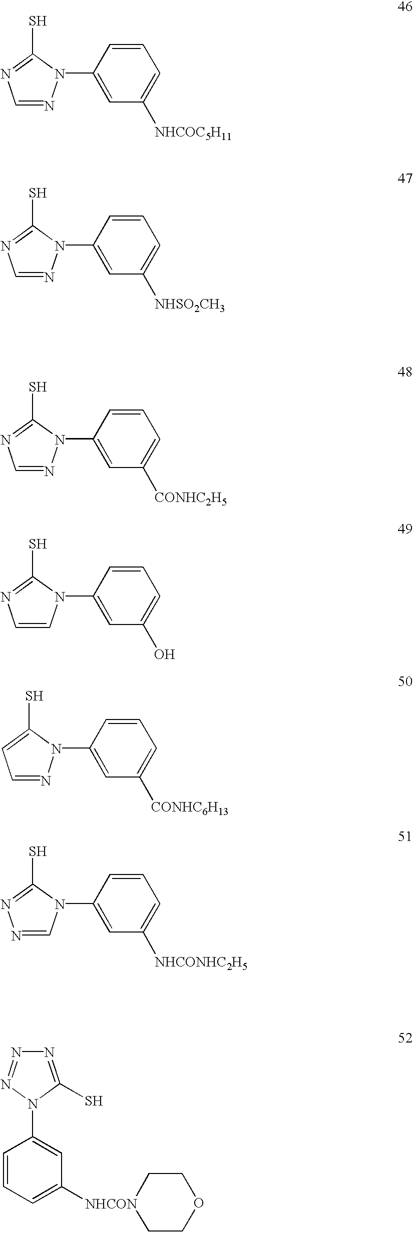

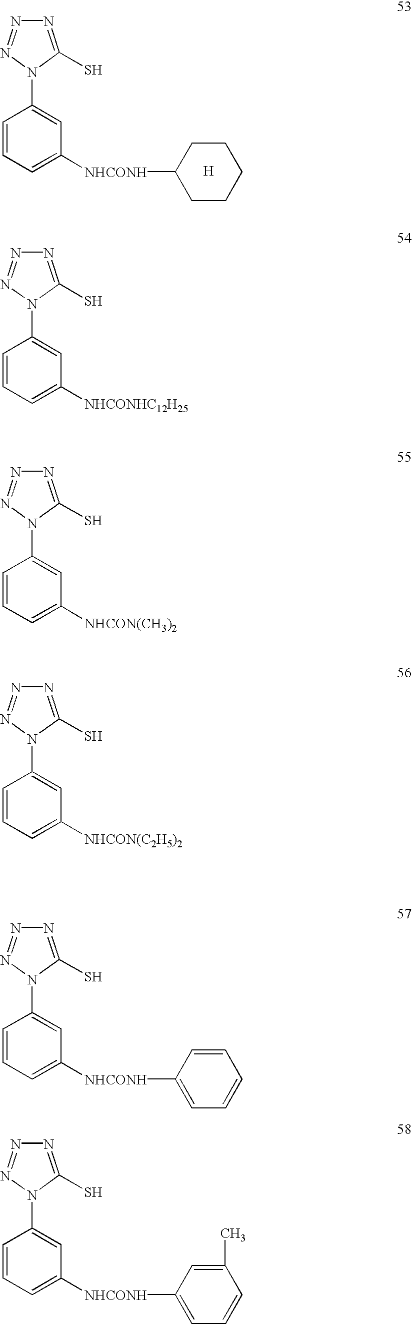

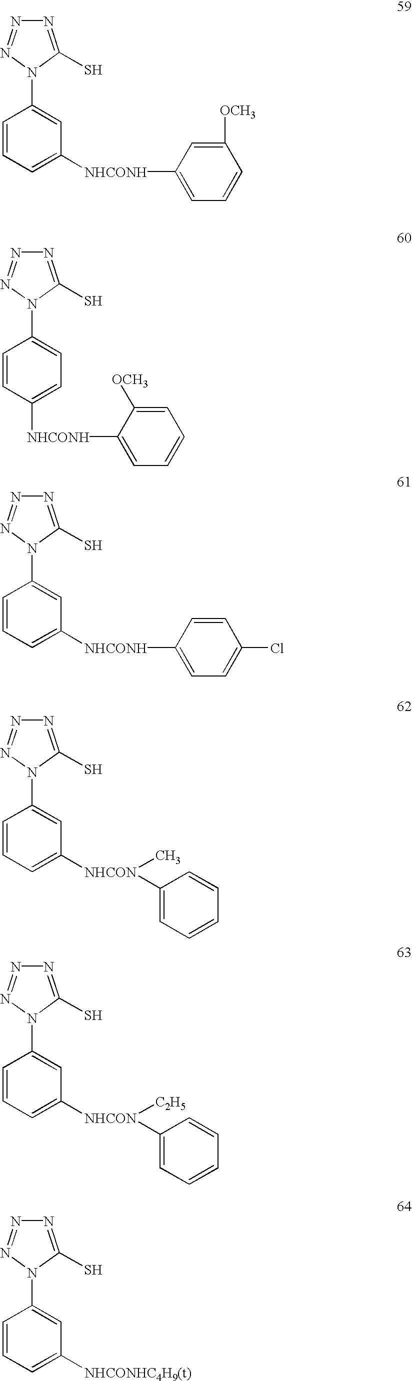

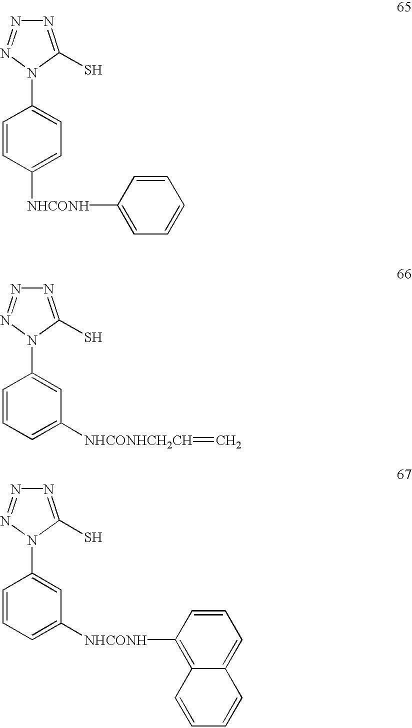

The compound represented by formula (A) can be used after dissolving it in water or an appropriate organic solvent such as alcohols (e.g., methanol, ethanol, propanol, fluorinated alcohol), ketones (e.g., acetone, methyl ethyl ketone), dimethylformamide, dimethylsulfoxide and methyl cellosolve.

This compound may also be used as an emulsification dispersion product obtained by a well-known emulsification dispersion method of dissolving the compound using an oil such as dibutyl phthalate, tricresyl phosphate, glyceryl triacetate or diethyl phthalate, and an auxiliary solvent such as ethyl acetate or cyclohexanone, and mechanically emulsification-dispersing the mixture. Also, the compound may be used by dispersing the powder of the compound in water using a ball mill, a colloid mill or an ultrasonic wave according to a well-known solid dispersion method.

The compound represented by formula (A) may be added to any layer insofar as the layer is in the side of a layer containing silver halide, namely, silver halide emulsion layer (photosensitive layer), on the support but is preferably added to a silver halide emulsion layer or a layer adjacent thereto.

The amount of the compound represented by formula (A) added is preferably from 1×10⁻⁴ to 5×10⁻¹ mol, more preferably from 5×10⁻⁴ to 5×10⁻² mol, per mol of silver halide.

(Description of Organic Silver Salt)

The organic silver salt which can be used in the present invention is a silver salt which is relatively stable to light but forms a silver image when heated at 80° C. or more in the presence of an exposed photocatalyst (e.g., a latent image of photosensitive silver halide) and a reducing agent. The organic silver salt may be any organic substance containing a source capable of reducing silver ion. Such a. non-photosensitive organic silver salt is described in JP-A-10-62899 (paragraphs 0048 to 0049), EP-A-0803764 (page 18, line 24 to page 19, line 37), EP-A-0962812, JP-A-11-349591, JP-A-2000-7683 and JP-A-2000-72711. The organic silver salt is preferably a silver salt of an organic acid, particularly a silver salt of a long chain aliphatic carboxylic acid (having from 10 to 30 carbon atoms, preferably from 15 to 28 carbon atoms). Preferred examples of the silver salt of a fatty acid include silver behenate, silver arachidate, silver stearate, silver oleate, silver laurate, silver caproate, silver myristate, silver palmitate, and mixtures thereof. Of these fatty acid silver salts, preferred in the present invention are the fatty acid silver salts having a silver behenate content of 50 mol % or more, more preferably 80 mol % or more, still more preferably 90 mol % or more.

The shape of the organic silver salt which can be in the present invention is not particularly limited, and the organic silver salt may have any shape of needle form, bar form, tabular form and scaly form.

In the present invention, the organic silver salt is preferably in the scaly form. Also, a short needle-like grain where the ratio of a long axis to a short axis is 5 or less, a rectangular parallelopiped grain, a cubic grain or a pebble-like amorphous grain is preferably used. These organic silver salt grains have a characteristic feature that fogging upon heat development is reduced as compared with a long needle-like grain where the ratio of a long axis to a short axis is 5 or more. In the present invention, the scaly organic silver salt is defined as follows. Assuming that when an organic acid silver salt grain is observed through an electron microscope and the shape thereof is approximated to a rectangular parallelopiped, the sides of the rectangular parallelopiped are a, b and c (c may be equal to b) from the shortest side, x is calculated and determined according to the following formula using shorter values a and b:

x=b/a

In this manner, x of about 200 grains is determined and grains satisfying the relationship of an average value x (average)≧1.5 are defined as a scaly grain. The relationship is preferably 30≧x (average)≧1.5, more preferably 20≧x (average)≧2.0. Incidentally, the needle-like grain has a relationship of 1≦x (average)<1.5.

In the scaly grain, a can be regarded as the thickness of a tabular grain where the main planes are the face having sides b and c. The average of a is preferably from 0.01 to 0.23 μm, more preferably from 0.1 to 0.20 μm. The average of c/b is preferably from 1 to 6, more preferably from 1.05 to 4, still more preferably from 1.1 to 3, particularly preferably from 1.1 to 2.

In the third embodiment of the present invention, the organic silver salt is preferably a silver salt of an organic acid, particularly a silver salt of a long chain aliphatic carboxylic acid (having from 10 to 30 carbon atoms, preferably from 15 to 28 carbon atoms) Preferred examples of the organic silver salt include silver behenate, silver arachidate, silver stearate, and mixtures thereof. The present invention is characterized in that the silver behenate content is from 90 to 100 mol %. By setting the silver behenate content to this range, an organic acid silver salt having low Dmin (namely, fog) and excellent image preservability can be obtained. The silver behenate content is more preferably from 94 to 99.5 mol %. For obtaining an organic acid silver salt having low Dmin and excellent image preservability, it is preferred that the silver stearate content is 1 mol % or less and the silver arachidate content is 6 mol % or less.

The shape of the organic silver salt which can be in the third embodiment of the present invention is preferably scaly form having a length to breadth ratio of 1 to 9. when the length to breadth ratio is in the range from 1 to 9, crushing of grains does not occur at the preparation of a dispersion and as a result, good image preservability can be attained.

In the third embodiment of the present invention, the scaly organic silver salt and the length to breadth ratio are defined as follows. Assuming that when an organic silver salt grain is observed through an electron microscope and the shape thereof is approximated to a rectangular parallelopiped, the sides of the rectangular parallelopiped are a, b and c (c may be equal to b) from the shortest side, x and y are calculated and determined according to the following formula using shorter values a and b:

x=b/a

y=c/b

In this manner, x and y of about 200 grains are determined and grains satisfying the relationship of 30≧average value x (average)≧1.5 are defined as a scaly grain. The relationship is preferably 30≧x (average)≧1.5, more preferably 20≧x (average)≧2.0. Incidentally, the needle-like grain has a relationship of 1≦x (average)<1.5. The average value y (average) is defined as a length to breadth ratio. The organic silver salt grain of the present invention is characterized in that the length to breadth ratio is from 1 to 9. The length to breadth ratio is preferably from 1 to 6, more preferably from 1 to 3.

In the scaly grain, a can be regarded as the thickness of a tabular grain where the main planes are the face having sides b and c. The average of a is preferably from 0.01 to 0.23 μm, more preferably from 0.1 to 0.20 μm.

In the scaly grain, the equivalent-sphere diameter/a of the grain is defined as an aspect ratio. In the present invention, the aspect ratio of the scaly grain is preferably from 1.1 to 30. By setting the aspect ratio to such a range, aggregation difficultly occurs in the photosensitive material and good image preservability can be attained. The aspect ratio is more preferably from 1.1 to 15.

In the present invention, the equivalent-sphere diameter of the scaly grain is preferably from 0.05 to 1 μm. With this equivalent-sphere diameter, aggregation difficultly occurs in the photosensitive material and good image preservability can be attained. The equivalent-sphere diameter is more preferably from 0.1 to 1 μm. In the present invention, the equivalent-sphere diameter is determined by directly taking a photograph of a sample using an electron microscope and image-processing the negative film.

The grain size distribution of the organic silver salt is preferably monodisperse. The term “monodisperse” as used herein means that the percentage of the value obtained by dividing the standard deviation of the length of short axis or long axis by the length of short axis or long axis, respectively, is preferably 100% or less, more preferably 80% or less, still more preferably 50% or less. The shape of the organic silver salt can be determined from a transmission electron microscope image of an organic silver salt dispersion. Another method for determining the monodispersity is a method of determining the standard deviation of a volume weighted average diameter of the organic silver salt. In this case, the “monodisperse” means that the percentage (coefficient of variation) of the value obtained by dividing the standard deviation by the volume weighted average diameter is preferably 100% or less, more preferably 80% or less, still more preferably 50% or less. In the measurement of monodispersity, for example, laser light is irradiated on an organic silver salt dispersed in a solution, an autocorrelation function of fluctuation of scattered light with respect to the time change is determined and from the autocorrelation function obtained, the grain size (volume weighted average diameter) can be determined.

As for the production of the organic silver salt used in the present invention and the dispersion method thereof, known methods can be employed. Examples thereof include the methods described in JP-A-10-62899, EP-A-0803763, EP-A-0962812, JP-A-11-349591, JP-A-2000-7683, JP-A-2000-72711, JP-A-2001-163827, JP-A-2001-163889, JP-A-2001-163890, JP-A-2001-33907, JP-A-2001-188313, JP-A-2001-83652, and Japanese Patent Application Nos. 2000-191226, 2000-213813 and 2000-214155

If a photosensitive silver salt is present together on dispersion of the organic silver salt, fog increases and sensitivity seriously decreases. Therefore, it is preferred to contain substantially no photosensitive silver salt at the dispersion. In the present invention, the amount of the photosensitive silver salt dispersed in a water dispersion is preferably 1 mol % or less, more preferably 0.1 mol % or less, per mol of the organic silver salt in the solution. It is still more preferred that the photosensitive silver salt is not added positively.

The organic silver salt grain for use in the present invention is preferably prepared at a reaction temperature of 60° C. or less from the standpoint of preparing a grain having a low Dmin. The temperature of chemicals added, for example, an aqueous solution of an organic acid alkali metal may be higher than 60° C., however, the temperature of the reaction bath to which the reaction solution is added is preferably 60° C. or less, more preferably 50° C. or less, still more preferably 40° C. or less.

The organic silver salt grain for use in the present invention is prepared by reacting a solution containing silver ion such as silver nitrate with a solution or suspension of an organic acid alkali metal salt and at this preparation, 50% or more of the total amount of silver added is preferably added simultaneously with the addition of the solution or suspension of an organic acid alkali metal salt. The addition may be made to the liquid surface of the reaction bath, into the liquid or to closed mixing means which is described later.

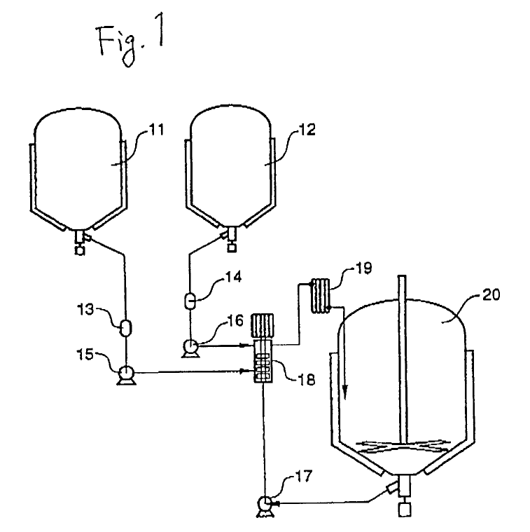

One example of an apparatus used in the preparation method using the addition to closed mixing means is described below, however, the present invention is not limited thereto. FIG. 1 is a view showing one practical embodiment of an apparatus for producing the non-photosensitive silver salt for use in the present invention. In the Figure, 11 and 12 are tanks for storing a silver ion-containing solution (for example, an aqueous silver nitrate solution) and a solution or suspension of an organic alkali metal salt, respectively, at a predetermined temperature; and 13 and 14 are flowmeters for measuring the flow rates of these solutions which are added through pumps 15 and 16 to a closed mixing device 18 filled with a liquid. In this practical embodiment, a pump 17 is provided for again feeding the prepared organic silver salt dispersion as the third component to the closed mixing device 18. After the completion of reaction, the liquid in the closed mixing device 18 is introduced into a heat exchanger 19 and swiftly cooled.

The pH of the silver ion-containing solution (for example, an aqueous silver nitrate solution) for use in the present invention is preferably from 1 to 6, more preferably from 1.5 to 4. For adjusting the pH, an acid and an alkali may be added to the silver ion-containing solution itself. The kinds of acid and alkali are not particularly limited.

In the present invention, after the completion of addition of a silver ion-containing solution (for example, an aqueous silver nitrate solution) and/or a solution or suspension of an organic acid alkali metal salt, the organic silver salt may be ripened by elevating the reaction temperature. In the present invention, the ripening temperature is different from the above-described reaction temperature. At the ripening, the silver ion-containing solution and the solution or suspension of an organic acid alkali metal salt are not added at all. The ripening temperature is preferably (reaction temperature+from 1 to 20° C.), more preferably (reaction temperature+from 1 to 10° C.). The ripening time is preferably determined by try-and-error.

In the present invention, the preparation of the organic silver salt may be performed by adding the organic acid alkali metal salt solution or suspension in parts of 2 to 6 times. By the addition in parts, various functions may be imparted to grains, for example, addition for enhancing the photographic performance or addition for changing the hydrophilicity on the surface. The number of divided additions is preferably from 2 to 4 times. At the addition in parts, since the organic acid salt solidifies unless the temperature is high, it must be considered, for example, to provide a plurality of lines for the divided addition or employ a circulation system.

In the preparation of the organic silver salt for use in the present invention, from 0.5 to 30 mol % of the total added molar number of the organic acid alkali metal salt solution or suspension may be added alone after the completion of addition of the silver ion-containing solution. Preferably, from 3 to 20 mol % may be added alone. One of the above-described divided additions is preferably this sole addition. This sole addition may be made to either, if a closed mixing means is used, the closed mixing means or the reaction tank but is preferably made to the reaction tank. By this sole addition, the hydrophilicity on the surface of the organic silver salt grain can be elevated, as a result, the photosensitive material can have good film-forming property and the film cracking can be improved.

The silver ion concentration of the silver ion-containing solution (for example, an aqueous silver nitrate solution) for use in the present invention may be freely selected but is preferably, in terms of the molar concentration, from 0.03 to 6.5 mol/L, more preferably from 0.1 to 5 mol/L.

In practice of the present invention, for forming organic silver salt grains, an organic solvent is preferably added to at least one of the silver ion-containing solution, the solution or suspension of an organic acid alkali metal salt and the solution previously prepared in the reaction site, in an amount sufficiently large to allow the alkali metal salt of organic acid to form a substantially transparent solution but not to form stringed aggregates or micelles. The organic solvent may be used by itself but is preferably used as a mixed solution with water.

The organic solvent for use in the present invention is not particularly limited on the kind thereof insofar as it is water-soluble and has the above-described properties, however, those which inhibit the photographic performance are not preferred. The organic solvent is preferably alcohol or acetone which can be mixed with water, more preferably a tertiary alcohol having from 4 to 6 carbon atoms.

The alkali metal in the alkali metal salt of organic acid for use in the present invention is preferably, to speak specifically, Na or K. The alkali metal salt of organic acid can be prepared by adding NaOH or KOH to an organic acid. At this time, it is preferred to allow unreacted organic acid to remain by setting the amount of alkali equivalent to or less than the amount of organic acid. The amount of residual organic acid is from 3 to 50 mol %, preferably from 3 to 30 mol %, based on all organic acids. The amount of residual organic acid may also be adjusted by adding an alkali in excess of the desired amount and thereafter adding an acid such as nitric acid or sulfuric acid to neutralize the excess alkali content.

The silver ion-containing solution or the organic acid alkali metal salt solution or suspension for use in the present invention or the solution within the closed mixing means to which those two solutions are added may contain, for example, a compound represented by formula (1) of JP-A-62-65035, a water-soluble group-containing N-heterocyclic compound described in JP-A-62-150240, an inorganic peroxide described in JP-A-50-101019, a sulfur compound descried in JP-A-51-78319, a disulfide compound described in JP-A-57-643 or a hydrogen peroxide.

The amount of the organic solvent for the organic acid alkali metal salt solution used in the present invention is preferably, in terms of the solvent volume, from 3 to 70%, more preferably from 5 to 50%, based on the volume of water content. Here, the optimal solvent volume varies depending on the reaction temperature and therefore, the optimal amount may be determined by try-and-error.

The concentration of the organic acid alkali metal salt for use in the present invention is, in terms of the weight ratio, from 5 to 50 wt %, preferably from 7 to 45 wt %, more preferably from 10 to 40 wt %.

The temperature of the organic acid alkali metal salt solution of suspension added to the closed mixing means or reactor is preferably from 50 to 90° C., more preferably from 60 to 85° C., most preferably from 65 to 85° C., so as to maintain the temperature necessary for preventing crystallization or solidification of the organic acid alkali metal salt. Also, for controlling constant the reaction temperature, the solution is preferably controlled to a constant temperature selected from the above-described range.

By this control, the speed when the organic acid alkali metal salt solution or suspension at a high temperature is rapidly cooled in the closed mixing means and precipitated in the form of fine crystal and the speed when an organic silver salt is formed by the reaction with the silver ion-containing solution can be properly controlled, so that the organic silver salt can be controlled to have preferred crystal form, crystal size and crystal size distribution and in turn, the heat-developable material using this crystal, particularly the heat-developable photosensitive material, can be more improved in the performance.

A solvent may be previously contained in the reactor. The solvent previously contained is preferably water but a mixed solvent with the organic acid alkali metal salt solution or suspension is also preferred.

The organic acid alkali metal salt solution or suspension, the ion-containing solution or the reaction solution may contain a dispersion aid which is soluble in an aqueous medium. Any dispersion aid may be used insofar as it can disperse the formed organic silver salt. Specific examples are the same as those described later for the dispersion aid of the organic silver salt.

In the preparation process of the organic silver salt, a step of forming desalting/dehydration is preferably provided after the formation of silver salt. The method therefor is not particularly limited and a known and commonly employed method can be used. For example, a known filtration method such as centrifugal filtration, suction filtration, ultrafiltration or flocculation/water washing by coagulation, or a method of removing the supernatant after centrifugal separation and precipitation is preferably used. In particular, ultrafiltration is preferred. The desalting/dehydration may be performed only once or may be repeated multiple times. The addition and removal of water may be performed continuously or individually. The desalting/dehydration is performed to such an extent that the finally dehydrated water preferably has a conductivity of 300 μS/cm or less, more preferably 100 μS/cm or less, most preferably 60 μS/cm or less. The lower limit of the conductivity is not particularly limited but is usually about 5 μS/cm.

In the ultrafiltration, a method used, for example, in the desalting/concentration of silver halide emulsion may be applied. This is described in Research Disclosure, No. 10 208 (1972), No. 13 122 (1975) and No. 16 351 (1977). The pressure difference and flow rate which are important operation conditions may be selected by referring to the characteristic curve described in Haruhiko Oya, Maku Riyo Gijutsu Handbook (Handbook for Membrane Using Technology), Saiwai Shobo Shuppan, page 275 (1978), however, in treating an objective organic silver salt dispersion, optimal conditions must be found out for preventing the aggregation or fogging of grains. The method of replenishing the solvent lost due to passing through a membrane include a constant-volume system of continuously adding the solvent and a batch system of discontinuously adding the solvent in parts and of these, the constant-volume system is preferred because the desalting time is relatively short.

For the solvent thus replenished, ion-exchanged water or pure water obtained by distillation is used. In order to keep an objective pH, a pH adjusting agent or the like may be mixed in the pure water or may be added directly to the organic silver salt dispersion.

As for the ultrafiltration membrane, a flat type already integrated as a module, a spiral type, a cylinder type, a hollow yarn type and a hollow fiber type are commercially available from Asahi Chemical Industry Co., Ltd., Daicel Chemical Industries, Ltd., Toray Industries, Inc., Nitto Electric Industrial Co., Ltd. and the like. In view of the total membrane area and the washing property, the spiral type and the hollow yarn type are preferred.

The fractional molecular weight as an index of the threshold value for components which can pass through the membrane is preferably ⅕ or less of the molecular weight of the polymer dispersant used.

In the desalting by ultrafiltration according to the present invention, it is preferred to disperse the solution to a grain size about 2 times the final grain size in terms of the volume weighted average, in advance of the treatment. The dispersion may be performed using any means such as high-pressure homogenizer or microfluidizer.

During the time period from the grain formation until the desalting operation starts, the liquid temperature is preferably maintained low, because in the state where the organic solvent used in dissolving the organic acid alkali metal salt is penetrated into the inside of the produced organic silver salt grains, silver nuclei are readily produced due to the shearing field or pressure field at the liquid feeding operation or on passing through the ultrafiltration membrane. Accordingly, in the present invention, the ultrafiltration operation is performed while keeping the organic silver salt grain dispersion at a temperature of 1 to 30° C., preferably from 5 to 25° C.

Furthermore, in order to impart good coated surface state to a heat-developable material, particularly a heat-developable photosensitive material, the desalted and dehydrated organic silver salt is preferably formed into a fine dispersion by adding a dispersant and re-dispersing the organic silver salt.

In the production and dispersion of the organic silver salt for use in the present invention, known methods can be applied. These methods are described, for example, in JP-A-8-234358 supra, JP-A-10-62899, EP-A-0803763, EP-A-0962812, JP-A-11-349591, JP-A-2000-7683, JP-A-2000-72711, JP-A-2000-53682, JP-A-2000-75437, JP-A-2000-86669, JP-A-2000-143578, JP-A-2000-178278, JP-A-2000-256254 and Japanese Patent Application Nos. 11-348228 to 11-348230, 11-203413, 11-115457, 11-180369, 11-297964, 11-157838, 11-202081, 2000-90093, 2000-195621, 2000-191226, 2000-213813, 2000-214155 and 2000-191226.

The organic silver salt may be finely dispersed by mechanically dispersing it using known pulverizing means (for example, high-speed mixer, homogenizer, high-speed impact mill, Banbury mixer, homomixer, kneader, ball mill, vibration ball mill, planetary mill, attritor, sand mill, beads mill, colloid mill, jet mill, roller mill, thoron mill and high-speed stone mill) in the presence of a dispersion aid.

For obtaining a uniform organic silver salt solid dispersion having a monodisperse grain size distribution and a small grain size and being free of aggregation, a large power is preferably given uniformly within the range of not causing breakage of organic silver salt grains as an image formation medium or elevation of the temperature. For this purpose, a dispersion method of converting a dispersion comprising the organic silver salt and a dispersant solution into a high-speed flow and then decreasing the pressure is preferably used. The dispersion medium used here may be any substance insofar as the dispersion aid can function in the solvent but is preferably water alone or water containing an organic solvent in an amount of 20 wt % or less. If a photosensitive silver salt is present together at the dispersion, fog increases and sensitivity seriously decreases. Therefore, the dispersion solution preferably contains substantially no photosensitive silver salt at the dispersion. In the present invention, the amount of the photosensitive silver salt in the dispersion solution where the photosensitive silver salt is dispersed is 0.1 mol % or less per mol of the organic silver salt in the solution and the photosensitive silver salt is preferably not added.

The dispersing apparatus used in practicing the above-described re-dispersion method and techniques thereon are described in detail, for example, in Toshio Kajiuchi and Hiromoto Usui, Bunsan-Kei Rheology to Bunsan-Ka Gijutsu (Dispersion System Rheology and Dispersion Technology), pp. 357-403, Shinzan-Sha Shuppan K. K. (1991), Kagaku Kogaku Kai Tokai Shibu (compiler), Kagaku Kogaku no Shimpo Dai 24 Shu (Progress of Chemical Engineering, No. 24), pp. 184-185, Maki Shoten (1990), JP-A-59-49832, U.S. Pat. No. 4,533,254, JP-A-8-137044, JP-A-8-238848, JP-A-2-261525 and JP-A-1-94933. In the present invention, the re-dispersion is performed by a method where a dispersion solution containing at least the organic silver salt is pressurized into a pipeline using a high-pressure pump or the like and passed through a thin slit provided within the pipeline, and thereafter, the pressure on the dispersion solution is abruptly reduced, thereby finely dispersing the organic silver salt.

In the high-pressure homogenizer, it is generally considered that when (a) the “shearing force” generated upon passing of the dispersoid through a narrow opening (approximately from 75 to 350 μm) at a high speed under a high pressure and (b) the impact force generated at the liquid-liquid collision in a narrow space under a high pressure or at the collision against the wall surface are not changed but the cavitation force due to the pressure reduction occurred thereafter is more intensified, uniform and highly efficient dispersion can be attained. As the dispersing apparatus of this type, Gaulin homogenizer is long known. In this homogenizer, the solution to be dispersed, which is transferred under a high pressure, is converted into a high-speed flow in the narrow opening on the cylindrical face, the force generated there enforces the solution to collide against the peripheral wall surface, and the impact force generated allows the emulsification and dispersion to proceed. Examples of the liquid-liquid collision-type apparatus include the Y-type chamber of microfluidizer and a spherical chamber using a spherical check valve described in JP-A-8-103642 which is described later, and examples of the liquid-wall surface collision-type apparatus include the Z-type chamber of microfluidizer. Some apparatuses are designed to increase the collision frequency by forming the high-speed flow part in the serrated shape and thereby increase the dispersion efficiency. Representative examples of the apparatus of this type include Gaulin homogenizer, the microfluidizer manufactured by Microfluidex International Corporation, the microfluidizer manufactured by Mizuho Kogyo K. K., and the nanomizer manufactured by Tokushu Kika Kogyo K. K. This apparatus is also described in JP-A-8-238848, JP-A-8-103642 and U.S. Pat. No. 4,533,254.

The organic acid silver salt can be dispersed to a desired grain size by controlling the flow rate, the pressure difference at the pressure drop, and the treatment frequency, however, in view of the photographic properties and the grain size, it is preferred that the flow rate is from 200 to 600 m/sec and the pressure difference at the pressure drop is from 900 to 3,000 kg/cm² (from 9 to 30 MPa), more preferably that the flow rate is from 300 to 600 m/sec and the pressure difference at the pressure drop is from 1,500 to 3,000 kg/cm² (15 to 30 MPa). The dispersion treatment frequency may be selected according to the necessity. The dispersion treatment frequency is usually from 1 to 10 times but in view of the productivity, it is preferably from 1 to 4 times. If the temperature of this dispersion solution is elevated under a high pressure, the dispersibility and the photographic properties are adversely affected. More specifically, if the temperature exceeds 90° C., a large grain size is liable to result and the fog readily increases. Therefore, it is preferred to contain a cooling device in the step before the conversion into a high-pressure and high-speed flow, in the step after the pressure drop or in these two steps and by such a cooling device, maintain the dispersion at a temperature of 5 to 90° C., more preferably from 5 to 80° C., still more preferably from 5 to 65° C. At the dispersion operation under a high pressure of 1,500 to 3,000 kg/cm² (from 15 to 30 MPa), the cooling device thus disposed is particularly effective. The cooling device may be appropriately selected according to the required heat exchanging amount from a cooling device using a static mixer for the double or triple pipe, a tubular heat exchanger and a coiled heat exchanger. Furthermore, by taking account of the pressure used, those having suitable pipe size, wall thickness or constructive material may be selected so as to increase the efficiency of heat exchanging. In view of the heat exchanging amount, the refrigerant used in the cooler is well water at 20° C. or chilled water treated by a refrigerator to 5 to 10° C. Also, if desired, a refrigerant at −30° C., such as ethylene glycol/water, may be used.

In forming the organic silver salt into solid fine grains using a dispersant, a synthetic anion polymer such as polyacrylic acid, acrylic acid copolymer, maleic acid copolymer, maleic acid monoester copolymer and acryloylmethylpropanesulfonic acid copolymer, a semisynthetic anion polymer such as carboxymethyl starch and carboxymethyl cellulose, an anionic polymer such as alginic acid and pectic acid, an anionic surfactant described in JP-A-52-92716 and WO88/04794, a compound described in Japanese Patent Application No. 7-350753, a known anionic, nonionic or cationic surfactant, a known polymer such as polyvinyl alcohol, polyvinylpyrrolidone, carboxymethyl cellulose, hydroxypropyl cellulose and hydroxypropylmethyl cellulose, or a naturally occurring polymer compound such as gelatin, may be appropriately selected and used. In the case of using a solvent as the dispersion medium, preferred examples of the solvent include polyvinyl butyral, butyl ethyl cellulose, methacrylate copolymers, maleic anhydride ester copolymers, polystyrene, and butadiene-styrene copolymers.

According to a general method, the dispersion aid is mixed with the organic silver salt in the powder form or in the wet cake state before the dispersion and fed as a slurry to a dispersing machine. The dispersion aid may be previously mixed with the organic silver salt and then heat-treated or treated with a solvent to form an organic silver salt powder or wet cake. Before, after or during the dispersion, the pH may be controlled using an appropriate pH adjusting agent.

Other than the mechanical dispersion, a method of crudely dispersing the organic silver salt in a solvent by controlling the pH and thereafter varying the pH in the presence of a dispersion aid to form fine grains may also be employed. At this time, a fatty acid solvent may be used as the solvent for the crude dispersion.

In the present invention, a photosensitive material can be produced by mixing the organic silver salt water dispersion and the photosensitive silver salt water dispersion and the mixing ratio of the organic silver salt to the photosensitive silver salt can be selected according to the purpose, however, the ratio of the photosensitive silver salt to the organic silver salt is preferably from 1 to 30 mol %, more preferably from 3 to 20 mol %, still more preferably from 5 to 15 mol %. A method of using two or more organic silver salt water dispersions and two or more photosensitive silver salt water dispersions at the mixing is preferably employed for controlling the photographic properties.

In the present invention, a non-photosensitive organic silver salt containing 2 or more reducible silver(I) ions within one molecular can be used. Specific examples of the compound which can be used include the compounds described in Japanese Patent Application No. 2001-251399. Also, a silver salt of a polymer containing acrylic acid or the like may be used.

The organic silver salt for use in the present invention may be used in any desired amount, however, the amount in terms of silver is preferably from 0.1 to 5 g/m², more preferably from 0.3 to 3 g/m², still more preferably from 0.5 to 2 g/m².

(Description of Silver Halide)

The photosensitive silver halide for use in the present invention is not particularly limited on the halogen composition and silver chloride, silver chlorobromide, silver bromide, silver iodobromide, silver iodochlorobromide or silver iodide may be used. Among these, silver bromide and silver iodobromide are preferred. The halogen composition distribution within the grain may be uniform or the halogen composition may be stepwise or continuously changed. A silver halide grain having a core/shell structure may also be preferably used. With respect to the structure, the core/shell grain preferably has from 2 to 5-ply structure, more preferably from 2 to 4-ply structure. Furthermore, a technique of localizing silver bromide or silver iodide on the silver chloride, silver bromide or silver chlorobromide grain surface may also be preferably used.

The method for forming a photosensitive silver halide is well known in the art and, for example, the methods described in Research Disclosure, No. 17029 (June, 1978) and U.S. Pat. No. 3,700,458 may be used. Specifically, a method of adding a silver-supplying compound and a halogen-supplying compound to gelatin or other polymer solution to prepare a photosensitive silver halide and mixing the silver halide with an organic silver salt is used. In addition, the methods described in JP-A-1′-119374 (paragraph Nos. 0217 to 0224), JP-A-11-352627 and JP-A-2000-347335 are also preferably used.

The size of photosensitive silver halide grain is preferably small for the purpose of suppressing occurrence of white turbidity after the image formation. Specifically, the grain size is preferably 0.20 μm or less, more preferably from 0.01 to 0.15 μm, still more preferably from 0.02 to 0.12 μm, particularly preferably from 0.03 to 0.05 μm (from 30 to 50 nm). The grain size as used herein means a diameter of a circle image having the same area as the projected area of a silver halide grain (in the case of a tabular grain, the projected area of a main plane).

Examples of the shape of a silver halide grain include cubic form, octahedral form, tabular form, spherical form, bar form and pebble-like form. In the present invention, a cubic grain is particularly preferred. A silver halide grain having rounded corners can also be preferably used. Although the face index (Miller indices) of the outer surface of a photosensitive silver halide grain is not particularly limited, {100} faces capable of giving a high spectral sensitization efficiency upon adsorption of a spectral sensitizing dye preferably occupy a high percentage. The percentage is preferably 50% or more, more preferably 65% or more, still more preferably 80% or more. The percentage of {100} faces according to the Miller indices can be determined by the method described in T. Tani, J. Imaging Sci., 29, 165 (1985) utilizing the adsorption dependency of {111} face and {100} face when a sensitizing dye is adsorbed.

In the present invention, a silver halide grain having allowed a hexacyano metal complex to be present on the outermost surface thereof is preferred. Examples of the hexacyano metal complex include [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻ and [Re(CN)₆]³⁻. In the present invention, hexacyano Fe complexes are preferred.

The hexacyano metal complex is present in the form of ion in an aqueous solution and therefore, the counter cation is not important but a cation easily miscible with water and suitable for the precipitation operation of a silver halide emulsion is preferably used. Examples thereof include alkali metal ions such as sodium ion, potassium ion, rubidium ion, cesium ion and lithium ion, ammonium ions, and alkylammonium ions (e.g., tetramethylammonium ion, tetraethylammonium ion, tetrapropylammonium ion, tetra(n-butyl)ammonium ion).

The hexacyano metal complex can be added after mixing it with water, a mixed solvent of water and an appropriate organic solvent miscible with water (for example, an alcohol, an ether, a glycol, a ketone, an ester or an amide), or gelatin.

The amount of the hexacyano metal complex added is preferably from 1×10⁻⁵ to 1×10⁻² mol, more preferably from 1×10⁻⁴ to 1×10⁻³ mol, per mol of silver.

For allowing the hexacyano metal complex to exist on the outermost surface of a silver halide grain, the hexacyano metal complex is directly added after the completion of addition of an aqueous silver nitrate solution used for the grain formation but before the starting of chemical sensitization step of performing chalcogen sensitization such as sulfur sensitization, selenium sensitization and tellurium sensitization, or noble metal sensitization such as gold sensitization, for example, before the completion of charging step, during the water washing step, during the dispersion step, or before the chemical sensitization step. In order to prevent growth of silver halide fine grains, the hexacyano metal complex is preferably added without delay after the grain formation and is preferably added before the completion of charging step.

The addition of hexacyano metal complex may be started after silver nitrate added for the grain formation is added to consume 96 mass %, preferably 98 mass %, more preferably 99 mass %, of the total amount.

When the hexacyano metal complex is added after an aqueous silver nitrate solution is added immediately before the completion of grain formation, the hexacyano metal complex can adsorb to the outermost surface of a silver halide grain and most of the complexes adsorbed form a sparingly-soluble salt with silver ion on the grain surface. This silver salt of hexacyanoferrate(II) is a salt more sparingly soluble than AgI and therefore, the fine grains can be prevented from re-dissolving, making it possible to produce silver halide fine grains having a small grain size.

The photosensitive silver halide grain for use in the present invention contains a metal of Group VIII to Group X in the Periodic Table (showing Group I to Group XVIII) or a metal complex thereof. The metal of Group VIII to Group X of the Periodic Table or the center metal of metal complex is preferably rhodium, ruthenium or iridium. One of these metal complexes may be used or two or more complexes of the same or different metals may be used in combination. The metal or metal complex content is preferably from 1×10⁻⁹ to 1×10⁻³ mol per Mol of silver. These heavy metals and metal complexes and the addition methods therefor are described in JP-A-7-225449, JP-A-11-65021 (paragraph Nos. 0018 to 0024) and JP-A-11-119374 (paragraph Nos. 0227 to 0240).

Furthermore, metal atoms (for example, [Fe(CN)₆]⁴⁻) which can be contained in the silver halide grain for use in the present invention, and the methods for desalting and chemical sensitization of a silver halide emulsion are described in JP-A-11-84574 (paragraph Nos. 0046 to 0050), JP-A-11-65021 (paragraph Nos. 0025 to 0031) and JP-A-11-119374 (paragraph Nos. 0242 to 0250).

For the gelatin contained in the photosensitive silver halide emulsion for use in the present invention, various gelatins can be used. In order to maintain good dispersion state of the photosensitive silver halide emulsion in the organic silver salt-containing coating solution, a low molecular weight gelatin having a molecular weight of 500 to 60,000 is preferably used. This low molecular weight gelatin may be used either during the grain formation or at the dispersion after desalting but is preferably used at the dispersion after desalting.

As for the sensitizing dye which can be used in the present invention, a sensitizing dye capable of spectrally sensitizing a silver halide grain in the desired wavelength region when adsorbed to the silver halide grain and having a spectral sensitivity suitable for the spectral characteristics of exposure light source can be advantageously selected. Examples of the sensitizing dye and the addition method therefor include compounds described in JP-A-11-65021 (paragraph Nos. 0103 to 0109), compounds represented by formula (II) of JP-A-10-186572, dyes represented by formula (I) and described in paragraph No. 0106 of JP-A-11-119374, dyes described in U.S. Pat. Nos. 5,510,236 and 3,871,887 (Example 5), dyes disclosed in JP-A-2-96131 and JP-A-59-48753, and those described in EP-A-0803764 (page 19, line 38 to page 20, line 35) and Japanese Patent Application Nos. 2000-86865, 2000-102560 and 2001-195648. These sensitizing dyes may be used individually or in combination of two or more thereof. In the present invention, the sensitizing dye is preferably added to the silver halide emulsion in the time period after desalting until the coating, more preferably after desalting until initiation of chemical ripening.

In the present invention, the amount of the sensitizing dye added may be appropriately selected according to the performance such as sensitivity or fogging but is preferably from 10⁻⁶ to 1 mol, more preferably from 10⁻⁴ to 10⁻¹ mol, per mol of silver halide in the photosensitive layer.

In the present invention, a supersensitizer may be used for improving the spectral sensitization efficiency. Examples of the supersensitizer for use in the present invention include the compounds described in EP-A-587338, U.S. Pat. Nos. 3,877,943 and 4,873,184, JP-A-5-341432, JP-A-11-109547 and JP-A-10-111543.

The photosensitive silver halide grain for use in the present invention is preferably chemically sensitized by sulfur sensitization, selenium sensitization or tellurium sensitization. As for the compound which is preferably used in the sulfur sensitization, selenium sensitization or tellurium sensitization, known compounds can be used, for example, compounds described in JP-A-7-128768 can be used. In the present invention, tellurium sensitization is particularly preferred and compounds described in JP-A-11-65021 (paragraph No. 0030) and compounds represented by formulae (II), (III) and (IV) of JP-A-5-313284 are more preferred.

In the present invention, the chemical sensitization may be performed at any stage after the grain formation but before the coating and, for example, can be performed, after desalting, (1) before spectral sensitization, (2) simultaneously with spectral sensitization, (3) after spectral sensitization or (4) immediately before coating. The chemical sensitization is particularly preferably performed after spectral sensitization.

The amount of the sulfur, selenium or tellurium sensitizer for use in the present invention varies depending on the silver halide grain used, chemical ripening conditions and the like but is from 10⁻⁸ to 10⁻² mol, preferably on the order from 10⁻⁷ to 10⁻³ mol, per mol of silver halide. In the present invention, the conditions for chemical sensitization are not particularly limited but the pH is from 5 to 8, the pAg is from 6 to 11 and the temperature is approximately from 40 to 95° C.

In the silver halide emulsion for use in the present invention, a thiosulfonic acid compound may be added by the method described in EP-A-293917.

In the photosensitive material for use in the present invention, only one photosensitive silver halide emulsion may be used or two or more emulsions (different, for example, in the average grain size, the halogen composition, the crystal habit or the chemical sensitization conditions) may be used in combination. By using a plurality of photosensitive silver halide emulsions different in the sensitivity, gradation can be controlled. Examples of the technique thereon include those described in JP-A-57-119341, JP-A-53106125, JP-A-47-3929, JP-A-48-55730, JP-A-46-5187, JP-A-50-73627 and JP-A-57-150841. The difference in sensitivity between respective emulsions is preferably 0.2logE or more.

The amount of the photosensitive silver halide added is, in terms of the coated silver amount per m² of the photosensitive material, preferably from 0.03 to 0.6 g/m², more preferably from 0.07 to 0.4 g/m², most preferably from 0.05 to 0.3 g/m². The amount of the photosensitive silver halide added is, per mol of the organic silver salt, preferably from 0.01 to 0.5 mol, more preferably from 0.02 to 0.3 mol, still more preferably from 0.03 to 0.2 mol.

The method and conditions for the mixing of separately prepared photosensitive silver halide and organic silver salt are not particularly limited insofar as the effect of the present invention is satisfactorily brought out but a method of mixing silver halide grain and organic silver salt each after the completion of preparation by a high-speed agitator or in a ball mill, a sand mill, a colloid mill, a vibration mill, a homogenizer or the like, or a method of preparing an organic silver salt by mixing a photosensitive silver halide of which preparation is completed, at any timing during the preparation of organic silver salt may be used. For controlling the photographic property, it is preferred to mix two or more water dispersions of organic silver salt with two or more water dispersions of photosensitive silver salt.

In the present invention, the timing of adding silver halide to a coating solution for the image-forming layer is preferably from 180 minutes before coating to immediately before coating, preferably from 60 minutes to 10 seconds before coating, however, the mixing method and the mixing conditions are not particularly limited insofar as the effect of the present invention can be satisfactorily brought out. Specific examples of the mixing method include a method of mixing the silver halide with the solution in a tank designed to give a desired average residence time which is calculated from the addition flow rate and the liquid transfer amount to the coater, and a method using a static mixer described in N. Harnby, M. F. Edwards and A. W. Nienow (translated by Koji Takahashi), Ekitai Kongo Gijutsu (Liquid Mixing Technique), Chap. 8, Nikkan Kogyo Shinbun Sha (1989).

The heat-developable photosensitive material of the present invention contains a heat developer which is a reducing agent for the organic silver salt. The reducing agent for the organic silver salt may be any substance (preferably an organic substance) capable of reducing silver ion into metal silver. Examples of this reducing agent include those described in JP-A-11-65021 (paragraph Nos. 0043 to 0045) and EP-A-0803764 (page 7, line 34 to page 18, line 12).

In the present invention, the reducing agent is preferably a so-called hindered phenol reducing agent or a bisphenol reducing agent, having a substituent at the ortho position of the phenolic hydroxyl group, more preferably a compound represented by the following formula (R):

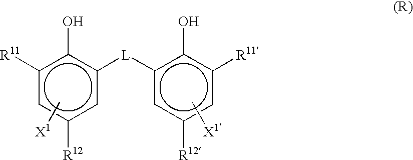

wherein R¹¹ and R¹¹′ each independently represents an alkyl group having from 1 to 20 carbon atoms, R¹² and R¹²′ each independently represents a hydrogen atom or a substituent capable of substituting to the benzene ring, L represents a —S— group or a —CHR¹³— group, R¹³ represents a hydrogen atom or an alkyl group having from 1 to 20 carbon atoms, and X¹ and X¹′ each independently represents a hydrogen atom or a group capable of substituting to the benzene ring.

In the fourth embodiment of the present invention, the heat-developable photosensitive material contains the compound represented by formula (R).

Formula (R) is described in detail.

R¹¹ and R¹¹′ each independently represents a substituted or unsubstituted alkyl group having from 1 to 20 carbon atoms. The substituent of the alkyl group is not particularly limited but preferred examples thereof include an aryl group, a hydroxy group, an alkoxy group, an aryloxy group, an alkylthio group, an arylthio group, an acylamino group, a sulfonamide group, a sulfonyl group, a phosphoryl group, an acyl group, a carbamoyl group, an ester group, a ureido group, a urethane group and a halogen atom.

R¹² and R¹²′ each independently represents a hydrogen atom or a substituent capable of substituting to the benzene ring, and X¹ and X¹′ each independently represents a hydrogen atom or a group capable of substituting to the benzene ring. Preferred examples of the group capable of substituting to the benzene ring include an alkyl group, an aryl group, a halogen atom, an alkoxy group and an acylamino group.

L represents a —S— group or a —CHR¹³— group. R¹³ represents a hydrogen atom or an alkyl group having from 1 to 20 carbon atoms, and the alkyl group may have a substituent. Specific examples of the unsubstituted alkyl group represented by R¹³ include a methyl group, an ethyl group, a propyl group, a butyl group, a heptyl group, a undecyl group, an isopropyl group, a 1-ethylpentyl group and a 2,4,4-trimethylpentyl group. Examples of the substituent of the alkyl group include those described above as the substituent for R¹¹.

R¹¹ and R¹¹′ each preferably represents a secondary or tertiary alkyl group having from 3 to 15 carbon atoms, and specific examples thereof include an isopropyl group, an isobutyl group, a tert-butyl group, a tert-amyl group, a tert-octyl group, a cyclohexyl group, a cyclopentyl group, 1-methylcyclohexyl group and a 1-methylcyclopropyl group. R¹¹ and R¹¹′ each is more preferably a tertiary alkyl group having from 4 to 12 carbon atoms, more preferably a tert-butyl group, a tert-amyl group or a 1-methylcyclohexyl group, most preferably a tert-butyl group.

R¹² and R¹²′ each is preferably an alkyl group having from 1 to 20 carbon atoms, and specific examples thereof include a methyl group, an ethyl group, a propyl group, a butyl group, an isopropyl group, a tert-butyl group, a tert-amyl group, a cyclohexyl group, a 1-methylcyclohexyl group, a benzyl group, a methoxymethyl group and a methoxyethyl group. of these, more preferred are a methyl group, an ethyl group, a propyl group, an isopropyl group and a tert-butyl group.

X¹ and X¹′ are each preferably a hydrogen atom, a halogen atom or an alkyl group, more preferably a hydrogen atom.

L is preferably a —CHR¹³— group.

R¹³ is preferably a hydrogen atom or an alkyl group having from 1 to 15 carbon atoms. Preferred examples of the alkyl group include a methyl group, an ethyl group, a propyl group, an isopropyl group and a 2,4,4-trimethylpentyl group R¹³ is more preferably a hydrogen atom, a methyl group, an ethyl group, a propyl group or an isopropyl group.

When R¹³ is a hydrogen atom, R¹² and R¹²′ are each preferably an alkyl group having from 2 to 5 carbon atoms, more preferably an ethyl group or a propyl group, most preferably an ethyl group.

When R¹³ is a primary or secondary alkyl group having from 1 to 8 carbon atoms, R¹² and R¹²′ are each preferably a methyl group. The primary or secondary alkyl group having from 1 to 8 carbon atoms represented by R¹³ is preferably a methyl group, an ethyl group, a propyl group or an isopropyl group, more preferably a methyl group, an ethyl group or a propyl group.

When R¹¹, R¹¹′, R¹² and R¹²′ are all a methyl group, R¹³ is preferably a secondary alkyl group. In this case, the secondary alkyl group represented by R¹³ is preferably an isopropyl group, an isobutyl group or a 1-ethylpentyl group, more preferably an isopropyl group.

The above-described reducing agent differs in heat developability and developed silver color tone depending on what are used in combination as R¹¹, R¹¹′, R¹², R¹²′ and R¹³. These properties can be controlled by combining two or more reducing agents and therefore, the combination use of two or more reducing agents is preferred according to the purpose.

Specific examples of the reducing agent for use in the present invention including the compound represented by formula (R) are set forth below, however, the present invention is not limited thereto.

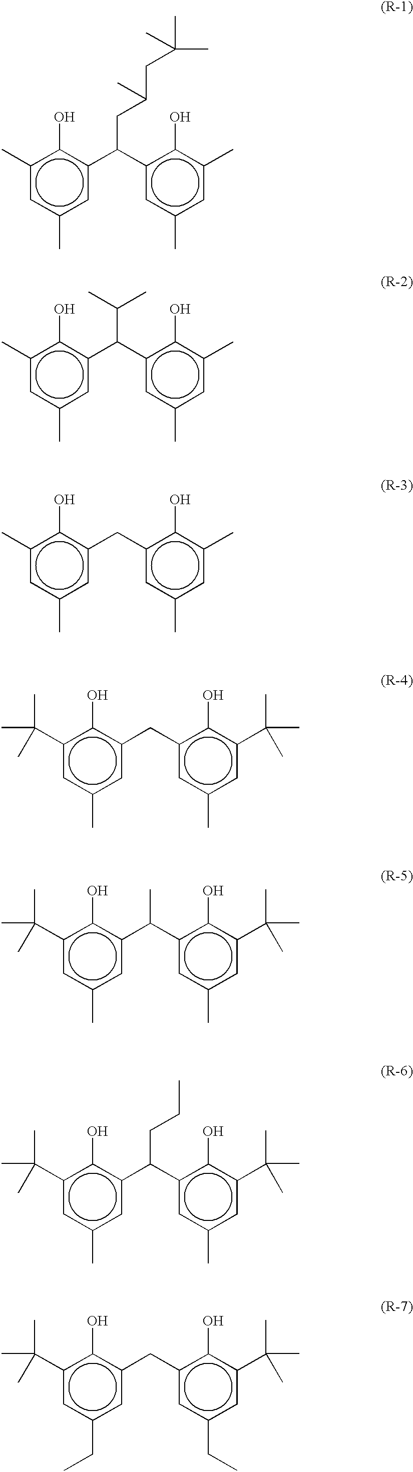

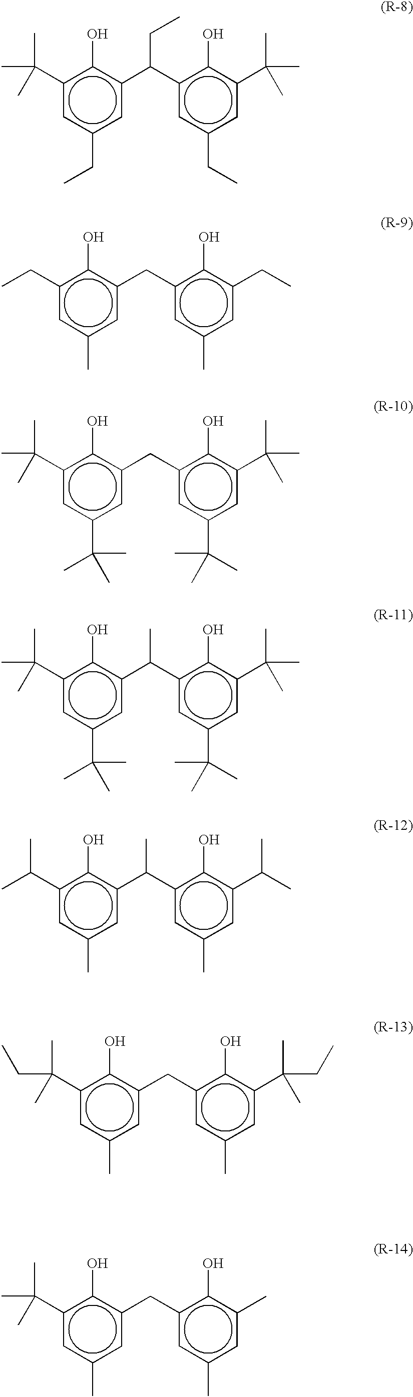

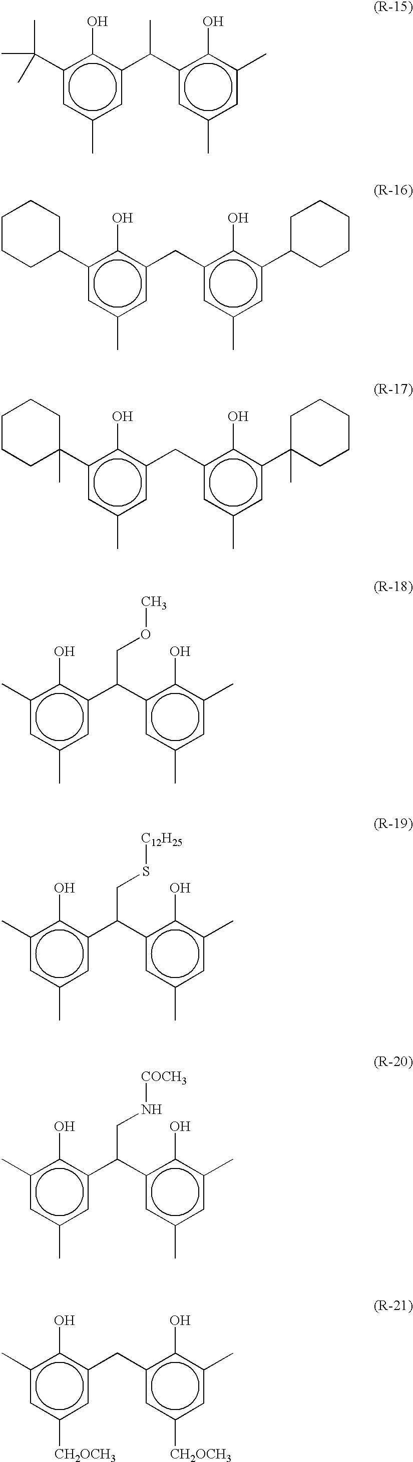

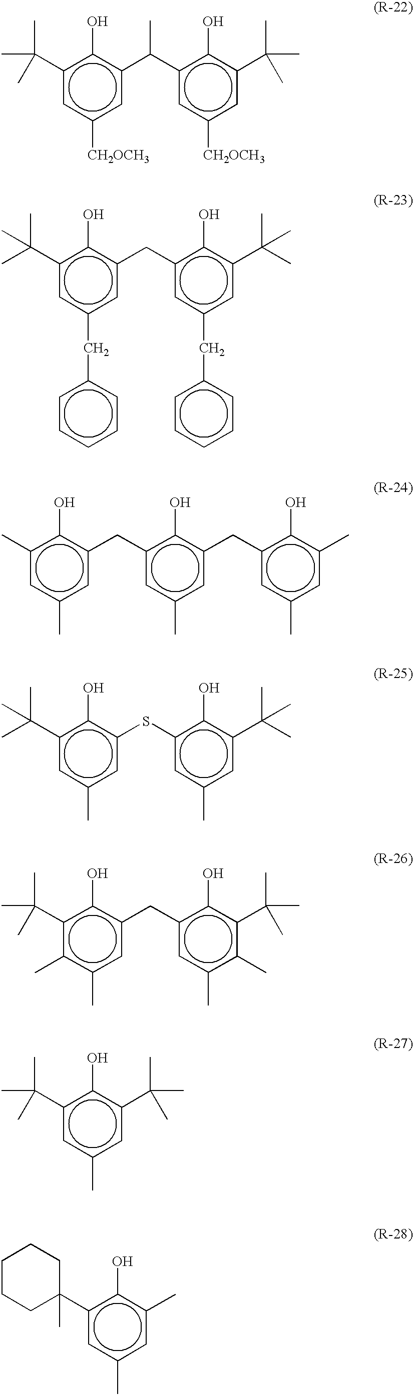

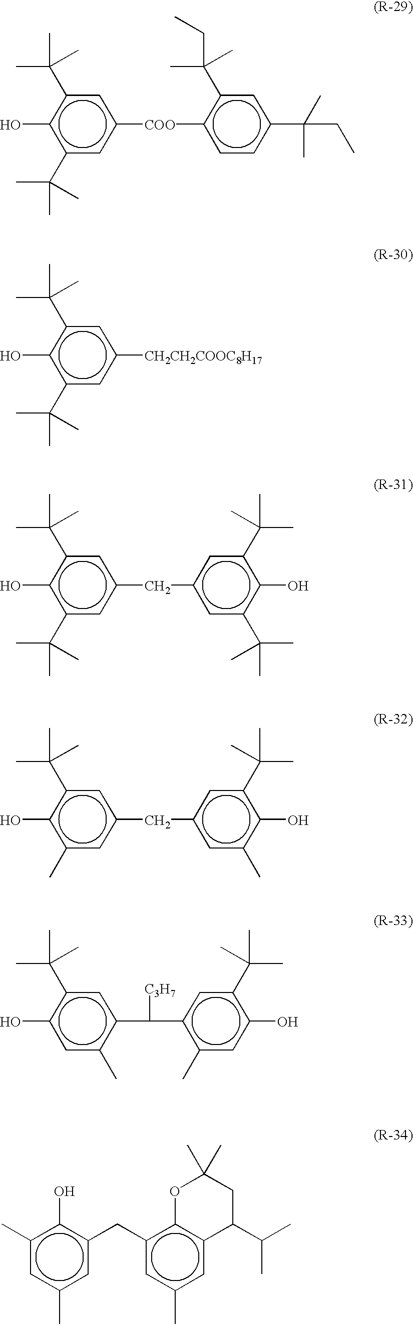

In the present invention, the amount of the reducing agent added is preferably from 0.1 to 3.0 g/m², more preferably from 0.2 to 1.5 g/m², still more preferably from 0.3 to 1.0 g/m². The reducing agent is preferably contained in an amount of 5 to 50 mol %, more preferably from 8 to 30 mol %, still more preferably from 10 to 20 mol %, per mol of silver on the surface having an image-forming layer. The reducing agent is preferably incorporated into an image-forming layer.

In adding the reducing agent to a coating solution and thereby incorporating it into the photosensitive material, the reducing agent may be added in any form, for example, in the form of a solution, an emulsified dispersion or a solid fine grain dispersion.

Well-known examples of the emulsification dispersion method include a method of dissolving the reducing agent using an oil such as dibutyl phthalate, tricresyl phosphate, glyceryl triacetate or diethyl phthalate, and an auxiliary solvent such as ethyl acetate or cyclohexanone, and mechanically forming an emulsified dispersion.

Examples of the solid fine grain dispersion method include a method of dispersing the reducing agent in the powder form in an appropriate solvent such as water using a ball mill, a colloid mill, a vibrating ball mill, a sand mill, a jet mill, a roller mill or an ultrasonic wave, thereby preparing a solid dispersion. At this time, a protective colloid (e.g., polyvinyl alcohol) or a surfactant (for example, an anionic surfactant such as sodium triisopropylnaphthalenesulfonate (a mixture of three substances different in the substitution position of an isopropyl group)) may be used. In the above-described mills, beads such as zirconia are commonly used as a dispersion medium and Zr or the like dissolved out from these beads may be mixed in the dispersion. The content thereof is usually from 1 to 1,000 ppm, though this varies depending on the dispersing conditions. It is not a problem in practice if the content of Zr in the photosensitive material is 0.5 mg or less per g of silver.

In the water dispersion, an antiseptic (e.g., benzoisothiazolinone sodium salt) is preferably added.

(Compound of Formula (II))

In the heat-developable photosensitive material of the present invention, any one layer in the side having a photosensitive layer on the support preferably contains a compound represented by formula (II):

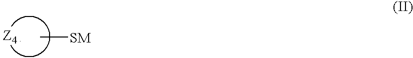

The compound represented by formula (II) is a mercapto compound.

Z₄ represents a heterocyclic ring, for example, an oxazole ring, a thiazole ring, an imidazole ring, a selenazole ring, a triazole ring, a tetrazole ring, a thiadiazole ring, an oxadiazole ring, a pentazole ring, a pyrimidine ring, a thiazine ring, a triazine ring, a thiadiazine ring or a ring combined with other carbon ring or heterocyclic ring, such as benzoxazole ring, benzothiazole ring, benzoselenazole ring, benzimidazole ring, naphthoxazole ring, triazeindolizine ring, diazaindolizine ring or triazaindolizine ring. M represents a hydrogen atom, an alkali metal atom or a quaternary ammonium or phosphonium group. Those heterocyclic rings may have a substituent and examples of the substituent include a hydroxyl group, an alkyl group, an aralkyl group, an aryl group, a halogen atom (e.g., fluorine, chlorine, bromine, iodine), a nitro group, a cyano group, a heterocyclic group, an alkenyl group, an alkoxy group, a —XO₃M group, a —COOR group, a —NR¹R₂ group, a —CONR¹R₂ group, a —NHCO₂R₁ group and a —SO₂NR₁R₂ group. M represents a hydrogen atom, an alkali metal atom, a quaternary ammonium group or a quaternary phosphonium group, R represents a hydrogen atom, an alkali metal, a quaternary ammonium a quaternary phosphonium, an alkyl group, an aralkyl group, an aryl group, a —COR₃ group, a —COOR₃ group or a —SO₂R₃ group, R₃ represents a hydrogen atom, an aliphatic group or an aromatic group and these groups each ma further have a substituent. R₁ and R₂ each represents a hydrogen atom, an alkyl group, an aralkyl group, an aryl group, a —COR³ group or a —SO₂R₃ groups R₃ represents a hydrogen atom, an aliphatic group or an aromatic group and these groups each may further have a substituent. One substituent or a plurality of substituents may be present.

Preferred examples of the mercapto group for use in the present invention include mercaptotetrazole compounds, mercaptotriazole compounds and mercaptothiazole compounds.

Specific examples of these compounds are set forth below, however, the present invention is not limited thereto.

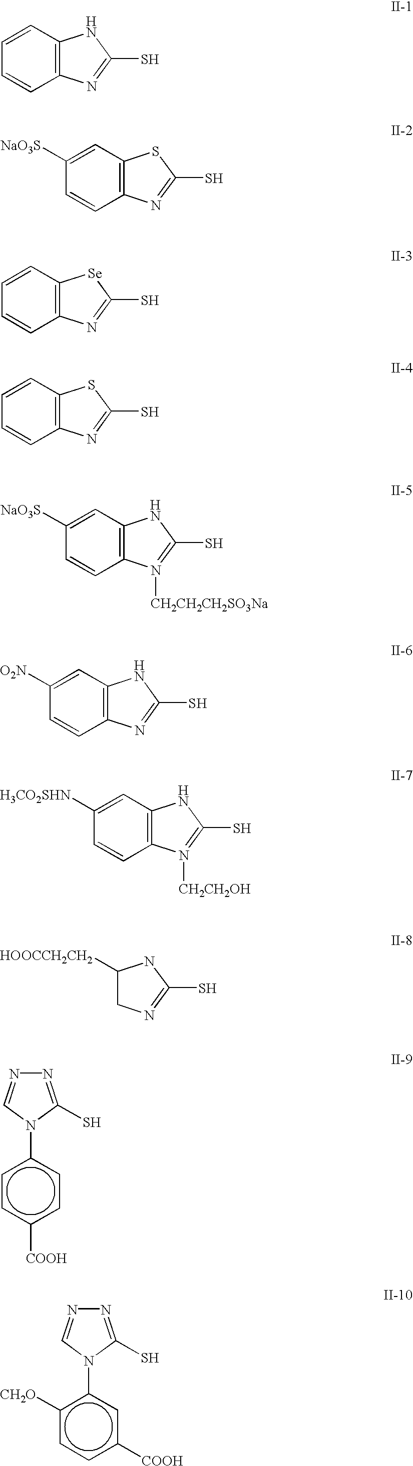

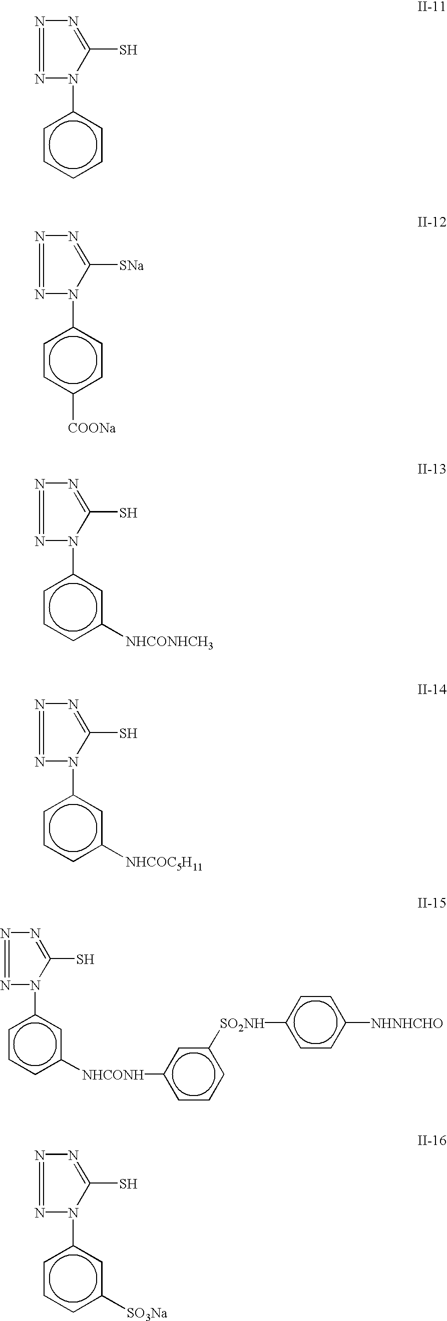

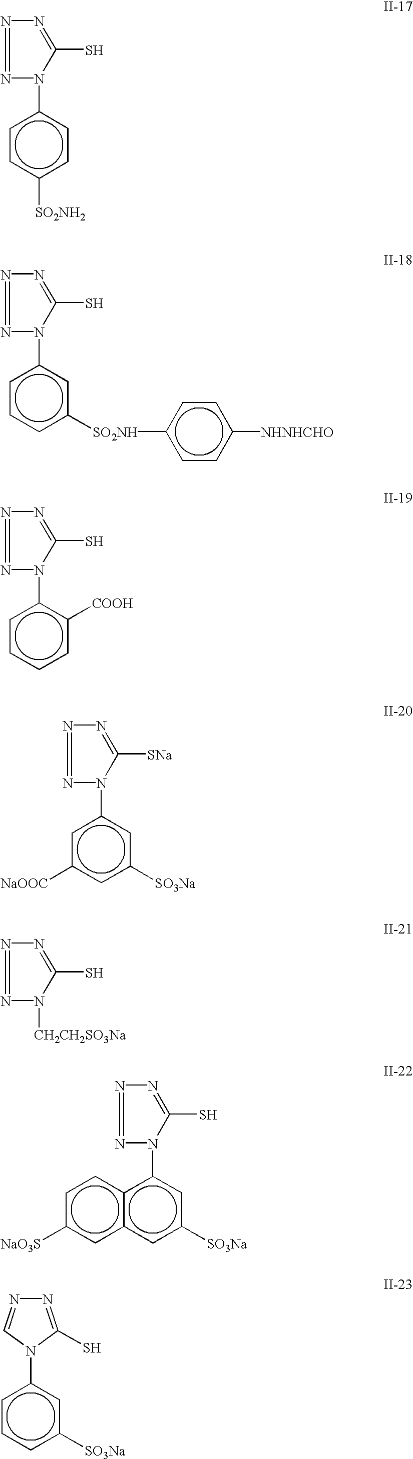

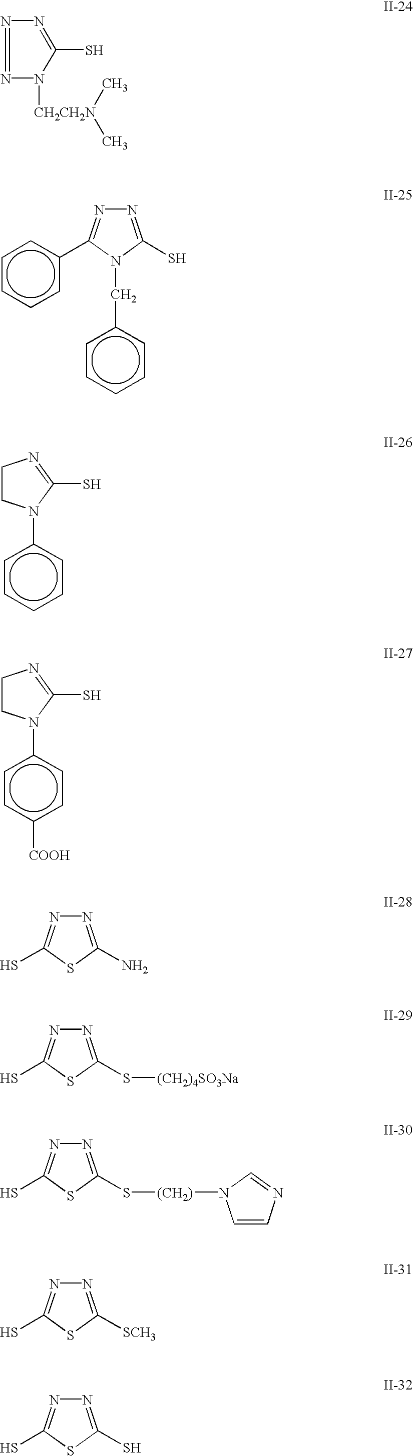

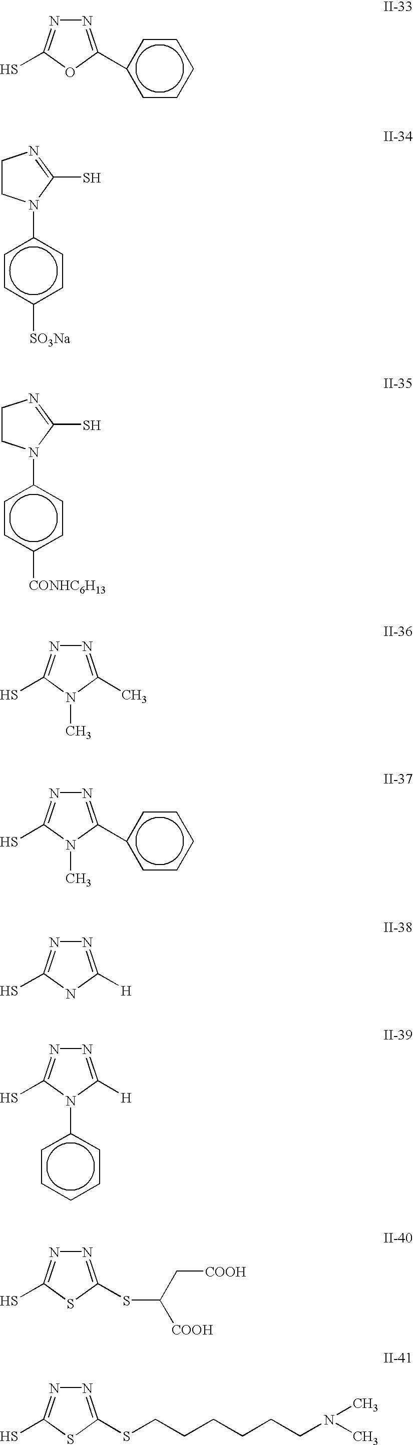

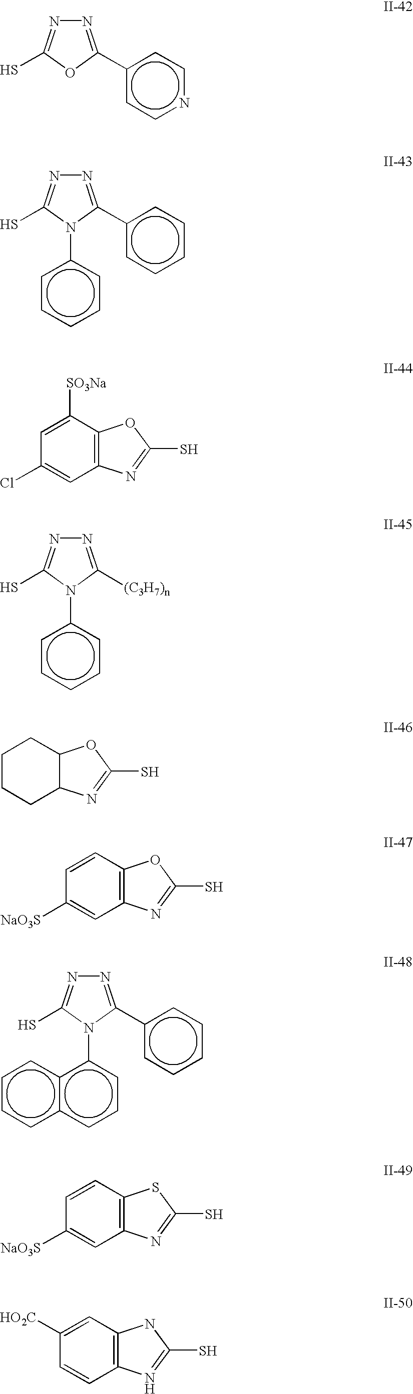

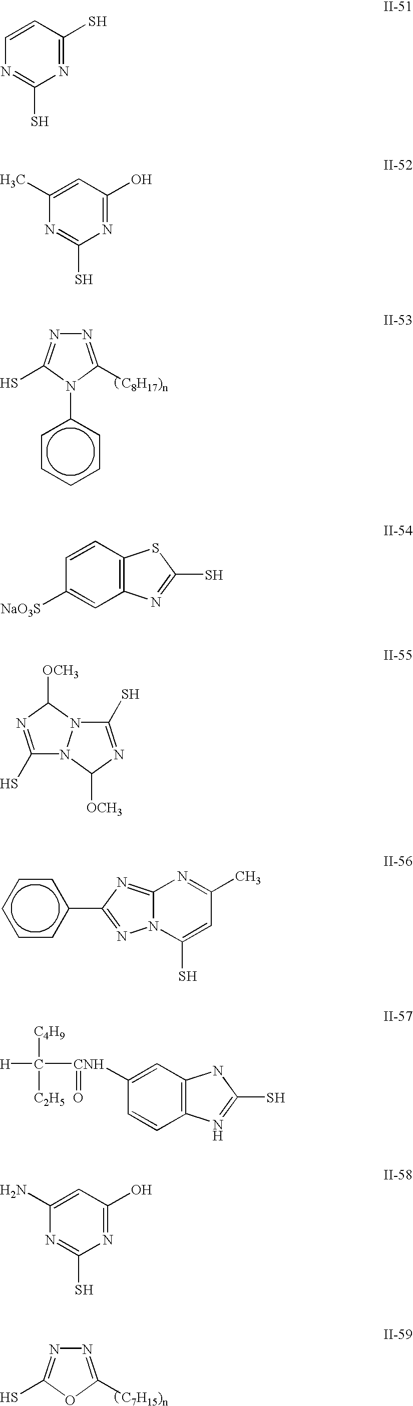

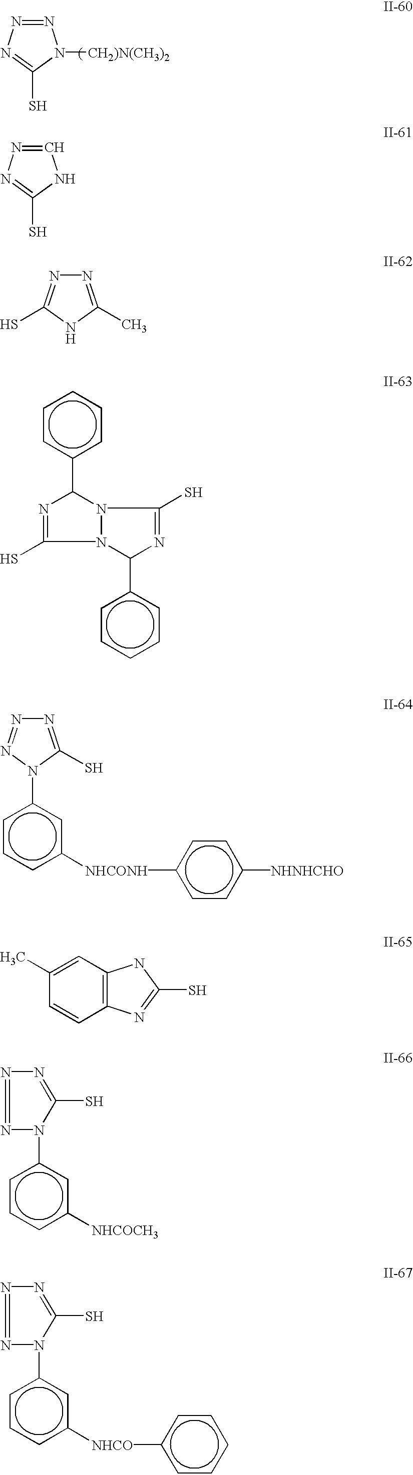

The compound of formula (II) for use in the present invention is known and can be synthesized by referring to the following publications.

The publications are U.S. Pat. Nos. 2,585,388 and 2,541,924, JP-B-42-21842, JP-A-53-50169, British Patent 1,275,701, D. A. Berges et al., Journal of Heterocyclic Chemistry, Vol. 15, No. 981 (1978), The Chemistry of Heterocyclic Chemistry, “Imidazole and Derivatives, Part I”, pp. 336-339, Chemical Abstract, 58, No. 7921, page 394 (1963), E. Hoggarth, Journal of Chemical Society, pp. 1160-1167 (1949), S. R. Saudler and W. Karo, Organic Functional Group Preparation, pp. 312-315, Academic Press (1968), M. Chamdon et al., Bulletin de la Societe Chirnigue de France, 723 (1954), D. A. Shirley and D. W. Alley, J. Amer. Chem. Soc., 79, 4922 (1954), A. Wohl and W. Marchwald, Ber., Vol. 22, page 568 (1889), J. Amer. Chem. Soc., 44, pp. 1502-1510, U.S. Pat. No. 3,017,270, British Paten 940,169, JP-B-49-8334, JP-A-55-59463, Advanced in Heterocyclic Chemistry, West German Patent 2,716,707, The Chemistry of Heterocyclic Compounds Imidazole and Derivatives, Vol. 1, page 485, Org. Synth, IV., 569 (1963), Ber., 9, 465 (1975), J. Amer. Chem. Soc., 45, 2390 (1923), JP-A-50-89034, JP-A-53-28426, JP-A-55-21007 and JP-B-40-28496.

The amount of the compound represented by formula (II) is preferably from 0.001 to 1 mol, more preferably from 0.003 to 0.1 mol, per mol of silver in the emulsion layer. The “per mol of silver” as used herein means “per mol of silver halide”.

In the heat-developable photosensitive material of the present invention, as the development accelerator other than the above-described development accelerators, a sulfonamide phenol-base compound represented by formula (A) of JP-A-2000-267222 and JP-A-2000-330234, a hindered phenol-base compound represented by formula (II) of JP-A-2001-92075, a hydrazine-base compound represented by formula (I) of JP-A-10-62895 and JP-A-11-15116, or formula (1) of Japanese Patent Application No. 2001-074278, or a phenol-base or naphthol-base compound represented by formula (2) of Japanese Patent Application No. 2000-76240 is preferably used. This development accelerator is used in the range from 0.1 to 20 mol %, preferably from 0.5 to 10 mol %, more preferably from 1 to 5 mol %, based on the reducing agent. The development accelerator may be introduced into the photosensitive material using the same methods as described above for the reducing agent but is preferably added as a solid dispersion or emulsified dispersion. In the case of addition as an emulsified dispersion, the development accelerator is preferably added as an emulsified dispersion obtained using a low boiling point auxiliary solvent and a high boiling point solvent which is a solid at an ordinary temperature, or as a so-called oil-less emulsified dispersion using no high boiling point solvent.

(Description of Hydrogen Bond-Forming Compound)

In the case where the reducing agent for use in the present invention has an aromatic hydroxyl group (—OH), particularly, in the case of a bisphenol described above, a non-reducing compound having a group capable of forming a hydrogen bond with the hydroxyl group is preferably used in combination. Examples of the group capable of forming a hydrogen bond with the hydroxyl group or amino group include a phosphoryl group, a sulfoxide group, a sulfonyl group, a carbonyl group, an amide group, an ester group, a urethane group, a ureido group, a tertiary amino group and a nitrogen-containing aromatic group. Of these, preferred are the compounds having a phosphoryl group, a sulfoxide group, an amide group (provided that it does not have a >N—H group but is blocked like >N—Ra (wherein Ra is a substituent except for H)), a urethane group (provided that it does not have a >N—H group but is blocked like >N—Ra (wherein Ra is a substituent except for H)) or a ureido group (provided that it does not have a >N—H group but is blocked like >N—Ra (wherein Ra is a substituent except for H)).

In the present invention, the hydrogen bond-forming compound is particularly preferably a compound represented by the following formula (D):

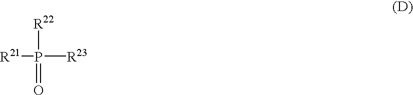

In formula (D), R²¹ to R²³ each independently represents an alkyl group, an aryl group, an alkoxy group, an aryloxy group, an amino group or a heterocyclic group, and these groups each may be unsubstituted or may have a substituent. When R²¹ to R²³ each have a substituent, examples of the substituent include a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group and a phosphoryl group. The substituent is preferably an alkyl group or an aryl group and examples thereof include a methyl group, an ethyl group, an isopropyl group, a tert-butyl group, a tert-octyl group, a phenyl group, a 4-alkoxyphenyl group and a 4-acyloxyphenyl group.

Specific examples of the alkyl group represented by R²¹ to R²³ include a methyl group, an ethyl group, a butyl group, an octyl group, a dodecyl group, an isopropyl group, a tert-butyl group, a tert-amyl group, a tert-octyl group, a cyclohexyl group, a 1-methylcyclohexyl group, a benzyl group, a phenethyl group and a 2-phenoxypropyl group. Examples of the aryl group include a phenyl group, a cresyl group, a xylyl group, a naphthyl group, a 4-tert-butylphenyl group, a 4-tert-octylphenyl group, a 4-anisidyl group and a 3,5-dichlorophenyl group. Examples of the alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group. Examples of the aryloxy group include a phenoxy group, a cresyloxy group, an isopropylphenoxy group, a 4-tert-butylphenoxy group, a naphthoxy group and a biphenyloxy group. Examples of the amino group include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

R²¹ to R²³ each is preferably an alkyl group, an aryl group, an alkoxy group or an aryloxy group. In view of the effect of the present invention, at least one of R²¹ to R²³ is preferably an alkyl group or an aryl group and more preferably, two or more thereof are an alkyl group or an aryl group. In view of the availability at a low cost, it is preferred that R²¹ to R²³ all are the same group.

Specific examples of the hydrogen bond-forming compound including the compound represented by formula (D) for use in the present invention are set forth below, however, the present invention is not limited thereto.

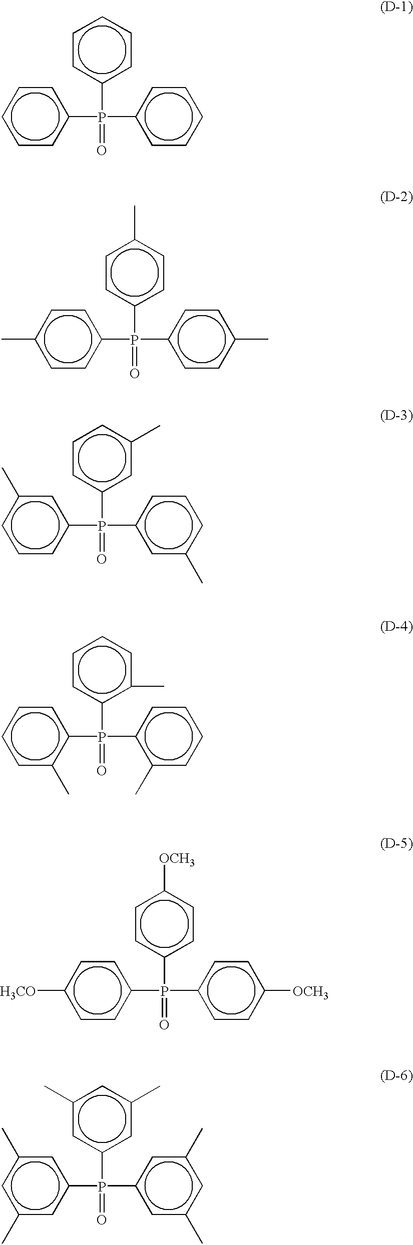

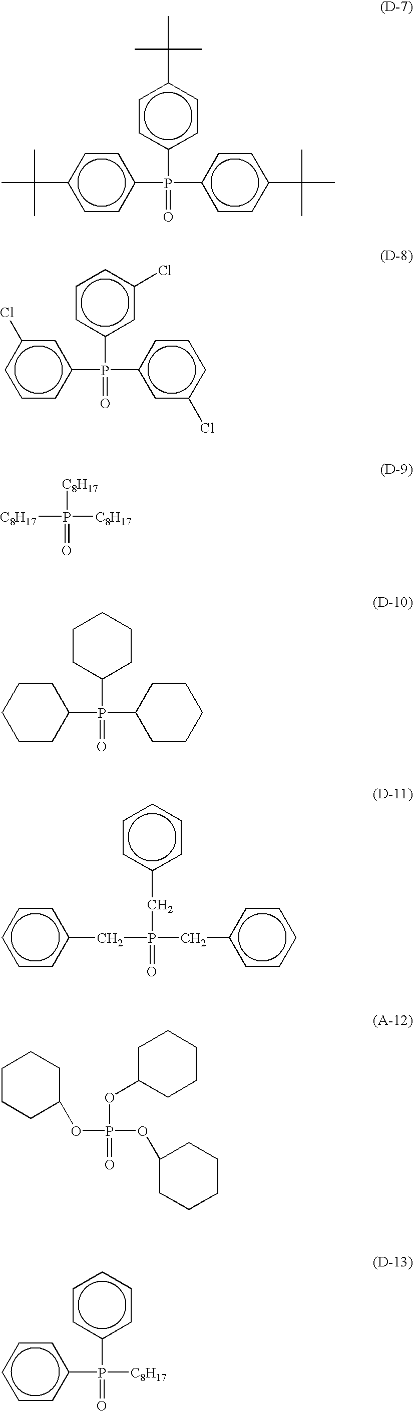

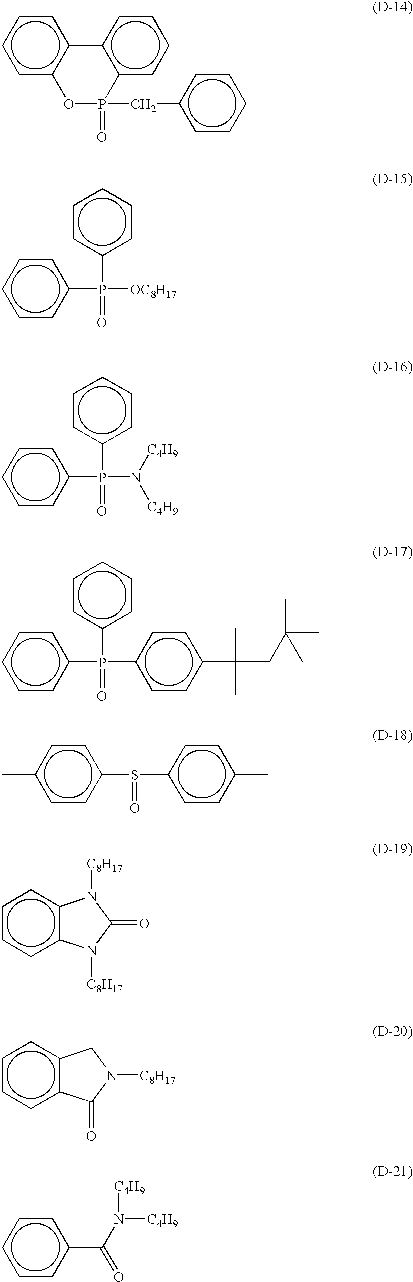

In addition to these compounds, specific examples of the hydrogen bond-forming compound include those described in European Patent No. 1096310 and Japanese Patent Application Nos. 2000-270498 and 2001-124796.

The compound represented by formula (D) for use in the present invention is added to a coating solution and thereby used in the photosensitive material and in this case, the compound can be added, similarly to the reducing agent, in the form of a solution, an emulsified dispersion or a solid fine grain dispersion. In the solution state, this compound forms a hydrogen bond-forming complex with a compound having a phenolic hydroxyl group or an amino group and depending on the combination of the reducing agent and the compound represented by formula (D) for use in the present invention, the complex can be isolated in the crystal state. Use of the thus-isolated crystal powder as a solid fine grain dispersion is particularly preferred for attaining stable performance. Also, a method of mixing the reducing agent and the compound represented by formula (D) for use in the present invention, each in the powder form, and dispersing the resulting mixture in a sand grinder mill or the like by using an appropriate dispersant, thereby forming a complex, can be preferably used.

The compound of the formula (D) for use in the present invention is preferably used in the range from 1 to 200 mol %, more preferably from 10 to 150 mol %, still more preferably from 20 to 100 mol %, based on the reducing agent.

(Preferred Solvent for Coating Solution)

In the present invention, the solvent (here, for the sake of simplicity, the solvent and the dispersion medium are collectively called a solvent) in the coating solution for the organic silver salt-containing layer of the photosensitive material is preferably an aqueous solvent containing 30 mass % or more of water. As for the component other than water, optional water-miscible organic solvents may be used, such as methyl alcohol, ethyl alcohol, isopropyl alcohol, methyl cellosolve, ethyl cellosolve, dimethylformamide and ethyl acetate. The solvent of the coating solution preferably has a water content of 50 mass % or more, more preferably 70 mass % or more. Examples of preferred solvent compositions include, in addition to water, water/methyl alcohol=90/10, water/methyl alcohol=70/30, water/methyl alcohol/dimethylformamide=80/15/5, water/methyl alcohol/ethyl cellosolve=85/10/5 and water/methyl alcohol/isopropyl alcohol=85/10/5 (the numerals are mass %).

(Description of Antifoggant)

Examples of the antifoggant, stabilizer and stabilizer precursor which can be used in the present invention include those described in JP-A-10-62899 (paragraph No. 0070) and EP-A-0803764 (page 20, line 57 to page 21, line 7), and compounds described in JP-A-9-281637, JP-A-9-329864, U.S. Pat. No. 6,083,681, and European Patent 1048975. The antifoggant preferably used in the present invention is an organic halide and examples thereof include those disclosed in the patents cited in JP-A-11-65021 (paragraph Nos. 0111 to 0112). In particular, organic halogen compounds represented by formula (P) of JP-A-2000-284399, organic polyhalogen compounds represented by formula (II) of JP-A-10-339934, and: organic polyhalogen compounds described in JP-A-2001-31644 and JP-A-2001-33911 are preferred.

(Description of Polyhalogen Compound)

The organic polyhalogen compound preferably used in the present invention is specifically described below. The polyhalogen compound preferred in the present invention is a compound represented by the following formula (H):

Q-(Y)ₙ—C(Z₁)(Z₂)X (H)

wherein Q represents an alkyl group, an aryl group or a heterocyclic group, Y represents a divalent linking group, n represents 0 or 1, Z₁ and Z₂ each represents a halogen atom and X represents a hydrogen atom or an electron-withdrawing group.

In formula (H), Q preferably represents a phenyl group substituted by an electron-withdrawing group having a Hammett's substituent constant σp of a positive value. The Hammett's substituent constant is described, for example, in Journal of Medicinal Chemistry, Vol. 16, No. 11, 1207-1216 (1973). Examples of this electron-withdrawing group include halogen atoms (e.g., fluorine (σp: 0.06), chlorine (σp: 0.23), bromine (up: 0.23), iodine (σp: 0.18)), trihalomethyl groups (e.g., tribromomethyl (σp: 0.29), trichloromethyl (σp: 0.33), trifluoromethyl (up: 0.54)), a cyano group (σp: 0.66), a nitro group (σp: 0.78), aliphatic.aryl or heterocyclic sulfonyl groups (e.g., methanesulfonyl (σp: 0.72)), aliphatic.aryl or heterocyclic acyl groups (e.g., acetyl (σp: 0.50), benzoyl (σp: 0.43)), alkynyl groups (e.g., C≡CH (σp: 0.23)), aliphatic.aryl or heterocyclic oxycarbonyl groups (e.g., methoxycarbonyl (σp: 0.45), phenoxycarbonyl (σp: 0.44)), a carbamoyl group (σp: 0.36), a sulfamoyl group (σp: 0.57), a sulfoxide group, a heterocyclic group and a phosphoryl group. The op value is preferably from 0.2 to 2.0, more preferably from 0.4 to 1.0. Among these electron-withdrawing groups, preferred are a carbamoyl group, an alkoxycarbonyl group, an alkylsulfonyl group and an alkylphosphoryl group, and most preferred is a carbamoyl group.

X is preferably an electron-withdrawing group, more preferably a halogen atom, an aliphatic.aryl or heterocyclic sulfonyl group, an aliphatic.aryl or heterocyclic acyl group, an aliphatic.aryl or heterocyclic oxycarbonyl group, a carbamoyl group or a sulfamoyl group, still more preferably a halogen atom. Among the halogen atoms, preferred are chlorine, bromine and iodine, more preferred are chlorine and bromine, and still more preferred is bromine.

Y preferably represents —C(═O)—, —SO— or —SO₂—, more preferably —C(═O)— or —SO₂—, still more preferably —SO₂—. n represents 0 or 1, preferably 1.

Specific examples of the compound represented by formula (H) for use in the present invention are set forth below.

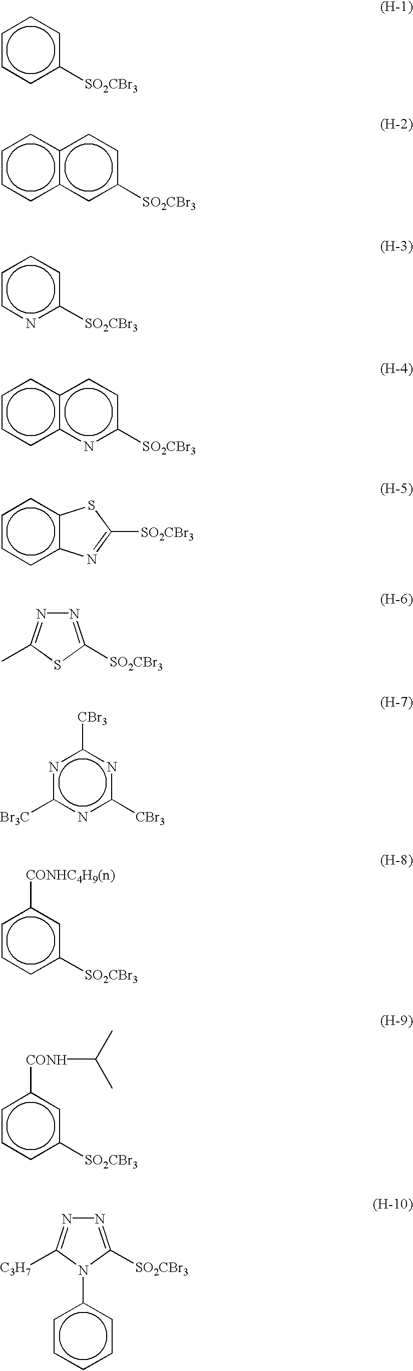

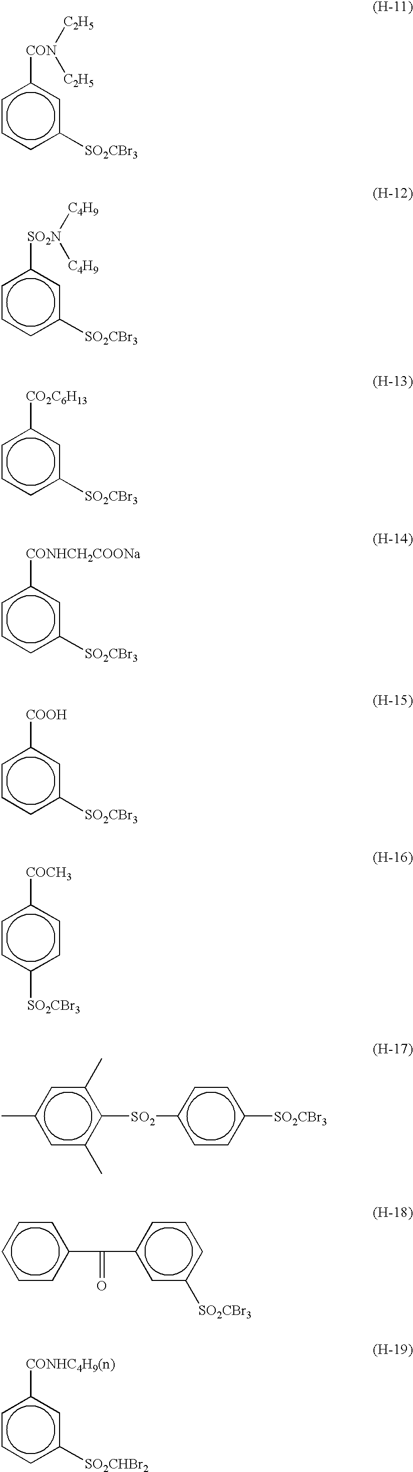

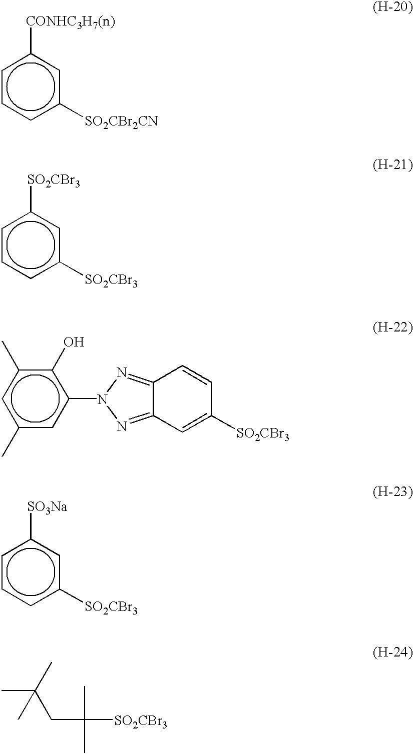

The compound represented by formula (H) is preferably used in the range from 10⁻⁴ to 1 mol, more preferably from 10⁻³ to 0.5 mol, still more preferably from 1×10⁻³ to 0.2 mol, per mol of the non-photosensitive silver salt in the image-forming layer.

In the present invention, for incorporating the antifoggant into the photosensitive material, the methods described above for the incorporation of a reducing agent may be used. The organic polyhalogen compound is also preferably added in the form of a solid fine particle dispersion.

(Other Antifoggants)

Other examples of the antifoggant include mercury(II) salts described in JP-A-11-65021 (paragraph No. 0113), benzoic acids described in the same patent publication (paragraph No. 0114), salicylic acid derivatives described in JP-A-2000-206642, formalin scavenger compounds represented by formula (S) of JP-A-2000-221634, triazine compounds according to claim 9 of JP-A-11-352624, compounds represented by formula (III) of JP-A-6-11791, and 4-hydroxy-6-methyl-1,3,3a,7-tetrazaindene.

For the purpose of preventing fogging, the heat-developable photosensitive material of the present invention may contain an azolium salt. Examples of the azolium salt include compounds represented by formula (XI) of JP-A-59-193447, compounds described in JP-B-55-12581, and compounds represented by formula (II) of JP-A-60-153039. The azolium salt may be added to any site of the photosensitive material but is preferably added to a layer on the surface having a photosensitive layer, more preferably to the organic silver salt-containing layer. The timing of adding azolium salt may be any step during the preparation of the coating solution. In the case of adding the azolium salt to the organic silver salt-containing layer, the addition may be made in any step between the preparation of the organic silver salt and the preparation of the coating solution, however, the addition is preferably made between after the preparation of the organic silver salt and immediately before the coating. The azolium salt may be added in any form such as powder, solution or fine grain dispersion. The azolium salt may also be added as a mixed solution with other additives such as sensitizing dye, reducing agent and toning agent. In the present invention, the azolium salt may be added in any amount but the amount added is preferably from 1×10⁻⁶ to 2 mol, more preferably from 1×10⁻³ to 0.5 mol, per mol of silver.

In the present invention, a mercapto compound, a disulfide compound or a thione compound may be incorporated so as to control development by preventing or accelerating the development, enhance the spectral sensitization efficiency or improve the shelf life before or after the development. Examples of these compounds include compounds described in JP-A-10-62899 (paragraph Nos. 0067 to 0069), compounds represented by formula (I) and specific examples thereof in paragraph Nos. 0033 to 0052 of JP-A-10-186572, and compounds described in EP-A-0803764 (page 20, lines 36 to 56). Among these, mercapto-substituted heteroaromatic compounds described in JP-A-9-297367, JP-A-9-304875 and JP-A-2001-100358 are preferred.

(Description of Color Toning Agent)

A color toning agent is preferably added to the heat-developable photosensitive material of the present invention. Examples of the color toning agent include those described in JP-A-10-62899 (paragraph Nos. 0054 to 0055), EP-A-0803764 (page 21, lines 23 to 48), JP-A-2000-356317 and Japanese Patent Application No. 2000-187298. Particularly preferred are phthalazinones (phthalazinone, phthalazinone derivatives, and metal salts of phthalazinone, e.g., 4-(1-naphthyl)phthalazinone, 6-chlorophthalazinone, 5,7-dimethoxyphthalazinone, 2,3-dihydro-1,4-phthalazinedione); combinations of a phthalazinone and a phthalic acid (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives, and metal salts of phthalazine, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); and combinations of a phthalazine and a phthalic acid. Among these, preferred are combinations of a phthalazine and a phthalic acid, and more preferred is a combination of 6-isopropylphthalazine and phthalic acid or 4-methylphthalic acid.

(Other Additives)

The plasticizer and lubricant which can be used in the photosensitive layer in the present invention are described in JP-A-11-65021 (paragraph No. 0117); the ultrahigh contrast-providing agent for the formation of an ultrahigh contrast image and the addition method or amount added thereof are described in JP-A-11-65021 supra (paragraph No. 0118), JP-A-11-223898 (paragraph Nos. 0136 to 0193), JP-A-2000-284399 (compounds represented by formula (H), formulae (1) to (3) and formulae (A) and (B)) and Japanese Patent Application No. 11-91652 (compounds represented by formulae (III) to (V), specific compounds: Chem. 21 to Chem. 24); and the contrast-promoting agent is described in JP-A-11-65021 (paragraph No. 0102) and JP-A-11-223898 (paragraph Nos. 0194 to 0195).

In the case of using a formic acid or a formate as a strong foggant, the formic acid or formate is preferably contained in an amount of 5 mmol or less, more preferably 1 mmol or less, per mol of silver, in the side having an image-forming layer containing a photosensitive silver halide.

In the case where an ultrahigh contrast-providing agent is used in the heat-developable photosensitive material of the present invention, an acid resulting from the hydration of diphosphorus pentoxide, or a salt thereof is preferably used in combination. Examples of the acid resulting from the hydration of diphosphorus pentoxide, and salts thereof include metaphosphoric acid (and salts thereof), pyrophosphoric acid (and salts thereof), orthophosphoric acid (and salts thereof), triphosphoric acid (and salts thereof), tetraphosphoric acid (and salts thereof), and hexametaphosphoric acid (and salts thereof). Among these, particularly preferred are orthophosphoric acid (and salts thereof) and hexametaphosphoric acid (and salts thereof). specific examples of the salts include sodium orthophosphate, sodium dihydrogenorthophosphate, sodium hexametaphosphate and ammonium hexametaphosphate.

The amount used (coated amount per m² of the photosensitive material) of the acid resulting from the hydration of diphosphorus pentoxide, or a salt thereof may be a desired amount in accordance with the properties such as sensitivity and fog, but is preferably from 0.1 to 500 mg/m², more preferably from 0.5 to 100 mg/m².

(Description of Layer Structure)

In the heat-developable photosensitive material of the present invention, a surface protective layer may be provided so as to prevent the adhesion of the image-forming layer. The surface protective layer may be a single layer or composed of a plurality of layers. The surface protective layer is described in JP-A-11-65021 (paragraph Nos. 0119 to 0120) and Japanese Patent Application No. 2000-171936.

In the present invention, the binder for the surface protective layer is preferably gelatin but polyvinyl alcohol (PVA) is also preferably used or used in combination with gelatin. Examples of the gelatin which can be used include inert gelatin (e.g., “Nitta Gelatin 750”) and phthalated gelatin (e.g., “Nitta Gelatin 801”). Examples of PVA include those described in JP-A-2000-171936 (paragraph Nos. 0009 to 0020) and preferred examples thereof include completely saponified product “PVA-105”, partially saponified product “PVA-205” and “PVA-335”, and modified polyvinyl alcohol “MP-203” (trade names, produced by Kuraray Co., Ltd.). The coated amount (per m² of the support) of polyvinyl alcohol of the protective layer (per one layer) is preferably from 0.3 to 4.0 g/m², more preferably from 0.3 to 2.0 g/m².

Particularly when the heat-developable photosensitive material of the present invention is used for printing where the dimensional change becomes a problem, a polymer latex is preferably used for the surface protective layer or the back layer. The polymer latex for this use is described in Taira Okuda and Hiroshi Inagaki (compilers), Gosei Jushi Emulsion (Synthetic Resin Emulsion), Kobunshi Kankokai (1978), Takaaki Sugimura, Yasuo Kataoka, Soichi Suzuki and Keishi Kasahara (compilers), Gosei Latex no Oyo (Application of Synthetic Latex), Kobunshi Kankokai (1993), and Soichi Muroi, Gosei Latex no Kagaku (Chemistry of synthetic Latex), Kobunshi Kankokai (1970). Specific examples of the polymer latex include a latex of methyl methacrylate (33.5 mass %)/ethyl acrylate (50 mass %)/methacrylic acid (16.5 mass %) copolymer, a latex of methyl methacrylate (47.5 mass %)/butadiene (47.5 mass %)/itaconic acid (5 mass %) copolymer, a latex of ethyl acrylate (50 mass %)/methacrylic acid (50 mass %) copolymer, a latex of methyl methacrylate (58.9 mass %)/2-ethylhexyl acrylate (25.4 mass %))/styrene (8.6 mass %)/2-hydroxyethyl methacrylate (5.1 mass %)/acrylic acid (2.0 mass %) copolymer and a latex of methyl methacrylate (64.0 mass %)/styrene (9.0 mass %)/butyl acrylate (20.0 mass %)/2-hydroxyethyl methacrylate (5.0 mass %)/acrylic acid (2.0 mass %) copolymer. For the binder of the surface protective layer, a combination of polymer latexes described in Japanese Patent Application No. 11-6872, and techniques described in JP-A-2000-267226 (paragraph Nos. 0021 to 0025), Japanese Patent Application No. 11-6872 (paragraph Nos. 0027 to 0028) and JP-A-2000-19678 (paragraph Nos. 0023 to 0041) may also be applied. The percentage of the polymer latex in the surface protective layer is preferably from 10 to 90 mass %, more preferably from 20 to 80 mass %, based on the entire binder.

The coated amount (per m² of the support) of the entire binder (including water-soluble polymer and latex polymer) for the surface protective layer (per one layer) is preferably from 0.3 to 5.0 g/m², more preferably from 0.3 to 2.0 g/m².

In the present invention, the temperature at the preparation of a coating solution for the image-forming layer is preferably from 30 to 65° C., more preferably from 35 to less than 60° C., still more preferably from 35 to 55° C. Furthermore, the coating solution for the image-forming layer immediately after the addition of the polymer latex is preferably kept at a temperature of 30 to 65° C.

In the present invention, the image-forming layer is composed of one or more layer(s) on the support. In the case where the image-forming layer is composed of a single layer, the layer comprises an organic silver salt, a photosensitive silver halide, a reducing agent and a binder and if desired, additionally contains desired materials such as a color toning agent, a coating aid and other adjuvants. In the case where the image-forming layer is composed of two or more layers, a first image-forming layer (usually a layer adjacent to the support) contains an organic silver salt and a photosensitive silver halide, and a second image-forming layer or these two layers contain some other components. In the structure of a multicolor photosensitive heat-developable photographic material, a combination of these two layers may be provided for each color or as described in U.S. Pat. No. 4,708,928, all the components may be contained in a single layer. In the case of a multi-dye multicolor photosensitive heat-developable photographic material, the emulsion layers are held separately from each other by interposing a functional or nonfunctional barrier layer between respective photosensitive layers, as described in U.S. Pat. No. 4,460,681.

In the present invention, the photosensitive layer may contain various dyes or pigments (for example, C.I. Pigment Blue 60, C.I. Pigment Blue 64, C.I. Pigment Blue 15:6) from the standpoint of improving the tone, inhibiting the generation of interference fringes on laser exposure or preventing the irradiation. These are described in detail in WO98/36322, JP-A-10-268465 and JP-A-11-338098.

In the heat-developable photosensitive material of the present invention, an antihalation layer can be provided in the side farther from a light source with respect to the photosensitive layer.

The heat-developable photosensitive material generally has a non-photosensitive layer in addition to the photosensitive layer. The non-photosensitive layer can be classified by its position, into (1) a protective layer provided on a photosensitive layer (in the side farther from the support), (2) an interlayer provided between a plurality of photosensitive layers or between a photosensitive layer and a protective layer, (3) an undercoat layer provided between a photosensitive layer and a support, and (4) a back layer provided in the side opposite the photosensitive layer. In the photosensitive material, a filter layer is provided as the layer (1) or (2) and an antihalation layer is provided as the layer (3) or (4).

The antihalation layer is described in JP-A-11-65021 (paragraph Nos. 0123 to 0124), JP-A-11-223898, JP-A-9-230531, JP-A-10-36695, JP-A-10-104779, JP-A-11-231457, JP-A-11-352625 and JP-A-11-352626.

The antihalation layer contains an antihalation dye having absorption at the exposure wavelength. In the case where the exposure wavelength is present in the infrared region, an infrared ray-absorbing dye is used and in this case, the dye preferably has no absorption in the visible region.

In the case of preventing the halation using a dye having absorption in the visible region, it is preferred to allow substantially no color of the dye to remain after the formation of an image. For this purpose, means capable of decolorizing under the action of heat at the heat-development is preferably used. In particular, the non-photosensitive layer is preferably rendered to function as an antihalation layer by adding thereto a thermally decolorizable dye and a base precursor. JP-A-11-231457 describes these techniques.

The amount of the decolorizable dye is determined according to the use purpose of the dye. In general, the decolorizable dye is used in an amount of giving an optical density (absorbance) in excess of 0.1 when measured at the objective wavelength. The optical density is preferably from 0.15 to 2, more preferably 0.2 to 1. For attaining such an optical density, the amount of the dye used is generally on the order of 0.001 to 1 g/m².

By such decolorization of a dye, the optical density after heat development can be reduced to 0.1 or less. Two or more decolorizable dyes may be used in combination in the thermally decolorizable recording material or heat-developable photosensitive material. Also, two or more base precursors may be used in combination.

In the thermal decolorization using these decolorizable dye and base precursor, for example, a substance (e.g., diphenylsulfone, 4-chlorophenyl(phenyl)sulfone) capable of lowering the melting point by 3° C. or more when mixed with the base precursor, described in JP-A-11-352626, or 2-naphthylbenzoate is preferably used in combination in view of the thermal decolorizability and the like.

In the present invention, a coloring agent having an absorption maximum at 300 to 450 nm can be added for the purpose of improving silver tone or change of image in aging. Examples of such a coloring agent include those described in JP-A-62-210458, JP-A-63-104046, JP-A-63-103235, JP-A-63-208846, JP-A-63-306436, JP-A-63-314535, JP-A-01-61745 and JP-A-2001-100363.

This coloring agent is usually added in the range from 0.1 mg/m² to 1 g/m² and the layer to which the coloring agent is added is preferably a back layer provided in the side opposite the photosensitive layer.

The heat-developable photosensitive material of the present invention is preferably a so-called one-side photosensitive material having at least one photosensitive layer containing a silver halide emulsion in one side of the support and having a back layer in the other side.

(Description of Matting Agent)

In the present invention, a matting agent is preferably added for improving the conveyance property. Examples of the matting agent include those described in JP-A-11-65021 (paragraph Nos. 0126 to 0127). The amount of the matting agent added is, in terms of the coated amount per m² of the photosensitive material, preferably from 1 to 400 mg/m², more preferably from 5 to 300 mg/m².

The matting agent may have either a fixed form or an amorphous form but preferably has a fixed form and is preferably spherical. The average particle size of the matting agent is preferably from 0.5 to 10 μm, more preferably from 1.0 to 8.0 μm, still more preferably from 2.0 to 6.0 μm. The coefficient of variation in the size distribution is preferably 50% or less, more preferably 40% or less, still more preferably 30% or less. The term “coefficient of variation” as used herein means a value expressed by (standard deviation of particle size)/(average particle size)×100. It is also preferred to use two matting agents having a small coefficient of variation and different in the average particle size by a ratio of 3 or more.

The matting degree on the emulsion surface may be any value insofar as a so-called stardust failure such as small white spot on the image area and light leakage does not occur but is preferably, in terms of the Beck smoothness, from 30 to 2,000 seconds, more preferably from 40 to 1,500 seconds. The Beck smoothness can be easily determined according to Japanese Industrial Standard (JIS) P8119, “Test Method for Smoothness of Paper and Paperboard by Beck Tester” and TAPPI Standard Method T479.

As for the matting degree of the back layer for use in the present invention, the Beck smoothness is preferably from 10 to 1,200 seconds, more preferably from 20 to 800 seconds, still more preferably from 40 to 500 seconds.

In the present invention, the matting agent is preferably incorporated into the outermost surface layer, a layer acting as the outermost surface layer, or a layer close to the outer surface, of the photosensitive material, or is preferably incorporated into a layer acting as a protective layer.

The back layer which can be applied to the present invention is described in JP-A-11-65021 (paragraph Nos. 0128 to 0130).

In the present invention, the pH on the layer surface of the heat-developable photosensitive layer before heat-development is preferably 7.0 or less, more preferably 6.6 or less. The lower limit thereof is not particularly limited but is about 3. The most preferred pH range is from 4 to 6.2. For adjusting the pH on the layer surface, a nonvolatile acid such as organic acid (e.g., phthalic acid derivative) or sulfuric acid, or a volatile base such as ammonia is preferably used from the standpoint of reducing the pH on the layer surface. In particular, ammonia is preferred for achieving a low layer surface pH, because ammonia is readily volatilized and can be removed before the coating step or the heat development.

Furthermore, a combined use of ammonia with a nonvolatile base such as sodium hydroxide, potassium hydroxide or lithium hydroxide is also preferred. The method of measuring the pH on the layer surface is described in JP-A-2000-284399 (paragraph No. 0123).

In the present invention, a hardening agent may be used for each of the layers such as photosensitive layer, protective layer and back layer. Preferred examples of the hardening agent include those described in T. H. James, The Theory of the Photographic Process, Fourth Edition, pp. 77-87, Macmillan Publishing Co., Inc. (1977), chrome alum, 2,4-dichloro-6-hydroxy-s-triazine sodium salt, N,N-ethylenebis(vinylsulfonacetamide), N,N-propylenebis(vinylsulfonacetamide), polyvalent metal ion described in ibid., page 78, polyisocyanates described in U.S. Pat. No. 4,281,060 and JP-A-6-208193, epoxy compounds described in U.S. Pat. No. 4,791,042, and vinyl sulfone-base compounds described in JP-A-62-89048.

The hardening agent is added as a solution. The timing of adding this solution to the coating solution for protective layer is from 180 minutes before coating to immediately before coating, preferably from 60 minutes to 10 seconds before coating. The mixing method and conditions for the mixing are not particularly limited insofar as the effect of the present invention is satisfactorily brought out. Specific examples of the mixing method include a method of mixing the solutions in a tank designed to give a desired average residence time which is calculated from the addition flow rate and the liquid transfer amount to the coater, and a method using a static mixer described in N. Harnby, M. F. Edwards and A. W. Nienow (translated by Koji Takahashi), Ekitai Kongo Gijutsu (Liquid Mixing Technique), Chap. 8, Nikkan Kogyo Shinbun Sha (1989).

The surfactant which can be applied to the present invention is described in JP-A-11-65021 (paragraph No. 132), the solvent is described in paragraph No. 0133 of the same, the support is described in paragraph No. 0134 of the same, the antistatic or electrically conducting layer is described in paragraph No. 0135 of the same, the method for obtaining a color image is described in paragraph No. 0136 of the same, and the slipping agent is described in JP-A-11-84573 (paragraph Nos. 0061 to 0064) and Japanese Patent Application No. 11-106881 (paragraph Nos. 0049 to 0062).

In the present invention, the photosensitive material preferably has an electrically conducting layer containing a metal oxide. The electrically conducting material for the electrically conducting layer is preferably a metal oxide increased in the electrical conductivity by introducing an oxygen defect or a different metal atom into the metal oxide. Preferred examples of the metal oxide include ZnO, TiO₂ and SnO₂. It is preferred to add Al or In to ZnO₂, add Sb, Nb, P or a halogen element to SnO₂, and add Nb or Ta to TiO₂. In particular, SnO₂ having added thereto Sb is preferred. The amount of the different metal atom added is preferably from 0.01 to 30 mol %, more preferably from 0.1 to 10 mol %. The shape of the metal oxide may be any one of spherical form, needle-like form and plate-like form but in view of the effect of imparting electrical conductivity, a needle-like particle having a long axis/short axis ratio of 2.0 or more, preferably from 3.0 to 50 is preferred. The amount of the metal oxide used is preferably from 1 to 1,000 mg/m², more preferably from 10 to 500 mg/m², still more preferably from 20 to 200 mg/m² In the present invention, the electrically conducting layer may be provided either in the emulsion surface side or in the back surface side but is preferably provided between a support and a back layer. Specific examples of the electrically conducting layer for use in the present invention include those described in JP-A-7-295146 and JP-A-11-223901.

In the present invention, a fluorine-containing surfactant is preferably used. Specific examples of the fluorine-containing surfactant include compounds described in JP-A-10-197985, JP-A-2000-19680 and JP-A-2000-214554. Also, a high-molecular fluorine-containing surfactant described in JP-A-9-281636 is preferably used. In the present invention, a fluorine-containing surfactant described in Japanese Patent Application No. 2000-206560 is particularly preferred.

The support for use in the heat-developable photosensitive material of the present invention is preferably a transparent support. The transparent support is preferably polyester, particularly polyethylene terephthalate, subjected to a heat treatment in the temperature range from 130 to 185° C. so as to relax the internal distortion remaining in the film at the biaxial stretching and thereby eliminate the occurrence of thermal shrinkage distortion during the heat development. In the case of a heat-developable photosensitive material for medical uses, the transparent support may be colored with a bluish dye (for example, Dye-1 described in Example of JP-A-8-240877) or may be colorless. For the support, an undercoat technique of undercoating, for example, a water soluble polyester described in JP-A-11-84574, a styrene butadiene copolymer described in JP-A-10-186565, or a vinylidene chloride copolymer described in JP-A-2000-39684 and Japanese Patent Application No. 11-106881 (paragraph Nos. 0063 to 0080) is preferably applied. As for the antistatic layer or undercoat, techniques described in JP-A-56-143430, JP-A-56-143431, JP-A-58-62646, JP-A-56-120519, JP-A-11-84573 (paragraph Nos. 0040 to 0051), U.S. Pat. No. 5,575,957 and JP-A-11-223898 (paragraph Nos. 0078 to 0084) can be applied.

The heat-developable photosensitive material is preferably a mono-sheet type (a type where an image can be formed on the heat-developable photosensitive material without using another sheet such as image-receiving material).

The heat-developable photosensitive material may further contain an antioxidant, a stabilizer, a plasticizer, an ultraviolet absorbent and a coating aid. These various additives are added to either a photosensitive layer or a non-photosensitive layer. These additives are described in WO98/36322, EP-A-803764, JP-A-10-186567 and JP-A-10-18568.

The heat-developable photosensitive material of the present invention may be coated in any manner. To speak specifically, various coating operations including extrusion coating, slide coating, curtain coating, dip coating, knife coating, flow coating, and extrusion coating using a hopper of the type described in U.S. Pat. No. 2,681,294 may be used. The extrusion coating or slide coating described in Stephen F. Kistler and Petert M. Schweizer, LIQUID FILM COATING, pp. 399-536, CHAPMAN & HALL (1977) is preferred. In particular, the slide coating is more preferred. An example of the shape of the slide coater used in the slide coating is shown in FIG. 11b.1 of ibid., page 427. If desired, two or more layers may be simultaneously coated using a method described in ibid., pp. 399-536, U.S. Pat. No. 2,761,791 and British Patent No. 837,095.

The coating solution for the organic silver salt-containing layer used in the present invention is preferably a so-called thixotropy fluid. This technique is described in JP-A-11-52509. The coating solution for the organic silver salt-containing layer used in the present invention preferably has a viscosity of 400 to 100,000 mPa·s, more preferably from 500 to 20,000 mPa·s, at a shear rate of 0.1 S⁻¹. At a shear rate of 1,000 S⁻¹, the viscosity is preferably from 1 to 200 mPa·s, more preferably from 5 to 80 mPa·s.

Examples of the technique which can be used in the heat-developable photosensitive material of the present invention include those described in EP-A-803764, EP-A-883022, WO98/36322, JP-A-56-62648, JP-A-58-62644, JP-A-9-43766, JP-A-9-281637, JP-A-9-297367, JP-A-9-304869, JP-A-9-311405, JP-A-9-329865, JP-A-10-10669, JP-A-10-62899, JP-A-10-69023, JP-A-10-186568, JP-A-10-90823, JP-A-10-171063, JP-A-10-186565, JP-A-10-186567, JP-A-10-186569 to JP-A-10-186572, JP-A-10-197974, JP-A-10-197982, JP-A-10-197983, JP-A-10-197985 to JP-A-10-197987, JP-A-10-207001, JP-A-10-207004, JP-A-10-221807, JP-A-10-282601, JP-A-10-288823, JP-A-10-288824, JP-A-10-307365, JP-A-10-312038, JP-A-10-339934, JP-A-11-7100, JP-A-11-15105, JP-A-11-24200, JP-A-11-24201, JP-A-11-30832, JP-A-11-84574, JP-A-11-65021, JP-A-11-109547, JP-A-11-125880, JP-A-11-129629, JP-A-11-133536 to JP-A-11-133539, JP-A-11-133542, JP-A-11-133543, JP-A-11-223898, JP-A-11-352627, JP-A-11-305377, JP-A-11-305378, JP-A-11-305384, JP-A-11-305380, JP-A-11-316435, JP-A-11-327076, JP-A-11-338096, JP-A-11-338098, JP-A-11-338099, JP-A-11-343420 and Japanese Patent Application No. 2000-187298, JP-A-2001-200414, JP-A-2001-234601, Japanese Patent Application Nos. 2000-206642, 2000-98530 and 2000-98531, JP-A-2000-313204, Japanese Patent Application No. 2000-112060, JP-A-2000-324888, Japanese Patent Application No. 2000-112064 and 2000-171936.

(Description of Packaging Material)

The photosensitive material of the present invention is preferably wrapped with a packaging material having a low oxygen permeability and/or water permeability so as to suppress fluctuation in the photographic performance during stock storage or improve the curl or curling habit. The oxygen permeability at 25° C. is preferably 50 ml/atm·m²·day or less, more preferably 10 ml/atm·m²·day or less, still more preferably 1.0 ml/atm·m²·day or less. The water permeability is preferably 10 g/atm·m²·day or less, more preferably 5 g/atm·m²·day or less, still more preferably 1 g/atm·m²·day or less.

Specific examples of the packaging material having a low oxygen permeability and/or a low water permeability include packaging materials described in JP-A-8-254793 and JP-A-2000-206653.

(Description of Heat Development)

The heat-developable photosensitive material of the present invention may be developed by any method but the development is usually performed by raising the temperature of an imagewise exposed heat-developable photosensitive material. The development temperature is preferably from 80 to 250° C., more preferably from 100 to 140° C., still more preferably from 110 to 130° C. The development time is preferably from 1 to 60 seconds, more preferably from 3 to 30 seconds, still more preferably from 5 to 25 seconds, particularly preferably from 7 to 15 seconds.

The heat development system may be either a drum-type heater or a plate-type heater but the plate heater system is preferred. The heat development system using the plate heater is preferably a system described in JP-A-11-133572, which is a heat developing apparatus of obtaining a visible image by bringing a heat-developable photosensitive material having formed thereon a latent image into contact with heating means in the heat-developing section, wherein the heating means comprises a plate heater, a plurality of press rollers are disposed to face each other along one surface of the plate heater, and the heat-developable photosensitive material is passed between the press rollers and the plate heater, thereby performing the heat-development. The plate heater is preferably divided into 2 to 6 stages and the temperature at the leading end is preferably lowered by approximately from 1 to 10° C. For example, four plate heaters capable of independently controlling the temperature are used and these heaters are controlled to 112° C., 119° C., 121° C. and 120° C., respectively. Such a method is described also in JP-A-54-30032, where the water content or organic solvent contained in the heat-developable photosensitive material can be excluded out of the system and also, the heat-developable photosensitive material can be prevented from change in the shape of the support, which is otherwise caused by abrupt heating of the heat-developable photosensitive material.

The heat-developable photosensitive material of the present invention may be exposed by any method but the exposure light source is preferably laser light. The laser light for use in the present invention is preferably a gas laser (e.g., Ar⁺, He−Ne), a YAG laser, a dye laser or a semiconductor laser. Also, a semiconductor laser combined with a second harmonic generating device may be used. A gas or semiconductor laser capable of emitting light from red to infrared is preferred.

Examples of the medical-use laser imager equipped with an exposure section and a heat-development section include Fuji Medical Dry Laser Imager “FM-DP L”. The MF-DP L is described in Fuji Medical Review, No. 8, pp. 39-55 and, needless to say, the technique described therein can be applied as a laser imager for the heat-developable photosensitive material of the present invention. Furthermore, the heat-developable photosensitive material of the present invention can be used as a heat-developable photosensitive material for a laser imager in the “AD network” proposed from Fuji Medical System as a network system adaptable for the DICOM standard.

The heat-developable photosensitive material of the present invention forms a black-and-white image by the silver image and is preferably used as a heat-developable photosensitive material for medical diagnosis, industrial photography, printing or COM.

The present invention is described in greater detail below by referring to Examples, however, it should understood that the present invention is not limited thereto.

### EXAMPLE 1

(Preparation of PET Support)

PET having an intrinsic viscosity IV of 0.66 (measured at 25° C. in phenol/tetrachloroethane=6/4 (by weight)) was obtained in a usual manner using terephthalic acid and ethylene glycol. The resulting PET was pelletized and the pellets obtained were dried at 130° C. for 4 hours, melted at 300° C., extruded from a T-die and then quenched to prepare an unstretched film having a thickness large enough to give a thickness of 175 μm after the heat setting.

This film was stretched to 3.3 times in the machine direction using rolls different in the peripheral speed and then stretched to 4.5 times in the cross direction by a tenter. At this time, the temperatures were 110° C. and 130° C., respectively. Subsequently, the film was heat set at 240° C. for 20 seconds and relaxed by 4% in the cross direction at the same temperature. Thereafter, the chuck part of the tenter was slit, both edges of the film were knurled, and the film was taken up at 4 kg/cm² to obtain a roll having a thickness of 175 μm.

(Surface Corona Treatment)

Both surfaces of the support were treated at room temperature at 20 m/min using a solid state corona treating machine “Model 6 KVA” (manufactured by Pillar Technologies). From the current and voltage read at this time, it was known that a treatment of 0.375 kV·A·min/m² was applied to the support. The treatment frequency here was 9.6 kHz and the gap clearance between the electrode and the dielectric roll was 1.6 mm.

(Preparation of Undercoated Support)

(1) Preparation of Coating Solution for Undercoat Layer
Formulation (1) (for undercoat layer in the photosensitive
layer side):

| “PESRESIN A-520” (30 mass % solution) | 59 | g |
|---|---|---|
| produced by Takamatsu Yushi K.K. | | |
| Polyethylene glycol monononylphenyl ether | 5.4 | g |
| (average ethylene oxide number: 8.5), 10 | | |
| mass % solution | | |
| “MP-1000” (fine polymer particles, average | 0.91 | g |
| particle size: 0.4 μm) produced by Soken | | |
| Kagaku K.K. | | |
| Distilled water | 935 | ml |
| Formulation (2) (for first layer on the back surface): | | |
| Styrene/butadiene copolymer latex (solid | 158 | g |
| content: 40 mass %, styrene/butadiene | | |
| weight ratio: 68/32) | | |
| 2,4-Dichloro-6-hydroxy-S-triazine sodium | 20 | g |
| salt, 8 mass % aqueous solution | | |
| 1 Mass % aqueous solution of sodium | 10 | ml |
| laurylbenzenesulfonate | | |
| Distilled water | 854 | ml |
| Formulation (3) (for second layer on the back surface): | | |
| SnO₂/SbO (9/1 by mass, average particle | 84 | g |
| size: 0.038 μm, 17 mass % dispersion) | | |
| Gelatin (10 mass % aqueous solution) | 89.2 | g |
| “METROSE TC-5” (2 mass % aqueous solution) | 8.6 | g |
| produced by Shin-Etsu Chemical Co., Ltd. | | |
| “MP-1000” produced by Soken Kagaku K.K. | 0.01 | g |
| 1 Mass % aqueous solution of sodium | 10 | ml |
| dodecylbenzenesulfonate | | |
| NaOH (1 mass %) | 6 | ml |
| “PROXEL” (produced by ICI) | 1 | ml |
| Distilled water | 805 | ml |

Both surfaces of the 175 μm-thick biaxially stretched polyethylene terephthalate support obtained above each was subjected to the above-described corona discharge treatment and on one surface (photosensitive layer surface), the undercoating solution of formulation (1) was applied by a wire bar to have a wet coated amount of 6.6 ml/m² (per one surface) and dried at 180° C. for 5 minutes. Thereafter, on the opposite surface thereof (back surface), the undercoating solution of formulation (2) was applied by a wire bar to have a wet coated amount of 5.7 ml/m² and dried at 180° C. for 5 minutes. On the opposite surface (back surface), the undercoating solution of formulation (3) was further applied by a wire bar to have a wet coated amount of 7.7 ml/m² and dried at 180° C. for 6 minutes, thereby obtaining an undercoated support.

(Preparation of Coating Solution for Back Surface)

(Preparation of Solid Fine Particle Dispersion (a) of Base Precursor)

Base Precursor Compound 1 (64 g), 28 g of diphenylsulfone and 10 g of surfactant “Demol N” (produced by Kao Corporation) were mixed with 220 ml of distilled water and the mixed solution was dispersed using beads in a sand mill (¼ Gallon Sand Grinder Mill, manufactured by AIMEX K. K.) to obtain Solid Fine Particle Dispersion (a) of Base Precursor Compound, having an average particle size of 0.2 μm.

(Preparation of Solid Fine Particle Dispersion of Dye)

Cyanine Dye Compound 1 (9.6 g) and 5.8 g of sodium p-dodecylbenzenesulfonate were mixed with 305 ml of distilled water and the mixed solution was dispersed using beads in a sand mill (¼ Gallon Sand Grinder Mill, manufactured by AIMEX K. K.) to obtain a solid fine particle dispersion of dye, having an average particle size of 0.2 μm.

(Preparation of Coating Solution for Antihalation Layer)

Gelatin (17 g), 9.6 g of polyacrylamide, 56 g of Solid Fine Particle Dispersion (a) of Base Precursor obtained above, 50 g of the solid fine particle dispersion of dye obtained above, 1.5 g of monodisperse polymethyl methacrylate fine particles (average particle size: 8 μm, standard deviation of particle size: 0.4), 0.03 g of benzoisothiazolinone, 2.2 g of sodium polyethylenesulfonate, 0.1 g of Blue Dye Compound 1, 0.1 g of Yellow Dye Compound 1 and 844 ml of water were mixed to prepare a coating solution for antihalation layer.

(Preparation of Coating Solution for Protective Layer on Back Surface)

In a container kept at 40° C., 50 g of gelatin, 0.2 g of sodium polystyrenesulfonate, 2.4 g of N,N-ethylene-bis(vinylsulfonacetamide), 1 g of sodium tert-octylphenoxyethoxyethanesulfonate, 30 mg of benzoisothiazolinone, 37 mg of Fluorine-Containing Surfactant (F-1) (N-perfluorooctylsulfonyl-N-propylalanine potassium salt), 150 mg of Fluorine-Containing Surfactant (F-2) (polyethylene glycol mono(N-perfluorooctylsulfonyl-N-propyl-2-aminoethyl) ether [ethylene oxide average polymerization degree: 15]), 64 mg of Fluorine-Containing Surfactant (F-3), 32 mg of Fluorine-Containing Surfactant (F-4), 8.8 g of an acrylic acid/ethyl acrylate copolymer (copolymerization weight ratio: 5/95), 0.6 g of “Aerosol OT” (produced by American Cyanamide), 1.8 g of liquid paraffin emulsion as liquid paraffin and 950 ml of water were mixed to prepare a coating solution for protective layer on the back surface.

(Preparation of Silver Halide Emulsion)

<Preparation of Silver Halide Emulsion 1>

A solution was prepared by adding 3.1 ml of a 1 mass % potassium bromide solution, 3.5 ml of sulfuric acid in a concentration of 0.5 mol/L and 31.7 g of phthalated gelatin to 1,421 ml of distilled water and while stirring the solution in a stainless steel-made reaction pot and thereby keeping the liquid temperature at 30° C., the entire amount of Solution A prepared by diluting 22.22 g of silver nitrate with distilled water to a volume of 95.4 ml and the entire amount of Solution B prepared by diluting 15.3 g of potassium bromide and 0.8 g of potassium iodide with distilled water to a volume of 97.4 ml were added at a constant flow rate over 45 seconds. Thereto, 10 ml of an aqueous 3.5 mass % hydrogen peroxide solution was added and then, 10.8 ml of a 10 mass % aqueous solution of benzimidazole was further added. Thereafter, the entire amount of Solution C prepared by diluting 51.86 g of silver nitrate with distilled water to a volume of 317.5 ml and the entire amount of Solution D obtained by diluting 44.2 g of potassium bromide and 2.2 g of potassium iodide with distilled water to a volume of 400 ml were added. Here, Solution C was added at a constant flow rate over 20 minutes and Solution D was added by the controlled double jet method while maintaining the pAg at 8.1. After 10 minutes from the initiation of addition of Solution C and Solution D, the entire amount of potassium hexachloroiridate(III) was added to a concentration of 1×10⁻⁴ mol per mol of silver. Furthermore, 5 seconds after the completion of addition of Solution C, the entire amount of an aqueous potassium hexacyanoferrate(II) solution was added to a concentration of 3×10⁻⁴ mol per mol of silver. Then, the pH was adjusted to 3.8 using sulfuric acid in a concentration of 0.5 mol/L and after stirring was stopped, the resulting solution was subjected to precipitation/desalting/water washing. The pH was then adjusted to 5.9 using sodium hydroxide in a concentration of 1 mol/L, thereby preparing a silver halide dispersion at a pAg of 8.0.

While stirring the silver halide dispersion obtained above and thereby keeping it at 38° C., 5 ml of a methanol solution containing 0.34 mass % of 1,2-benzoisothiazolin-3-one was added and after 40 minutes, a methanol solution containing Spectral Sensitizing Dye A and Spectral Sensitizing Dye B at a molar ratio of 1:1 was added in an amount, as a total of Sensitizing Dye A and Sensitizing Dye B, of 1.2×10⁻³ mol per mol of silver. After 1 minute, the temperature was elevated to 47° C. and 20 minutes after the elevation of temperature, a methanol solution of sodium benzenethiosulfonate was added in an amount of 7.6×10⁻⁵ mol per mol of silver. After 5 minutes, a methanol solution of Tellurium Sensitizer B was further added in an amount of 2.9×10⁻⁴ mol per mol of silver and then, the solution was ripened for 91 minutes. Thereto, 1.3 ml of a 0.8 mass % methanol solution of N,N′-dihydroxy-N″-diethylmelamine was added and after 4 minutes, a methanol solution of 5-methyl-2-mercaptobenzimidazole and a methanol solution of 1-phenyl-2-heptyl-5-mercapto-1,3,4-triazole were added in an amount of 4.8×10⁻³ mol and 5.4×10⁻³ mol, respectively, per mol of silver to prepare Silver Halide Emulsion 1.

The grains in the thus-prepared silver halide emulsion were silver iodobromide grains having an average equivalent-sphere diameter of 0.042 μm and a coefficient of variation in the equivalent-sphere diameter of 20% and uniformly containing 3.5 mol % of iodide. The grain size and the like were determined as an average of 1,000 grains using an electron microscope. The percentage of [100] faces in this grain was 80% as determined using the Kubelka-Munk equation.

<Preparation of Silver Halide Emulsion 2>

Silver Halide Emulsion 2 was prepared in the same manner as Silver Halide Emulsion 1 except that the liquid temperature at the grain formation was changed from 30° C. to 47° C., Solution B was obtained by diluting 15.9 g of potassium bromide with distilled water to a volume of 97.4 ml, Solution D was obtained by diluting 45.8 g of potassium bromide with distilled water to a volume of 400 ml, the addition time of Solution C was changed to 30 minutes and potassium hexacyanoferrate(II) was excluded. Also, precipitation/desalting/water washing/dispersion were performed in the same manner as in the preparation of Silver Halide Emulsion 1. Thereafter, spectral sensitization, chemical sensitization and addition of 5-methyl-2-mercaptobenzimidazole and 1-phenyl-2-heptyl-5-mercapto-1,3,4-triazole were performed in the same manner as in the preparation of Emulsion 1 except that the amount added of the methanol solution containing Spectral Sensitizing Dye A and Spectral Sensitizing Dye B at a molar ratio of 1:1 was changed, as a total of Sensitizing Dye A and Sensitizing Dye B, to 7.5×10⁻⁴ mol per mol of silver, the amount of Tellurium Sensitizer B added was changed to 1.1×10⁻⁴ Mol per mol of silver, and the amount of 1-phenyl-2-heptyl-5-mercapto-1,3,4-triazole added was changed to 3.3×10⁻³ mol per mol of silver. Thus, Silver Halide Emulsion 2 was obtained. The emulsion grains of Silver Halide Emulsion 2 were pure silver bromide cubic grains having an average equivalent-sphere diameter of 0.080 μm and a coefficient of variation in the equivalent-sphere diameter of 20%.

<Preparation of Silver Halide Emulsion 3>

Silver Halide Emulsion 3 was prepared in the same manner as Silver Halide Emulsion 1 except that the liquid temperature at the grain formation was changed from 30° C. to 27° C. Also, precipitation/desalting/water washing/dispersion were performed in the same manner as in the preparation of Silver Halide Emulsion 1. Thereafter, Silver Halide Emulsion 3 was obtained in the same manner as Emulsion 1 except that a solid dispersion (aqueous gelatin solution) containing Spectral Sensitizing Dye A and Spectral Sensitizing Dye B at a molar ratio of 1:1 was added in an amount, as a total of Sensitizing Dye A and Sensitizing Dye B, of 6×10⁻³ mol per mol of silver, and the amount of Tellurium Sensitizer B added was changed to 5.2×10⁻⁴ mol per mol of silver. The emulsion grains of Silver Halide Emulsion 3 were silver iodobromide grains having an average equivalent-sphere diameter of 0.034 μm and a coefficient of variation in the equivalent-sphere diameter of 20% and uniformly containing 3.5 mol % of iodide.

<Preparation of Mixed Emulsion A for Coating Solution>

70 Mass % of Silver Halide Emulsion 1, 15 mass % of Silver Halide Emulsion 2 and 15 mass % of Silver Halide Emulsion 3 were dissolved and thereto, a 1 mass % aqueous solution of benzothiazolium iodide was added in an amount of 7×10⁻³ mol per mol of silver. Furthermore, water was added to adjust the silver halide content to 38.2 g in terms of silver per kg of the mixed emulsion for coating solution.

<Preparation of Fatty Acid Silver Salt Dispersion>

Behenic acid (87.6 kg, “Edenor C22-85R”, trade name, produced by Henkel Co.), 423 L of distilled water, 49.2 L of an aqueous NaOH solution in a concentration of 5 mol/L, and 120 L of tert-butyl alcohol were mixed. The mixture was reacted by stirring at 75° C. for one hour to obtain a sodium behenate solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the sodium behenate solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the sodium behenate solution was started, and only the sodium behenate solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the sodium behenate solution was kept warm by circulating hot water in the outer side of a double pipe, whereby the outlet liquid temperature at the distal end of the addition nozzle was adjusted to 75° C., The piping in the system of adding the aqueous silver nitrate solution was kept warm by circulating cold water in the outer side of a double pipe. The addition site of sodium behenate solution and the addition site of aqueous silver nitrate solution were symmetrically arranged centered around the stirring axis. Also, these addition sites were each adjusted to a height of not causing contact with the reaction solution.

After the completion of addition of the sodium behenate solution, the mixture was left standing at that temperature for 20 minutes with stirring. The temperature was then elevated to 35° C. over 30 minutes and the solution was ripened for 210 minutes. Immediately after the completion of ripening, the solid content was separated by centrifugal filtration and washed with water until the conductivity of filtrate became 30 μS/cm. In this manner, a fatty acid silver salt was obtained. The solid content obtained was not dried but stored as a wet cake.

The shape of the thus-obtained silver behenate grains was analyzed by electron microphotography. As a result, the grains were scaly crystals having average sizes of a=0.14 μm, b=0.4 μm and c=0.6 μm, an average aspect ratio of 5.2, an average equivalent-sphere diameter of 0.52 μm and a coefficient of variation in the equivalent-sphere diameter of 15′-(a, b and c comply with the definition in this specification).

To the wet cake corresponding to 260 Kg as a dry solid content, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain a silver behenate dispersion. At the dispersion, the temperature was set to 18° C. by a cooling operation of controlling the temperature of coolant using coiled heat exchangers attached to the inlet side and outlet side of the interaction chamber.

(Preparation of Reducing Agent Dispersion)

<Preparation of Reducing Agent Complex 1 Dispersion>

To 10 kg of Reducing Agent Complex 1 (a 1:1 complex of 6,6′-di-tert-butyl-4,4′-dimethyl-2,2′-butylidenediphenol and triphenylphosphine oxide), 0.12 Kg of triphenylphosphine oxide and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 4 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the Reducing Agent Complex 1 concentration to 22 mass %, thereby obtaining Reducing Agent Complex 1 Dispersion. The reducing agent complex particles contained in the thus-obtained Reducing Agent Complex 1 Dispersion had a median diameter of 0.45 μm and a maximum particle size of 1.4 μm or less. The obtained Reducing Agent Complex 1 Dispersion was filtered through a polypropylene-made filter having a pore size of 3.0 μm to remove foreign matters such as dust and then housed.

<Preparation of Reducing Agent 2 Dispersion>

To 10 kg of Reducing Agent 2 (6,6′-di-tert-butyl-4,4′-dimethyl-2,2′-butylidenediphenol) and 16 Kg of a 10 mass % aqueous solution of modified polyvinyl alcohol (“poval MP203”, produced by Kuraray Co., Ltd.), 10 Kg of water was added and thoroughly mixed to form a slurry. This slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the Reducing Agent 2 concentration to 25 mass %, thereby obtaining Reducing Agent 2 Dispersion. The reducing agent particles contained in the thus-obtained Reducing Agent 2 Dispersion had a median diameter of 0.40 μm and a maximum particle size of 1.5 μm or less. The obtained reducing agent dispersion was filtered through a polypropylene-made filter having a pore size of 3.0 μm to remove foreign matters such as dust and then housed.

<Preparation of Hydrogen Bond-Forming Compound 1 Dispersion>

To 10 Kg of Hydrogen Bond-Forming Compound 1 (tri(4-tert-butylphenyl)phosphine oxide) and 16 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the Hydrogen Bond-Forming Compound 1 concentration to 25 mass %, thereby obtaining Hydrogen Bond-Forming Compound 1 Dispersion. The dispersed particles contained in the thus-obtained Hydrogen Bond-Forming Compound 1 Dispersion had a median diameter of 0.35 μm and a maximum particle size of 1.5 μm or less. The obtained Hydrogen Bond-Forming Compound 1 Dispersion was filtered through a polypropylene-made filter having a pore size of 3.0 μm to remove foreign matters such as dust and then housed.

<Preparation of Development Accelerator 1 Dispersion>

To 10 Kg of Development Accelerator 1 (Development Accelerator (1-68) of the present invention) and 20 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the Development Accelerator 1 concentration to 20 mass %, thereby obtaining Development Accelerator 1 Dispersion. The dispersed particles contained in the thus-obtained Development Accelerator 1 Dispersion had a median diameter of 0.48 μm and a maximum particle size of 1.4 μm or less. The obtained development accelerator dispersion was filtered through a polypropylene-made filter having a pore size of 3.0 μm to remove foreign matters such as dust and then housed.

Solid Dispersions of Development Accelerator 2, Development Accelerator 3, Development Accelerator 4 and Color Tone Adjuster 1 each was obtained as a 20 mass % dispersion in the same manner as Development Accelerator 1.

(Preparation of Polyhalogen Compound)

<Preparation of Organic Polyhalogen Compound 1 Dispersion>

To 10 Kg of Organic Polyhalogen Compound 1 (tribromomethanesulfonylbenzene), 10 Kg of a 20 mass % aqueous solution of modified polyvinyl alcohol (“Poval MP203”, produced by Kuraray Co., Ltd.) and 0.4 Kg of a 20 mass % aqueous solution of sodium triisopropylnaphthalenesulfonate, 14 Kg of water was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 26 mass %, thereby obtaining Organic Polyhalogen Compound 1 Dispersion. The organic polyhalogen compound particles contained in the thus-obtained organic polyhalogen compound dispersion had a median diameter of 0.41 μm and a maximum particle size of 2.0 μm or less. The obtained organic polyhalogen compound dispersion was filtered through a polypropylene-made filter having a pore size of 10.0 μm to remove foreign matters such as dust and then housed.

<Preparation of Organic Polyhalogen Compound 2 Dispersion>

To 10 Kg of Organic Polyhalogen Compound 2 (N-butyl-3-tribromomethanesulfonylbenzamide) and 20 Kg of a 10 mass % aqueous solution of modified polyvinyl alcohol (“Poval MP203”, produced by Kuraray Co., Ltd.), 0,4 Kg of a 20 mass % aqueous solution of sodium triisopropyl naphthalenesulfonate was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 30 mass %. This dispersion solution was heated at 40° C. for 5 hours, whereby Organic Polyhalogen Compound 2 Dispersion was obtained. The organic polyhalogen compound particles contained in the thus-obtained polyhalogen compound dispersion had a median diameter of 0.40 μm and a maximum particle size of 1.3 μm or less. The obtained organic polyhalogen compound dispersion was filtered through a polypropylene-made filter having a pore size of 3.0 μm to remove foreign matters such as dust and then housed.

<Preparation of Phthalazine Compound 1 Solution>

In 174.57 Kg of water, 8 Kg of modified polyvinyl alcohol “MP203” produced by Kuraray Co., Ltd. was dissolved. Thereto, 3.15 Kg of a 20 mass % aqueous solution of sodium triisopropylnaphthalenesulfonate and 14.28 Kg of a 70 mass % aqueous solution of Phthalazine Compound 1 (6-isopropylphthalazine) were added to prepare a 5 mass % solution of Phthalazine Compound 1.

(Preparation of Mercapto Compound)

<Preparation of Aqueous Mercapto Compound 1 Solution>

In 993 g of water, 7 g of Mercapto Compound 1 (1-(3-sulfophenyl)-5-mercaptotetrazole sodium salt) was dissolved to prepare a 0.7 mass % aqueous solution.

<Preparation of Aqueous Mercapto Compound 2 Solution>

In 980 g of water, 20 g of Mercapto Compound 2 (1-(3-methylureido)-5-mercaptotetrazole sodium salt) was dissolved to prepare a 2.0 mass % aqueous solution.

<Preparation of Pigment 1 Dispersion>

To 64 g of C.I. Pigment Blue 60 and 6.4 g of “Demol N” (produced by Kao Corporation), 250 g of water was added and thoroughly mixed to form a slurry. The resulting slurry and 800 g of zirconia beads having an average diameter of 0.5 mm were put together into a vessel and dispersed in a dispersing machine (¼G Sand Grinder Mill, manufactured by AIMEX K. K.) for 25 hours to obtain Pigment 1 Dispersion. The pigment particles contained in the thus-obtained pigment dispersion had an average particle size of 0.21 μm.

<Preparation of SBR Latex Solution>

The binder for the image-forming layer was obtained as follows. To each of the polymer latexes (P-1 to P-29) of the present invention and Compounds (RP-1 to RP-3) obtained in Comparative Examples 1 to 3 below, 1 mol/liter of NaOH and NH₄OH were added to have a molar ratio of Na⁺ ion:NH₄⁺ ion=1:2.3 in an SBR latex and then, the pH was adjusted to 8.4. Thereafter, each polymer latex was adjusted to a solid concentration of 40 mass %, filtered through a polypropylene-made filter having a pore diameter of 1.0 μm to remove foreign matters such as dust, and then housed.

### COMPARATIVE SYNTHESIS EXAMPLE 1

Synthesis of Compound (RP-1):

Combound RP-1 (solid content: 45%, particle size: 80 nm) was synthesized all in accordance with the synthesis formulation of Polymer Latex P-1 in Synthesis Example 1 of the present invention except that the surfactant was changed to “PELEX SS-L” (produced by Kao Corporation). The chloride ion concentration was 400 ppm.

### COMPARATIVE SYNTHESIS EXAMPLE 2

Synthesis of Compound (RP-2):

Compound RP-2 (solid content: 44%, particle size: 75 nm) was synthesized all in accordance with the synthesis formulation of Polymer Latex P-2 in Synthesis Example 2 of the present invention except that the surfactant was changed to “PELEX SS-L” (produced by Kao Corporation) and tetrasodium ethylenediaminetetraacetate (chelate compound) was not used. The chloride ion concentration was 390 ppm.

### COMPARATIVE SYNTHESIS EXAMPLE 3

Synthesis of Compound (RP-3):

Compound RP-1 (solid content: 44%, particle size: 90 nm) was synthesized all in accordance with the synthesis formulation of Polymer Latex P-2 in Synthesis Example 2 of the present invention except that 1 mol/liter of NaOH was not added and instead, water in the same amount was added. The chloride ion concentration was 4 ppm.

<Preparation of Coating Solution 1 for Emulsion Layer (Photosensitive Layer)>

The fatty acid silver salt dispersion prepared above (1,000 g), 276 ml of water, 33.2 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of an SBR latex (Tg: 22° C.) solution, 299 g of Reducing Agent Complex 1 Dispersion, 6 g of Development Accelerator 1 Dispersion, 9 ml of Aqueous Mercapto Compound 1 Solution and 27 ml of Aqueous Mercapto Compound 2 Solution were sequentially added. Immediately before the coating, 117 g of Silver Halide Mixed Emulsion A was added and thoroughly mixed. The resulting coating solution for emulsion layer was transferred as it was to a coating die and coated.

The viscosity of the coating solution for emulsion layer obtained above was measured by a Brookfield viscometer manufactured by Tokyo Keiki Kogyo K. K. and found to be 25 [mPa·s] at 40° C. (No. 1 rotor, 60 rpm).

The viscosity of the coating solution measured at 25° C. using “RFS Field Spectrometer” (manufactured by Rheometrics Far East K. K.) was 230, 60, 46, 24 and 18 [mPa·s] at a shear rate of 0.1, 1, 10, 100 and 1,000 [1/sec], respectively.

The amount of zirconium in the coating solution was 0.38 mg per g of silver.

<Preparation of Coating Solution 2 for Emulsion Layer (Photosensitive Layer)>

The fatty acid silver salt dispersion prepared above (1,000 g), 276 ml of water, 32.8 g of Pigment 1 Dispersion, 21 g of Organic Polyhalogen Compound 1 Dispersion, 58 g of organic Polyhalogen Compound 2 Dispersion, 173 g of Phthalazine Compound 1 Solution, 1,082 g of an SBR latex (Tg: 20° C.) solution, 155 g of Reducing Agent 2 Dispersion, 55 g of Hydrogen Bond-Forming Compound 1 Dispersion, 6 g of Development Accelerator 1 Dispersion, 2 g of Development Accelerator 2 Dispersion, 3 g of Development Accelerator 3 Dispersion, 2 g of Color Tone Adjuster 1 Dispersion and 6 ml of Aqueous Mercapto Compound 2 Solution were sequentially added. Immediately before the coating, 117 g of Silver Halide Mixed Emulsion A was added and thoroughly mixed. The resulting coating solution for emulsion layer was transferred as it was to a coating die and coated.

The viscosity of the coating solution for emulsion layer obtained above was measured by a Brookfield viscometer manufactured by Tokyo Keiki Kogyo K. K. and found to be 40 [mPa s] at 40° C. (No. 1 rotor, 60 rpm).

The viscosity of the coating solution measured at 25° C. using “RFS Field Spectrometer” (manufactured by Rheometrics Far East K. K.) was 530, 144, 96, 51 and 28 [mPa·s] at a shear rate of 0.1, 1, 10, 100 and 1,000 [1/sec], respectively.

The amount of zirconium in the coating solution was 0.25 mg per g of silver.

<Preparation of Coating Solution for Interlayer on Emulsion Surface>

A 5 mass % aqueous solution (27 ml) of “Aerosol OT” (produced by American Cyanamide), 135 ml of a 20 mass % aqueous solution of diammonium phthalate and water for making a total amount of 10,000 g were added to 1,000 g of polyvinyl alcohol “PVA-205” (produced by Kuraray Co., Ltd.), 272 g of a 5 mass % pigment dispersion and 4,200 ml of a 19 mass % solution of methyl methacrylate/styrene/butyl acrylate/hydroxyethyl methacrylate/acrylic acid copolymer (copolymerization weight ratio: 64/9/20/5/2) latex. The pH was adjusted to 7.5 with NaOH to prepare a coating solution for interlayer and then the coating solution for interlayer was transferred to a coating die to give a coverage of 9.1 ml/m².

The viscosity of the coating solution was measured at 40° C. by a Brookfield viscometer (No. 1 rotor, 60 rpm) and found to be 58 [mPa·s].

<Preparation of Coating Solution for First Protective Layer on Emulsion Surface>

In water, 64 g of inert gelatin was dissolved. Thereto, 80 g of a 27.5 mass % solution of methyl methacrylate/styrene/butyl acrylate/hydroxyethyl methacrylate/acrylic acid copolymer (copolymerization weight ratio: 64/9/20/5/2) latex, 23 ml of a 10 mass % methanol solution of phthalic acid, 23 ml of a 10 mass % aqueous solution of 4-methylphthalic acid, 28 ml of sulfuric acid in a concentration of 0.5 mol/L, 5 ml of a 5 mass % aqueous solution of “Aerosol OT” (produced by American Cyanamide), 0.5 g of phenoxyethanol, 0.1 g of benzoisothiazolinone and water for making a total amount of 750 g were added to prepare a coating solution. Immediately before the coating, 26 ml of a 4 mass % chrome alum was mixed using a static mixer. Then, the coating solution was transferred to a coating die to give a coverage of 18.6 ml/m².

The viscosity of the coating solution was measured at 40° C. by a Brookfield viscometer (No. 1 rotor, 60 rpm) and found to be 20 [mPa·s].

<Preparation of Coating Solution for Second Protective Layer on Emulsion Surface>

In water, 80 g of inert gelatin was dissolved. Thereto, 102 g of a 27.5 mass % solution of methyl methacrylate/styrene/butyl acrylate/hydroxyethyl methacrylate/acrylic acid copolymer (copolymerization weight ratio: 64/9/20/5/2) latex, 3.2 ml of a 5 mass % solution of Fluorine-Containing Surfactant (F-1) (N-perfluorooctylsulfonyl-N-propylalanine potassium salt), 32 ml of a 2 mass % aqueous solution of Fluorine-Containing Surfactant (F-2) (polyethylene glycol mono(N-perfluorooctylsulfonyl-N-propyl-2-aminoethyl)ether [ethylene oxide average polymerization degree: 15]), 23 ml of a 5 mass % solution of “Aerosol OT” (produced by American Cyanamide), 4 g of polymethyl methacrylate fine particles (average particle size: 0.7 μm), 21 g of polymethyl methacrylate fine particles (average particle size: 4.5 μm), 1.6 g of 4-methylphthalic acid, 4.8 g of phthalic acid, 44 ml of sulfuric acid in a concentration of 0.5 mol/L, 10 mg of benzoisothiazolinone and water for making a total amount of 650 g were added. Immediately before the coating, 445 ml of an aqueous solution containing 4 mass % of chrome alum and 0.67 mass % of phthalic acid was mixed using a static mixer to obtain a coating solution for surface protective layer and then the coating solution for surface protective layer was transferred to a coating die to give a coverage of 8.3 ml/m².

The viscosity of the coating solution was measured at 40° C. by a Brookfield viscometer (No. 1 rotor, 60 rpm) and found to be 19 [mPa·s].

<Preparation of Heat-Developable Photosensitive Material 101>

In the back surface side of the undercoated support prepared above, the coating solution for antihalation layer and the coating solution for back surface protective layer were simultaneously coated one on another to give a coated amount of solid fine particle dye of 0.04 g/m² as a solid content and a gelatin coated amount of 1.7 g/m², respectively. Then, the coating was dried to form a back layer.

On the surface opposite the back surface, Coating Solution 1 for Emulsion Layer, the coating solution for interlayer on emulsion surface, the coating solution for first protective layer on emulsion surface and the coating solution for second protective layer on emulsion surface were simultaneously coated one on another in this order from the undercoated surface by the slide bead coating method to prepare a heat-developable photosensitive material sample. At this time, the emulsion layer, the interlayer, the first protective layer and the second protective layer all were adjusted to a temperature of 36° C. The coated amount (g/m²) of each compound in the emulsion layer is shown below.

| | |
|---|---|
| Silver behenate | 5.55 |
| Pigment (C.I. Pigment Blue 60) | 0.036 |
| Polyhalogen Compound 1 | 0.05 |
| Polyhalogen Compound 2 | 0.32 |
| Phthalazine Compound 1 | 0.19 |
| SBR Latex (RP-1) | 9.97 |
| Mercapto Compound 2 | 0.012 |
| Silver halide (as Ag) | 0.091 |

The coating and drying conditions were as follows.

The coating was performed at a speed of 160 m/min, the distance between the tip of coating die and the support was set to from 0.10 to 0.30 mm, and the pressure in the vacuum chamber was set lower by 196 to 882 Pa than the atmospheric pressure. The support was destaticized by ionized wind before the coating.

In the subsequent chilling zone, the coating solution was cooled with air at a dry bulb temperature of 10 to 20° C. The sample was then subjected to contact-free transportation and in a helical floating-type dryer, dried with drying air at a dry bulb temperature of 23 to 45° C. and a wet bulb temperature of 15 to 21° C.

After drying, the humidity was adjusted to 40 to 60% RH at 25° C. and then, the layer surface was heated to 70 to 90° C. The heated layer surface was then cooled to 25° C.

The heat-developable photosensitive material thus prepared had a matting degree of, in terms of the Beck's smoothness, 550 seconds on the photosensitive layer surface and 130 seconds on the back surface. The pH on the layer surface in the photosensitive layer side was measured and found to be 6.0.

<Preparation of Heat-Developable Photosensitive Materials 102 to 120>

Heat-Developable Photosensitive Materials 102 to 120 were prepared by changing SBR latex (RP-1) and Development Accelerator 1 as shown in Table 2 in the preparation of Heat-Developable Photosensitive Material 101.

<Preparation of Heat-Developable Photosensitive Material 201>

Heat-Developable Photosensitive Material 201 was prepared in the same manner as Heat-Developable Photosensitive Material 101 except that in the preparation of Heat-Developable Photosensitive Material 101, Coating Solution 1 for Emulsion Layer was changed to Coating Solution 2 for Emulsion Layer, Yellow Dye Compound 15 was eliminated from the antihalation layer, and the fluorine-containing surfactants in the back surface protective layer and emulsion surface protective layer were changed from F-1, F-2, F-3 and F-4 to F-5, F-6, F-7 and F-8, respectively.

The coated amount (g/m²) of each compound in this emulsion layer is shown below.

| | |
|---|---|
| Silver behenate | 5.55 |
| Pigment (C.I. Pigment Blue 60) | 0.036 |
| Polyhalogen Compound 1 | 0.08 |
| Polyhalogen Compound 2 | 0.33 |
| Phthalazine Compound 1 | 0.19 |
| SBR Latex (RP-1) | 9.67 |
| Reducing Agent 2 | 0.81 |
| Hydrogen Bond-Forming Compound 1 | 0.30 |
| Development Accelerator 1 | 0.024 |
| Development Accelerator 2 | 0.010 |
| Development Accelerator 3 | 0.015 |
| Color Tone Adjuster 1 | 0.010 |
| Mercapto Compound 2 | 0.002 |
| Silver halide (as Ag) | 0.091 |

<Preparation of Heat-Developable Photosensitive Materials 202 to 220>

Heat-Developable Photosensitive Materials 202 to 220 were prepared by changing SBR latex (RP-1) and Development Accelerator 2 as shown in Table 3 in the preparation of Heat-Developable Photosensitive Material 201.

Chemical structures of the compounds used in Examples of the present invention are shown below.

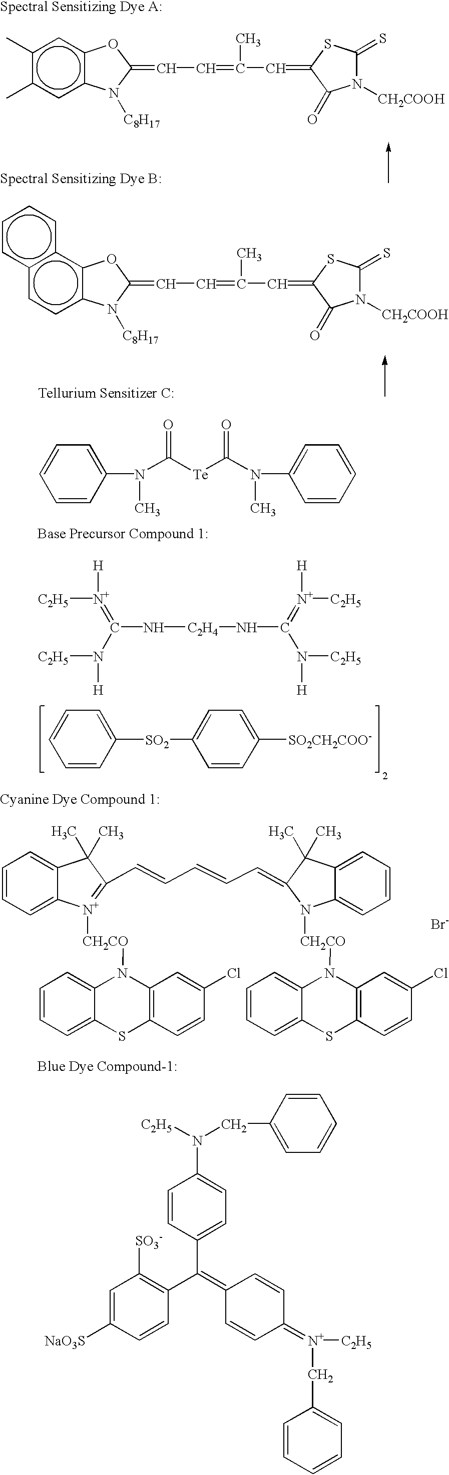

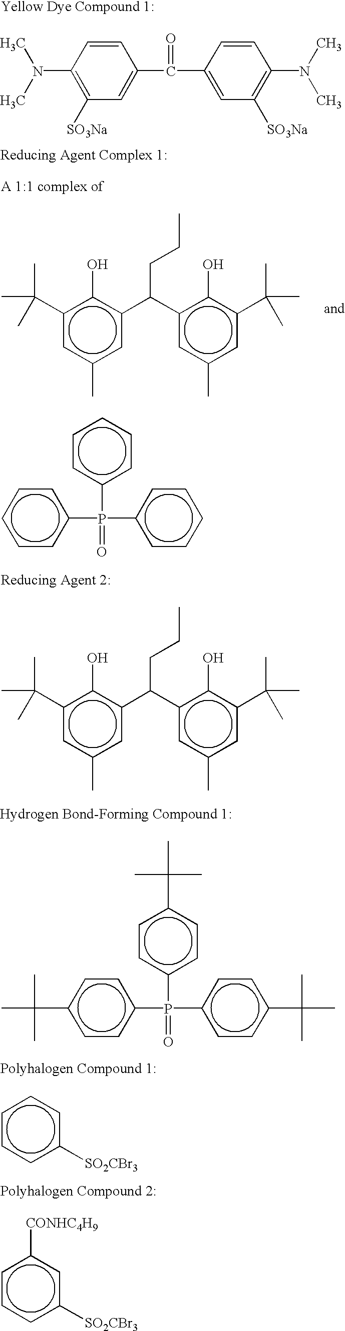

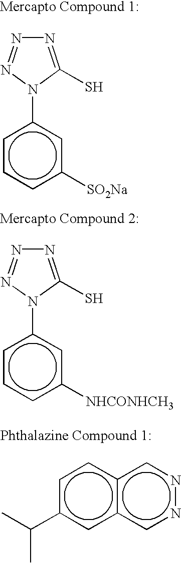

Development Accelerator 1:

(Development Accelerator (1-68) of Formula (1) of the Present Invention)

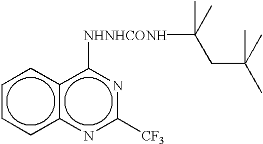

Development Accelerator 2:

(Development Accelerator (2-60) of Formula (2) of the Present Invention)

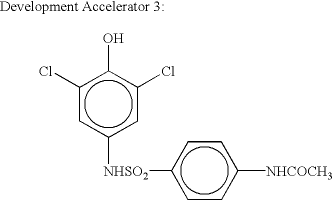

(Development Accelerator (3-3) of formula (3) of the present invention)

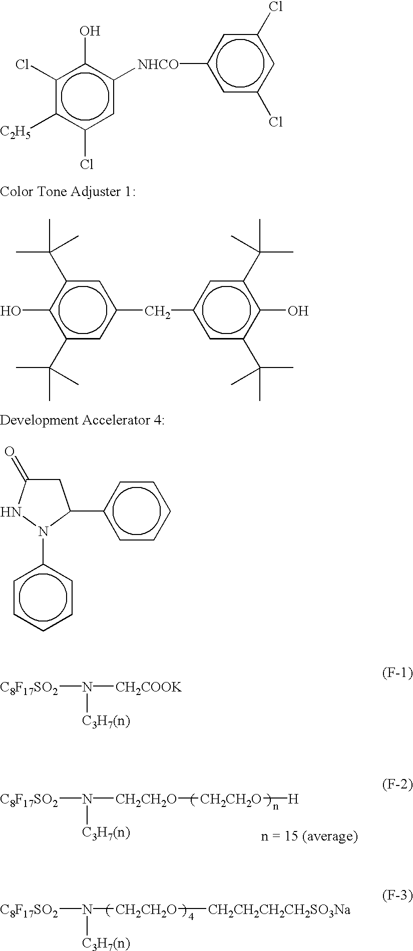

(F-4) C₈F₁₇SO₃K

(F-5) CF₃(CF₂)ₙCH₂CH₂SCH₂CH₂COOLi

a mixture of n=5 to 11

(F-6) CF₃(CF₂)ₙCH₂CH₂O(CH₂CH₂O)ₘH

a mixture of n=5 to 11, m=5 to 15

(F-7) CF₃(CF₂)ₙCH₂CH₂SO₃Na

a mixture of n=5 to 11

(F-8) C₆F₁₃CH₂CH₂SO₃Li

(Evaluation of Photographic Performance)

The samples obtained each was cut into a size of 356×432 mm, wrapped with the following packaging material in the environment of 25° C. and 50% RH, stored at an ordinary temperature for 2 weeks and then evaluated on the items shown below.

(Packaging Material)

Polyethylene (50 μm) containing 10 μm of PET/12 μm of PE/9 μm of aluminum foil/15 μm of Ny/3% of carbon:

oxygen permeability: 0.02 ml/atm·m²·25° C.·day

water permeability: 0.10 g/atm·m²·25° C.·day

(Evaluation of Storability of Unprocessed Photosensitive Material)

The obtained photosensitive material was stored at 60° C. for 15 hours and the sensitivity was measured before and after the storage. The sensitivity was calculated as a logarithm of reciprocal of the exposure amount necessary for giving a density of 1.0.

(Evaluation of Storage Stability of Processed Photosensitive Material)

The photosensitive material after the processing was irradiated with a fluorescent lamp in an environment of 40° C. and 60% RH under the condition of 1,000 Lux for 3 days and the increase of density in the unexposed area from the density before the irradiation was measured.

The development of the sample was performed by performing exposure heat development (with four sheets of panel heater set at 112° C.-119° C.-121° C.-121° C., for 24 seconds in total in the case of Heat-Developable Photosensitive Material 101 and for 14 seconds in total in the case of Heat-Developable Photosensitive Material 201) in “Fuji Medical Dry Laser Imager FM-DP L” (in which a semiconductor laser of 660 nm having a maximum output of 60 mW (IIIB) was mounted). The obtained image was evaluated by a densitometer.

The results are shown in Tables 2 and 3.

TABLE 2

| | | | Chloride Ion | | | | | |
|---|---|---|---|---|---|---|---|---|
| | | Chloride Ion | Concentration | | | Storability of | | |
| | | Concentration | Based on | | | Unprocessed | Image | |
| Sample | SBR | in Latex | Organic Silver | Development | Sensitivity | Photosensitive | Storability | |
| No. | Latex | (ppm) | (ppm) | Accelerator | (1) | Material (2) | (3) | Remarks |
| 101 | RP-1 | 400 | 1650 | Development | 0 | −0.25 | 100 | Comparison |
| | | | | Accelerator 1 | | | | |
| 102 | RP-1 | 400 | 1590 | none | −0.55 | −0.22 | 93 | ″ |
| 103 | RP-2 | 390 | 1500 | Development | 0.01 | −0.27 | 99 | ″ |
| | | | | Accelerator 1 | | | | |
| 104 | RP-3 | 3 | 18 | Development | 0.01 | −0.04 | 43 | Invention |
| | | | | Accelerator 1 | | | | |
| 105 | P-1 | 9 | 45 | Development | 0.02 | −0.02 | 45 | ″ |
| | | | | Accelerator 1 | | | | |
| 106 | P-1 | 9 | 50 | none | −0.48 | 0.12 | 77 | Comparison |
| 107 | P-2 | 3 | 15 | Development | 0 | −0.02 | 32 | Invention |
| | | | | Accelerator 1 | | | | |
| 108 | P-4 | 25 | 110 | Development | 0.01 | −0.01 | 43 | ″ |
| | | | | Accelerator 1 | | | | |
| 109 | P-5 | 200 | 750 | Development | −0.01 | −0.05 | 50 | ″ |
| | | | | Accelerator 1 | | | | |
| 110 | P-14 | 146 | 550 | Development | 0.01 | −0.04 | 49 | ″ |
| | | | | Accelerator 1 | | | | |
| 111 | P-20 | 10 | 45 | Development | 0 | −0.01 | 35 | ″ |
| | | | | Accelerator 1 | | | | |
| 112 | P-1 | 9 | 40 | Development | 0.05 | −0.01 | 33 | ″ |
| | | | | Accelerator 4 | | | | |
| 113 | P-1 | 9 | 45 | 1-1 | −0.02 | 0 | 36 | ″ |
| 114 | P-1 | 9 | 40 | 1-12 | 0.04 | −0.02 | 38 | ″ |
| 115 | P-1 | 9 | 46 | 1-47 | 0.02 | −0.01 | 35 | ″ |
| 116 | P-1 | 9 | 44 | 6-8 | 0.01 | −0.01 | 37 | ″ |
| 117 | P-1 | 9 | 50 | 2-60 | 0.01 | 0 | 35 | ″ |
| 118 | P-1 | 9 | 45 | 3-3 | 0.05 | 0.01 | 36 | ″ |
| 119 | P-1 | 9 | 45 | 4-7 | 0.01 | −0.01 | 36 | ″ |
| 120 | P-1 | 9 | 40 | 4-39 | 0.06 | −0.01 | 35 | ″ |

(1) Sensitivity before storage test; difference from Sample 101 (as the value is larger, the sensitivity is higher).
(2) Change in sensitivity after storage test; the positive value denotes increase of sensitivity and the negative value denotes decrease of sensitivity; as the change of sensitivity is smaller, the image storability is better.
(3) Shown by a relative value to Sample 101 as 100; as the value is larger, the image storability is worse.
(4) The chloride ion concentration was determined using the coating solution for emulsion layer.

TABLE 3

| | | | Chloride Ion | | | | | |
|---|---|---|---|---|---|---|---|---|
| | | Chloride Ion | Concentration | | | Storability of | | |
| | | Concentration | Based on | | | Unprocessed | Image | |
| Sample | SBR | in Latex | Organic Silver | Development | Sensitivity | Photosensitive | Storability | |
| No. | Latex | (ppm) | (ppm) | Accelerator | (1) | Material (2) | (3) | Remarks |
| 201 | RP-1 | 400 | 1650 | Development | 0 | −0.18 | 100 | Comparison |
| | | | | Accelerator 2 | | | | |
| 202 | RP-1 | 400 | 1500 | none | −0.35 | −0.15 | 99 | ″ |
| 203 | RP-2 | 390 | 1550 | Development | 0.01 | −0.2 | 102 | ″ |
| | | | | Accelerator 2 | | | | |
| 204 | RP-3 | 3 | 16 | Development | 0.01 | −0.02 | 33 | Invention |
| | | | | Accelerator 2 | | | | |
| 205 | P-1 | 9 | 50 | Development | 0.01 | −0.01 | 40 | ″ |
| | | | | Accelerator 2 | | | | |
| 206 | P-1 | 9 | 45 | none | −0.31 | 0.1 | 69 | Comparison |
| 207 | P-2 | 3 | 15 | Development | −0.01 | −0.02 | 35 | Invention |
| | | | | Accelerator 2 | | | | |
| 208 | P-4 | 25 | 90 | Development | 0.01 | −0.02 | 40 | ″ |
| | | | | Accelerator 2 | | | | |
| 209 | P-5 | 200 | 780 | Development | 0 | −0.03 | 48 | ″ |
| | | | | Accelerator 2 | | | | |
| 210 | P-14 | 146 | 600 | Development | −0.01 | −0.03 | 43 | ″ |
| | | | | Accelerator 2 | | | | |
| 211 | P-23 | 13 | 70 | Development | 0.01 | −0.01 | 35 | ″ |
| | | | | Accelerator 2 | | | | |
| 212 | P-1 | 9 | 40 | Development | 0.03 | −0.01 | 31 | ″ |
| | | | | Accelerator 4 | | | | |
| 213 | P-1 | 9 | 50 | 1-1 | −0.01 | 0 | 33 | ″ |
| 214 | P-1 | 9 | 40 | 1-12 | 0.02 | 0 | 30 | ″ |
| 215 | P-1 | 9 | 45 | 6-6 | 0.02 | 0 | 34 | ″ |
| 216 | P-1 | 9 | 45 | 2-50 | 0.01 | −0.01 | 32 | ″ |
| 217 | P-1 | 9 | 43 | 2-65 | 0.01 | 0 | 31 | ″ |
| 218 | P-1 | 9 | 45 | 3-11 | 0.02 | 0.01 | 32 | ″ |
| 219 | P-1 | 9 | 50 | 4-7 | 0.01 | −0.01 | 33 | ″ |
| 220 | P-1 | 9 | 45 | 4-39 | 0.03 | 0 | 33 | ″ |

(1) Sensitivity before storage test; difference from Sample 201 (as the value is larger, the sensitivity is higher).
(2) Change in sensitivity after storage test; the positive value denotes increase of sensitivity and the negative value denotes decrease of sensitivity; as the change of sensitivity is smaller, the image storability is better.
(3) Shown by a relative value to Sample 201 as 100; as the value is larger, the image storability is worse.
(4) The chloride ion concentration was determined using the coating solution for emulsion layer.

It is seen that by using the polymer latex of the present invention as the binder, the chloride. ion concentration in the photosensitive material can be reduced and by combining it with the development accelerator of the present invention, the storability of the unprocessed sample and the image storability after processing can be remarkably improved.

### EXAMPLE 2

<Preparation of Photosensitive Silver Halide Emulsion>

In 5,429 ml of water, 88.3 g of phenylcarbamoyl gelatin, 10 ml of an aqueous 10% methanol solution of PAO compound (HO(CH₂CH₂O)ₙ—(CH(Cl₃)CH₂O)₁₇—(CH₂CH₂O)ₘ—H; m+n=5 to 7) and 0.32 g of potassium bromide were added and dissolved. The resulting solution was kept at 45° C. and thereto, 659 ml of an aqueous 0.67 mol/liter silver nitrate solution and a solution having dissolved therein 0.703 mol of KBr and 0.013 mol of KI per liter were added by a double jet method over 4 minutes and 45 seconds while controlling the pAg to 8.09 using a mixing and stirring machine described in JP-B-58-58288 and JP-B-58-58289, thereby performing the nucleation. After 1 minute, 20 ml of a 0.63N potassium hydroxide solution was added. After the passing of 6 minutes, 1,976 ml of an aqueous 0.67 mol/liter silver nitrate solution and a solution having dissolved therein 0.657 mol of KBr, 0.013 mol of potassium iodide and 30 μmol of dipotassium hexachloroiridate per 1 liter were added by a double jet method over 14 minutes and 15 seconds at a temperature of 45° C. while controlling the pAg to 8.09. After stirring for 5 minutes, the temperature was lowered to 40° C.

To the resulting solution, 18 ml of an aqueous 56% acetic acid solution was added and a silver halide emulsion was precipitated. The supernatant was removed, 10 liter of water was added to the remaining precipitated part (2 liter) and after stirring, a silver halide emulsion was again precipitated. The supernatant was again removed, 10 liter of water was added to the remaining precipitated part (1.5 liter) and after stirring, a silver halide emulsion was precipitated. furthermore, the supernatant was removed, a solution prepared by dissolving 1.72 g of anhydrous sodium carbonate in 151 ml of water was added to the remaining precipitated part (1.5 liter), the temperature was elevated to 60° C., and the resulting solution was stirred for 120 minutes. Finally, the pH was adjusted to 5.0 and water was added in an amount of 1,161 g per mol of silver.

The obtained emulsion was monodisperse cubic silver iodobromide grains where the average grain size was 0.058 μm, the coefficient of variation in the grain size was 12% and the percentage of [100] faces was 92%.

<Preparation of Powdery Organic Silver Salt>

In 4,720 ml of pure water, 130.8 g of behenic acid, 67.7 g of arachidinic acid, 43.6 g of stearic acid and 2.3 g of palmitic acid were dissolved at 80° C. Thereto, 540.2 ml of an aqueous 1.5N sodium hydroxide solution was added and after 6.9 ml of concentrated nitric acid was added, the resulting solution was cooled to 55° C. to obtain an organic acid sodium solution. While keeping the organic acid sodium solution at a temperature of 55° C., 45.3 g of the silver halide emulsion prepared above and 450 ml of pure water was added. The mixture was stirred at 13,200 rpm (21.1 KHz as mechanical vibration frequency) using a homogenizer (ULTRA-TORRAXT-25, manufactured by IKA Japan). Then, 702,6 ml of a 1 mol/liter silver nitrate solution was added over 2 minutes and the resulting solution was stirred for 10 minutes to obtain an organic silver salt dispersion. Thereafter, the obtained organic silver salt dispersion was transferred to a water washing vessel, deionized water was added thereto, the resulting solution was stirred and then left standing to float and separate the organic silver salt dispersion, and the water-soluble salts in the lower part were removed. Subsequently, centrifugal dehydration was performed by repeating the washing with deionized water and the discharging of water until the electrical conductivity of discharged water became 2 μS/cm. Then, drying was performed at 40° C. by a hot air circulation drier until the weight loss did not occur to obtain a powdery organic silver salt.

<Preparation of Photosensitive Emulsion Dispersion>

In 1,457 g of methyl ethyl ketone (MEK), 14.57 g of polyvinyl butyral (Butvar B-79, produced by Monsant) was dissolved. While stirring by a dissolver DISPERMAT Model CA-40M manufactured by VMA-GETZMANN, 500 g of the powdery organic silver salt was gradually added and thoroughly mixed to form a slurry. This slurry was dispersed through 2 baths in a pressure-type homogenizer Model GM-2 manufactured by SMT Co. to prepare a photosensitive emulsion dispersion. At this time, the processing pressure in the first bath was 280 kg/cm² and the processing pressure in the second bath was 560 kg/cm².

<Preparation of Coating Solution for Photosensitive Layer>

In the photosensitive emulsion dispersion (50 g) prepared above, 15.1 g of MEK was added. While stirring the mixture by a dissolver-type homogenizer at 1,000 rpm and thereby keeping the temperature at 21° C., 390 μl of a 10 wt % methanol solution of an aggregate of N,N-dimethylacetamide 2 molecules/bromic acid 1 molecule/bromine 1 molecule was added and the solution was stirred for 1 hour. Thereto, 494 μl of a 10 wt % methanol solution of calcium bromide was added and the solution was stirred for 20 minutes. Subsequently, 167 mg of a methanol solution containing 15.9 wt % of dibenzo-18-crown-6 and 4.9 wt % of potassium acetate was added and the solution was stirred for 10 minutes. Thereto, 2.6 g of an MEK solution containing 0.24 wt % of Dye B, 18.3 wt % of 2-chlorobenzoic acid, 34.2 wt % of salicylic acid-p-toluene sulfonate and 4.5 wt % of 5-methyl-2-mercaptobenzimidazole was added and the solution was stirred for 1 hour. Thereafter, the temperature was lowered to 13° C. and the solution was further stirred for 30 minutes. While keeping the temperature at 13° C., 1>3.31 g of polyvinyl butyral (Butvar B-79, produced by Monsant) was added and the solution was stirred for 30 minutes. Then, 1.08 g of a 9.4 wt % of tetrachlorophthalic acid solution was added and the solution was stirred for 15 minutes. While continuing stirring, 12.4 g of an MEK solution containing 20 wt % of 1,1-bis(2-hydroxy-3,5-dimethylphenyl)-2-methylpropane, 1.1 wt % of 4-methylphthalic acid and Dye 1 was added and subsequently, 1.5 g of 10 wt % Desmodur N3300 (aliphatic isocyanate, produced by Morbey Co.) was added. Thereto, 4.27 g of an MEK solution containing 7.4 wt % of tribromomethyl-2-azaphenylsulfone and 7.2 wt % of phthalazine was added to obtain a coating solution for photosensitive layer.

<Preparation of Coating Solution for Surface Protective Layer>

In 865 g of MEK under stirring, 96 g of cellulose acetate butyrate (CAB171-15, produced by Eastman Chemical Co.), 4.5 g of polymethylmethacrylic acid (Palaroid A-21, produced by Roam & Haas Co.), 1.5 g of 1,3-di(vinyl-sulfonyl)-2-propanol, 1.0 g of benzotriazole and 1.0 g of fluorine-containing surfactant (Surflon KH40, produced by Asahi Glass Co., Ltd.) were added and dissolved. Thereto, 30 g of a solution prepared by dispersing 13.6 wt % of cellulose acetate butyrate (CAB171-15, produced by Eastman Chemical Co.) and 9 wt % of calcium carbonate (Super-Pflex200, produced by Speciality Minerals) in MEK using a dissolver-type homogenizer at 8,000 rpm for 30 minutes was added and the resulting solution was stirred to prepare a coating solution for surface protective layer.

<Preparation of Support>

Both sides of a 175 μm-thick PET film colored blue to a density of 0.170 (measured by a densitometer PDA-65, produced by Konica Co.) were subjected to a corona discharge treatment at 8 W/m².

<Coating of Back Surface Side>

In 830 g of MEK under stirring, 84.2 g of cellulose acetate butyrate (CAB381-20, produced by Eastman Chemical Co.) and 4.5 g of polyester resin (Vitel PE2200B, produced by Bostic Co.) were added and dissolved. To the dissolved solution, 0.30 g of Dye B was added and further, 43.2 g of methanol having dissolved therein 4.5 g of fluorine-containing surfactant (Surflon KH40, product by Asahi Glass Co., Ltd.) and 2.3 g of fluorine-containing surfactant (Megafac F120K, produced by Dainippon Ink & Chemicals Inc.) was added. The resulting solution was thoroughly stirred until these were dissolved. Finally, 75 g of silica (Siloid 64×6000, produced by W. R. Grace Co.) dispersed in MEK to a concentration of 1 wt % using a dissolver-type homogenizer was added and the mixture was stirred to prepare a coating solution for back surface.

The thus-prepared coating solution for back surface was coated by an extrusion coater to a dry thickness of 3.5 μm and dried. Drying was performed using a drying air having a dry temperature of 100° C. and a dew point temperature of 100° C. for 5 minutes.

<Preparation of Photosensitive Material 301>

On a support having a coated back surface, the coating solutions for photosensitive layer and for surface protective layer prepared above were simultaneously coated one on another by an extrusion coater to prepare a photosensitive material. Coating was performed such that the photosensitive layer had a coated silver amount of 1.9 g/m² and the surface protective layer had a dry thickness of 2.5 μm. Thereafter, the coating was dried by a drying air having a dry temperature of 75° C. and a dew point temperature of 10° C. for 10 minutes.

In the thus-obtained photosensitive material, the sum of MEK and methanol contents determined under the following conditions was used as a solvent content. The photosensitive material was cut out to a film area of 46.3 m² and was further cut into pieces of about 5 mm. These pieces were housed in a dedicated vial and the vial was tightly sealed by a septum and an aluminum cap and then set in a Head Space Sampler Model HP7694 with gas chromatography (GC) Model 5971, manufactured by Hewlett Packard Co. The detector of GC was a hydrogen flame ion detector (FID) and the column was DB-624 produced by J&W Co. The main measurement conditions were such that the heating conditions of the Head Space Sampler were 120° C. and 20 minutes, the GC introduction temperature was 150° C., and the temperature was elevated from 45° C. for 3 minutes to 100° C. at 8° C./minute. A calibration curve was prepared using a peak area in chromatogram obtained by housing a fixed amount of each solvent diluted with butanol in a dedicated vial and performing the measurement in the same manner as above. The solvent content of the photosensitive material was 40 mg/m².

The photosensitive material was cut out to 100 cm² and the photosensitive layer was peeled off in MEK. The peeled layer was subjected to sulfuric nitric acid decomposition in Microdigest Model A300 Microwave Wet Type Decomposition Apparatus manufactured by Prolab Co. and analyzed by a calibration curve method using an inductive coupling plasma mass spectrometer, Model PQ-Ω ICP-MS manufactured by VG Elemental Co. As a result, the Zr content in the photosensitive material was 10 μg per 1 mg of Ag.

The amount of chloride ion was determined and found to be 1,300 ppm based on the organic silver salt.

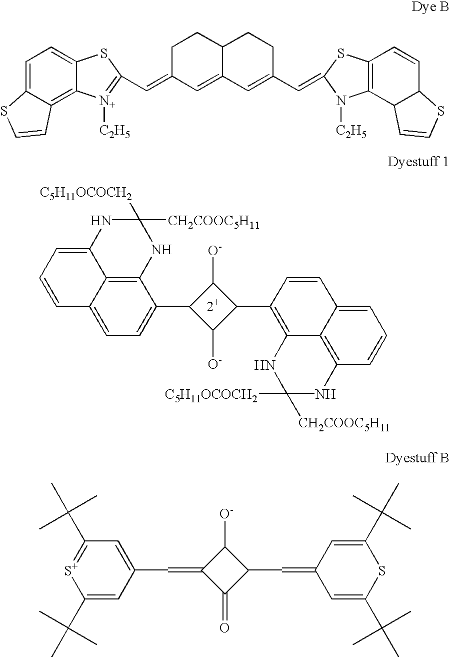

Sample 302 was prepared in the same manner as Sample 301 except that in the preparation of Sample 301, the polyvinyl butyral used in the photosensitive material was dissolved in MEK and washed and thereby desalted and the obtained polyvinyl butyral was used.

The chloride ion concentration of Sample 302 was 150 ppm based on the organic silver salt.

Samples 303 to 310 were prepared by adding 5 mol % of 1,1-bis (2-hydroxy-3,5-dimethylphenyl)-2-methylpropane as the development accelerator as shown in Table 4 in the preparation of Sample 302.

TABLE 4

| | Chloride Ion | | |
|---|---|---|---|
| Sample | Concentration Based on | Development | |
| No. | Organic Silver (ppm) | Accelerator | Remarks |
| 301 | 1300 | none | Comparison |
| 302 | 150 | Development | Invention |
| | | Accelerator 1 | |
| 303 | 150 | Development | ″ |
| | | Accelerator 2 | |
| 304 | 150 | Development | ″ |
| | | Accelerator 3 | |
| 305 | 150 | Development | ″ |
| | | Accelerator 4 | |
| 306 | 150 | 1-47 | ″ |
| 307 | 150 | 2-50 | ″ |
| 308 | 150 | 3-11 | ″ |
| 309 | 150 | 4-7 | ″ |
| 310 | 150 | 4-39 | ″ |

(Exposure and Development Processing)

An exposing machine having an exposure source composed of a longitudinally multi-mode semiconductor laser with a wavelength of 800 to 820 nm by superimposed high frequency wave was manufactured Using this exposing machine, the photosensitive material prepared above was exposed from the emulsion surface side by laser scanning. At this time, the image was recorded by scanning the laser light at an incident angle of 75° to the exposure surface of the photosensitive material. Then, using an automatic developing machine having a heat drum, the heat development was performed at 123° C. for 16 seconds by bringing the protective layer of the photosensitive material in contact with the drum surface. The obtained image was evaluated by a densitometer. At this time, the exposure and development were performed in a room at 23° C. and 50% RH. As compared with the image recorded using normal scan laser light by scanning the laser light at an incident angle of 900 to the exposure surface of the photosensitive material, the image obtained was reduced in the deterioration of image quality ascribable to the interference unevenness and had unexpectedly good sharpness and high contrast.

Using Samples 301 to 310 obtained, the same test as in Example 1 was performed, as a result, by combining the photosensitive material reduced in the chloride ion with the development accelerator of the present invention, good results were obtained similarly to Example 1.

### EXAMPLE 3

Samples 105-1 to 105-8 were prepared in the same manner as Sample 105 prepared in Example 1 except that the NaOH at the neutralization of SBR latex solution was changed to a molar ratio to NH₄OH as shown in Table 5 and the pH was adjusted to 8.40.

The alkali metal ion concentration and the ammonium ion concentration of SBR solution were analyzed by ion chromatography.

Using the samples prepared, 5 kinds of modalities were output by Fuji Medical Dry Laser Imager FM-DPL and a sensory evaluation of silver tone was performed.

The criteria of evaluation are as follows.

⊚: Pure black silver tone and preferred.

∘: Slightly deviated from pure black but good.

Δ: Magenta, cyan or yellow color was perceived but acceptable.

x: Strong magenta, cyan or yellow color and problem.

The results are shown in Table 5.

It is seen that by varying the ratio between the alkali metal ion and NH₄⁺ ion, the color tone is changed and the preferred range is from 1:5 to 1:0.5 of the present invention.

Other samples prepared in Example 1 were evaluated on the silver tone in the same manner by changing the ratio between alkali metal ion and NH₄⁺ ion, as a result, the evaluation results obtained were the same.

TABLE 5

| | | Alkali Metal Ion : NH₄⁺ Ion | Evaluation |
|---|---|---|---|
| Sample No. | Alkali | (by mol) | Results |
| 105 | NaOH | 1:2.3 | ⊚ |
| 105-1 | ″ | 1:6 | X |
| 105-2 | ″ | 1:4 | ◯ |
| 105-3 | ″ | 1:2 | ⊚ |
| 105-4 | ″ | 1:1 | ◯ |
| 105-5 | ″ | 1:0.6 | Δ |
| 105-6 | ″ | 1:0.4 | X |
| 105-7 | ″ | 1:2.3 | ⊚ |
| 105-8 | ″ | 1:2.3 | ⊚ |

According to the present invention, a heat-developable photosensitive material having excellent aging stability by showing reduced change in the sensitivity even when aged in the unprocessed state, and capable of giving an image having excellent preservability after the processing can be provided.

### EXAMPLE 4

(Preparation of PET Support)

PET having an intrinsic viscosity IV of 0.66 (measured in phenol/tetrachloroethane=6/4 (by weight) at 25° C.) was obtained in a usual manner using terephthalic acid and ethylene glycol. The resulting PET was pelletized and the pellets obtained were dried at 130° C. for 4 hours, melted at 300° C., extruded from a T-die and then quenched to prepare an unstretched film having a thickness large enough to give a thickness of 175 μm after the heat setting.

This film was stretched to 3.3 times in the machine direction using rolls different in the peripheral speed and then stretched to 4.5 times in the cross direction by a tenter. At this time, the temperatures were 110° C. and 130° C., respectively. subsequently, the film was heat set at 240° C. for 20 seconds and relaxed by 4% in the cross direction at the same temperature. Thereafter, the chuck part of the tenter was slit, both edges of the film were knurled, and the film was taken up at 4 kg/cm² to obtain a roll having a thickness of 175 μm.

(Surface Corona Treatment)

Both surfaces of the support were treated at room temperature at 20 m/min using a solid state corona treating machine “Model 6 KVA” (manufactured by Pillar Technologies). From the current and voltage read at this time, it was known that a treatment of 0.375 kV·A·min/m² was applied to the support. The treatment frequency here was 9.6 kHz and the gap clearance between the electrode and the dielectric roll was 1.6 mm.

(Preparation of Undercoated Support)

(1) Preparation of Coating Solution for Undercoat Layer
Formulation (1) (for undercoat layer in the photosensitive
layer side):

| “PESRESIN A-520” (30 mass % solution) | 59 | g |
|---|---|---|
| produced by Takamatsu Yushi K.K. | | |
| Polyethylene glycol monononylphenyl ether | 5.4 | g |
| (average ethylene oxide number: 8.5), 10 | | |
| mass % solution | | |
| “MP-1000” (fine polymer particles, average | 0.91 | g |
| particle size: 0.4 μm) produced by Soken | | |
| Kagaku K.K. | | |
| Distilled water | 935 | ml |
| Formulation (2) (for first layer on the back surface): | | |
| Styrene/butadiene copolymer latex (solid | 158 | g |
| content: 40 mass %, styrene/butadiene | | |
| weight ratio: 68/32) | | |
| 2,4-Dichloro-6-hydroxy-S-triazine sodium | 20 | g |
| salt, 8 mass % aqueous solution | | |
| Sodium laurylbenzenesulfonate (1 mass % | 10 | ml |
| aqueous solution) | | |
| Distilled water | 854 | ml |
| Formulation (3) (for second layer on the back surface): | | |
| SnO₂/SbO (9/1 by mass, average particle | 84 | g |
| size: 0.038 μm, 17 mass % dispersion) | | |
| Gelatin (10 mass % aqueous solution) | 89.2 | g |
| “METROSE TC-5” produced by Shin-Etsu | 8.6 | g |
| Chemical Co., Ltd. | | |
| “MP-1000” produced by Soken Kagaku K.K. | 0.01 | g |
| Sodium dodecylbenzenesulfonate (1 mass % | 10 | ml |
| aqueous solution) | | |
| NaOH (1 mass %) | 6 | ml |
| “PROXEL” (produced by ICI) | 1 | ml |
| Distilled water | 805 | ml |

(Preparation of Undercoated Support)

Both surfaces of the 175 μm-thick biaxially stretched polyethylene terephthalate support obtained above each was subjected to the above-described corona discharge treatment and on one surface (photosensitive layer surface), the undercoating solution of formulation (1) was applied by a wire bar to have a wet coated amount of 6.6 ml/m² (per one surface) and dried at 180° C. for 5 minutes. Thereafter, on the opposite surface thereof (back surface), the undercoating solution of formulation (2) was applied by a wire bar to have a wet coated amount of 5.7 ml/m² and dried at 180° C. for 5 minutes. On the opposite surface (back surface), the undercoating solution of formulation (3) was further applied by a wire bar to have a wet coated amount of 7.7 ml/m² and dried at 180° C. for 6 minutes, thereby obtaining an undercoated support.

(Preparation of Coating Solution for Back Surface)

(Preparation of Solid Fine Particle Dispersion (a) of Base Precursor)

Base Precursor Compound 1 (64 g), 28 g of diphenylsulfone and 10 g of surfactant “Demol N” (produced by Kao Corporation) were mixed with 220 ml of distilled water and the mixed solution was dispersed using beads in a sand mill (¼ Gallon Sand Grinder Mill, manufactured by AIMEX K. K.) to obtain Solid Fine Particle Dispersion (a) of Base Precursor Compound, having an average particle size of 0.2 μm.

(Preparation of Solid Fine Particle Dispersion of Dye)

Cyanine Dye Compound 1 (9.6 g) and 5.8 h of sodium p-dodecylbenzenesulfonate were mixed with 305 ml of distilled water and the mixed solution was dispersed using beads in a sand mill (¼ Gallon Sand Grinder Mill, manufactured by AIMEX K. K.) to obtain a solid fine particle dispersion of dye, having an average particle size of 0.2 μm.

(Preparation of Coating Solution for Antihalation Layer)

Gelatin (17 g), 9.6 g of polyacrylamide, 56 g of Solid Fine Particle Dispersion (a) of Base Precursor obtained above, 50 g of the solid fine particle dispersion of dye obtained above, 1.5 g of monodisperse polymethyl methacrylate fine particles (average particle size: 8 μm, standard deviation of particle size: 0.4), 0.03 g of benzoisothiazolinone, 2.2 g of sodium polyethylenesulfonate, 0.1 g of Blue Dye Compound 1, 0.1 g of Yellow Dye Compound 1 and 844 ml of water were mixed to prepare a coating solution for antihalation layer.

(Preparation of Coating Solution for Protective Layer on Back Surface)

In a container kept at 40° C., 50 g of gelatin, 0.2 g of sodium polystyrenesulfonate, 2.4 g of N,N-ethylene-bis(vinylsulfonacetamide), 1 g of sodium tert-octylphenoxyethoxyethanesulfonate, 30 mg of benzoisothiazolinone, 37 mg of Fluorine-Containing Surfactant (F-1) (N-perfluorooctylsulfonyl-N-propylalanine potassium salt), 150 mg of Fluorine-Containing Surfactant (F-2) (polyethylene glycol mono(N-perfluorooctylsulfonyl-N-propyl-2-aminoethyl) ether [ethylene oxide average polymerization degree: 15]), 64 mg of Fluorine-Containing Surfactant (F-3), 32 mg of Fluorine-Containing Surfactant (F-4), 8.8 g of an acrylic acid/ethyl acrylate copolymer (copolymerization weight ratio: 5/95), 0.6 g of “Aerosol OT” (produced by American Cyanamide), 1.8 g of liquid paraffin emulsion as liquid paraffin and 950 ml of water were mixed to prepare a coating solution for protective layer on the back surface.

(Preparation of Silver Halide Emulsion)

<Preparation of Silver Halide Emulsion 1>

A solution was prepared by adding 3.1 ml of a 1 mass % potassium bromide solution, 3.5 ml of sulfuric acid in a concentration of 0.5 mol/L and 31.7 g of phthalated gelatin to 1,421 ml of distilled water and while stirring the solution in a stainless steel-made reaction pot and thereby keeping the liquid temperature at 30° C., the entire amount of Solution A prepared by diluting 22.22 g of silver nitrate with distilled water to a volume of 95.4 ml and the entire amount of Solution B prepared by diluting 15.3 g of potassium bromide and 0.8 g of potassium iodide with distilled water to a volume of 97.4 ml were added at a constant flow rate over 45 seconds. Thereto, 10 ml of an aqueous 3.5 mass % hydrogen peroxide solution was added and then, 10.8 ml of a 10 mass % aqueous solution of benzimidazole was further added. Thereafter, the entire amount of Solution C prepared by diluting 51.86 g of silver nitrate with distilled water to a volume of 317.5 ml and the entire amount of Solution D obtained by diluting 44.2 g of potassium bromide and 2.2 g of potassium iodide with distilled water to a volume of 400 ml were added. Here, Solution C was added at a constant flow rate over 20 minutes and Solution D was added by the controlled double jet method while maintaining the pAg at 8.1. After 10 minutes from the initiation of addition of Solution C and Solution D, the entire amount of potassium hexachloroiridate(III) was added to a concentration of 1×10⁻⁴ mol per mol of silver. Furthermore, 5 seconds after the completion of addition of Solution C, the entire amount of an aqueous potassium hexacyanoferrate(II) solution was added to a concentration of 3×10⁻⁴ mol per mol of silver. Then, the pH was adjusted to 3.8 using sulfuric acid in a concentration of 0.5 mol/L and after stirring was stopped, the resulting solution was subjected to precipitation/desalting/water washing. The pH was then adjusted to 5.9 using sodium hydroxide in a concentration of 1 mol/L, thereby preparing a silver halide dispersion at a pAg of 8.0.

While stirring the silver halide dispersion obtained above and thereby keeping it at 38° C., 5 ml of a methanol solution containing 0.34 mass % of 1,2-benzoisothiazolin-3-one was added and the temperature was elevated 47° C. After 20 minutes from the elevation of temperature, a methanol solution of sodium benzenethiosulfonate was added in an amount of 7.6×10⁻⁵ mol per mol of silver and after 5 minutes, a methanol solution of Tellurium Sensitizer C was further added in an amount of 2.9×10⁻⁴ Mol per mol of silver. Then, the solution was ripened for 80 minutes. Thereafter, a methanol solution containing Spectral Sensitizing Dye A and Spectral Sensitizing Dye B at a molar ratio of 1:1 was added in an amount, as a total of Sensitizing Dye A and Sensitizing Dye B, of 1.2×10⁻³ mol per mol of silver. Thereto, 1.3 ml of a 0.8 mass % methanol solution of N,N′-dihydroxy-N″-diethylmelamine was added and after 4 minutes, a methanol solution of Compound (28) as a compound of formula (1) and a methanol solution of Compound (26) as a compound of formula (1) were added in an amount of 4.6×10⁻³ mol and 5.4×10⁻³ mol, respectively, per mol of silver to prepare Silver Halide Emulsion 1.

The grains in the thus-prepared silver halide emulsion were silver iodobromide grains having an average equivalent-sphere diameter of 0.039 μm and a coefficient of variation in the equivalent-sphere diameter of 18% and uniformly containing 3.5 mol % of iodide. The grain size and the like were determined as an average of 1,000 grains using an electron microscope. The percentage of [100] faces in this grain was 80% as determined using the Kubelka-Munk equation.

<Preparation of Silver Halide Emulsion 11>

Silver Halide Emulsion 11 was prepared in the same manner as Silver Halide Emulsion 1 except that the liquid temperature at the grain formation was changed from 30° C. to 47° C., Solution B was obtained by diluting 15.9 g of potassium bromide with distilled water to a volume of 97.4 ml, Solution D was obtained by diluting 45.8 g of potassium bromide. with distilled water to a volume of 400 ml, the addition time of Solution C was changed to 30 minutes and potassium hexacyanoferrate(II) was excluded. Also, precipitation/desalting/water washing/dispersion were performed in the same manner as in the preparation of Silver Halide Emulsion 1. Thereafter, spectral sensitization, chemical sensitization and addition of compounds (26) and (28) as compounds of formula (1) were performed in the same manner as in the preparation of Emulsion 1 except that the amount added of the methanol solution containing Spectral Sensitizing Dye A and Spectral Sensitizing Dye B at a molar ratio of 1:1 was changed, as a total of Sensitizing Dye A and Sensitizing Dye B, to 7.5×10⁻⁴ mol per mol of silver, the amount of Tellurium Sensitizer C added was changed to 1×10⁻⁴ mol per mol of silver, and the amount of Compound (26) as a compound of formula (1) added was changed to 3.3×10⁻³ mol per mol of silver. Thus, Silver Halide Emulsion 11 was obtained. The emulsion grains of Silver Halide Emulsion 11 were pure silver bromide cubic grains having an average equivalent-sphere diameter of 0.080 μm and a coefficient of variation in the equivalent-sphere diameter of 20%.

<Preparation of Silver Halide Emulsion 2>

Silver Halide Emulsion 2 was prepared in the same manner as Silver Halide Emulsion 1 except that at the chemical sensitization in the preparation of Emulsion 1, a solid dispersion (aqueous gelatin solution) containing Spectral Sensitizing Dye A and Spectral Sensitizing Dye B at a molar ratio of 1:1 was added in an amount, as a total of Sensitizing Dye A and Sensitizing Dye B, of 6×10⁻³ mol per mol of silver, the amount of Tellurium Sensitizer C added was changed to 5.2×10⁻⁴ mol per mol of silver, and a methanol solution of compound (17) as a compound of formula (1) was added in an amount of 1.4×10⁻² mol per mol of silver in place of adding Compounds (26) and (28) as compounds of formula (1). The emulsion grains of Silver Halide Emulsion 2 were silver iodobromide grains having an average equivalent-sphere diameter of 0.039 μm and a coefficient of variation in the equivalent-sphere diameter of 19% and uniformly containing 3.5 mol % of iodide.

<Preparation of Silver Halide Emulsion 12>

Silver Halide Emulsion 12 was prepared in the same manner as Silver Halide Emulsion 11 except that at the chemical sensitization in the preparation of Emulsion 11, Spectral Sensitizing Dye A and Spectral Sensitizing Dye B were added in a total amount of 9.0×10⁻⁴ mol per mol of silver and Compound (17) as a compound of formula (1) was added in an amount of 4.7×10⁻³ mol per mol of silver in place of adding Compounds (26) and (28) as compounds of formula (1). The emulsion grains of Silver Halide Emulsion 12 were pure silver bromide grains having an average equivalent-sphere diameter of 0.079 μm and a coefficient of variation in the equivalent-sphere diameter of 19%.

<Preparation of Silver Halide Emulsion 3>

Silver Halide Emulsion 3 was prepared in the same manner as Silver Halide Emulsion 2 except that in place of adding a methanol solution of Compound (17) as a compound of formula (1) in an amount of 1.4×10⁻² mol per mol of silver, 5-methyl-benzotriazole (comparative compound) was added in the same amount at the chemical sensitization in the preparation of Emulsion 2. The emulsion grains of Silver Halide Emulsion 3 were silver iodobromide grains having an average equivalent-sphere diameter of 0.038 μm and a coefficient of variation in the equivalent-sphere diameter of 19% and uniformly containing 3.5 mol % of iodide.

<Preparation of Silver Halide Emulsion 13>

Silver Halide Emulsion 13 was prepared in the same manner as Silver Halide Emulsion 12 except that in place of adding a methanol solution of Compound (17) as a compound of formula (1) in an amount of 4.7×10⁻³ mol per mol of silver, 5-methyl-benzotriazole (comparative compound) was added in the same amount at the chemical sensitization in the preparation of Emulsion 12. The emulsion grains of Silver Halide Emulsion 13 were pure silver bromide grains having an average equivalent-sphere diameter of 0.078 μm and a coefficient of variation in the equivalent-sphere diameter of 19%.

<Preparation of Silver Halide Emulsion 4>

Silver Halide Emulsion 4 was prepared in the same manner as Silver Halide Emulsion 2 except that chemical sensitizers were excluded in the preparation of Emulsion 2. The emulsion grains of Silver Halide Emulsion 4 were silver iodobromide grains having an average equivalent-sphere diameter of 0.039 μm and a coefficient of variation in the equivalent-sphere diameter of 19% and uniformly containing 3.5 mol % of iodide

<Preparation of Silver Halide Emulsion 14>

Silver Halide Emulsion 14 was prepared in the same manner as Silver Halide Emulsion 12 except that chemical sensitizers were excluded in the preparation of Emulsion 12. The emulsion grains of Silver Halide Emulsion 14 were pre silver bromide grains having an average equivalent-sphere diameter of 0.079 μm and a coefficient of variation in the equivalent-sphere diameter of 19%.

The characteristic features of each emulsion are shown together in Table 6.

TABLE 6

| Emulsion | Halogen | Grain | Chemical | Compound of |
|---|---|---|---|---|
| No. | Composition | Size (nm) | Sensitizer | Formula (1) |
| 1 | AgBrI_{3.5} | 39 | Te sensitizer | 26, 28 |
| 2 | AgBrI_{3.5} | 39 | Te sensitizer | 17 |
| 3 | AgBrI_{3.5} | 39 | Te sensitizer | Comparative |
| | | | | compound |
| 4 | AgBrI_{3.5} | 39 | None | 17 |
| 11 | AgBr | 80 | Te sensitizer | 26, 28 |
| 12 | AgBr | 79 | Te sensitizer | 17 |
| 13 | AgBr | 78 | Te sensitizer | Comparative |
| | | | | compound |
| 14 | AgBr | 79 | Te sensitizer | 17 |

(Preparation of Mixed Emulsion for Coating Solution)

<Preparation of Mixed Emulsion 21 for Coating Solution>

87 Mass % of Silver Halide Emulsion 1 and 13 mass % of Silver Halide Emulsion 11 were dissolved. Thereto, water was added to adjust the silver halide content to 38.2 g in terms of silver per kg of the mixed emulsion for coating solution.

<Preparation of Mixed Emulsion 22 for Coating Solution>

87 Mass % of Silver Halide Emulsion 2 and 13 mass % of Silver Halide Emulsion 12 were dissolved. Thereto, water was added to adjust the silver halide content. to 38.2 g in terms of silver per kg of the mixed emulsion for coating solution.

<Preparation of Mixed Emulsion 23 for Coating Solution>

87 Mass % of Silver Halide Emulsion 3 and 13 mass % of Silver Halide Emulsion 13 were dissolved. Thereto, water was added to adjust the silver halide content to 38.2 g in terms of silver per kg of the mixed emulsion for coating solution.

<Preparation of Mixed Emulsion 24 for Coating Solution>

87 Mass % of Silver Halide Emulsion 4 and 13 mass % of Silver Halide Emulsion 14 were dissolved. Thereto, water was added to adjust the silver halide content to 38.2 g in terms of silver per kg of the mixed emulsion for coating solution.

(Preparation of Fatty Acid Silver Salt Dispersion)

Behenic acid (87.6 kg, “Edenor C22-85R”, trade name, produced by Henkel Co.), 423 L of distilled water, 49.2 L of an aqueous NaOH solution in a concentration of 5 mol/L, and 120 L of tert-butyl alcohol were mixed. The mixture was reacted by stirring at 75° C. for one hour to obtain a sodium behenate solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the sodium behenate solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the sodium behenate solution was started, and only the sodium behenate solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the sodium behenate solution was kept warm by circulating hot water in the outer side of a double pipe, whereby the outlet liquid temperature at the distal end of the addition nozzle was adjusted to 75° C. The piping in the system of adding the aqueous silver nitrate solution was kept warm by circulating cold water in the outer side of a double pipe. The addition site of sodium behenate solution and the addition site of aqueous silver nitrate solution were symmetrically arranged centered around the stirring axis. Also, these addition sites were each adjusted to a height of not causing contact with the reaction solution.

After the completion of addition of the sodium behenate solution, the mixture was left standing at that temperature for 20 minutes with stirring. The temperature was then elevated to 35° C. over 30 minutes and the solution was ripened for 210 minutes. Immediately after the completion of ripening, the solid content was separated by centrifugal filtration and washed with water until the conductivity of filtrate became 30 μS/cm. In this manner, a fatty acid silver salt was obtained. The solid content obtained was not dried but stored as a wet cake.

The shape of the thus-obtained silver behenate grains was analyzed by electron microphotography. The grains were scaly crystals having average sizes of a=0.14 μn, b=0.4 μm and c=0.6 μm, an average aspect ratio of 5.2, an average equivalent-sphere diameter of 0.52 μm and a coefficient of variation in the equivalent-sphere diameter of 15% (a, b and c comply with the definition in this specification).

To the wet cake corresponding to 260 Kg as a dry solid content, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain a silver behenate dispersion. At the dispersion, the temperature was set to 18° C. by a cooling operation of controlling the temperature of coolant using coiled heat exchangers attached to the inlet side and outlet side of the interaction chamber.

(Preparation of Reducing Agent Dispersion)

<Preparation of Reducing Agent Complex 1 Dispersion>

To 10 kg of Reducing Agent Complex 1 (a 1:1 complex of 6,6′-di-tert-butyl-4,4′-dimethyl-2,2′-butylidenediphenol and triphenylphosphine oxide), 0.12 Kg of triphenylphosphine oxide and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 4 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the reducing agent concentration to 22 mass %, thereby obtaining Reducing Agent Complex 1 Dispersion. The reducing agent complex particles contained in the thus-obtained reducing agent complex dispersion had a median diameter of 0.45 μm and a maximum particle size of 1.4 μm or less. The obtained reducing agent complex dispersion was filtered through a polypropylene-made filter having a pore size of 3.0 μm to remove foreign matters such as dust and then housed.

<Preparation of Reducing Agent 2 Dispersion>

To 10 kg of Reducing Agent 2 (6,6′-di-tert-butyl-4,4′-dimethyl-2,2′-butylidenediphenol) and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the reducing agent concentration to 25 mass %, thereby obtaining Reducing Agent 2 Dispersion. The reducing agent particles contained in the thus-obtained reducing agent dispersion had a median diameter of 0.40 μm and a maximum particle size of 1.5 μm or less. The obtained reducing agent dispersion was filtered through a polypropylene-made filter having a pore size of 3.0 μm to remove foreign matters such as dust and then housed.

<Preparation of Hydrogen Bond-Forming Compound 1 Dispersion>

To 10 Kg of Hydrogen Bond-Forming Compound 1 (tri(4-tert-butylphenyl)phosphine oxide) and 16 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the hydrogen bond-forming compound concentration to 25 mass %, thereby obtaining Hydrogen Bond-Forming Compound 1 Dispersion. The hydrogen bond-forming compound particles contained in the thus-obtained hydrogen bond-forming compound dispersion had a median diameter of 0.35 μm and a maximum particle size of 1.5 μm or less. The obtained hydrogen bond-forming compound dispersion was filtered through a polypropylene-made filter having a pore size of 3.0 μm to remove foreign matters such as dust and then housed.

<Preparation of Development Accelerator 1 Dispersion>

To 10 Kg of Development Accelerator 1 and 20 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the development accelerator concentration to 20 mass %, thereby obtaining Development Accelerator 1 Dispersion. The development accelerator particles contained in the thus-obtained development accelerator dispersion had a median diameter of 0.48 μm and a maximum particle size of 1.4 μm or less. The obtained development accelerator dispersion was filtered through a polypropylene-made filter having a pore size of. 3.0 m to remove foreign matters such as dust and then housed.

Solid Dispersions of Development Accelerator 2, Development Accelerator 3 and Color Tone Adjuster 1 each was obtained as a 20 mass % dispersion in the same manner as Development Accelerator 1.

(Preparation of Polyhalogen compound)

<Preparation of Organic Polyhalogen Compound 1 Dispersion>

To 10 Kg of Organic Polyhalogen Compound 1 (tribromomethanesulfonylbenzene), 10 Kg of a 20 mass % aqueous solution of modified polyvinyl alcohol (“Poval MP203”, produced by Kuraray Co., Ltd.) and 0.4 Kg of a 20 mass % aqueous solution of sodium triisopropylnaphthalenesulfonate, 14 Kg of water was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 26 mass %, thereby obtaining Organic Polyhalogen Compound 1 Dispersion. The organic polyhalogen compound particles contained in the thus-obtained organic polyhalogen compound dispersion had a median diameter of 0.41 μm and a maximum particle size of 2.0 μm or less. The obtained organic polyhalogen compound dispersion was filtered through a polypropylene-made filter having a pore size of 10.0 μm to remove foreign matters such as dust and then housed.

<Preparation of Organic Polyhalogen Compound 2 Dispersion>

To 10 Kg of Organic Polyhalogen Compound 2 (N-butyl-3-tribromomethanesulfonylbenzamide) and 20 Kg of a 10 mass % aqueous solution of modified polyvinyl alcohol (“Poval MP203”, produced by Kuraray Co., Ltd.), 0.4 Kg of a 20 mass % aqueous solution of sodium triisopropylnaphthalenesulfonate was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 30 mass %. This dispersion solution was heated at 40° C. for 5 hours, whereby Organic Polyhalogen Compound 2 Dispersion was obtained. The organic polyhalogen compound particles contained in the thus-obtained polyhalogen compound dispersion had a median diameter of 0.40 μm and a maximum particle size of 1.3 μm or less. The obtained organic polyhalogen compound dispersion was filtered through a polypropylene-made filter having a pore size of 3.0 μm to remove foreign matters such as dust and then housed.

<Preparation of Phthalazine Compound 1 Solution>

In 174.57 Kg of water, 8 Kg of modified polyvinyl alcohol “MP203” produced by Kuraray Co., Ltd. was dissolved. Thereto, 3.15 Kg of a 20 mass % aqueous solution of sodium triisopropylnaphthalenesulfonate and 14.28 Kg of a 70 mass % aqueous solution of Phthalazine Compound 1 (6-isopropylphthalazine) were added to prepare a 5 mass % solution of Phthalazine Compound 1.

<Preparation of Pigment 1 Dispersion>

To 64 g of C.I. Pigment Blue 60 and 6.4 g of “Demol N” (produced by Kao Corporation), 250 g of water was added and thoroughly mixed to form a slurry. The resulting slurry and 800 g of zirconia beads having an average diameter of 0.5 mm were put together into a vessel and dispersed for 25 hours in a dispersing machine (¼G Sand Grinder Mill, manufactured by AIMEX K. K.) to obtain Pigment 1 Dispersion. The pigment particles contained in the thus-obtained pigment dispersion had an average particle size of 0.21 μm.

<Preparation of Comparative Binder>

The comparative binder for the image-forming layer was obtained as follows. To Compound (RP-1) obtained in Comparative Examples 1 to 3 below, 1 mol/liter of NaOH and NH₄OH were added to have a molar ratio of Na⁺ ion:NH₄⁺ ion=1:2.3 and then, the pH was adjusted to 8.4. At this time, the latex concentration was 40 mass %.

### COMPARATIVE SYNTHESIS EXAMPLE 1

Synthesis of Compound (RP-1):

Compound RP-1 (solid content: 45%, particle size; 80 nm) was synthesized all in accordance with the synthesis formulation of Polymer Latex P-1 in Synthesis Example 1 of the present invention except that the surfactant was changed to “PELEX SS-L” (produced by Kao Corporation). The chloride ion concentration was 400 ppm.

### COMPARATIVE SYNTHESIS EXAMPLE 2

Synthesis of Compound (RP-2):

Compound RP-2 (solid content: 44%, particle size: 75 nm) was synthesized all in accordance with the synthesis formulation of Polymer Latex P-2 in Synthesis Example 2 of the present invention except that the surfactant was changed to “PELEX SS-L” (produced by Kao Corporation) and tetrasodium ethylenediaminetetraacetate (chelate compound) was not used. The chloride ion concentration was 390 ppm.

<Preparation of Coating Solution 1 for Emulsion Layer (Photosensitive Layer)>

The fatty acid silver salt dispersion prepared above (1,000 g), 276 ml of water, 33.2 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of an SBR latex solution shown in Table 7, 299 g of Reducing Agent Complex 1 Dispersion, 6 g of Development Accelerator 1 Dispersion and a compound of formula (1) shown in Table 7 in an amount to have a concentration of 1×10⁻⁵ mol per mol of fatty acid silver salt were sequentially added. Immediately before the coating, 17 g of a silver halide mixed emulsion shown in Table 7 was added and thoroughly mixed. The resulting coating solution for emulsion layer was transferred as it was to a coating die.

The viscosity of the coating solution for emulsion layer obtained above was measured by a Brookfield viscometer manufactured by Tokyo Keiki Kogyo K. K. and found to be 25 [mPa·s] at 40° C. (No. 1 rotor, 60 rpm).

The viscosity of the coating solution measured at 25° C. using “RFS Field Spectrometer” (manufactured by Rheometrics Far East K. K.) was 230, 60, 46, 24 and 18 [mPa·s] at a shear rate of 0.1, 1, 10, 100 and 1,000 [1/sec], respectively.

The amount of zirconium in the coating solution was 0.38 mg per g of silver.

<Preparation of Coating Solution 2 for Emulsion Layer (Photosensitive Layer)>

The fatty acid silver salt dispersion prepared above (1,000 g), 276 ml of water, 32.8 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of an SBR latex (Tg: 20° C.) solution shown in Table 8, 155 g of Reducing Agent 2 Dispersion, 55 g of Hydrogen Bond-Forming Compound 1 Dispersion, 6 g of Development Accelerator 1 Dispersion, 2 g of Development Accelerator 2 Dispersion, 3 g of Development Accelerator 3 Dispersion and 2 g of Color Tone Adjuster 1 Dispersion were sequentially added. Thereto, a compound of formula (1) shown in Table 8 was added in an amount to have a concentration of 1×10⁻⁵ mol per g of fatty acid silver salt. immediately before the coating, a silver halide mixed emulsion shown in Table 8 was added and thoroughly mixed. The resulting coating solution for emulsion layer was transferred as it was to a coating die.

The viscosity of the coating solution for emulsion layer obtained above was measured by a Brookfield viscometer manufactured by Tokyo Keiki Kogyo K. K. and found to be 40 [mPa·s] at 40° C. (No. 1 rotor, 60 rpm).

The viscosity of the coating solution measured at 25° C. using “RFS Field spectrometer” (manufactured by Rheometrics Far East K. K.) was 530, 144, 96, 51 and 28 [mPa·s] at a shear rate of 0.1, 1, 10, 100 and 1,000 [1/sec], respectively.

The amount of zirconium in the coating solution was 0.25 mg per g of silver.

<Preparation of Coating Solution for Interlayer on Emulsion Surface>

A 5 mass % aqueous solution (27 ml) of “Aerosol OT” (produced by American Cyanamide), 135 ml of a 20 mass % aqueous solution of diammonium phthalate and water for making a total amount of 10,000 g were added to 1,000 g of polyvinyl alcohol “PVA-205” (produced by Kuraray Co., Ltd.), 272 g of a 5 mass % pigment dispersion and 4,200 ml of a 19 mass % solution of methyl methacrylate/styrene/butyl acrylate/hydroxyethyl methacrylate/acrylic acid copolymer (copolymerization weight ratio: 64/9/20/5/2) latex. The pH was adjusted to 7.5 with NaOH to prepare a coating solution for interlayer and then the coating solution for interlayer was transferred to a coating die to. give a coverage of 9.1 ml/m².

The viscosity of the coating solution was measured at 40° C. by a Brookfield viscometer (No. 1 rotor, 60 rpm) and found to be 58 [mPa·s].

<Preparation of Coating Solution for First Protective Layer on Emulsion Surface>

In water, 64 g of inert gelatin was dissolved. Thereto, 80 g of a 27.5 mass % solution of methyl methacrylate/styrene/butyl acrylate/hydroxyethyl methacrylate/acrylic acid copolymer (copolymerization weight ratio: 64/9/20/5/2) latex, 23 ml of a 10 mass % methanol solution of phthalic acid, 23 ml of a 10 mass % aqueous solution of 4-methylphthalic acid, 28 ml of sulfuric acid in a concentration of 0.5 mol/L, 5 ml of a 5 mass % aqueous solution of “Aerosol OT” (produced by American Cyanamide), 0.5 g of phenoxyethanol, 0.1 g of benzoisothiazolinone and water for making a total amount of 750 g were added to prepare a coating solution. Immediately before the coating, 26 ml of a 4 mass % chrome alum was mixed using a static mixer. Then, the coating solution was transferred to a coating die to give a coverage of 18.6 ml/m².

The viscosity of the coating solution was measured at 40° C. by a Brookfield viscometer (No. 1 rotor, 60 rpm) and found to be 20 [mPa·s].

<Preparation of Coating Solution for Second Protective Layer on Emulsion Surface>

In water, 80 g of inert gelatin was dissolved. Thereto, 102 g of a 27.5 mass % solution of methyl methacrylate/styrene/butyl acrylate/hydroxyethyl methacrylate/acrylic acid copolymer (copolymerization weight ratio: 64/9/20/5/2) latex, 3.2 ml of a 5 mass % solution of Fluorine-Containing Surfactant (F-1) (N-perfluorooctylsulfonyl-N-propylalanine potassium salt), 32 ml of a 2 mass % aqueous solution of Fluorine-Containing Surfactant (F-2) (polyethylene glycol mono (N-perfluorooctylsulfonyl-N-propyl-2-aminoethyl)ether [ethylene oxide average polymerization degree: 15]), 23 ml of a 5 mass % solution of “Aerosol OT” (produced by American Cyanamide), 4 g. of polymethyl methacrylate fine particles (average particle size: 0.7 μm), 21 g of polymethyl methacrylate fine particles (average particle size: 4.5 μm), 1.6 g of 4-methylphthalic acid, 4.8 g of phthalic acid, 44 ml of sulfuric acid in a concentration of 0.5 mol/L, 10 mg of benzoisothiazolinone and water for making a total amount of 650 g were added. Immediately before the coating, 445 ml of an aqueous solution containing 4 mass % of chrome alum and 0.67 mass % of phthalic acid was mixed using a static mixer to obtain a coating solution for surface protective layer and then the coating solution for surface protective layer was transferred to a coating die to give a coverage of 8.3 ml/m².

The viscosity of the coating solution was measured at 40° C. by a Brookfield viscometer (No. 1 rotor, 60 rpm) and found to be 19 [mPa·s].

<Preparation of Heat-Developable Photosensitive Material 1>

In the back surface side of the undercoated support prepared above, the coating solution for antihalation layer and the coating solution for back surface protective layer were simultaneously coated one on another to give a coated amount of solid fine particle dye of 0.04 g/m² as a solid content and a gelatin coated amount of 1.7 g/m², respectively. Then, the coating was dried to form a back layer.

On the surface opposite the back surface, an emulsion layer, an interlayer, a first protective layer and a second protective layer were simultaneously coated one on another in this order from the undercoated surface by the slide bead coating method using respective coating solutions including Coating Solution 1 for Emulsion Layer to prepare Samples 1 to 12 of Heat-Developable Photosensitive Material 1. At this time, the temperature was adjusted such that the emulsion layer and the interlayer were 31° C., the first protective layer was 36° C. and the second protective layer was 37° C.

The coated amount (g/m²) of each compound in the emulsion layer is shown below.

| | |
|---|---|
| Silver behenate | 5.55 |
| Pigment (C.I. Pigment Blue 60) | 0.036 |
| Polyhalogen Compound 1 | 0.12 |
| Polyhalogen Compound 2 | 0.37 |
| Phthalazine Compound 1 | 0.19 |
| SBR Latex (shown in Table 7) | 9.97 |
| Reducing Agent Complex 1 | 1.41 |
| Development Accelerator 1 | 0.024 |

Compound of formula (1) (shown in Table 7)

1×10⁻⁵ mol per g of fatty acid silver salt

Silver halide (as Ag) 0.091

The coating and drying conditions were as follows.

The coating was performed at a speed of 160 m/min, the distance between the tip of coating die and the support was set to from 0.10 to 0.30 mm, and the pressure in the vacuum chamber was set lower by 196 to 882 Pa than the atmospheric pressure. The support was destaticized by ionized wind before the coating.

In the subsequent chilling zone, the coating solution was cooled with air at a dry bulb temperature of 10 to 20° C. The sample was then subjected to contact-free transportation and in a helical floating-type dryer, dried with drying air at a dry bulb temperature of 23 to 45° C. and a wet bulb temperature of 15 to 21° C.

After drying, the humidity was adjusted to 40 to 60% R¹⁴ at 25° C. and then, the layer surface was heated to 70 to 90° C. The heated layer surface was then cooled to 25° C.

The heat-developable photosensitive material thus prepared had a matting degree of, in terms of the Beck's smoothness, 550 seconds on the photosensitive layer surface and 130 seconds on the back surface. Furthermore, the pH on the layer surface in the photosensitive layer side was measured and found to be 6.0.

<Preparation of Heat-Developable Photosensitive Material 2>

Samples 13 to 20 of Heat-Developable Photosensitive Material 2 were prepared in the same manner as Heat-Developable Photosensitive Material 1 except that in the preparation of Heat-Developable Photosensitive Material 1, Coating Solution 1 for Emulsion Layer was changed to Coating Solution 2 for Emulsion Layer, Yellow Dye Compound 15 was eliminated from the antihalation layer, and the fluorine-containing surfactants in the back surface protective layer and emulsion surface protective layer were changed from F-1, F-2, F-3 and F-4 to F-5, F-6, F-7 and F-8, respectively.

The coated amount (g/m²) of each compound in this emulsion layer is shown below.

| | |
|---|---|
| Silver behenate | 5.55 |
| Pigment (C.I. Pigment Blue 60) | 0.036 |
| Polyhalogen Compound 1 | 0.12 |
| Polyhalogen Compound 2 | 0.37 |
| Phthalazine Compound 1 | 0.19 |
| SBR Latex (shown in Table 8) | 9.67 |
| Reducing Agent 2 | 0.81 |
| Hydrogen Bond-Forming Compound 1 | 0.30 |
| Development Accelerator 1 | 0.024 |
| Development Accelerator 2 | 0.010 |
| Development Accelerator 3 | 0.015 |
| Color Tone Adjuster 1 | 0.010 |

Compound of formula (1) (shown in Table 8)

1×10⁻⁵ mol per g of fatty acid silver salt

Silver halide (as Ag) 0.091

Chemical structures of the compounds used in Examples of the present invention are shown below.

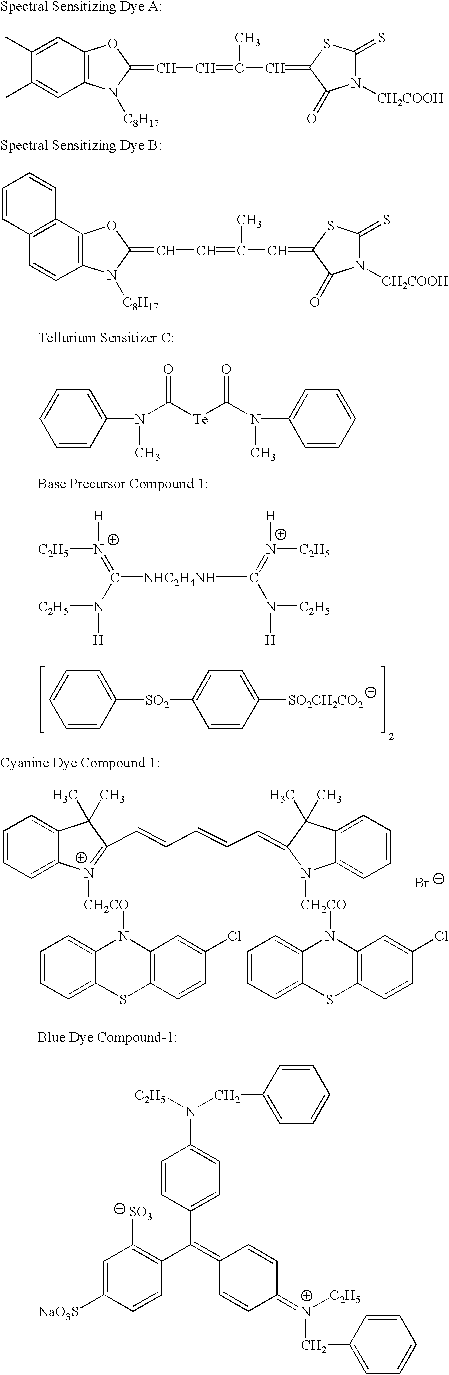

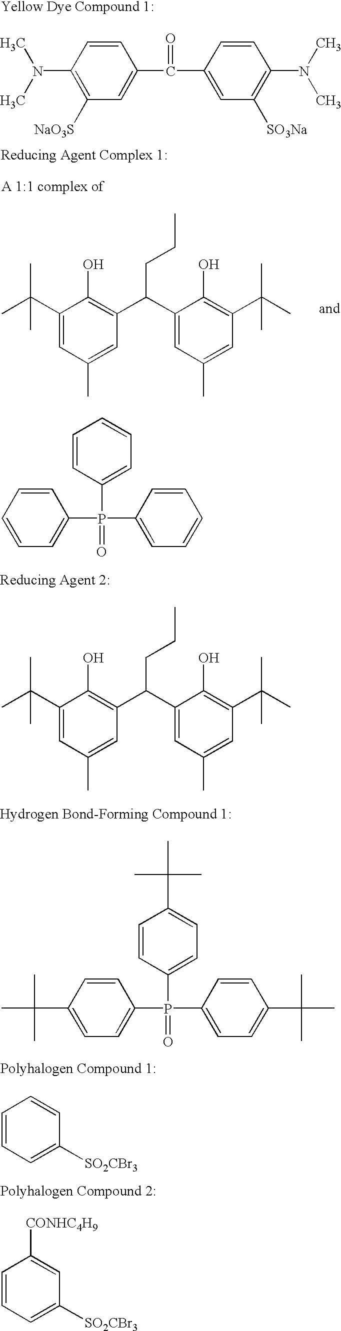

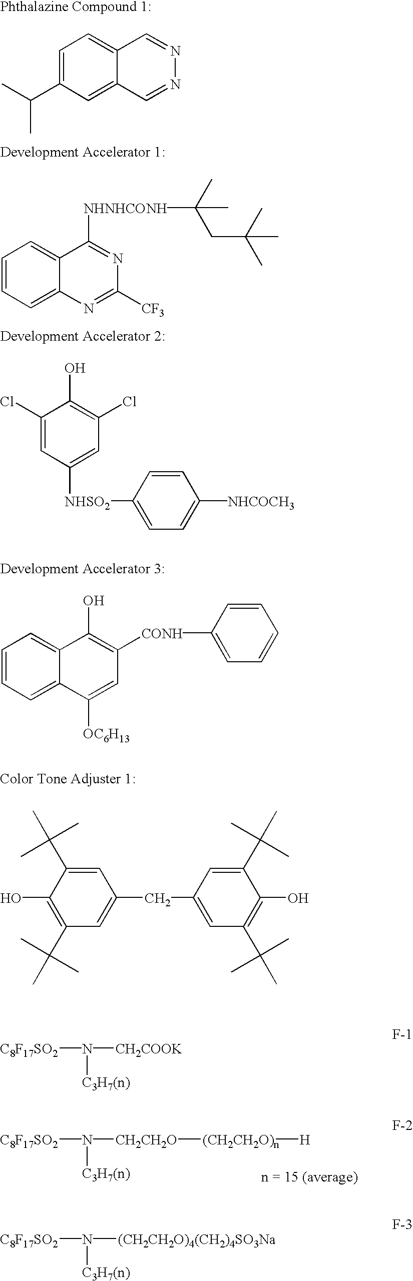

F-4 C₈F₁₇SO₃K

F-5 CF₃—(CF₂ₙ—CH₂CH₂SCH₂CH₂CO₂Li

a mixture of n=5 to 11

F-6 CF₃—(CF₂)ₙ—CH₂CH₂O—(CH₂CH₂O)ₘ—H

a mixture of n=5 to 11, m=5 to 15

F-7 CF₃—(CF₂)ₙ—CH₂CH₂SO₃Na

a mixture of n=5 to 11

F-8 C₆F₁₃CH₂CH₂SO₃Li

[Evaluation]

The heat-developable photosensitive material samples obtained each was cut into a size of 356×432 mm, wrapped with the following packaging material in an environment of 25° C. and 50% RH, stored at an ordinary temperature for 2 weeks and then evaluated on the items shown below.

(Packaging Material)

Polyethylene (50 μm) containing 10 μm of PET/12 μm of PE/9 μm of aluminum foil/15 μm of Ny/3% of carbon:

oxygen permeability: 0 ml/atm·m²·25° C.·day

water permeability: 0 g/atm·m²·25° C.·day

(Evaluation of Sensitivity)

The samples each was exposed and heat-developed (with four sheets of panel heater set at 112° C.-119° C.-121° C.-121° C., for 24 seconds in total in the case of Photosensitive Material 1 and for 14 seconds in total in the case of Photosensitive Material 2) in “Fuji Medical Dry Laser Imager FM-DP L” (in which a semiconductor laser of 660 nm having a maximum output of 60 mW (IIIB) was mounted). The sensitivity of the obtained image was evaluated by a densitometer.

(Evaluation of Storability (Fog in Aging) of Photosensitive Material of Unprocessed Photosensitive Material)

The photosensitive materials obtained were stored at 30° C. for 2 months and the change of fog in aging was measured. The change of fog is shown by the difference (ΔFog) between the initial density and the density after storage.

TABLE 7
Evaluation Results of Heat-Developable Photosensitive Material 1

| | | | Chloride | Compound of | | | |
|---|---|---|---|---|---|---|---|
| | | | Ion | Formula (1) | | | |
| | | | Concen- | at the | | | |
| | | | tration | Preparation | | | |
| | | | Based on | of Coating | | | |
| | | | Organic | Solution for | | Fog in | |
| | Mixed | SBR | Silver | Emulsion | Sensi- | Aging, | |
| Sample | Emulsion | Latex | (ppm) | Layer | tivity | ΔFog | |
| 1 | 21 | P-1 | 150 | none | 100 | 0.08 | Invention |
| 2 | 22 | P-1 | 150 | 17 | 103 | 0.03 | Invention |
| 3 | 23 | P-1 | 150 | 17 | 102 | 0.04 | Invention |
| 4 | 24 | P-1 | 150 | 17 | 91 | 0.01 | Invention |
| 5 | 21 | P-5 | 800 | 17 | 101 | 0.03 | Invention |
| 6 | 22 | P-5 | 800 | 17 | 101 | 0.04 | Invention |
| 7 | 22 | P-5 | 800 | 23 | 100 | 0.03 | Invention |
| 8 | 22 | P-5 | 800 | 17, 23 | 101 | 0.02 | Invention |
| 9 | 23 | P-5 | 800 | none | 102 | 0.08 | Comparison |
| 10 | 24 | P-5 | 800 | 17 | 90 | 0.01 | Invention |
| 11 | 22 | RP-1 | 1650 | 17 | 103 | 0.07 | Comparison |
| 12 | 22 | RP-2 | 1600 | 17 | 105 | 0.07 | Comparison |

The chloride ion concentration was determined using the coating solution for emulsion layer.

TABLE 8
Evaluation Results of Heat-Developable Photosensitive Material 2

| | | | | Compound of | | | |
|---|---|---|---|---|---|---|---|
| | | | Chloride | Formula (1) | | | |
| | | | Ion | at the | | | |
| | | | Concen- | Preparation | | | |
| | | | tration | of Coating | | | |
| | | | Based on | Solution | | | |
| | | | Organic | for | | Fog in | |
| | Mixed | SBR | silver | Emulsion | Sensi- | Aging, | |
| Sample | Emulsion | Latex | (ppm) | Layer | tivity | ΔFog | |
| 13 | 22 | P-1 | 100 | 17 | 100 | 0.03 | Invention |
| 14 | 23 | P-1 | 100 | none | 101 | 0.08 | Comparison |
| 15 | 22 | P-5 | 800 | 17 | 102 | 0.04 | Invention |
| 16 | 22 | P-5 | 800 | 23 | 101 | 0.03 | Invention |
| 17 | 23 | P-5 | 800 | none | 103 | 0.09 | Comparison |
| 18 | 24 | P-5 | 800 | 17 | 92 | 0.01 | Invention |
| 19 | 22 | RP-1 | 1650 | 17 | 100 | 0.09 | Comparison |
| 20 | 23 | RP-1 | 1650 | none | 102 | 0.11 | Comparison |

The chloride ion concentration was determined using the coating solution for emulsion layer.

It is seen from the results in Tables 7 and 8 that the photosensitive material of the present invention, having a low chloride ion concentration based on the organic silver and containing a compound represented by formula (1) has high sensitivity and is suppressed from the increase of fog in aging.

### EXAMPLE 5

<Preparation of Silver Halide Emulsion 5>

Silver Halide Emulsion 5 was prepared in the same manner as Silver Halide Emulsion 2 except that the liquid temperature at the grain formation was changed from 30° C. to 26° C. and all chemicals added at the chemical sensitization were changed in the amount added to 1.4 times. The emulsion grains of Silver Halide Emulsion 5 were silver iodobromide grains having an average equivalent-sphere diameter of 0.025 μm and a coefficient of variation in the equivalent-sphere diameter of 20% and uniformly containing 3.5 mol % of iodide.

<Preparation of Silver Halide Emulsion 6>

Silver Halide Emulsion 6 was prepared in the same manner as Silver Halide Emulsion 2 except that the liquid temperature at the grain formation was changed from 30° C. to 34° C. and all chemicals added at the chemical sensitization were changed in the amount added to 0.85 times. The emulsion grains of Silver Halide Emulsion 6 were silver iodobromide grains having an average equivalent-sphere diameter of 0.046 μm and a coefficient of variation in the equivalent-sphere diameter of 19% and uniformly containing 3.5 mol % of iodide.

<Preparation of Silver Halide Emulsion 7>

Silver Halide Emulsion 7 was prepared in the same manner as Silver Halide Emulsion 2 except that the liquid temperature at the grain formation was changed from 30° C. to 38° C. and all chemicals added at the chemical sensitization were changed in the amount added to 0.7 times. The emulsion grains of Silver Halide Emulsion 7 were silver iodobromide grains having an average equivalent-sphere diameter of 0.055 μm and a coefficient of variation in the equivalent-sphere diameter of 19% and uniformly containing 3.5% of iodide.

<Preparation of Silver Halide Emulsion 8>

Silver Halide Emulsion 8 was prepared in the same manner as Silver Halide Emulsion 2 except that sodium thiosulfate and chloroauric acid were added in an amount of 2.5×10⁻⁴ mol and 1.2×10⁻⁴ mol, respectively, per mol of silver in place of adding Tellurium Sensitizer B at the chemical sensitization. The emulsion grains of Silver Halide Emulsion 8 were silver iodobromide grains having an average equivalent-sphere diameter of 0.039 μm and a coefficient of variation in the equivalent-sphere diameter of 19% and uniformly containing 3.5 mol % of iodide.

The characteristic features of each emulsion prepared above are shown together in Table 9.

TABLE 9
List of Emulsions Used

| Emulsion | | Grain Size | Compound of Formula |
|---|---|---|---|
| No. | Chemical Sensitizer | (nm) | (1) |
| 2 | Te sensitizer | 39 | 17 |
| 5 | Te sensitizer | 25 | 17 |
| 6 | Te sensitizer | 46 | 17 |
| 7 | Te sensitizer | 55 | 17 |
| 8 | S/Au sensitizer | 39 | 17 |

(Preparation of Photosensitive Material)

Samples 21 to 25 of Heat-Developable Photosensitive Material 3 and Samples 26 to 30 of Heat-Developable Photosensitive Material 4 were prepared in the same manner as Heat-Developable Photosensitive material 1 and Heat-Developable Photosensitive Material 2 of Example 4, respectively, except that a coating solution prepared using each of Emulsions 6 to 8 according to Tables 10 and 11 was used. Then, Samples 21 to 30 were evaluated in the same manner as in Example 4. The results are shown in Tables 10 and 11.

TABLE 10
Evaluation Results of Heat-Developable Photosensitive Material 3

| | | | | Compound of | | | |
|---|---|---|---|---|---|---|---|
| | | | Chloride | Formula (1) | | | |
| | | | ion | at the | | | |
| | | | Concen- | Preparation | | | |
| | | | tration | of Coating | | | |
| | | | Based on | Solution | | | |
| | | | Organic | for | | Fog in | |
| | Mixed | SBR | Silver | Emulsion | Sensi- | Aging, | |
| Sample | Emulsion | Latex | (ppm) | Layer | tivity | ΔFog | |
| 21 | 5 | P-5 | 800 | 17 | 92 | 0.02 | Invention |
| 22 | 2 | P-5 | 800 | 17 | 100 | 0.02 | Invention |
| 23 | 6 | P-5 | 800 | 17 | 102 | 0.03 | Invention |
| 24 | 7 | P-5 | 800 | 17 | 105 | 0.04 | Invention |
| 25 | 8 | P-5 | 800 | 17 | 110 | 0.04 | Invention |

The chloride ion concentration was determined using the coating solution for emulsion layer.

TABLE 11
Evaluation Results of Heat-Developable Photosensitive Material 4

| | | | | Compound of | | | |
|---|---|---|---|---|---|---|---|
| | | | Chloride | Formula (1) | | | |
| | | | Ion | at the | | | |
| | | | Concen- | Preparation | | | |
| | | | tration | of coating | | | |
| | | | Based on | Solution | | | |
| | | | Organic | for | | Fog in | |
| | Mixed | SBR | Silver | Emulsion | Sensi- | Aging, | |
| Sample | Emulsion | Latex | (ppm) | Layer | tivity | ΔFog | |
| 26 | 5 | P-5 | 100 | 17 | 93 | 0.02 | Invention |
| 27 | 2 | P-5 | 100 | 17 | 100 | 0.02 | Invention |
| 28 | 6 | P-5 | 100 | 17 | 102 | 0.03 | Invention |
| 29 | 7 | p-5 | 100 | 17 | 105 | 0.04 | Invention |
| 30 | 8 | P-5 | 100 | 17 | 111 | 0.03 | Invention |

The chloride ion concentration was determined using the coating solution for emulsion layer.

It is seen from the results in Tables 10 and 11 that samples using Emulsion 2 exhibit sufficiently high sensitivity and particularly good performance with respect to the fog in aging and samples using Emulsion 8 exhibit higher sensitivity.

According to the present invention, a heat-developable photosensitive material free of worsening in aging fog and having high sensitivity can be provided.

### EXAMPLE 6

(Preparation of PET Support)

PET having an intrinsic viscosity IV of 0.66 (measured at 25° C. in phenol/tetrachloroethane=6/4 (by weight)) was obtained in a usual manner using terephthalic acid and ethylene glycol. The resulting PET was pelletized and the pellets obtained were dried at 130° C. for 4 hours, melted at 300° C., extruded from a T-die and then quenched to prepare an unstretched film having a thickness large enough to give a thickness of 175 μm after the heat setting.

This film was stretched to 3.3 times in the machine direction using rolls different in the peripheral speed and then stretched to 4.5 times in the cross direction by a tenter. At this time, the temperatures were 110° C. and 130° C., respectively. Subsequently, the film was heat set at 240° C. for 20 seconds and relaxed by 4% in the cross direction at the same temperature. Thereafter, the chuck part of the tenter was slit, both edges of the film were knurled, and the film was taken up at 4 kg/cm² to obtain a roll having a thickness of 175 μm.

(Surface Corona Treatment)

Both surfaces of the support were treated at room temperature at 20 m/min using a solid state corona treating machine “Model 6 KVA” (manufactured by Pillar Technologies). From the current and voltage read at this time, it was known that a treatment of 0.375 kV·A·min/m² was applied to the support. The treatment frequency here was 9.6 kHz and the gap clearance between the electrode and the dielectric roll was 1.6 mm.

(Preparation of Undercoated Support)

(1) Preparation of Coating Solution for Undercoat Layer
Formulation (1) (for undercoat layer in the photosensitive
layer side):

| “PESRESIN A-520” (30 mass % solution) | 59 | g |
|---|---|---|
| produced by Takamatsu Yushi K.K. | | |
| Polyethylene glycol monononylphenyl ether | 5.4 | g |
| (average ethylene oxide number: 8.5), 10 | | |
| mass % solution | | |
| “MP-1000” (fine polymer particles, average | 0.91 | g |
| particle size: 0.4 μm) produced by Soken | | |
| Kagaku K.K. | | |
| Distilled water | 935 | ml |
| Formulation (2) (for first layer on the back surface): | | |
| Styrene/butadiene copolymer latex (solid | 158 | g |
| content: 40 mass %, styrene/butadiene | | |
| weight ratio: 68/32) | | |
| 2,4-Dichloro-6-hydroxy-S-triazine sodium | 20 | g |
| salt, 8 mass % aqueous solution | | |
| 1 Mass % aqueous solution of sodium | 10 | ml |
| laurylbenzenesulfonate | | |
| Distilled water | 854 | ml |
| Formulation (3) (for second layer on the back surface): | | |
| SnO₂/SbO (9/1 by mass, average particle | 84 | g |
| size: 0.038 μm, 17 mass % dispersion) | | |
| Gelatin (10 mass % aqueous solution) | 89.2 | g |
| “METROSE TC-5” (2 mass % aqueous solution) | 8.6 | g |
| produced by Shin-Etsu Chemical Co., Ltd. | | |
| “MP-1000” produced by Soken Kagaku K.K. | 0.01 | g |
| 1 Mass % aqueous solution of sodium | 10 | ml |
| dodecylbenzenesulfonate | | |
| NaOH (1 mass %) | 6 | ml |
| “PROXEL” (produced by ICI) | 1 | ml |
| Distilled water | 805 | ml |

(Preparation of Undercoated Support)

Both surfaces of the 175 μm-thick biaxially stretched polyethylene terephthalate support obtained above each was subjected to the above-described corona discharge treatment and on one surface (photosensitive layer surface), the undercoating solution of formulation (1) was applied by a wire bar to have a wet coated amount of 6.6 ml/m² (per one surface) and dried at 180° C. for 5 minutes. Thereafter, on the opposite surface thereof (back surface), the undercoating solution of formulation (2) was applied by a wire bar to have a wet coated amount of 5.7 ml/m² and dried at 180° C. for 5 minutes. On the opposite surface (back surface), the undercoating solution of formulation (3) was further applied by a wire bar to have a wet coated amount of 7.7 ml/m² and dried at 180° C. for 6 minutes, thereby obtaining an undercoated support.

(Preparation of Coating Solution for Back Surface)

(Preparation of Solid Fine Particle Dispersion (a) of Base Precursor)

Base Precursor Compound 1 (64 g), 28 g of diphenylsulfone and 10 q of surfactant “Demol N” (produced by Kao Corporation) were mixed with 220 ml of distilled water and the mixed solution was dispersed using beads in a sand mill (¼ Gallon Sand Grinder Mill, manufactured by AIMEX K. K.) to obtain Solid Fine Particle Dispersion (a) of Base Precursor Compound, having an average particle size of 0.2 μm.

(Preparation of Solid Fine Particle Dispersion of Dye)

Cyanine Dye Compound 1 (9.6 g) and 5.8 g of sodium p-dodecylbenzenesulfonate were mixed with 305 ml of distilled water and the mixed solution was dispersed using beads in a sand mill (¼ Gallon Sand Grinder Mill, manufactured by AIMEX K. K.) to obtain a solid fine particle dispersion of dye, having an average particle size of 0.2 μm.

(Preparation of Coating Solution for Antihalation Layer)

Gelatin (17 g), 9.6 g of polyacrylamide, 56 g of Solid Fine Particle Dispersion (a) of Base Precursor obtained above, 50 g of the solid fine particle dispersion of dye obtained above, 1.5 g of monodisperse polymethyl methacrylate fine particles (average particle size; 8 μm, standard deviation of particle size: 0.4), 0.03 g of benzoisothiazolinone, 2.2 g of sodium polyethylenesulfonate, 0.1 g of Blue Dye Compound 1, 0.1 g of Yellow Dye Compound 1 and 844 ml of water were mixed to prepare a coating solution for antihalation layer.

(Preparation of Coating Solution for Protective Layer on Back Surface)

In a container kept at 40° C., 50 g of gelatin, 0.2 g of sodium polystyrenesulfonate, 2.4 g of N,N-ethylene-bis(vinylsulfonacetamide), 1 g of sodium tert-octylphenoxyethoxyethanesulfonate, 30 mg of benzoisothiazolinone, 37 mg of Fluorine-Containing Surfactant (F-1) (N-perfluorooctylsulfonyl-N-propylalanine potassium salt), 150 mg of Fluorine-Containing Surfactant (F-2) (polyethylene glycol mono(N-perfluorooctylsulfonyl-N-propyl-2-aminoethyl) ether [ethylene oxide average polymerization degree: 15]), 64 mg of Fluorine-Containing Surfactant (F-3), 32 mg of Fluorine-Containing Surfactant (F-4), 8.8 g of an acrylic acid/ethyl acrylate copolymer (copolymerization weight ratio: 5/95), 0.6 g of “Aerosol OT”. (produced by American Cyanamide), 1.8 g of liquid paraffin emulsion as liquid paraffin and 950 ml of water were mixed to prepare a coating solution for protective layer on the back surface.

(Preparation of Silver Halide Emulsion)

<Preparation of Silver Halide Emulsion 1>

A solution was prepared by adding 3.1 ml of a 1 mass % potassium bromide solution, 3.5 ml of sulfuric acid in a concentration of 0.5 mol/L and 31.7 g of phthalated gelatin to 1,421 ml of distilled water and while stirring the solution in a stainless steel-made reaction pot and thereby keeping the liquid temperature at 30° C., the entire amount of Solution A prepared by diluting 22.22 g of silver nitrate with distilled water to a volume of 95.4 ml and the entire amount of Solution B prepared by diluting 15.3 g of potassium bromide and 0.8 g of potassium iodide with distilled water to a volume of 97.4 ml were added at a constant flow rate over 45 seconds. Thereto, 10 ml of an aqueous 3.5 mass % hydrogen peroxide solution was added and then, 10.8 ml of a 10 mass % aqueous solution of benzimidazole was further added. Thereafter, the entire amount of Solution C prepared by diluting 51.86 g of silver nitrate with distilled water to a volume of 317.5 ml and the entire amount of Solution D obtained by diluting 44.2 g of potassium bromide and 2.2 g of potassium iodide with distilled water to a volume of 400 ml were added. Here, Solution C was added at a constant flow rate over 20 minutes and Solution D was added by the controlled double jet method while maintaining the pAg at 8.1. After 10 minutes from the initiation of addition of Solution C and Solution D, the entire amount of potassium hexachloroiridate(III) was added to a concentration of 1×10⁻⁴ mol per mol of silver. Furthermore, 5 seconds after the completion of addition of Solution C, the entire amount of an aqueous potassium hexacyanoferrate(II) solution was added to a concentration of 3×10⁻⁴ mol per mol of silver. Then, the pH was adjusted to 3.8 using sulfuric acid in a concentration of 0.5 mol/L and after stirring was stopped, the resulting solution was subjected to precipitation/desalting/water washing. The pH was then adjusted to 5.9 using sodium hydroxide in a concentration of 1 mol/L, thereby preparing a silver halide dispersion at a pAg of 8.0.

While stirring the silver halide dispersion obtained above and thereby keeping it at 38° C., 5 ml of a methanol solution containing 0.34 mass % of 1,2-benzoisothiazolin-3-one was added and after 40 minutes, a methanol solution containing Spectral Sensitizing Dye A and Spectral Sensitizing Dye B at a molar ratio of 1:1 was added in an amount, as a total of Sensitizing Dye A and Sensitizing Dye B, of 1.2×10⁻³ mol per mol of silver. After 1 minute, the temperature was elevated to 47° C. and 20 minutes after the elevation of temperature, a methanol solution of sodium benzenethiosulfonate was added in an amount of 7.6×10⁻⁵ mol per mol of silver. After 5 minutes, a methanol solution of Tellurium Sensitizer B was further added in an amount of 2.9×10⁻⁴ mol per mol of silver and then, the solution was ripened for 91 minutes. Thereto, 1.3 ml of a 0.8 mass % methanol solution of N,N′-dihydroxy-N″-diethylmelamine was added and after 4 minutes, a methanol solution of 5-methyl-2-mercaptobenzimidazole and a methanol solution of 1-phenyl-2-heptyl-5-mercapto-1,3,4-triazole were added in an amount of 4.8×10⁻³ mol and 5.4×10⁻³ mol, respectively, per mol of silver to prepare Silver Halide Emulsion 1.

The grains in the thus-prepared silver halide emulsion were silver iodobromide grains having an average equivalent-sphere diameter of 0.042 μm and a coefficient of variation in the equivalent-sphere diameter of 20% and uniformly containing 3.5 mol % of iodide. The grain size and the like were determined as an average of 1,000 grains using an electron microscope. The percentage of [100] faces in this grain was 80% as determined using the Kubelka-Munk equation.

<Preparation of Silver Halide Emulsion 2>

Silver Halide Emulsion 2 was prepared in the same manner as Silver Halide Emulsion 1 except that the liquid temperature at the grain formation was changed from 30° C. to 47° C., Solution B was obtained by diluting 15.9 g of potassium bromide with distilled water to a volume of 97.4 ml, Solution D was obtained by diluting 45.8 g of potassium bromide with distilled water to a volume of 400 ml, the addition time of Solution C was changed to 30 minutes and potassium hexacyanoferrate(II) was excluded. Also, precipitation/desalting/water washing/dispersion were performed in the same manner as in the preparation of Silver Halide Emulsion 1. Thereafter, spectral sensitization, chemical sensitization and addition of 5-methyl-2-mercaptobenzimidazole and 1-phenyl-2-heptyl-5-mercapto-1,3,4-triazole were performed in the same manner as in the preparation of Emulsion 1 except that the amount added of the methanol solution containing Spectral Sensitizing Dye A and Spectral Sensitizing Dye B at a molar ratio of 1:1 was changed, as a total of Sensitizing Dye A and Sensitizing Dye B, to 7.5×10⁻⁴ mol per mol of silver, the amount of Tellurium Sensitizer B added was changed to 1.1×10⁻⁴ mol per mol of silver, and the amount of 1-phenyl-2-heptyl-5-mercapto-1,3,4-triazole added was changed to 3.3×10⁻³ mol per mol of silver. Thus, Silver Halide Emulsion 2 was obtained. The emulsion grains of Silver Halide Emulsion 2 were pure silver bromide cubic grains having an average equivalent-sphere diameter of 0.080 μm and a coefficient of variation in the equivalent-sphere diameter of 20%.

<Preparation of Silver Halide Emulsion 3>

Silver Halide Emulsion 3 was prepared in the same manner as Silver Halide Emulsion 1 except that the liquid temperature at the grain formation was changed from 30° C. to 27° C. Also, precipitation/desalting/water washing/dispersion were performed in the same manner as Silver Halide Emulsion 1. Thereafter, Silver Halide Emulsion 3 was obtained in the same manner as Emulsion 1 except that a solid dispersion (aqueous gelatin solution) containing Spectral Sensitizing Dye A and Spectral Sensitizing Dye B at a molar ratio of 1:1 was added in an amount, as a total of Sensitizing Dye A and Sensitizing Dye B, of 6×10⁻³ mol per mol of silver, and the amount of Tellurium Sensitizer B added was changed to 5.2×10⁻⁴ mol per mol of silver.

The emulsion grains of Silver Halide Emulsion 3 were silver iodobromide grains having an average equivalent-sphere diameter of 0.034 μm and a coefficient of variation in the equivalent-sphere diameter of 20% and uniformly containing 3.5 mol % of iodide.

<Preparation of Mixed Emulsion A for Coating Solution>

70 Mass % of Silver Halide Emulsion 1, 15 mass % of Silver Halide Emulsion 2 and 15 mass % of Silver Halide Emulsion 3 were dissolved and thereto, a 1 mass % aqueous solution of benzothiazolium iodide was added in an amount of 7×10⁻³ mol per mol of silver. Furthermore, water was added to adjust the silver halide content to 38.2 g in terms of silver per kg of the mixed emulsion for coating solution.

<Preparation of Organic Acid Silver Salt Dispersions A to E>

A saturated fatty acid (258.8 mol) having a composition shown in Table 2, 423 L of distilled water, 49.2 L of an aqueous NaOH solution in a concentration of 5 mol/L, and 120 L of tert-butyl alcohol were mixed. The mixture was reacted by stirring at 75° C. for one hour to obtain a fatty acid sodium salt solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the fatty acid sodium salt solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the fatty acid sodium salt solution was started, and only the fatty acid sodium salt solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the fatty acid sodium salt solution was kept warm by circulating hot water in the outer side of a double pipe, whereby the outlet liquid temperature at the distal end of the addition nozzle was adjusted to 75° C. The piping in the system of adding the aqueous silver nitrate solution was kept warm by circulating cold water in the outer side of a double pipe. The addition site of fatty acid sodium salt solution and the addition site of aqueous silver nitrite solution were symmetrically arranged centered around the stirring axis. Also, these addition sites were each adjusted to a height of not causing contact with the reaction solution.

TABLE 12

| Dispersion of | | | | | |
|---|---|---|---|---|---|
| Fatty Acid Silver | Lignoceric | Behenic | Arachic | Stearic | Erucic |
| Salt/Organic Acid | Acid | Acid | Acid | Acid | Acid |
| Silver Salt | (mol %) | (mol %) | (mol %) | (mol %) | (mol %) |
| A | 2 | 96 | 2 | 0 | 0 |
| B | 1 | 98 | 1 | 0 | 0 |
| C | 2 | 92 | 5 | 1 | 0 |
| D | 2 | 89 | 6 | 3 | 0 |
| E | 2 | 96 | 1 | 0 | 1 |
| F | 2 | 96 | 2 | 0 | 0 |
| G | 1 | 98 | 1 | 0 | 0 |
| H | 2 | 89 | 6 | 3 | 0 |
| I | 2 | 96 | 2 | 0 | 0 |
| J | 1 | 98 | 1 | 0 | 0 |
| K | 2 | 89 | 6 | 3 | 0 |
| L | 2 | 96 | 2 | 0 | 0 |

After the completion of addition of the fatty acid sodium salt solution, the mixture was left standing at that temperature for 20 minutes with stirring. The temperature was then elevated to 35° C. over 30 minutes and the solution was ripened for 210 minutes. Immediately after the completion of ripening, the solid content was separated by centrifugal filtration and washed with water until the conductivity of filtrate became 50 μS/cm. In this manner, a fatty acid silver salt was obtained. The solid content obtained was not dried but stored as a wet cake.

To the wet cake corresponding to 581 mol as silver, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain a fatty acid silver salt dispersion. At the dispersion, the temperature was set to 18° C. by a cooling operation of controlling the temperature of coolant using coiled heat exchangers attached to the inlet side and outlet side of the interaction chamber.

Organic silver salt grains contained in the thus-obtained Organic Silver Salt Dispersions A to E had a volume weighted average diameter (equivalent-sphere diameter), a coefficient of variation in the volume weighted average diameter, a ratio of long side c to short side b of grain (length to breadth ratio), and an aspect ratio as shown in Table 13. The grain size was measured by Master Sizer X manufactured by Malvern Instruments Ltd.

TABLE 13

| Dispersion of Fatty | | | | |
|---|---|---|---|---|
| Acid Silver | Length to | Average | | |
| Salt/Organic Acid | Breadth | Diameter | Aspect | Coefficient |
| Silver Salt | Ratio | (μm) | Ratio | of Variation |
| A | 1.3 | 0.42 | 2.3 | 12 |
| B | 1.1 | 0.4 | 2.1 | 10 |
| C | 1.7 | 0.47 | 4.6 | 13 |
| D | 4.5 | 0.5 | 6.2 | 14 |
| E | 1.3 | 0.43 | 2.3 | 12 |
| F | 1.3 | 0.42 | 2.3 | 12 |
| G | 1.1 | 0.4 | 2.1 | 10 |
| H | 4.5 | 0.5 | 6.2 | 14 |
| I | 1.3 | 0.42 | 2.3 | 12 |
| J | 1.1 | 0.4 | 2.1 | 10 |
| K | 4.5 | 0.5 | 6.2 | 14 |
| L | 1.3 | 0.42 | 2.3 | 12 |
| M | 1.2 | 0.45 | 2.1 | 11 |
| N | 1.2 | 0.1 | 1.8 | 9 |

<Preparation of-Organic Silver Salt Dispersions F to H>

(1) Preparation of Organic Acid Salt Solution

A fatty acid (258.5 mol) having a composition shown in Table 12, 423 L of distilled water, 49.2 L of an aqueous NaOH solution in a concentration of 5 mol/L, and 120 L of tert-butyl alcohol were mixed and the mixture was reacted under stirring at 75° C. for one hour to obtain a fatty acid sodium salt solution.

(2) Preparation of Silver Ion-Containing Solution

An aqueous solution (206.2 L, pH: 4.0) containing 40.4 Kg of silver nitrate was prepared and kept at 10° C.

(3) Preparation of Reaction Bath Solution

A reactor containing 635 L of distilled water and 30 L of tert-butyl alcohol was kept at 30° C.

As the closed mixing means, small crystallization equipment shown in FIG. 1 was used. Solutions (1), (2) and (3) were weighed and charged into tanks 12, 11 and 20, respectively, and each was circulated at a flow rate of 250 L/min through a pump 17. While stirring a pipeline mixer “Model PM-10” manufactured by Mizuho Kogyo as a mixing device 18 shown in FIG. 18 at 2,500 rpm, (1) and (2) were added. The addition of (2) was performed at a constant flow rate over 120 minutes and the addition of (1) was started after 1 minute from the initiation of addition of (2) and performed at a constant flow rate over 81 minutes. During the addition, (3) was stirred as vigorously as possible within the range of not involving bubbles. The temperature was controlled by cooling the tank 20 and additionally using a heat exchanger 19. Here, the temperature was controlled by supplying water at an appropriate temperature to the jackets of heat exchanger 19 and tank 20 at 20 L/min so as to give a temperature shown in Table 1.

The piping in the system of adding the organic acid salt (organic acid sodium salt) solution was kept warm using a double pipe and the temperature of water in the piping was controlled such that the outlet liquid temperature at the distal end of addition nozzle became 75° C. The piping in the system of adding the aqueous silver nitrate solution was kept warm by circulating cold water in the outer side of a double pipe.

Thereafter, each solution was subjected to ripening, centrifugal filtration, preliminary dispersion and final dispersion treatment in the same manner as above to have the same concentration as that of Organic Silver Salt Dispersion A.

Organic silver salt grains contained in the thus-obtained organic silver salt dispersions F to H had a volume weighted average diameter (equivalent-sphere diameter), a coefficient of variation in the volume weighted average diameter, a ratio of long side c to short side b of grain (length to breadth ratio), and an aspect ratio shown in Table 13. The grain size was measured by Master Sizer X manufactured by Malvern Instruments Ltd.

<Preparation of Organic Silver Salt Dispersions I to K>

To a fatty acid silver salt-charged solution obtained in the same manner as in the preparation of Organic Silver Salt Dispersions F to H, 7.4 g of PVA217 dissolved in 74 g of water was added per 100 g as a dry solid content and treated once using Microfluidizer described above while controlling the pressure to 600 kg/cm² (6 MPa). The resulting solution was transferred to an ultrafiltration device and desalted.

The ultrafiltration device is fundamentally composed of a tank for stocking an organic silver salt dispersion and a circulation pump for supplying the stocked dispersion to an ultrafiltration module and has a flowmeter for measuring the supplied pure water, a flow meter for measuring the permeated water, a pump for backwashing and the like. The membrane module was hollow yarn type ACP-1050 produced by Asahi Chemical Industry Co., Ltd., the feed flow rate was 18 liter/minute, and the pressure difference before and after the module was 1.0 kg/cm² (1×10⁴ Pa). During the treatment, the solution treated was kept at a temperature of 17° C. or less.

When the electrical conductivity was lowered to 100 [S/cm, the supply of pure water was stopped and the solution was concentrated to 0.581 mol/L as silver. Thereafter, the treatment was performed twice by controlling the pressure to 1,750 kg/cm² (17.5 MPa) using the above-described Microfluidizer to obtain Organic Silver Salt Dispersions T to K. The solid concentration was measured using a digital hydrometer Model DA-3000 manufactured by Kyoto Denshi Sha and finally assayed by the absolute dry weight.

The organic silver salt grains contained in the thus-obtained organic silver salt dispersions I to K had a volume weighted average diameter (equivalent-sphere diameter) a coefficient of variation in the volume weighted average diameter, a ratio of long side c to short side b of grain (length to breadth ratio) and an aspect ratio as shown in Table 13. The grain size was measured by Master Sizer X manufactured by Malvern Instruments Ltd.

<Preparation of Fatty Acid Silver Salt Dispersion>

Behenic acid (87.6 kg, “Edenor C22-85R”, trade name, produced by Cognis Co.) was recrystallized using IPA to obtain a saturated fatty acid having a composition shown in Table 2. The obtained fatty acid (258.8 mol), 423 L of distilled water, 49.2 L of an aqueous NaOH solution in a concentration of 5 mol/L, and 120 L of tert-butyl alcohol were mixed. The mixture was reacted by stirring at 75° C. for one hour to obtain a fatty acid sodium salt solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the fatty acid sodium salt solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the fatty acid sodium salt solution was started, and only the fatty acid sodium salt solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the fatty acid sodium salt solution was kept warm by circulating hot water in the outer side of a double pipe, whereby the outlet liquid temperature at the distal end of the addition nozzle was adjusted to 75° C. The piping in the system of adding the aqueous silver nitrate solution was kept warm by circulating cold water in the outer side of a double pipe. The addition site of fatty acid sodium salt solution and the addition site of aqueous silver nitrate solution were symmetrically arranged centered around the stirring axis. Also, these addition sites were each adjusted to a height of not causing contact with the reaction solution.

After the completion of addition of the fatty acid sodium salt solution, the mixture was left standing at that temperature for 20 minutes with stirring. The temperature was then elevated to 35° C. over 30 minutes and the solution was ripened for 210 minutes. Immediately after the completion of ripening, the solid content was separated by centrifugal filtration and washed with water until the conductivity of filtrate became 50 μS/cm. In this manner, a fatty acid silver salt was obtained. The solid content obtained was not dried but stored as a wet cake.

To the wet cake corresponding to 581 mol as silver, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain a fatty acid silver salt dispersion. At the dispersion, the temperature was set to 18° C. by a cooling operation of controlling the temperature of coolant using coiled heat exchangers attached to the inlet side and outlet side of the interaction chamber.

Fatty acid silver salt grains contained in the thus-obtained Fatty Acid Silver Salt Dispersion L had a volume weighted average diameter (equivalent-sphere diameter), a coefficient of variation in the volume weighted average diameter, a ratio of long side c to short side b of grain (length to breadth ratio), and an aspect ratio as shown in Table 13. The grain size was measured by Master Sizer X manufactured by Malvern Instruments Ltd.

<Preparation of Organic Acid Silver Salt Dispersion M>

Compound (1) (258.8 mol as a molar number of carboxylic acid), 423 L of distilled water, 49.2 L of an aqueous NaOH solution in a concentration of 5 mol/L, and 120 L of tert-butyl alcohol were mixed. The mixture was reacted by stirring at 75° C. for one hour to obtain an organic acid sodium salt solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the organic acid sodium salt solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the organic acid sodium salt solution was started, and only the organic acid sodium salt solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the organic acid sodium salt solution was kept warm by circulating hot water in the outer side of a double pipe, whereby the outlet liquid temperature at the distal end of the addition nozzle was adjusted to 75° C. The piping in the system of adding the aqueous silver nitrate solution was kept warm by circulating cold water in the outer side of a double pipe. The addition site of organic acid sodium salt solution and the addition site of aqueous silver nitrate solution were symmetrically arranged centered around the stirring axis. Also, these addition sites were each adjusted to a height of not causing contact with the reaction solution.

After the completion of addition of the organic acid sodium salt solution, the mixture was left standing at that temperature for 20 minutes with stirring. The temperature was then elevated to 35° C. over 30 minutes and the solution was ripened for 210 minutes, Immediately after the completion of ripening, the solid content was separated by centrifugal filtration and washed with water until the conductivity of filtrate became 50 μS/cm. In this manner, an organic acid silver salt was obtained. The solid content obtained was not dried but stored as a wet cake.

To the wet cake corresponding to 581 mol as silver, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain an organic acid silver salt dispersion. At the dispersion, the temperature was set to 18° C. by a cooling operation of controlling the temperature of coolant using coiled heat exchangers attached to the inlet side and outlet side of the interaction chamber.

Organic acid silver salt grains contained in the thus-obtained Organic Acid Silver Salt Dispersion M had a volume weighted average diameter (equivalent-sphere diameter), a coefficient of variation in the volume weighted average diameter, a ratio of long side c to short side b of grain (length to breadth ratio), and an aspect ratio as shown in Table 13. The grain size was measured by Master Sizer X manufactured by Malvern Instruments Ltd.

<Preparation of Organic Acid Silver Salt Dispersion N>

Compound (2) (258.8 mol as a molar number of carboxylic acid), 423 L of distilled water, 49.2 L of an aqueous NaOH solution in a concentration of 5 mol/L, and 120 L of tert-butyl alcohol were mixed. The mixture was reacted by stirring at 75° C. for one hour to obtain an organic acid sodium salt solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the organic acid sodium salt solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the organic acid sodium salt solution was started, and only the organic acid sodium salt solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the organic acid sodium salt solution was kept warm by circulating hot water in the outer side of a double pipe, whereby the outlet liquid temperature at the distal end of the addition nozzle was adjusted to 75° C. The piping in the system of adding the aqueous silver nitrate solution was kept warm by circulating cold water in the outer side of a double pipe. The addition site of organic acid sodium salt solution and the addition site of aqueous silver nitrate solution were symmetrically arranged centered around the stirring axis. Also, these addition sites were each adjusted to a height of not causing contact with the reaction solution.

After the completion of addition of the organic acid sodium salt solution, the mixture was left standing at that temperature for 20 minutes with stirring. The temperature was then elevated to 35° C. over 30 minutes and the solution was ripened for 210 minutes. Immediately after the completion of ripening, the solid content was separated by centrifugal filtration and washed with water until the conductivity of filtrate became 50 μS/cm. In this manner, an organic acid silver salt was obtained. The solid content obtained was not dried but stored as a wet cake.

To the wet cake corresponding to 581 mol as silver, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain an organic acid silver salt dispersion. At the dispersion, the temperature was set to 18° C. by a cooling operation of controlling the temperature of coolant using coiled heat exchangers attached to the inlet side and outlet side of the interaction chamber.

Organic acid silver salt grains contained in the thus-obtained Organic Acid Silver Salt Dispersion N had a volume weighted average diameter (equivalent-sphere diameter), a coefficient of variation in the volume weighted average diameter, a ratio of long side c to short side b of grain (length to breadth ratio), and an aspect ratio as shown in Table 13. The grain size was measured by Master Sizer X manufactured by Malvern Instruments Ltd.

(Preparation of Reducing Agent Dispersion)

<Preparation of Reducing Agent Complex 1 Dispersion>

To 10 kg of Reducing Agent Complex 1 (a 1:1 complex of 6,6′-di-tert-butyl-4,4′-dimethyl-2,2′-butylidenediphenol and triphenylphosphine oxide), 0.12 Kg of triphenylphosphine oxide and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 4 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the reducing agent concentration to 22 mass %, thereby obtaining Reducing Agent Complex 1 Dispersion. The reducing agent complex particles contained in the thus-obtained reducing agent complex dispersion had a median diameter of 0.45 μm and a maximum particle size of 1.4 μm or less. The obtained reducing agent complex dispersion was filtered through a polypropylene-made filter having a pore size of 3.0 μm to remove foreign matters such as dust and then housed.

<Preparation of Reducing Agent 2 Dispersion>

To 10 kg of Reducing Agent 2 (6,6′-di-tert-butyl-4,4′-dimethyl-2,2′-butylidenediphenol) and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the reducing agent concentration to 25 mass %, thereby obtaining Reducing Agent 2 Dispersion. The reducing agent particles contained in the thus-obtained reducing agent dispersion had a median diameter of 0.40 μm and a maximum particle size of 1.5 μm or less. The obtained reducing agent dispersion was filtered through a polypropylene-made filter having a pore size of 3.0 μm to remove foreign matters such as dust and then housed.

<Preparation of Hydrogen Bond-Forming Compound 1 Dispersion>

To 10 Kg of Hydrogen Bond-Forming Compound 1 (tri(4-tert-butylphenyl)phosphine oxide) and 16 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the hydrogen bond-forming compound concentration to 25 mass %, thereby obtaining Hydrogen Bond-Forming Compound 1 Dispersion. The hydrogen bond-forming compound particles contained in the thus-obtained hydrogen bond-forming compound dispersion had a median diameter of 0.35 μm and a maximum particle size of 1.5 μm or less. The obtained hydrogen bond-forming compound dispersion was filtered through a polypropylene-made filter having a pore size of 3.0 μm to remove foreign matters such as dust and then housed.

<Preparation of Development Accelerator 1 Dispersion>

To 10 Kg of Development Accelerator 1 and 20 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the development accelerator concentration to 20 mass %, thereby obtaining Development Accelerator 1 Dispersion. The development accelerator particles contained in the thus-obtained development accelerator dispersion had a median diameter of 0.48 μm and a maximum particle size of 1.4 μm or less. The obtained development accelerator dispersion was filtered through a polypropylene-made filter having a pore size of 3.0 μm to remove foreign matters such as dust and then housed.

Solid Dispersions of Development Accelerator 2, Development Accelerator 3 and Color Tone Adjuster 1 each was obtained as a 20 mass % dispersion in the same manner as Development Accelerator 1.

(Preparation of Polyhalogen Compound)

<Preparation of Organic Polyhalogen Compound 1 Dispersion>

To 10 Kg of Organic Polyhalogen Compound 1 (tribromomethanesulfonylbenzene), 10 Kg of a 20 mass % aqueous solution of modified polyvinyl alcohol (“Poval MP203”, produced by Kuraray Co., Ltd.) and 0.4 Kg of a 20 mass % aqueous solution of sodium triisopropylnaphthalenesulfonate, 14 Kg of water was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 26 mass %, thereby obtaining Organic Polyhalogen Compound 1 Dispersion. The organic polyhalogen compound particles contained in the thus-obtained organic polyhalogen compound dispersion had a median diameter of 0.41 μm and a maximum particle size of 2.0 μm or less. The obtained organic polyhalogen compound dispersion was filtered through a polypropylene-made filter having a pore size of 10.0 μm to remove foreign matters such as dust and then housed.

<Preparation of organic Polyhalogen Compound 2 Dispersion>

To 10 Kg of Organic Polyhalogen Compound 2 (N-butyl-3-tribromomethanesulfonylbenzamide) and 20 Kg of a 10 mass % aqueous solution of modified polyvinyl alcohol (“Poval MP203”, produced by Kuraray Co., Ltd.), 0.4 Kg of a 20 mass % aqueous solution of sodium triisopropylnaphthalenesulfonate was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 30 mass %. This dispersion solution was heated at 40° C. for 5 hours, whereby Organic Polyhalogen Compound 2 Dispersion was obtained. The organic polyhalogen compound particles contained in the thus-obtained polyhalogen compound dispersion had a median diameter of 0.40 μm and a maximum particle size of 1.3 μm or less. The obtained organic polyhalogen compound dispersion was filtered through a polypropylene-made filter having a pore size of 3.0 μm to remove foreign matters such as dust and then housed.

<Preparation of Phthalazine Compound 1 Solution>

In 174.57 Kg of water, 8 Kg of modified polyvinyl alcohol “MP203” produced by Kuraray Co., Ltd. was dissolved. Thereto, 3.15 Kg of a 20 mass % aqueous solution of sodium triisopropylnaphthalenesulfonate and 14.28 Kg of a 70 mass % aqueous solution of Phthalazine Compound 1 (6-isopropylphthalazine) were added to prepare a 5 mass % solution of Phthalazine Compound 1.

(Preparation of Mercapto Compound)

<Preparation of Aqueous Mercapto Compound 1 Solution>

In 993 g of water, 7 g of Mercapto Compound 1 (1-(3-sulfophenyl)-5-mercaptotetrazole sodium salt) was dissolved to prepare a 0.7 mass % aqueous solution.

<Preparation of Aqueous Mercapto Compound 2 Solution>

In 980 g of water, 20 g of Mercapto Compound 2 (1-(3-methylureido)-5-mercaptotetrazole sodium salt) was dissolved to prepare a 2.0 mass % aqueous solution.

<Preparation of Pigment 1 Dispersion>

To 64 g of C.I. Pigment Blue 60 and 6.4 g of “Demol N” (produced by Kao Corporation), 250 g of water was added and thoroughly mixed to form a slurry. The resulting slurry and 800 g of zirconia beads having an average diameter of 0.5 mm were put together into a vessel and dispersed for 25 hours in a dispersing machine (¼G Sand Grinder Mill, manufactured by AIMEX K. K.) to obtain Pigment 1 Dispersion. The pigment particles contained in the thus-obtained pigment dispersion had an average particle size of 0.21 μm.

<Preparation of Binder for Image-Forming Layer>

The binder for image-forming layer was obtained as follows.

Synthesis examples of the polymer for use in the present invention are described below, however, the present invention is not limited thereto. Other compounds can also be synthesized by a similar synthesis method. To a compound obtained in the following Synthesis Examples, 1 mol/liter of NaOH and NH₄OH were added to have a molar ratio of Na⁺ ion:NH₄⁺ ion=1:2.3. Then, the pH was adjusted to 8.4. At this time, the latex concentration was 40 mass %.

### SYNTHESIS EXAMPLE 1

### Synthesis of Compound P1-1

Into the polymerization furnace of a gas monomer reaction apparatus (Model TAS-2J, manufactured by Taiatsu Techno Corp.), 375.29 g of distilled water, 13.61 g of a surfactant (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 27.6%), 14.06 ml of 1 mol/liter NaOH, 0.15 g of tetrasodium ethylenediaminetetraacetate, 258.75 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 105.0 g of 1,3-butadiene was charged under pressure and the inner temperature was elevated to 60° C. Thereto, a solution prepared by dissolving 1.875 g of sodium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 812.2 g of Compound P1-1 (solid content: 45%, particle size: 95 nm, Tg: 19° C.). The halide ion was measured by ion chromatography, as a result, the chloride ion concentration was 9 ppm. Also, the concentration of chelating agent was measured by high-performance liquid chromatography and found to be 150 ppm.

### SYNTHESIS EXAMPLE 2

### Synthesis of Compound P-2

Into the polymerization furnace of a gas monomer reaction apparatus (Model TAS-2J, manufactured by Taiatsu Techno Corp.), 287 g of distilled water, 7.73 g of a surfactant (PIONIN A-43-S, produced by Takemoto Yushi, solid content: 48.5%), 14.06 ml of 1 mol/liter NaOH, 0.15 g of tetrasodium ethylenediaminetetraacetate, 255 g of styrene, 11.25 g of acrylic acid and 3.0 g of tert-dodecylmercaptan were charged. The reactor was closed and stirred at a stirring rate of 200 rpm. After an operation of degassing the reactor by a vacuum pump and purging it with nitrogen gas was repeated several times, 108.75 g of 1,3-butadiene was charged under pressure and the inner temperature was elevated to 60° C. Thereto, a solution prepared by dissolving 1.875 g of ammonium persulfate in 50 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 774.7 g of Compound P-2 (solid content: 45%, particle size: 90 nm, Tg: 17° C.). The halide ion was measured by ion chromatography, as a result, the chloride ion concentration was 3 ppm. Also, the concentration of chelating agent was measured by high-performance liquid chromatography and found to be 145 ppm.

### SYNTHESIS EXAMPLE 3

### Synthesis of Compound P-20

Into a glass-made three-neck flask equipped with a stirrer and a condenser, 296 g of distilled water, 10.89 g of a surfactant (prepared by purifying Sandet BL (produced by Sanyo Chemical Industries, Ltd.) using Micro Acilyzer G3 (membrane: AC110-800) produced by Asahi Chemical Industry Co., Ltd. until change in the electric conductivity did not occur; solid content: 27.6%), 15 ml of 1 mol/liter NaOH, 0.3 g of nitrilotri-hexaacetate, 135 g of methyl methacrylate, 150 g of butyl acrylate, 12 g of sodium styrenesulfonate, 3 g of methylbisacrylamide and 2.4 g of tert-dodecylmercaptan were charged. The mixture was stirred at a stirring rate of 200 rpm in a nitrogen stream and the inner temperature was elevated to 60° C. Thereto, a solution prepared by dissolving 0.6 g of sodium persulfate in 40 ml of water was added and the mixture was stirred for 5 hours. The temperature was further elevated to 90° C. and the mixture was stirred for 3 hours. After the completion of reaction, the inner temperature was lowered to room temperature and the resulting polymer was filtered through a paper towel to obtain 622 g of Compound P-20 (solid content: 45%, particle size: 108 nm, mass average molecular weight: 140,000, Tg: 5° C.). The halide ion was measured by ion chromatography, as a result, the chloride ion concentration was 10 ppm. Also, the concentration of chelating agent was measured by high-performance liquid chromatography and found to be 450 ppm.

### COMPARATIVE SYNTHESIS EXAMPLE 1

Synthesis of Compound (RP-1):

Compound RP-1 (solid content: 45%, particle size: 80 nm) was synthesized all in accordance with the synthesis formulation of Polymer Latex P-1 of the present invention except that the surfactant was changed to “PELEX SS-L” (produced by Kao Corporation). The chloride ion concentration was 400 ppm.

### COMPARATIVE SYNTHESIS EXAMPLE 2

Synthesis of Compound (RP-2):

Compound RP-2 (solid content: 44%, particle size: 75 nm) was synthesized all in accordance with the synthesis formulation of Polymer Latex P-2 in Synthesis Example 2 of the present invention except that the surfactant was changed to “PELEX SS-L” (produced by Kao Corporation) and tetrasodium ethylenediaminetetraacetate (chelate compound) was not used. The chloride ion concentration was 390 ppm.

### SYNTHESIS EXAMPLE 4

### Synthesis of Compound (RP-3)

Compound RP-1 (solid content: 44%, particle size: 90 nm) was synthesized all in accordance with the synthesis formulation of Polymer Latex P-2 in Synthesis Example 2 of the present invention except that 1 mol/liter of NaOH was not added and instead, water in the same amount was added. The chloride ion concentration was 3 ppm.

<Preparation of Coating Solution 1 Series for Emulsion Layer (Photosensitive Layer)>

The fatty acid/organic acid silver salt dispersion (1,000 g) shown in Table 12, which was prepared above, 276 ml of water, 33.2 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of the polymer latex solution shown in Table 14, 299 g of Reducing Agent Complex 1 Dispersion, 6 g of Development Accelerator 1 Dispersion, 9 ml of Aqueous Mercapto Compound 1 Solution and 27 ml of Aqueous Mercapto Compound 2 Solution were sequentially added. Immediately before the coating, 117 g of Silver Halide Mixed Emulsion A was added and thoroughly mixed. The resulting coating solution for emulsion layer was transferred as it was to a coating die and coated.

The viscosity of the coating solution for emulsion layer obtained above was measured by a Brookfield viscometer manufactured by Tokyo Keiki Kogyo K. K. and found to be 25 [mPa·s] at 40° C. (No. 1 rotor, 60 rpm).

The viscosity of the coating solution measured at 25° C. using “RFS Field Spectrometer” (manufactured by Rheometrics Far East K. K.) was 230, 60, 46, 24 and 18 [mPa·s] at a shear rate of 0.1, 1, 10, 100 and 1,000 [1/sec], respectively.

The amount of zirconium in the coating solution was 0.38 mg per g of silver.

<Preparation of Coating Solution 2 Series for Emulsion Layer (Photosensitive Layer)>

Fatty Acid Silver Salt Dispersion A or D shown in Table 12 (1,000 g), 276 ml of water, 32.8 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of an SBR latex solution shown in Table B, 155 g of Reducing Agent 2 Dispersion, 55 g of Hydrogen Bond-Forming Compound 1 Dispersion, 6 g of Development Accelerator 1 Dispersion, 2 g of Development Accelerator 2 Dispersion, 3 g of Development Accelerator 3 Dispersion, 2 g of Color Tone Adjuster 1 Dispersion and 6 ml of Aqueous Mercapto Compound 2 Solution were sequentially added. Immediately before the coating, 117 g of Silver Halide Mixed Emulsion A was added and thoroughly mixed. The resulting coating solution for emulsion layer was transferred as it was to a coating die and coated.

The viscosity of the coating solution for emulsion layer obtained above was measured by a Brookfield viscometer manufactured by Tokyo Keiki Kogyo K. K. and found to be 40 [mPa·s] at 40° C. (No. 1 rotor, 60 rpm).

The viscosity of the coating solution measured at 25° C. using “RFS Field Spectrometer” (manufactured by Rheometrics Far East K. K.) was 530, 144, 96, 51 and 28 [mPa·s] at a shear rate of 0.1, 1, 10, 100 and 1,000 [1/sec], respectively.

The amount of zirconium in the coating solution was 0.25 mg per g of silver.

<Preparation of Coating Solution for Interlayer on Emulsion Surface>

A 5 mass % aqueous solution (27 ml) of “Aerosol OT” (produced by American Cyanamide), 135 ml of a 20 mass % aqueous solution of diammonium phthalate and water for making a total amount of 10,000 g were added to 1,000 g of polyvinyl alcohol “PVA-205” (produced by Kuraray Co., Ltd.), 272 g of a 5 mass % pigment dispersion and 4,200 ml of a 19 mass % solution of methyl methacrylate/styrene/butyl acrylate/hydroxyethyl methacrylate/acrylic acid copolymer (copolymerization weight ratio: 64/9/20/5/2) latex. The pH was adjusted to 7.5 with NaOH to prepare a coating solution for interlayer and then the coating solution for interlayer was transferred to a coating die to give a coverage of 9.1 ml/m².

The viscosity of the coating solution was measured at 40° C. by a Brookfield viscometer (No. 1 rotor, 60 rpm) and found to be 58 [mPa·s].

<Preparation of Coating Solution for First Protective Layer on Emulsion Surface>

In water, 64 g of inert gelatin was dissolved. Thereto, 80 g of a 27.5 mass % solution of methyl methacrylate/styrene/butyl acrylate/hydroxyethyl methacrylate/acrylic acid copolymer (copolymerization weight ratio: 64/9/20/5/2) latex, 23 ml of a 10 mass % methanol solution of phthalic acid, 23 ml of a 10 mass % aqueous solution of 4-methylphthalic acid, 28 ml of sulfuric acid in a concentration of 0.5 mol/L, 5 ml of a 5 mass % aqueous solution of “Aerosol OT” (produced by American Cyanamide), 0.5 g of phenoxyethanol, 0.1 g of benzoisothiazolinone and water for making a total amount of 750 g were added to prepare a coating solution. Immediately before the coating, 26 ml of a 4 mass % chrome alum was mixed using a static mixer. Then, the coating solution was transferred to a coating die to give a coverage of 18.6 ml/m².

The viscosity of the coating solution was measured at 40° C. by a Brookfield viscometer (No. 1 rotor, 60 rpm) and found to be 20 μmPa·s].

<Preparation of Coating Solution for Second Protective Layer on Emulsion Surface>

In water, 80 g of inert gelatin was dissolved. Thereto, 102 g of a 27.5 mass % solution of methyl methacrylate/styrene/butyl acrylate/hydroxyethyl methacrylate/acrylic acid copolymer (copolymerization weight ratio: 64/9/20/5/2) latex, 3.2 ml of a 5 mass % solution of Fluorine-Containing Surfactant (F-1) (N-perfluorooctylsulfonyl-N-propylalanine potassium salt), 32 ml of a 2 mass % aqueous solution of Fluorine-Containing Surfactant (F-2) (polyethylene glycol mono(N-perfluorooctylsulfonyl-N-propyl-2-aminoethyl)ether [ethylene oxide average polymerization degree: 15]), 23 ml of a 5 mass % solution of “Aerosol OT” (produced by American Cyanamide), 4 g of polymethyl methacrylate fine particles (average particle size: 0.7 μm), 21 g of polymethyl methacrylate fine particles (average particle size: 4.5 μm), 1.6 g of 4-methylphthalic acid, 4.8 q of phthalic acid, 44 ml of sulfuric acid in a concentration of 0.5 mol/L, 10 mg of benzoisothiazolinone and water for making a total amount of 650 g were added. Immediately before the coating, 445 ml of an aqueous solution containing 4 mass % of chrome alum and 0.67 mass % of phthalic acid was mixed using a static mixer to obtain a coating solution for surface protective layer and then the coating solution for surface protective layer was transferred to a coating die to give a coverage of 8.3 ml/m².

The viscosity of the coating solution was measured at 40° C. by a Brookfield viscometer (No. 1 rotor, 60 rpm) and found to be 19 [mPa·s].

<Preparation of Heat-Developable Photosensitive Material 1 Series (1A(1) to 1N(1))>

In the back surface side of the undercoated support prepared above, the coating solution for antihalation layer and the coating solution for back surface protective layer were simultaneously coated one on another to give a coated amount of solid fine particle dye of 0.04 g/m² as a solid content and a gelatin coated amount of 1.7 g/m², respectively. Then, the coating was dried to form a back layer.

On the surface opposite the back surface, Coating Solution 1 Series for Emulsion Layer, an interlayer, a first protective layer and a second protective layer were simultaneously coated one on another in this order from the undercoated surface by the slide bead coating method to prepare a heat-developable photosensitive material sample. At this time, the temperature was adjusted such that the emulsion layer and the interlayer were 31° C., the first protective layer was 36° C. and the second protective layer was 37° C.

The coated amount (g/m²) of each compound in the emulsion layer is shown below.

| | |
|---|---|
| Fatty acid (organic acid) silver salt (as silver) | 1.34 |
| Pigment (C.I. Pigment Blue 60) | 0.036 |
| Polyhalogen Compound 1 | 0.12 |
| Polyhalogen Compound 2 | 0.37 |
| Phthalazine Compound 1 | 0.19 |
| Polymer latex | 9.97 |
| Reducing Agent Complex 1 | 1.41 |
| Development Accelerator 1 | 0.024 |
| Mercapto Compound 1 | 0.002 |
| Mercapto Compound 2 | 0.012 |
| Silver halide (as Ag) | 0.091 |

The coating and drying conditions were as follows.

The coating was performed at a speed of 160 m/min, the distance between the tip of coating die and the support was set to from 0.10 to 0.30 mm, and the pressure in the vacuum chamber was set lower by 196 to 882 Pa than the atmospheric pressure. The support was destaticized by ionized wind before the coating.

In the subsequent chilling zone, the coating solution was cooled with air at a dry bulb temperature of 10 to 20° C. The sample was then subjected to contact-free transportation and in a helical floating-type dryer, dried with drying air at a dry bulb temperature of 23 to 45° C. and a wet bulb temperature of 15 to 21° C.

After drying, the humidity was adjusted to 40 to 60% RH at 25° C. and then, the layer surface was heated to 70 to 90° C. The heated layer surface was then cooled to 25° C.

The heat-developable photosensitive materials thus prepared each had a matting degree of, in terms of the Beck's smoothness, 550 seconds on the photosensitive layer surface and 130 seconds on the back surface. Furthermore, the pH on the layer surface in the photosensitive layer side was measured and found to be 6.0.

<Preparation of Heat-Developable Photosensitive Material 2 Series (2A(1) and 2D(1))>

Heat-Developable Photosensitive Material 2 was prepared in the same manner as Heat-Developable Photosensitive Material 1 except that in the preparation of Heat-Developable Photosensitive Material 1, Coating Solution 1 Series for Emulsion Layer was changed to Coating Solution 2 Series for Emulsion Layer, Yellow Dye Compound 15 was eliminated from the antihalation layer, and the fluorine-containing surfactants in the back surface protective layer and emulsion surface protective layer were changed from F-1, F-2, F-3 and F-4 to F-5, F-6, F-7 and F-8, respectively.

The coated amount (g/m²) of each compound in this emulsion layer is shown below.

| | |
|---|---|
| Fatty acid silver salt (as silver) | 1.34 |
| Pigment (C.I. Pigment Blue 60) | 0.036 |
| Polyhalogen Compound 1 | 0.12 |
| Polyhalogen Compound 2 | 0.37 |
| Phthalazine Compound 1 | 0.19 |
| Polymer latex | 9.67 |
| Reducing Agent 2 | 0.81 |
| Hydrogen Bond-Forming Compound 1 | 0.30 |
| Development Accelerator 1 | 0.024 |
| Development Accelerator 2 | 0.010 |
| Development Accelerator 3 | 0.015 |
| Color Tone Adjuster 1 | 0.010 |
| Mercapto Compound 2 | 0.002 |
| Silver halide (as Ag) | 0.091 |

Chemical structures of the compounds used in Examples of the present invention are shown below.

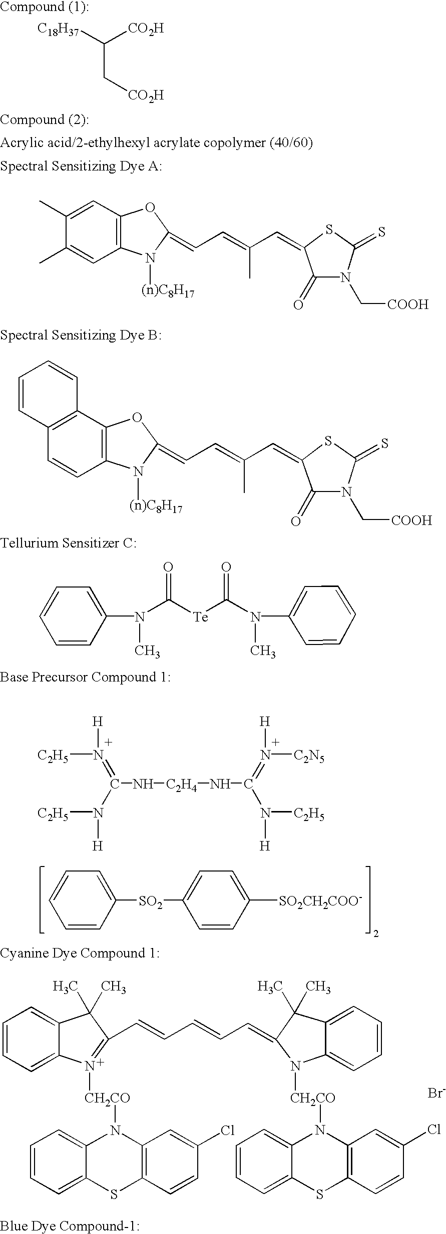

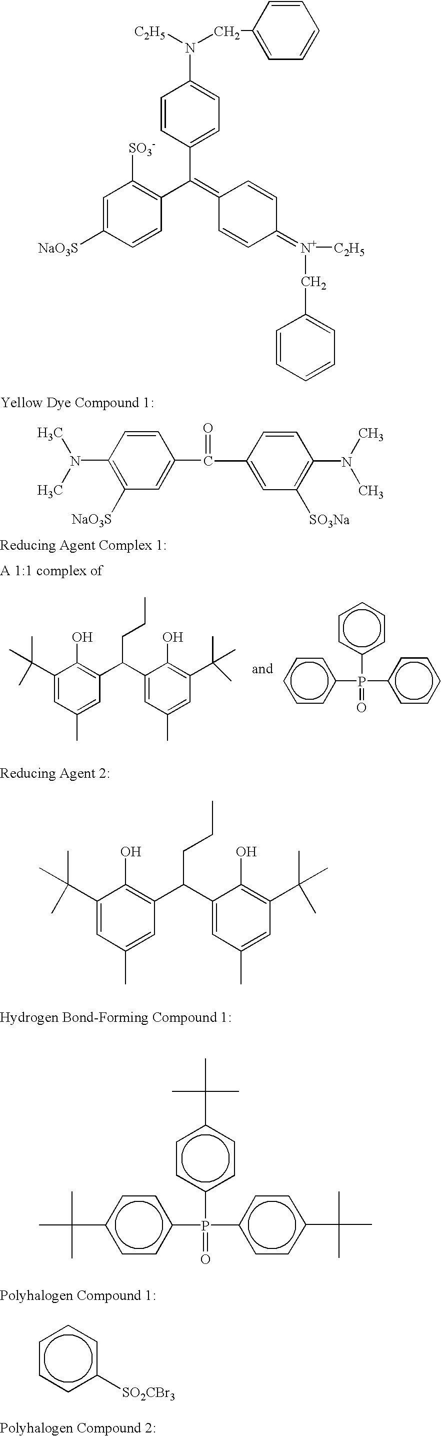

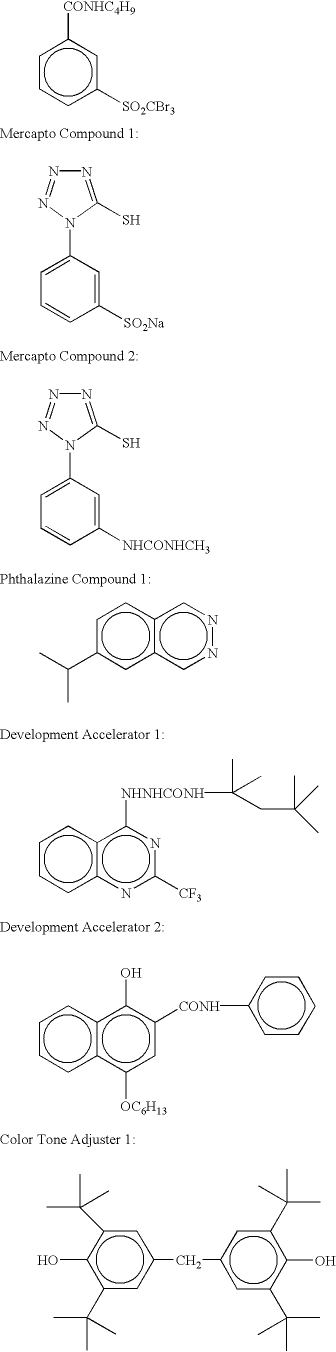

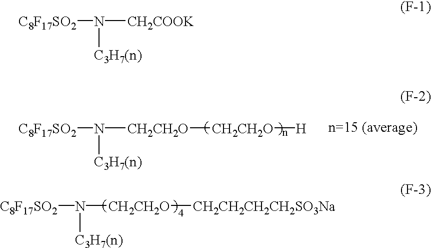

(F-4) C₈F₁₇SO₃K

(F-5) CF₃(CF₂)ₙCH₂Cl₂SCH₂CH₂COOLi

a mixture of n=5 to 11

(F-6) CF₃(CF₂)ₙCl₂CH₂O(CH₂CH₂O)ₘH

a mixture of n=5 to 11, m⁻⁵ to 15

(F-7) CF₃(CF₂)ₙCH₂CH₂SO₃Na

a mixture of n=5 to 11

(F-8) C₆F₁₃CH₂CH₂SO₃Li

(Evaluation of Photographic Performance)

The samples obtained each was cut into a size of 356×432 mm, wrapped with the following packaging material in the environment of 25° C. and 50% RH, stored at an ordinary temperature for 2 weeks and then evaluated on the items shown below.

(Packaging Material)

Polyethylene (50 μm) containing 10 μm of PET/12 μm of PE/9 μm of aluminum foil/15 μm of Ny/3% of carbon:

oxygen permeability: 0 ml/atm·m²·25° C.·day

water permeability: 0 g/atm·m²·25° C.·day

The samples each was exposed and heat-developed (with four sheets of panel heater set at 112° C.-119° C.-121° C.-121° C., for 24 seconds in total in the case of Heat-Developable Photosensitive Material 1 and for 14 seconds in total in the case of Heat-Developable Photosensitive Material 2) in “Fuji Medical Dry Laser Imager FM-DP L” (in which a semiconductor laser of 660 nm having a maximum output of 60 mW (IIIB) was mounted). The obtained image was evaluated by a densitometer. The results of Dmin are shown in Table 14.

<evaluation of Image Preservability>

The photographic materials each was exposed and heat-developed (with four sheets of panel heater set at 112° C.-119° C.-121° C.-121° C., for 24 seconds in total) in “Fuji Medical Dry Laser Imager FM-DP L” (in which a semiconductor laser of 660 nm having a maximum output of 60 mW (IIIB) was mounted). Thereafter, light was fully applied to condition humidity at 70% RH for 3 hours, enclosed in a bag capable of shielding light and left standing in an environment of 60° C. for 72 hours. The percentage of change in Dmin is shown in Table 14.

TABLE 14

| | Dispersion | | | | |
|---|---|---|---|---|---|
| Heat- | of Fatty | | | | |
| Developable | Acid Silver | | | Percentage | |
| Photo- | Salt/Organic | | Dmin | of Change | |
| sensitive | Acid Silver | Polymer | (1A(1) | in Dmin | |
| Material | salt | Latex | as 100) | (%) | Remarks |
| 1A(1) | A | P-1 | 100 | 2 | Invention |
| 1A(2) | A | P-2 | 100 | 4 | Invention |
| 1A(3) | A | P-5 | 100 | 0 | Invention |
| 1A(4) | A | P-15 | 100 | 7 | Invention |
| 1A(5) | A | P-20 | 100 | 12 | Invention |
| 1A(6) | A | RP-1 | 100 | 37 | Comparison |
| 1A(7) | A | RP-2 | 121 | 20 | Comparison |
| 1A(8) | A | RP-3 | 101 | 7 | Invention |
| 1B(1) | B | P-1 | 100 | 1 | Invention |
| 1C(1) | C | P-1 | 100 | 7 | Invention |
| 1D(1) | D | P-1 | 100 | 29 | Comparison |
| 1E(1) | E | P-1 | 100 | 2 | Invention |
| 1F(1) | F | P-1 | 100 | 1 | Invention |
| 1G(1) | G | P-1 | 100 | 0 | Invention |
| 1H(1) | H | P-1 | 100 | 34 | Comparison |
| 1I(1) | I | P-1 | 100 | 1 | Invention |
| 1J(1) | J | P-1 | 100 | 0 | Invention |
| 1K(1) | K | P-1 | 100 | 28 | Comparison |
| 1L(1) | L | P-1 | 100 | 2 | Invention |
| 1M(1) | M | P-1 | 100 | 5 | Invention |
| 1N(1) | N | P-1 | 100 | 3 | Invention |
| 2A(1) | A | P-1 | 100 | 2 | Invention |
| 2D(1) | D | P-1 | 100 | 25 | Comparison |

### EXAMPLE 7

(Preparation of PET Support)

PET having an intrinsic viscosity IV of 0.66 (measured in phenol/tetrachloroethane=6/4 (by weight) at 25° C.) was obtained in a usual manner using terephthalic acid and ethylene glycol. The resulting PET was pelletized and the pellets obtained were dried at 130° C. for 4 hours, melted at 300° C., extruded from a T-die and then quenched to prepare an unstretched film having a thickness large enough to give a thickness of 175 μm after the heat setting.

This film was stretched to 3.3 times in the machine direction using rolls different in the peripheral speed and then stretched to 4.5 times in the cross direction by a tenter. At this time, the temperatures were 110° C. and 130° C., respectively. Subsequently, the film was heat set at 240° C. for 20 seconds and relaxed by 4% in the cross direction at the same temperature. Thereafter, the chuck part of the tenter was slit, both edges of the film were knurled, and the film was taken up at 4 kg/cm² to obtain a roll having a thickness of 175 μm.

(Surface Corona Treatment)

Both surfaces of the support were treated at room temperature at 20 m/min using a solid state corona treating machine “Model 6 KVA” (manufactured by Pillar Technologies). From the current and voltage read at this time, it was known that a treatment of 0.375 kV·A·min/m² was applied to the support. The treatment frequency here was 9.6 kHz and the gap clearance between the electrode and the dielectric roll was 1.6 mm.

(Preparation of Undercoated Support)

(1) Preparation of Coating Solution for Undercoat Layer
Formulation (1) (for undercoat layer in the photosensitive
layer side):

| “PESRESIN A-520” (30 mass % solution) | 59 | g |
|---|---|---|
| produced by Takamatsu Yushi K.K. | | |
| Polyethylene glycol monononylphenyl ether | 5.4 | g |
| (average ethylene oxide number: 8.5), 10 | | |
| mass % solution | | |
| “MP-1000” (fine polymer particles, average | 0.91 | g |
| particle size: 0.4 μm) produced by Soken | | |
| Kagaku K.K. | | |
| Distilled water | 935 | ml |
| Formulation (2) (for first layer on the back surface): | | |
| Styrene/butadiene copolymer latex (solid | 158 | g |
| content: 40 mass %, styrene/butadiene | | |
| weight ratio: 68/32) | | |
| 2,4-Dichloro-6-hydroxy-S-triazine sodium | 20 | g |
| salt, 8 mass % aqueous solution | | |
| 1 Mass % aqueous solution of sodium | 10 | ml |
| laurylbenzenesulfonate | | |
| Distilled water | 854 | ml |
| Formulation (3) (for second layer on the back surface): | | |
| SnO₂/SbO (9/1 by mass, average particle | 84 | g |
| size: 0.038 μm, 17 mass % dispersion) | | |
| Gelatin (10 mass % aqueous solution) | 89.2 | g |
| “METROSE TC-5” (2 mass % aqueous solution) | 8.6 | g |
| produced by Shin-Etsu Chemical Co., Ltd. | | |
| “MP-1000” produced by Soken Kagaku K.K. | 0.01 | g |
| 1 Mass % aqueous solution of sodium | 10 | ml |
| dodecylbenzenesulfonate | | |
| NaOH (1 mass %) | 6 | ml |
| “PROXEL” (produced by ICI) | 1 | ml |
| Distilled water | 805 | ml |

Both surfaces of the 175 μm-thick biaxially stretched polyethylene terephthalate support obtained above each was subjected to the above-described corona discharge treatment and on one surface (photosensitive layer surface), the undercoating solution of formulation (1) was applied by a wire bar to have a wet coated amount of 6.6 ml/m² (per one surface) and dried at 180° C. for 5 minutes. Thereafter, on the opposite surface thereof (back surface), the undercoating solution of formulation (2) was applied by a wire bar to have a wet coated amount of 5.7 ml/m² and dried at 180° C. for 5 minutes. On the opposite surface (back surface), the undercoating solution of formulation (3) was further applied by a wire bar to have a wet coated amount of 7.7 ml/m² and dried at 180° C. for 6 minutes, thereby obtaining an undercoated support.

(Preparation of Coating Solution for Back Surface)

(Preparation of Solid Fine Particle Dispersion (a) of Base Precursor)

Base Precursor Compound 1 (64 g), 28 g of diphenylsulfone and 10 g of surfactant “Demol N” (produced by Kao Corporation) were mixed with 220 ml of distilled water and the mixed solution was dispersed using beads in a sand mill (¼ Gallon Sand Grinder Mill, manufactured by AIMEX K. K.) to obtain Solid Fine Particle Dispersion (a) of Base Precursor Compound, having an average particle size of 0.2 μm.

(Preparation of Solid Fine Particle Dispersion of Dye)

Cyanine Dye Compound 1 (19.2 g), 9.6 g of sodium p-dodecylbenzenesulfonate and 1.92 g of surfactant “Demol SNB” (produced by Kao Corporation) were mixed with 289 ml of distilled water and the mixed solution was dispersed using zirconia beads of 0.5 mm in a sand mill (¼ Gallon Sand Grinder Mill, manufactured by AIMEX K. K.) to obtain a solid fine particle dispersion of dye, having an average particle size of 0.2 μm.

(Preparation of Coating Solution for Antihalation Layer)

Gelatin (17 g), 9.6 g of polyacrylamide, 56 q of Solid Fine Particle Dispersion (a) of Base Precursor obtained above, 25 g of the solid fine particle dispersion of dye obtained above, 1.5 g of monodisperse polymethyl methacrylate fine particles (average particle size: 8 μm, standard deviation of particle size: 0.4), 0.03 g of benzoisothiazolinone, 2.2 g of sodium polyethylenesulfonate, 0.1 g of Blue Dye Compound 1, 0.1 g of Yellow Dye Compound 1 and 869 ml of water were mixed to prepare a coating solution for antihalation layer.

(Preparation of Coating Solution for Protective Layer on Back Surface)

In a container kept at 40° C., 50 g of gelatin, 0.2 g of sodium polystyrenesulfonate, 2.4 g of N,N-ethylene-bis(vinylsulfonacetamide), 1 g of sodium tert-octylphenoxyethoxyethanesulfonate, 30 mg of benzoisothiazolinone, 37 mg of Fluorine-Containing Surfactant (β-1) (N-perfluorooctyl sulfonyl-N-propylalanine potassium salt), 150 mg of Fluorine-Containing Surfactant (F-2) (polyethylene glycol mono(N-perfluorooctylsulfonyl-N-propyl-2-aminoethyl) ether [ethylene oxide average polymerization degree: 151), 64 mg of Fluorine-Containing Surfactant (F-3), 32 mg of Fluorine-Containing Surfactant (F-4), 8.8 g of an acrylic acid/ethyl acrylate copolymer (copolymerization weight ratio: 5/95), 0.6 g of “Aerosol OT” (produced by American Cyanamide), 1.8 g of liquid paraffin emulsion as liquid paraffin and 950 ml of water were mixed to prepare a coating solution for protective layer on the back surface.

(Preparation of Silver Halide Emulsion)

<Preparation of Silver Halide Emulsion 1>

A solution was prepared by adding 3.1 ml of a 1 mass % potassium bromide solution, 3.5 ml of sulfuric acid in a concentration of 0.5 mol/L and 31.7 g of phthalated gelatin to 1,421 ml of distilled water and while stirring the solution in a stainless steel-made reaction pot and thereby keeping the liquid temperature at 30° C., the entire amount of Solution A prepared by diluting 22.22 g of silver nitrate with distilled water to a volume of 95.4 ml and the entire amount of Solution B prepared by diluting 15.3 g of potassium bromide and 0.8 g of potassium iodide with distilled water to a volume of 97.4 ml were added at a constant flow rate over 45 seconds. Thereto, 10 ml of an aqueous 3.5 mass % hydrogen peroxide solution was added and then, 10.8 ml of a 10 mass % aqueous solution of benzimidazole was further added. Thereafter, the entire amount of Solution C prepared by diluting 51.86 g of silver nitrate with distilled water to a volume of 317.5 ml and the entire amount of Solution D obtained by diluting 44.2 g of potassium bromide and 2.2 g of potassium iodide with distilled water to a volume of 400 ml were added. Here, Solution C was added at a constant flow rate over 20 minutes and Solution D was added by the controlled double jet method while maintaining the pAg at 8.1. After 10 minutes from the initiation of addition of Solution C and Solution D, the entire amount of potassium hexachloro iridate(III) was added to a concentration of 1×10 ⁴ mol per mol of silver. Furthermore, 5 seconds after the completion of addition of Solution C, the entire amount of an aqueous potassium hexacyanoferrate(II) solution was added to a concentration of 3×10⁻⁴ mol per mol of silver. Then, the pH was adjusted to 3.8 using sulfuric acid in a concentration of 0.5 mol/L and after stirring was stopped, the resulting solution was subjected to precipitation/desalting/water washing. The pH was then adjusted to 5.9 using sodium hydroxide in a concentration of 1 mol/L, thereby preparing a silver halide dispersion at a pAg of 8.0.

While stirring the silver halide dispersion obtained above and thereby keeping it at 38° C., 5 ml of a methanol solution containing 0.34 mass % of 1,2-benzoisothiazolin-3-one was added and after 40 minutes, a methanol solution containing Spectral Sensitizing Dye A and Spectral Sensitizing Dye B at a molar ratio of 1:1 was added in an amount, as a total of Sensitizing Dye A and Sensitizing Dye B, of 1.2×10⁻³ mol per mol of silver. After 1 minute, the temperature was elevated to 47° C. and 20 minutes after the elevation of temperature, a methanol solution of sodium benzenethiosulfonate was added in an amount of 7.6×10⁻⁵ mol per mol of silver. After 5 minutes, a methanol solution of Tellurium Sensitizer C was further added in an amount of 2.9×10⁻⁴ mol per mol of silver and then, the solution was ripened for 91 minutes. Thereto, 1.3 ml of a 0.8 mass % methanol solution of N,N′-dihydroxy-N″-diethylmelamine was added and after 4 minutes, a methanol solution of 5-methyl-2-mercaptobenzimidazole and a methanol solution of 1-phenyl-2-heptyl-5-mercapto-1,3,4-triazole were added in an amount of 4.8×10⁻³ mol and 5.4×10⁻³ mol, respectively, per mol of silver to prepare Silver Halide Emulsion 1.

The grains in the thus-prepared silver halide emulsion were silver iodobromide grains having an average equivalent-sphere diameter of 0.042 μm and a coefficient of variation in the equivalent-sphere diameter of 20% and uniformly containing 3.5 mol % of iodide. The grain size and the like were determined as an average of 1,000 grains using an electron microscope. The percentage of (100] faces in this grain was 80% as determined using the Kubelka-Munk equation.

<Preparation of Silver Halide Emulsion 2>

Silver Halide Emulsion 2 was prepared in the same manner as Silver Halide Emulsion 1 except that the liquid temperature at the grain formation was changed from 30° C. to 47° C., Solution B was obtained by diluting 15.9 g of potassium bromide with distilled water to a volume of 97.4 ml, Solution D was obtained by diluting 45.8 g of potassium bromide with distilled water to a volume of 400 ml, the addition time of Solution C was changed to 30 minutes and potassium hexacyanoferrate(II) was excluded. Also, precipitation/desalting/water washing/dispersion were performed in the same manner as in the preparation of Silver Halide Emulsion 1. Thereafter, spectral sensitization, chemical sensitization and addition of 5-methyl-2-mercaptobenzimidazole and 1-phenyl-2-heptyl-5-mercapto-1,3,4-triazole were performed in the same manner as in the preparation of Emulsion 1 except that the amount added of the methanol solution containing Spectral Sensitizing Dye A and Spectral Sensitizing Dye B at a molar ratio of 1:1 was changed, as a total of Sensitizing Dye A and Sensitizing Dye B, to 7.5×10⁴ mol per mol of silver, the amount of Tellurium Sensitizer C added was changed to 1.1×10⁻⁴ mol per mol of silver, and the amount of 1-phenyl-2-heptyl-5-mercapto-1,3,4-triazole added was changed to 3.3×10⁻³ mol per mol of silver. Thus, Silver Halide Emulsion 2 was obtained. The emulsion grains of Silver Halide Emulsion 2 were pure silver bromide cubic grains having an average equivalent-sphere diameter of 0.080 μm and a coefficient of variation in the equivalent-sphere diameter of 20%.

<Preparation of Silver Halide Emulsion 3>

Silver Halide Emulsion 3 was prepared in the same manner as Silver Halide Emulsion 1 except that the liquid temperature at the grain formation was changed from 30° C. to 27° C. Also, precipitation/desalting/water washing/dispersion were performed in the same manner as in the preparation of Silver Halide Emulsion 1. Thereafter, Silver Halide Emulsion 3 was obtained in the same manner as Emulsion 1 except that a solid dispersion (aqueous gelatin solution) containing Spectral Sensitizing Dye A and Spectral Sensitizing Dye B at a molar ratio of 1:1 was added in an amount, as a total of Sensitizing Dye A and Sensitizing Dye B, of 6×10⁻³ mol per mol of silver and the amount of Tellurium Sensitizer C added was changed to 5.2×10⁻⁴ mol per mol of silver. The emulsion grains of Silver Halide Emulsion 3 were silver iodobromide grains having an average equivalent-sphere diameter of 0.034 μm and a coefficient of variation in the equivalent-sphere diameter of 20% and uniformly containing 3.5 mol % of iodide.

<Preparation of Mixed Emulsion A for Coating Solution>

70 Mass % of Silver Halide Emulsion 1, 15 mass % of Silver Halide Emulsion 2 and 15 mass % of Silver Halide Emulsion 3 were dissolved and thereto, a 1 mass % aqueous solution of benzothiazolium iodide was added in an amount of 7×10⁻³ mol per mol of silver. Furthermore, water was added to adjust the silver halide content to 38.2 g in terms of silver per kg of the mixed emulsion for coating solution.

<Preparation of Fatty Acid Silver Salt Dispersion>

Behenic acid (87.6 kg, “Edenor C22-85R”, trade name, produced by Henkel Co.), 423 L of distilled water, 49.2 L of an aqueous NaOH solution in a concentration of 5 mol/L, and 120 L of tert-butyl alcohol were mixed. The mixture was reacted by stirring at 75° C. for one hour to obtain a sodium behenate solution. Separately, 206.2 L (pH 4.0) of an aqueous solution containing 40.4 kg of silver nitrate was prepared and kept at 10° C. A reactor containing 635 L of distilled water and 30 L of tert-butyl alcohol was kept at 30° C. and while thoroughly stirring, the entire amount of the sodium behenate solution obtained above and the entire amount of the aqueous silver nitrate solution prepared above were added at constant flow rates over 93 minutes and 15 seconds and over 90 minutes, respectively. At this time, only the aqueous silver nitrate solution was added for the period of 11 minutes after the initiation of addition of the aqueous silver nitrate solution, then addition of the sodium behenate solution was started, and only the sodium behenate solution was added for the period of 14 minutes and 15 second after the completion of addition of the aqueous silver nitrate solution. During the addition, the temperature inside the reactor was kept at 30° C. and the outer temperature was controlled to make constant the liquid temperature. The piping in the system of adding the sodium behenate solution was kept warm by circulating hot water in the outer side of a double pipe, whereby the outlet liquid temperature at the distal end of the addition nozzle was adjusted to 75° C. The piping in the system of adding the aqueous silver nitrate solution was kept warm by circulating cold water in the outer side of a double pipe. The addition site of sodium behenate solution and the addition site of aqueous silver nitrate solution were symmetrically arranged centered around the stirring axis. Also, these addition sites were each adjusted to a height of not causing contact with the reaction solution.

After the completion of addition of the sodium behenate solution, the mixture was left standing at that temperature for 20 minutes with stirring. The temperature was then elevated to 35° C. over 30 minutes and the solution was ripened for 210 minutes. Immediately after the completion of ripening, the solid content was separated by centrifugal filtration and washed with water until the conductivity of filtrate became 30 μS/cm. In this manner, a fatty acid silver salt was obtained. The solid content obtained was not dried but stored as a wet cake.

The shape of the thus-obtained silver behenate grains was analyzed by electron microphotography. The grains were scaly crystals having average sizes of a=0.14 μm, b=0.4 μm and c=0.6 μm, an average aspect ratio of 5.2, an average equivalent-sphere diameter of 0.52 μm and a coefficient of variation in the equivalent-sphere diameter of 15% (a, b and c comply with the definition in this specification).

To the wet cake corresponding to 260 Kg as a dry solid content, 19.3 Kg of polyvinyl alcohol (“PVA-217”, trade name) and water were added to make a total amount of 1,000 Kg. The resulting mixture was made into a slurry by a dissolver blade and the slurry was preliminarily dispersed by a pipeline mixer (“Model PM-10”, manufactured by Mizuho Kogyo).

Then, the preliminarily dispersed stock solution was treated three times in a dispersing machine (“Microfluidizer M-610”, trade name, manufactured by Microfluidex International Corporation, using a Z-type interaction chamber) under the control of pressure to 1,260 kg/cm² to obtain a silver behenate dispersion. At the dispersion, the temperature was set to 18° C. by a cooling operation of controlling the temperature of coolant using coiled heat exchangers attached to the inlet side and outlet side of the interaction chamber.

(Preparation of Reducing Agent Dispersion)

<Preparation of Reducing Agent Complex 1 Dispersion>

To 10 kg of Reducing Agent Complex 1 (a 1:1 complex of 6,6′-di-tert-butyl-4,4′-dimethyl-2,2′-butylidenediphenol and triphenylphosphine oxide), 0.12 Kg of triphenylphosphine oxide and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 4 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the reducing agent concentration to 22 mass %, thereby obtaining Reducing Agent Complex 1 Dispersion. The reducing agent complex particles contained in the thus-obtained reducing agent complex dispersion had a median diameter of 0.45 μm and a maximum particle size of 1.4 μm or less. The obtained reducing agent complex dispersion was filtered through a polypropylene-made filter having a pore size of 3.0 μm to remove foreign matters such as dust and then housed.

<Preparation of Reducing Agent 2 Dispersion>

To 10 kg of Reducing Agent 2 (6,6′-di-tert-butyl-4,4′-dimethyl-2,2′-butylidenediphenol) and 16 Kg of a 10 mass % aqueous solution of modified polyvinyl alcohol (“Poval MP203”, produced by Kuraray Co., Ltd.), 10 Kg of water was added and thoroughly mixed to form a slurry. This slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the reducing agent concentration to 25 mass %, thereby obtaining Reducing Agent 2 Dispersion. The reducing agent particles contained in the thus-obtained reducing agent dispersion had a median diameter of 0.40 μm and a maximum particle size of 1.5 μm or less. The obtained reducing agent dispersion was filtered through a polypropylene-made filter having a pore size of 3.0 μm to remove foreign matters such as dust and then housed.

<Preparation of hydrogen Bond-Forming Compound 1 Dispersion>

To 10 Kg of Hydrogen Bond-Forming Compound 1 (tri(4-tert-butylphenyl)phosphine oxide) and 16 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the hydrogen bond-forming compound concentration to 25 mass %, thereby obtaining Hydrogen Bond-Forming Compound 1 Dispersion. The hydrogen bond-forming compound particles contained in the thus-obtained hydrogen bond-forming compound dispersion had a median diameter of 0.35 μm and a maximum particle size of 1.5 μm or less. The obtained hydrogen bond-forming compound dispersion was filtered through a polypropylene-made filter having a pore size of 3.0 μm to remove foreign matters such as dust and then housed.

<Preparation of Development Accelerator 1 Dispersion>

To 10 Kg of Development Accelerator 1 and 20 Kg of a 10 mass % aqueous solution of modified polyvinyl alcohol (“Poval MP203”, produced by Kuraray Co., Ltd.), 10 Kg of water was added and thoroughly mixed to form a slurry. The resulting slurry was transferred by a diaphragm pump and dispersed for 3 hours and 30 minutes in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the development accelerator concentration to 20 mass %, thereby obtaining Development Accelerator 1 Dispersion. The development accelerator particles contained in the thus-obtained development accelerator dispersion had a median diameter of 0.48 μm and a maximum particle size of 1.4 μm or less. The obtained development accelerator dispersion was filtered through a polypropylene-made filter having a pore size of 3.0 μm to remove foreign matters such as dust and then housed.

Solid Dispersions of Development Accelerator 2, Development Accelerator 3 and Color Tone Adjuster 1 each was obtained as a 20 mass % dispersion in the same manner as Development Accelerator 1.

(Preparation of Polyhalogen Compound)

<Preparation of organic Polyhalogen Compound 1 Dispersion>

To 10 Kg of Organic Polyhalogen Compound 1 (tribromomethanesulfonylbenzene), 10 Kg of a 20 mass % aqueous solution of modified polyvinyl alcohol (“Poval MP203”, produced by Kuraray Co., Ltd.) and 0.4 Kg of a 20 mass % aqueous solution of sodium triisopropylnaphthalenesulfonate, 14 Kg of water was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 26 mass %, thereby obtaining Organic Polyhalogen Compound 1 Dispersion. The organic polyhalogen compound particles contained in the thus-obtained organic polyhalogen compound dispersion had a median diameter of 0.41 μm and a maximum particle size of 2.0 μm or less. The obtained organic polyhalogen compound dispersion was filtered through a polypropylene-made filter having a pore size of 10.0 μm to remove foreign matters such as dust and then housed.

<Preparation of Organic Polyhalogen Compound 2 Dispersion>

To 10 Kg of Organic Polyhalogen Compound 2 (N-butyl-3-tribromomethanesulfonylbenzamide) and 20 Kg of a 10 mass % aqueous solution of modified polyvinyl alcohol (“Poval MP203”, produced by Kuraray Co., Ltd.), 0.4 Kg of a 20 mass % aqueous solution of sodium triisopropylnaphthalenesulfonate was added and thoroughly mixed to form a slurry. The resulting slurry was transferred by a diaphragm pump and dispersed for 5 hours in a horizontal sand mill (“UVM-2”, manufactured by AIMEX K. K.) filled with zirconia beads having an average diameter of 0.5 mm. Thereafter, 0.2 g of benzoisothiazolinone sodium salt and water were added to adjust the organic polyhalogen compound concentration to 30 mass %. This dispersion solution was heated at 40° C. for 5 hours, whereby Organic Polyhalogen Compound 2 Dispersion was obtained. The organic polyhalogen compound particles contained in the thus-obtained polyhalogen compound dispersion had a median diameter of 0.40 μm and a maximum particle size of 1.3 μm or less. The obtained organic polyhalogen compound dispersion was filtered through a polypropylene-made filter having a pore size of 3.0 μm to remove foreign matters such as dust and then housed.

<Preparation of Phthalazine Compound 1 Solution>

In 174.57 Kg of water, 8 Kg of modified polyvinyl alcohol “MP203” produced by Kuraray Co., Ltd. was dissolved. Thereto, 3.15 Kg of a 20 mass % aqueous solution of sodium triisopropylnaphthalenesulfonate and 14.28 Kg of a 70 mass % aqueous solution of Phthalazine Compound 1 (6-isopropylphthalazine) were added to prepare a 5 mass % solution of Phthalazine Compound 1.

(Preparation of Mercapto Compound)

<Preparation of Aqueous Mercapto Compound 1 Solution>

In 993 g of water, 7 g of Mercapto Compound 1 (1-(3-sulfophenyl)-5-mercaptotetrazole sodium salt) was dissolved to prepare a 0.7 mass % aqueous solution.

<Preparation of Aqueous Mercapto Compound 2 Solution>

In 980 g of water, 20 g of Mercapto Compound 2 (1-(3-inethylureido)-5-mercaptotetrazole sodium salt) was dissolved to prepare a 2.0 mass % aqueous solution.

<Preparation of Pigment 1 Dispersion>

To 64 g of C.I. Pigment Blue 60 and 6.4 g of “Demol N” (produced by Kao Corporation), 250 g of water was added and thoroughly mixed to form a slurry. The resulting slurry and 800 g of zirconia beads having an average diameter of 0.5 mm were put together into a vessel and dispersed for 25 hours in a dispersing machine (¼G Sand Grinder Mill, manufactured by AIMEX K. K.) to obtain Pigment 1 Dispersion. The pigment particles contained in the thus-obtained pigment dispersion had an average particle size of 0.21 μm.

<Preparation of SBR Latex Solution>

An SBR latex having a Tg of 22° C. was prepared as follows.

Using ammonium persulfate as a polymerization initiator and an anionic surfactant as an emulsifier, 70.0 mass of styrene, 27.0 mass of butadiene and 3.0 mass of acrylic acid were emulsion-polymerized. After aging at 80° C. for 8 hours, the resulting polymer was cooled to 40° C. and adjusted to a pH of 7.0 with aqueous ammonia. Thereto, “SANDET BL” (produced by Sanyo Kasei K. K.) was added to have a concentration of 0.22%. In this SANDET BL, an aqueous sodium chloride solution was added to adjust the chloride ion concentration to 300 ppm in the SBR latex solution and the chloride ion concentration was controlled by dialyzing the SBR latex (the chloride ion concentration is shown in Table 1). The chloride ion concentration could be reduced by increasing the frequency of dialysis. Thereafter, the pH was adjusted to 8.3 by adding an aqueous 5% sodium hydroxide solution and then, the pH was adjusted to 8.4 with aqueous ammonia. The molar ratio of Na⁺ ion and NH₄⁺ ion used here was 1:2.3. To 1 Kg of this solution, 0.15 ml of a 7% aqueous solution of benzoisothiazolinone sodium salt was added to prepare an $SR latex solution. (SBR Latex: latex of -St(70.0)-Bu(27.0)-AA(3.0)-):

Tg: 22° C.

Average particle size: 0.1 μm, concentration: 43 mass %, equilibrium moisture content at 25° C. and 60% RH: 0.6 mass %, ion conductivity: 4.2 mS/cm (in the measurement of ion conductivity, the latex stock solution (43 mass %) was measured at 25° C. using a conductivity meter “CM-30S” manufactured by Toa Denpa Kogyo K. K.), pH: 8.4.

SBR latexes different in the Tg can be prepared in the same manner by appropriately changing the ratio of styrene and butadiene.

<Preparation of Coating Solution 1 for Emulsion Layer (Photosensitive Layer)>

The fatty acid silver salt dispersion prepared above (1,000 g), 276 ml of water, 33.2 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of an SBR latex (Tg: 22° C.) solution, 299 g of Reducing Agent Complex 1 Dispersion, 6 g of Development Accelerator 1 Dispersion, 9 ml of Aqueous Mercapto Compound 1 Solution and 27 ml of Aqueous Mercapto Compound 2 Solution were sequentially added. Immediately before the coating, 117 g of Silver Halide Mixed Emulsion A was added and thoroughly mixed. The resulting coating solution for emulsion layer was transferred as it was to a coating die and coated. Coating solutions where Mercpato Compounds 1 and 2 were not added are shown in Table 15.

The viscosity of the coating solution for emulsion layer obtained above was measured by a Brookfield viscometer manufactured by Tokyo Keiki Kogyo K. K. and found to be 25 [mPa·s] at 40° C. (No. 1 rotor, 60 rpm).

The viscosity of the coating solution measured at 25° C. using “RFS Field Spectrometer” (manufactured by Rheometrics Far East K. K.) was 230, 60, 46, 24 and 18 [mPa·s] at a shear rate of 0.1, 1, 10, 100 and 1,000 [1/sec], respectively.

The amount of zirconium in the coating solution was 0.38 mg per g of silver.

<Preparation of Coating Solution 2 for Emulsion Layer (Photosensitive Layer)>

The fatty acid silver salt dispersion prepared above (1,000 g), 276 ml of water, 32.8 g of Pigment 1 Dispersion, 21 g of Organic Polyhalogen Compound 1 Dispersion, 58 g of Organic Polyhalogen Compound 2 Dispersion, 173 g of Phthalazine Compound 1 Solution, 1,082 g of an SBR latex (Tg: 20° C.) solution, 155 g of Reducing Agent 2 Dispersion, 55 g of Hydrogen Bond-Forming Compound 1 Dispersion, 6 g of Development Accelerator 1 Dispersion, 2 g of Development Accelerator 2 Dispersion, 3 g of Development Accelerator 3 Dispersion, 2 g of Color Tone Adjuster 1 Dispersion and 6 ml of Aqueous Mercapto Compound 2 Solution were sequentially added. Immediately before the coating, 117 g of Silver Halide Mixed Emulsion A was added and thoroughly mixed. The resulting coating solution for emulsion layer was transferred as it was to a coating die and coated.

The viscosity of the coating solution for emulsion layer obtained above was measured by a Brookfield viscometer manufactured by Tokyo Keiki Kogyo K. K. and found to be 40 [mPa·s] at 40° C. (No. 1 rotor, 60 rpm).

The viscosity of the coating solution measured at 25° C. using “RFS Field Spectrometer” (manufactured by Rheometrics Far East K. K.) was 530, 144, 96, 51 and 28 [mPa·s] at a shear rate of 0.1, 1, 10, 100 and 1,000 [1/sec], respectively.

The amount of zirconium in the coating solution was 0.25 mg per g of silver.

<Preparation of Coating Solution for Interlayer on Emulsion Surface>

A 5 mass % aqueous solution (27 ml) of “Aerosol OT” (produced by American Cyanamide), 135 ml of a 20 mass % aqueous solution of diammonium phthalate and water for making a total amount of 10,000 g were added to 1,000 g of polyvinyl alcohol “PVA-205” (produced by Kuraray Co., Ltd.), 272 g of a 5 mass % pigment dispersion and 4,200 ml of a 19 mass % solution of methyl methacrylate/styrene/butyl acrylate/hydroxyethyl methacrylate/acrylic acid copolymer (copolymerization weight ratio: 64/9/20/5/2) latex. The pH was adjusted to 7.5 with NaOH to prepare a coating solution for interlayer and then the coating solution for interlayer was transferred to a coating die to give a coverage of 9.1 ml/m².

The viscosity of the coating solution was measured at 40° C. by a Brookfield viscometer (No. 1 rotor, 60 rpm) and found to be 58 [mPa·s].

<Preparation of Coating Solution for First Protective Layer on Emulsion Surface>

In water, 64 g of inert gelatin was dissolved. Thereto, 80 g of a 27.5 mass % solution of methyl methacrylate/styrene/butyl acrylate/hydroxyethyl methacrylate/acrylic acid copolymer (copolymerization weight ratio: 64/9/20/5/2) latex, 23 ml of a 10 mass % methanol solution of phthalic acid, 23 ml of a 10 mass % aqueous solution of 4-methylphthalic acid, 28 ml of sulfuric acid in a concentration of 0.5 mol/L, 5 ml of a 5 mass % aqueous solution of “Aerosol OT” (produced by American Cyanamide), 0.5 g of phenoxyethanol, 0.1 g of benzoisothiazolinone and water for making a total amount of 750 g were added to prepare a coating solution. Immediately before the coating, 26 ml of a 4 mass % chrome alum was mixed using a static mixer. Then, the coating solution was transferred to a coating die to give a coverage of 18.6 ml/m² The viscosity of the coating solution was measured at 40° C. by a Brookfield viscometer (No. 1 rotor, 60 rpm) and found to be 20 [mPa·s].

<Preparation of Coating Solution for Second Protective Layer on Emulsion Surface>

In water, 80 g of inert gelatin was dissolved. Thereto, 102 g of a 27.5 mass % solution of methyl methacrylate/styrene/butyl acrylate/hydroxyethyl methacrylate/acrylic acid copolymer (copolymerization weight ratio: 64/9/20/5/2) latex, 3.2 ml of a 5 mass % solution of Fluorine-Containing Surfactant (F-1) (N-perfluorooctylsulfonyl-N-propylalanine potassium salt), 32 ml of a 2 mass % aqueous solution of Fluorine-Containing Surfactant (F-2) (polyethylene glycol mono(N-perfluorooctylsulfonyl-N-propyl-2-aminoethyl)ether [ethylene oxide average polymerization degree: 15]), 23 ml of a 5 mass % solution of “Aerosol OT” (produced by American Cyanamide), 4 g of polymethyl methacrylate fine particles (average particle size: 0.7 μm), 21 g of polymethyl methacrylate fine particles (average particle size: 4.5 μm), 1.6 g of 4-methylphthalic acid, 4.8 g of phthalic acid, 44 ml of sulfuric acid in a concentration of 0.5 mol/L, 10 mg of benzoisothiazolinone and water for making a total amount of 650 g were added. Immediately before the coating, 445 ml of an aqueous solution containing 4 mass % of chrome alum and 0.67 mass % of phthalic acid was mixed using a static mixer to obtain a coating solution for surface protective layer and then the coating solution for surface protective layer was transferred to a coating die to give a coverage of 8.3 ml/m².

The viscosity of the coating solution was measured at 40° C. by a Brookfield viscometer (No. 1 rotor, 60 rpm) and found to be 19 [mPa·s].

<Preparation of Heat-Developable Photosensitive Material 1>

In the back surface side of the undercoated support prepared above, the coating solution for antihalation layer and the coating solution for back surface protective layer were simultaneously coated one on another to give a coated amount of solid fine particle dye of 0.04 g/m² as a solid content and a gelatin coated amount of 1.7 g/m², respectively. Then, the coating was dried to form a back layer.

On the surface opposite the back surface, an emulsion layer, an interlayer, a first protective layer and a second protective layer were simultaneously coated one on another in this order from the undercoated surface by the slide bead coating method to prepare a heat-developable photosensitive material sample. At this time, the temperature was adjusted such that the emulsion layer and the interlayer were 31° C., the first protective layer was 36° C. and the second protective layer was 37° C.

The coated amount (g/m²) of each compound in the emulsion layer is shown below.

| | |
|---|---|
| Silver behenate | 5.55 |
| Pigment (C.I. Pigment Blue 60) | 0.036 |
| Polyhalogen Compound 1 | 0.12 |
| Polyhalogen Compound 2 | 0.37 |
| Phthalazine Compound 1 | 0.19 |
| SBR Latex | 9.97 |
| Reducing Agent Complex 1 | 1.41 |
| Development Accelerator 1 | 0.024 |
| Mercapto Compound 1 | 0.002 |
| MercaptO Compound 2 | 0.012 |
| Silver halide (as Ag) | 0.091 |

The coating and drying conditions were as follows.

The coating was performed at a speed of 160 m/min, the distance between the tip of coating die and the support was set to from 0.10 to 0.30 mm, and the pressure in the vacuum chamber was set lower by 196 to 882 Pa than the atmospheric pressure. The support was destaticized by ionized wind before the coating.

In the subsequent chilling zone, the coating solution was cooled with air at a dry bulb temperature of 10 to 20° C. The sample was then subjected to contact-free transportation and in a helical floating-type dryer, dried with drying air at a dry bulb temperature of 23 to 45° C. and a wet bulb temperature of 15 to 21° C.

After drying, the humidity was adjusted to 40 to 60% RH at 25° C. and then, the layer surface was heated to 70 to 90° C. The heated layer surface was then cooled to 25° C.

The heat-developable photosensitive material thus prepared had a matting degree of, in terms of the Beck's smoothness, 550 seconds on the photosensitive layer surface and 130 seconds on the back surface. Furthermore, the pH on the layer surface in the photosensitive. layer side was measured and found to be 6.0.

<Preparation of Heat-Developable Photosensitive Material 2>

Heat-Developable Photosensitive Material 2 was prepared in the same manner as Heat-Developable Photosensitive Material 1 except that in the preparation of Heat-Developable Photosensitive Material 1, Coating Solution 1 for Emulsion Layer was changed to Coating Solution 2 for Emulsion Layer, Yellow Dye Compound 15 was eliminated from the antihalation layer, and the fluorine-containing surfactants in the back surface protective layer and emulsion surface protective layer were changed from F-1, F-2, F-3 and F-4 to F-5, F-6, F-7 and F-8, respectively.

The coated amount (g/m²) of each compound in this emulsion layer is shown below.

| | |
|---|---|
| Silver behenate | 5.55 |
| Pigment (C.I. Pigment Blue 60) | 0.036 |
| Polyhalogen Compound 1 | 0.12 |
| Polyhalogen Compound 2 | 0.37 |
| Phthalazine Compound 1 | 0.19 |
| SBR Latex | 9.67 |
| Reducing Agent 2 | 0.81 |
| Hydrogen Bond-Forming Compound 1 | 0.30 |
| Development Accelerator 1 | 0.024 |
| Development Accelerator 2 | 0.010 |
| Development Accelerator 3 | 0.015 |
| Color Tone Adjuster 1 | 0.010 |
| Mercapto Compound 2 | 0.002 |
| Silver halide (as Ag) | 0.091 |

Chemical structures of the compounds used in Examples of the present invention are shown below.

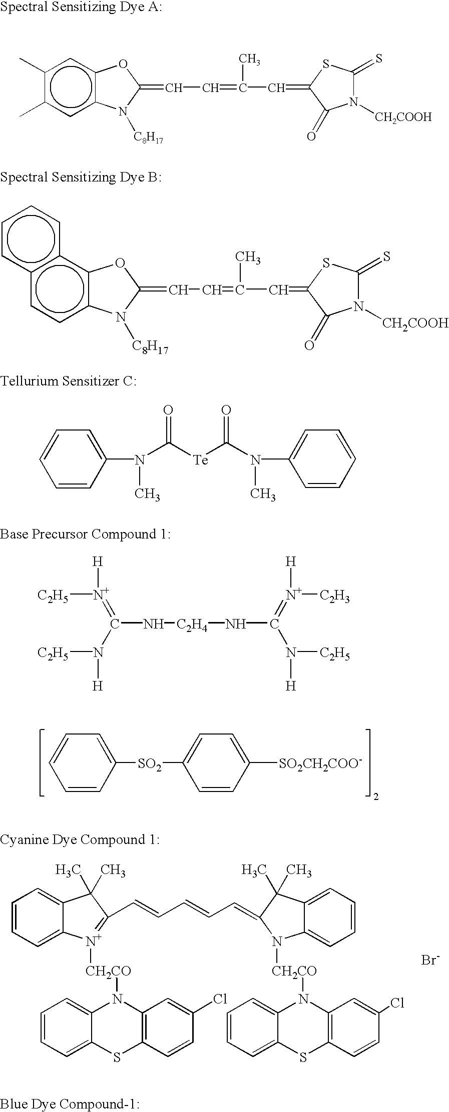

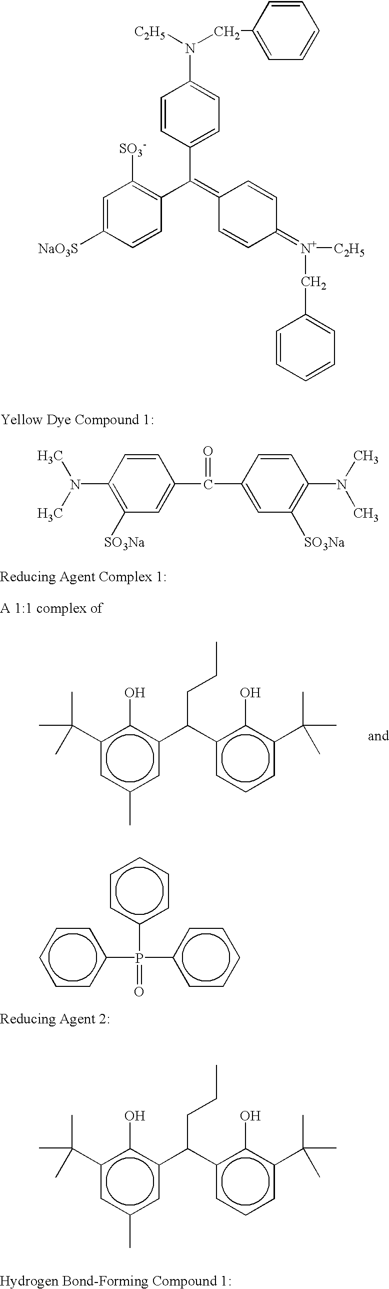

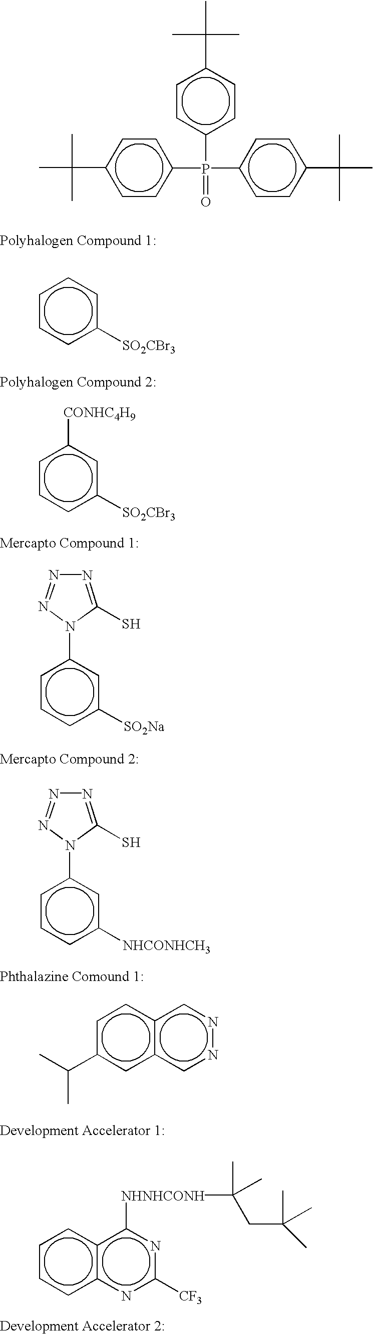

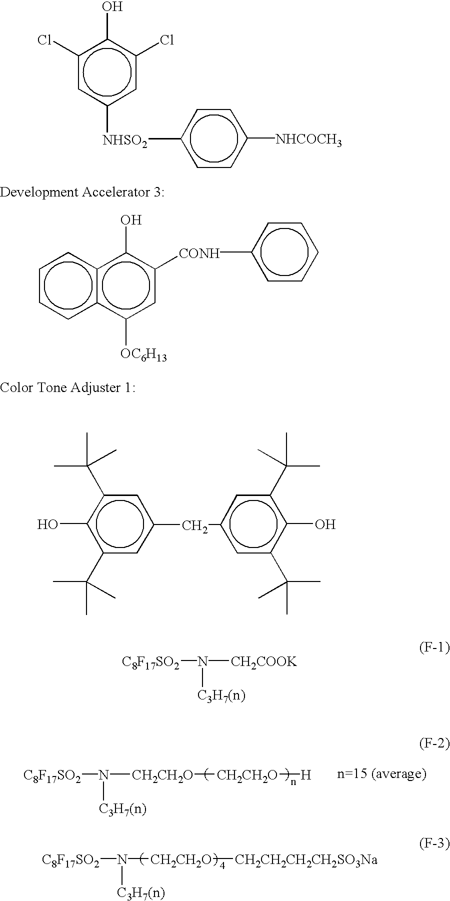

(F-4) C₈F₁₇SO₃K

(F-5) CF₃(CF₂) CH₂CH₂SCH₂CH₂COOLi

a mixture of n=5 to 11

(F-6) CF₃(CF₂) CH₂CH₂O(CH₂CH₂O)ₘH

a mixture of n=5 to 11, m=5 to 15

(F-7) CF₃(CF₂)ₙCH₂CH₂SO₃Na

a mixture of n=5 to 11

(F-8) C₆F₁₃CH₂CH₂SO₃Li

(Evaluation of Photographic Performance)

The samples obtained each was cut into a size of 356×432 mm, wrapped with the following packaging material in the environment of 25° C. and 50% RH, stored at an ordinary temperature for 2 weeks and then evaluated on the items shown below.

(Packaging Material)

Polyethylene (50 μm) containing 10 μm of PET/12 μm of PE/9 μm of aluminum foil/15 μm of Ny/3% of carbon:

oxygen permeability: 0 ml/atm·m²·25° C.·day

water permeability: 0 g/atm·m²·25° C.·day

The samples each was exposed and heat-developed (with four sheets of panel heater set at 112° C.-119° C.-121° C.-211° C., for 24 seconds in total in the case of Heat-Developable Photosensitive Material 1 and for 12 seconds in total in the case of Heat-Developable Photosensitive Material 2) in “Fuji Medical Dry Laser Imager FM-DP L” (in which a semiconductor laser of 660 nm having a maximum output of 60 mW (IIIB) was mounted). The obtained image was evaluated by a densitometer.

(Evaluation of Image Preservability)

Samples after heat development each was aged for 2 days in a room (30° C., 70% RH) with fluorescent light (illuminance: 1,000 lux) under two kinds of conditions (condition (1): aged as it was; condition (2): aged by placing a filter of density=1.0 on the sample evaluated). This test was performed by imaging the case where a heat-developed sample is superposed with another actual sample (having an image) and undergoes print out due to aging under room light. Samples reduced in the change of density under the condition (1) are preferred, and samples where the difference in density after aging is small between the condition (1) and the condition (2) are more preferred because these samples exhibit good performance with respect to the print out when samples are laid one on another.

TABLE 15

| | Heat- | Chloride | Chloride Ion | Presence | | Photo- | | | | |
|---|---|---|---|---|---|---|---|---|---|---|
| | Developable | Ion | Concentra- | or Absence | Photo- | graphic | | | ΔFog of | |
| | Photo- | Concen- | tion Based | of | graphic | Properties | | | Condition | |
| | sensitive | tration in | on Organic | Mercapto | Properties | after Heat | Condition | Condition | (1) − | |
| Test | Material | SBR Latex | Silver Salt | Compound | after Heat | Develop- | (1), ΔFog | (2), ΔFog | Condition | |
| No. | (Note 1) | Solution | (ppm) | (Note 2) | Development | ment | Density | Density | (2) | Remarks |
| 1 | 1 | 300 | 1220 | added | 0.15 | 4.0 | 0.10 | 0.05 | 0.05 | Comparison |
| 2 | 1 | 140 | 570 | added | 0.15 | 4.0 | 0.05 | 0.03 | 0.02 | Invention |
| | | | | | | | | | | (preferred |
| | | | | | | | | | | embodiment) |
| 3 | 1 | 50 | 200 | added | 0.15 | 4.0 | 0.04 | 0.03 | 0.01 | Invention |
| | | | | | | | | | | (preferred |
| | | | | | | | | | | embodiment) |
| 4 | 1 | 10 | 40 | added | 0.05 | 4.0 | 0.02 | 0.02 | 0.00 | Invention |
| | | | | | | | | | | (preferred |
| | | | | | | | | | | embodiment) |
| 5 | 2 | 300 | 1220 | added | 0.15 | 4.1 | 0.11 | 0.05 | 0.06 | Comparison |
| 6 | 2 | 140 | 570 | added | 0.15 | 4.1 | 0.06 | 0.03 | 0.03 | Invention |
| | | | | | | | | | | (preferred |
| | | | | | | | | | | embodiment) |
| 7 | 2 | 50 | 200 | added | 0.15 | 4.1 | 0.04 | 0.03 | 0.01 | Invention |
| | | | | | | | | | | (preferred |
| | | | | | | | | | | embodiment) |
| 8 | 2 | 10 | 40 | added | 0.15 | 4.1 | 0.02 | 0.02 | 0.00 | Invention |
| | | | | | | | | | | (preferred |
| | | | | | | | | | | embodiment) |
| 9 | 1 | 140 | 570 | none | 0.15 | 4.0 | 0.06 | 0.03 | 0.03 | Invention |
| 10 | 1 | 50 | 200 | none | 0.15 | 4.0 | 0.05 | 0.03 | 0.02 | Invention |
| 11 | 1 (reducing | 300 | 1220 | added | 0.15 | 4.0 | 0.15 | 0.08 | 0.07 | Comparison |
| | agent = 1-1) | | | | | | | | | |
| 12 | 1 (reducing | 140 | 570 | added | 0.15 | 4.0 | 0.07 | 0.04 | 0.03 | Invention |
| | agent = 1-1) | | | | | | | | | (preferred |
| | | | | | | | | | | embodiment) |

(Note 1)

Test Nos. 11 and 12, reducing agent=1-1:

Samples where the reducing agent complex of Heat-Developable Photosensitive Material 1 was replaced by an equimolar amount of Reducing Agent 1-1 which was dispersed in the same manner.

(Note 2)

Test Nos. 9 and 10, mercapto compound=none:

Samples where Mercapto Compounds 1 and 2 were excluded.

By virtue of the combination of the present invention, excellent image preservability is attained under room light after heat development. When mercapto compounds are added, more excellent image preservability is attained.

### EXAMPLE 8

<Preparation of Silver Halide Grain>

In 700 ml of water, 22 g of phthalated gelatin and 30 mg of potassium bromide were dissolved. Thereto, after adjusting the pH to 5.0 at a temperature of 35° C., 159 ml of an aqueous solution containing 18.6 g of silver nitrate and 0.9 g of ammonium nitrate and an aqueous solution containing potassium bromide and potassium iodide at a molar ratio of 92:8 were added over 10 minutes by a controlled double jet method while keeping the pAg at 7.7. Subsequently, 476 ml of an aqueous solution containing 55.4 g of silver nitrate and 2 g of ammonium nitrate and an aqueous solution containing 10 mmol/liter of dipotassium hexachloroiridate and 1 mol/liter of potassium bromide were added over 30 minutes by a controlled double jet method while keeping the pAg at 7.7. Thereto, 1 g of 4-hydroxy-6-methyl-1,3,3a,7-tetrazaindene was added and the pH was lowered to cause coagulation precipitation, thereby performing the dehydration treatment. Thereafter, 0.1 g of phenoxyethanol was added and the pH and the pAg were adjusted to 5.9 and 8.2, respectively, to complete the preparation of silver iodobromide grains (cubic grains where iodine content of core: 8 mol %, average iodine content: 2 mol %, average size: 0.05 μm, coefficient of variation in projected area: 8%, percentage of (100) faces: 88%).

The thus-obtained silver halide grains were heated to 60° C. and thereto, 85 μmol of sodium thiosulfate, 11 μmol of 2,3,4,5,6-pentafluorophenyldiphenylphosphine selenide, 15 μmol of Tellurium Compound A, 3.4 μmol of chloroauric acid and 200 μmol of thiocyanic acid were added per mol of silver. The mixture was ripened for 120 minutes and then rapidly cooled to 30° C. to obtain a silver halide emulsion.

<Preparation of Organic Acid Silver Salt Emulsion>

An aqueous 1N-NaOH solution (187 ml) was added to 7 g of stearic acid, 4 g of arachidinic acid, 36 g of behenic acid and 850 ml of distilled water which were under vigorous stirring at 90° C., and reacted for 60 minutes. Thereto, 65 ml of 1N-nitric acid was added. Subsequently, the temperature was lowered to 50° C. and while more vigorously stirring, 0.6 g of N-bromosuccinimide was added. After 10 minutes, the previously prepared silver halide grains were added to give a silver halide amount of 6.2 mmol. Furthermore, 125 ml of an aqueous solution containing 21 g of silver nitrate was added over 100 seconds and the resulting solution was continuously stirred for 10 minutes. Thereto, 0.6 g of N-bromosuccinimide was added and the solution was left standing for 10 minutes. Thereafter, the solid content was separated by suction filtration and washed with water until the conductivity of the filtrate became 30 μS/cm. To the thus-obtained solid content, 150 g of a 0.6 wt % butyl acetate solution of polyvinyl acetate was added and the solution was stirred. After the stirring was stopped, the solution was left standing to cause separation into an oil layer and an aqueous layer. The aqueous layer was removed together with salts contained and thereby the oil layer was obtained. To this oil layer, 80 g of a 2.5 wt % 2-butanone solution of polyvinyl butyral (Denka Butyral π3000-K, produced by Denki Kagaku Kogyo K. K.) was added and the mixture was stirred. Furthermore, 0.1 mmol of pyridinium perbromide and 0.1 mmol of calcium bromide dihydrate were added together with 0.7 g of methanol and then, 200 g of 2-butanone and 59 g of polyvinyl butyral (BUTVAR™ B-76 produced by Monsanto, a 2-butanone solution of polyvinyl butyral was washed with water to prepare a sample from which chloride ion was removed, and this sample and a normal sample were mixed at a desired ratio to control the chloride ion concentration in the polyvinyl butyral; the concentration is shown in Table 16) were added and dispersed in a homogenizer to obtain an organic acid silver salt emulsion (needle-like grains where the average short diameter was 0.04 μm, the average long diameter was 1 μm, and the coefficient of variation was 30%).

<Preparation of Coating Solution for Emulsion Layer>

To the organic acid silver salt emulsion obtained above, chemicals were added each in an amount shown below per mol of silver. At 25° C., 10 mg of sodium phenylthiosulfonate, 80 mg of Dye A, 2 g of 2-mercapto-5-methylbenzimidazole, 12 g of 4-chlorobenzophenone-2-carboxylic acid, 10 q of monobutyl phthalate, 580 g of 2-butanone and 220 g of dimethylformamide were added while stirring. Thereafter, 3 g of 5-tribromomethylsulfonyl-2-methylthiadiazole, 3 g of tribromomethylnaphthylsulfone, 6 g of tribromomethylphenylsulfone, 5 g of 4,6-ditrichloromethyl-2-phenyltriazine, 2 g of disulfide compound, 50 g of 1,1-bis(2-hydroxy-3,5-dimethylphenyl)-2-methylpropane, 100 g of 1,1-bis(2-hydroxy-3,5-dimethylphenyl)-3,5,5-trimethylhexane, 12 g of Dye A, 1.1 g of Megafac F-176P (fluorine-containing surfactant produced by Dainippon Ink & Chemicals Inc.), 590 g of methyl ethyl ketone (MEK) and 10 g of methyl isobutyl ketone (MIBK) were added while stirring to obtain a coating solution for emulsion layer.

<Coating Solution for Protective Layer on Emulsion Surface>

CAB171-15 (75 g) (cellulose acetate butyrate, produced by Eastman Chemical Co.), 5.7 g of 4-methylphthalic acid, 1.5 g of tetrachlorophthalic anhydride, 12.5 g of phthalazine, 5.1 g of tetrachlorophthalic acid, 0.3 g of Megafac F-176P, 2 g of SILDEX H31 (spherical silica, produced by Tokai Kagaku, average size: 3 μm) and 7 g of Sumidur N3500 (polyisocyanate, produced by Sumitomo Beyer Urethane) were dissolved in 3,070 g of MEK and 30 g of ethyl acetate to prepare a coating solution for protective layer on the emulsion surface.

<Coating of Back Surface>

Polyvinyl butyral (6 g) (Denka Butyral π4000-2, produced by Denki Kagaku Kogyo K. K.), SILDEX H121 (spherical silica, produced by Tokai Kagaku, average size: 12 μm, 0.2 g of SILDEX H51 (spherical silica, produced by Tokai Kagaku, average size: 5 μm) and 0.1 g of Megafac F-176P were added with stirring, dissolved and mixed in 64 g of 2-propanol. Thereto, a 10 g methanol and 20 g acetone solution containing 420 mg of Dye A, and a 7 g ethyl acetate solution containing 1 g of 3-isocyanatomethyl-3,5,5-trimethylhexyl isocyanate were added to prepare a coating solution.

On a polyethylene terephthalate film with both surfaces having a moisture-proof undercoat layer containing vinylidene chloride, the coating solution for back surface was coated to give an optical density of 0.4 at 810 nm. The smoothness on the back surface (the Beck smoothness was determined using the Ohken smoothness measurement described in Paper Pulp Test Method No, 5 of J. TAPPI) was 80 seconds.

<Preparation of Photosensitive Material>

On a 175-μm polyethylene terephthalate support with the back surface being previously coated as above, an emulsion layer and an emulsion surface protective layer were provided by coating the coating solution for emulsion layer to a coverage of 2.5 μm² as silver and the coating solution for emulsion surface protective layer to have a dry thickness of 2 sun. The residual solvent amount on the emulsion layer-coated surface of the coated sample was measured by gas chromatography, as a result, from 40 to 200 ppm of MEK, from 10 to 100 ppm of MIBK and from 40 to 120 ppm of butyl acetate were detected, based on the weight of coated material.

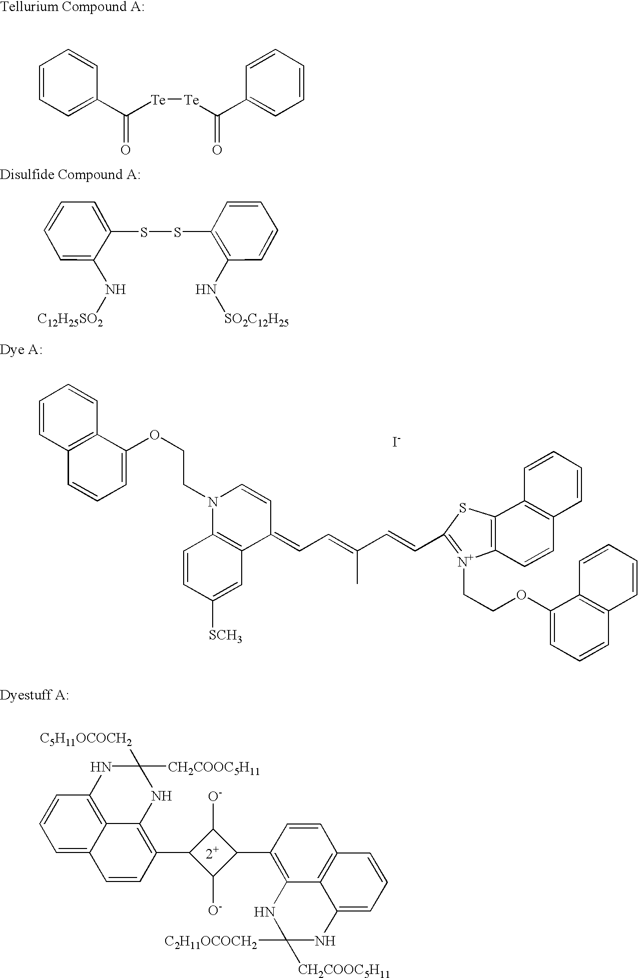

(Evaluation of Photographic Performance)

The photographic material was exposed by a laser sensitometry equipped with a diode of 810 nm and then processed (developed) at 120° C. for 15 seconds. The evaluation was performed using a densitometer.

(Evaluation of Image Preservability)

The evaluation was performed in the same manner as in Example 7 and similar results were obtained.

TABLE 16

| | | Chloride Ion | | | | | | |
|---|---|---|---|---|---|---|---|---|
| | | Concentration | Photographic | Photographic | | | | |
| | Chloride Ion | Based on | Properties | Properties | | | | |
| | Concentration | Organic | after Heat | after Heat | Condition | Condition | ΔFog Density of | |
| Test | in Polyvinyl | Silver Salt | Development | Development | (1), ΔFog | (2), ΔFog | Condition (1) − | |
| No. | Butyral | (ppm) | (Dmin) | (Dmax) | Density | Density | Condition (2) | Remarks |
| 1 | 400 | 390 | 0.18 | 4.1 | 0.09 | 0.06 | 0.03 | Invention |
| 2 | 100 | 98 | 0.18 | 4.1 | 0.06 | 0.04 | 0.02 | Invention |
| 3 | 45 | 44 | 0.18 | 4.1 | 0.03 | 0.03 | 0.00 | Invention |
| | | | | | | | | (preferred |
| | | | | | | | | embodiment) |
| 4 | 10 | 10 | 0.18 | 4.1 | 0.02 | 0.02 | 0.00 | Invention |
| | | | | | | | | (preferred |
| | | | | | | | | embodiment) |
| 5 | 670 | 650 | 0.18 | 4.1 | 0.15 | 0.07 | 0.08 | Comparison |

While the invention has been described in detail and with reference to specific embodiments thereof, it will be apparent to one skilled in the art that various changes and modifications can be made therein without departing from the spirit and scope thereof.

The entire disclosure of each and every foreign patent application from which the benefit of foreign priority has been claimed in the present application is incorporated herein by reference, as if fully set forth.

What is claimed is:

1. A photothermographic material comprising a support and on the same surface of the support, a photosensitive silver halide, a non-photosensitive organic silver salt, a reducing agent, a binder, cloride ion and a development accelerator,
wherein the concentration of chloride ion on said same surface is 1,000 ppm or less based on said organic silver salt.

2. The photothermographic material as claimed in claim 1, wherein said binder contains a polymer latex.

3. The photothermographic material as claimed in claim 2, wherein the concentration of chloride ion in said polymer latex is 300 ppm or less based on the latex solution.

4. The photothermographic material as claimed in claim 3, wherein said polymer latex contains a chelate compound in an amount of 20 to 900 ppm based on the latex solution.

5. The photothermographic material as claimed in claim 2, wherein said polymer latex is a polymer latex synthesized by emulsion polymerization in the presence of a basic compound.

6. The photothermographic material as claimed in claim 2, wherein the ratio (dv/dn) of the volume weighted average diameter (dv) to the number average diameter (dn) of dispersed particles in said polymer latex is from 1:00 to 1.10.

7. The photothermographic material as claimed in claim 1, wherein said development accelerator is at least one compound represented by the following formula (1), (5) or (6):
Q¹-NHNH—R¹ (1)
wherein Q¹ represents a 5-, 6- or 7-membered unsaturated ring bonded to NHNH—R¹ through a carbon atom, and R¹ represents a carbamoyl group, an acyl group, an alkoxycarbonyl group, an aryloxycarbonyl group, a sulfonyl group or a sulfamoyl group; 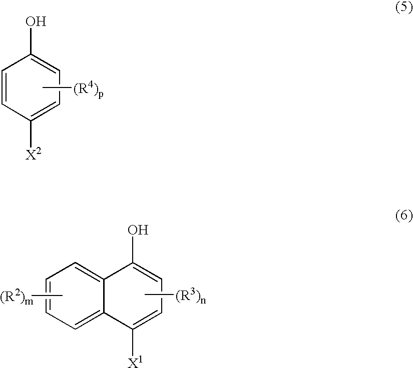
wherein X¹ and X² each independently represents a hydrogen atom or a substituent, R² to R⁴ each independently represents a hydrogen atom or a substituent, m and p each independently represents an integer of 0 to 4, and n represents an integer of 0 to 2.

8. The photothermographic material as claimed in claim 1, wherein the molar ratio of alkali metal ion to NH₄⁺ ion on the surface that said binder resides is from 1:5 to 1:0.5.

9. The photothermographic material as claimed in claim 2, wherein the molar ratio of alkali metal ion to NH₄⁺ ion in said polymer latex is from 1:5 to 1:0.5.

10. The photothermographic material as claimed in claim 9, wherein the alkali metal ion contains at least one of Li⁺, Na⁺ and K⁺.

11. The photothermographic material as claimed in claim 9, wherein the polymer latex is a polymer latex of styrene/butadiene copolymer.

12. A photothermographic material comprising a support and on the same surface of the support, a photosensitive silver halide, a non-photosensitive organic silver salt, a reducing agent and a binder,
wherein the concentration of chloride ion in all layers in the side of a layer containing said photosensitive silver halide is 1,000 ppm or less based on said organic silver salt, and the photothermographic material comprises a compound represented by the following formula (A): 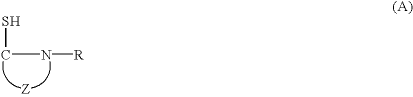
wherein Z represents an atomic group necessary for forming a 5- or 6-membered heteroaromatic ring having at least two or more nitrogen atoms, R represents a hydrogen atom, an alkyl group, an aralkyl group, an alkoxy group, an aryl group, an alkyl group substituted by a substituent (an amino group, an amide group, a sulfonamide group, a ureido group, a urethane group, an aryloxy group, a sulfamoyl group, a carbamoyl group, an aryl group, an alkylthio group, an arylthio group, a hydroxy group, a halogen atom, a sulfonic acid group, a carboxylic acid group, a cyano group, a carboxy group or a salt thereof, or a phosphoric acid amide group) or an aryl group substituted by a substituent (an amino group, an amide group, a sulfonamide group, a ureido group, a urethane group, an aryloxy group, a sulfamoyl group, a carbamoyl group, an aryl group, an alkylthio group, an arylthio group, a hydroxy group, a halogen atom, a sulfonic acid group, a carboxylic acid group, a cyano group, a carboxy group or a salt thereof, or a phosphoric acid amide group).

13. The photothermographic material as claimed in claim 12, wherein said photosensitive silver halide is chemically sensitized.

14. The photothermographic material as claimed in claim 12, wherein said silver halide emulsion is subjected to gold sensitization.

15. The photothermographic material as claimed in claim 12, wherein the average grain size of said silver halide emulsion is from 30 to 50 nm.

16. The photothermographic material as claimed in claim 12, wherein the concentration of chloride ion in all layers in the side of a layer containing said photosensitive silver halide on said support is 200 ppm or less based on said organic silver salt.

17. A photothermographic material comprising a support and on the same surface of the support, a photosensitive silver halide, a non-photosensitive organic silver salt, a reducing agent and a binder,
wherein said non-photosensitive organic salt has a silver behenate content of 90 to 100 mol %, and said binder contains a polymer latex containing halide ion in an amount of 500 ppm or less based on the latex solution.

18. The photothermographic material as claimed in claim 17, wherein said polymer latex contains a chelate compound in an amount of 20 to 900 ppm based on the latex solution.

19. The photothermographic material as claimed in claim 17, wherein said polymer latex is a polymer latex synthesized by emulsion polymerization in the presence of a basic compound.

20. The photothermographic material as claimed in claim 17, wherein in said polymer latex, the ratio (dv/dn) of the volume weighted average diameter (dv) to the number average diameter (dn) of dispersed particles is from 1.00 to 1.10.

21. The photothermographic material as claimed in claim 17, wherein said non-photosensitive organic silver salt has a silver behenate content of 94 to 99.5 mol %.

22. The photothermographic material as claimed in claim 17, wherein said non-photosensitive organic silver salt particle has an aspect ratio of 1 to 9.

23. A process for producing a non-photosensitive organic silver salt particle, comprising adding a solution containing silver ion and a solution or suspension of an organic acid alkali metal salt into closed mixing means to prepare said non-photosensitive organic silver salt particle used in the photothermographic material claimed in claim 1.

24. A process for producing a non-photosensitive organic silver salt particle, comprising ultrafiltering and thereby desalting said non-photosensitive organic silver salt particle used in the photothermographic material claimed in claim 1.

25. A process for producing a non-photosensitive organic silver salt particle, comprising:
adding a solution containing silver ion and a solution or suspension of an organic acid alkali metal salt into closed mixing means to prepare said non-photosensitive organic silver salt grain used in the photothermographic material claimed in claim 1; and
ultrafiltering and thereby desalting said non-photosensitive organic silver salt particle.

26. A photothermographic material comprising a support and on the same surface of the support, a photosensitive silver halide, a non-photosensitive organic silver salt, a reducing agent and a binder,
wherein said non-photosensitive organic silver salt contains two or more reducible silver(I) ions in one molecule, and said binder contains a polymer latex containing a halogen ion in an amount of 500 ppm or less based on the latex solution.

27. The photothermographic material as claimed in claim 26, wherein said polymer latex contains a chelate compound in an amount of 20 to 900 ppm based on the latex solution.

28. The photothermographic material as claimed in claim 26, wherein said polymer latex is a polymer latex synthesized by emulsion polymerization in the presence of a basic compound.

29. The photothermographic material as claimed in claim 26, wherein in said polymer latex, the ratio (dv/dn) of the volume weighted average diameter (dv) to the number average diameter (dn) of dispersed particles is from 1.00 to 1.10.

30. A photothermographic material comprising a support and on the same surface of the support, a photosensitive silver halide, a non-photosensitive organic silver salt, a reducing agent and a binder,
wherein the concentration of chloride ion on said same surface is 600 ppm or less based on the weight of said organic silver salt, and said reducing agent containes a compound represented by the following formula (R): 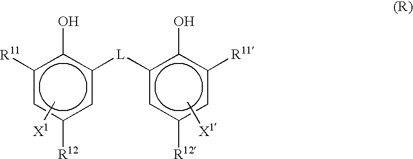
wherein R¹¹ and R¹¹′ each independently represents an alkyl group having from 1 to 20 carbon atoms, R¹² and R¹²′ each independently represents a hydrogen atom or a substituent capable of substituting to the benzene ring, L represents a —S— group or a —CHR¹³— group, R¹³ represents a hydrogen atom or an alkyl group having from 1 to 20 carbon atoms, and X¹ and X¹′ each independently represents a hydrogen atom or a group capable of substituting to the benzene ring.

31. The photothermographic material as claimed in claim 30, wherein said binder contains a polymer latex in a proportion of 60 to 100 wt %.

32. The photothermographic material as claimed in claim 30, wherein said binder contains polyvinyl butyral in a proportion of 60 to 100 wt %.

33. The photothermographic material as claimed in claim 31, wherein the concentration of chloride ion in said polymer latex is 100 ppm or less based on said polymer latex solution.

34. The photothermographic material as claimed in claim 32, wherein the concentration of chloride ion in said polyvinyl butyral is 50 ppm or less based on said polyvinyl butyral.

35. The photothermographic material as claimed in claim 30, wherein any one of the layers on the same surface of a support contains a compound represented by the following formula (II): 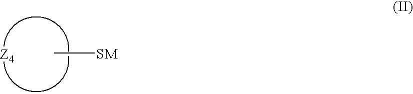
wherein Z₄ represents a heterocyclic ring and M represents a hydrogen atom, an alkali metal atom or a quaternary ammonium or phosphonium group.

36. The photothermographic material as claimed in claim 30, wherein in formula (I), R¹¹ and R¹¹′ each is independently a tertiary alkyl group.
